(19) United States
(12) Patent Application Publication
(10) Pub. No.: US 2011/0288877 A1
(43) Pub. Date: Nov. 24, 2011

(54) Health Information Exchange and Integration System and Methods Useful in Conjunction Therewith

(75) Inventors: Ziv Ofek, Meitar (IL); Shiri Ben-Tal, Omer (IL); Yuri Ackerman, Be'er Sheva (IL); Ychonatan Mazar, Jerusalem (IL); Yinon Zohar, Be'er Sheva (IL); Dmitry Sigalov, Ashdod (IL); Ohad Young, Tel-Aviv (IL); Ziv Gome, Beit Kama (IL); Boris Giterman, Be'er Sheva (IL); David Boaz, Netanya (IL)

(73) Assignee: dbMotion Ltd., Hod Hasharon (IL)

(21) Appl. No.: 12/840,806

(22) Filed: Jul. 21, 2010

Related U.S. Application Data
(60) Provisional application No. 61/259,437, filed on Nov. 9, 2009.

(51) Int. Cl. G06Q 50/00; G06F 17/30

(52) U.S. Cl. 705/2; 707/661; 707/769; 707/E17.005

(57) ABSTRACT

A health information exchange system comprising ontological apparatus for defining and storing ontological link elements ontologically linking between individual health care information items within a first population of health care information items; apparatus for receiving a second population of health care information items and for associating at least some individual items in the second population, with corresponding individual items within the first population of health care information items; and apparatus for responding to queries regarding particular information items in the second population including translating the particular information items into items in the first population corresponding to the particular information items and using link elements linking the items in the first population corresponding to the particular information items to generate data pertaining to the particular information items in the second population.

### REFERENCE TO CO-PENDING APPLICATIONS

Priority is claimed from U.S. provisional application No. 61/259,437 “Health information exchange and integration system and methods useful in conjunction therewith” filed on Nov. 9, 2009.

### FIELD OF THE INVENTION

The present invention relates generally to information processing systems and more particularly to health information processing systems.

### BACKGROUND OF THE INVENTION

State of the art health information exchange and integration systems, and conventional technology pertaining to certain embodiments of the present invention, are described in the following publications inter alia:
US20080046292
Platform for interoperable healthcare data exchange
MYERS, Scott, D
US20050144043
Medication management system
Holland, Geoffrey N

Specifically, US20080046292 describes a health information exchange system which is based on program codes for implementing health information exchange, plus archiving the data of the patients and use of semantic technology for retrieving data. US20050144043 describes a medical management unit having its own caching mechanism. The management unit is capable of making its decisions and implementing them.

Other prior art references include:

| Document No. | Title |
|---|---|
| 1. US20070118540 | Integrating medical data and images in a database |
| | management system |
| 2. US20090125555 | Method and apparatus for flexible archiving |
| 3. US20080189496 | Patient and user oriented data archiving |
| 4. WO2007010485 | Automated system for capturing and archiving |
| | information to verify medical necessity of performing |
| | medical procedure |
| 5. JP6243152 | Program archive system |
| 6. DE10163469 | Storage of medical images in an archive with an |
| | associated keyword, so that a doctor or specialist |
| | subsequently treating a patient can access relevant |
| | images |
| 7. US20040141661 | Intelligent medical image management system |
| 8. US20090080408 | Healthcare semantic interoperability platform |
| 9. US20040122709 | Medical procedure prioritization system and method |
| | utilizing integrated knowledge base |
| 10. US20040122719 | Medical resource processing system and method |
| | utilizing multiple resource type data |
| 11. US20040122787 | Enhanced computer-assisted medical data processing |
| | system and method |
| 12. US20040122707 | Patient-driven medical data processing system and |
| | method |

The first eight references above describe archiving of health information using a coding procedure. Specifically:

WO2007010485 describes “an interoperable healthcare data exchange platform for gathering health records from a plurality of disparate locations, the platform comprising: a message handling service to request and receive the health records in real time, wherein the message handling service converts the health records to a standard protocol; a mapping engine that receives the converted health records and maps the converted health records to a standard heath terminology; a data store for receiving and storing the mapped, converted health records, wherein the data store stores the mapped, converted health records (emphasis added) using the standard protocol and the standard heath terminology; and a information governance application for providing controlled access to the data store. The above reference does not store non-mapped records and use these to perform translations/mappings, including semantics, at query time.

US2004122709 may be pertinent to making clinical conclusions based on patient data, but does not use semantically enriched vocabulary in order to simplify rule definition and evaluation.

The last four references, 9-12 above each describe a health information system that is capable of responding to queries and making decisions.

Non-Patent Literature describing health information exchange through the use of semantic technology includes:

### Comput Methods Programs Biomed., 2009, 93 (3), 297-312 #1

XML technologies for the Omaha System: a data model, a Java tool and several case studies supporting home healthcare

### Vittorini Pierpaolo; Tarquinio Antonietta; di Orio Ferdinando

### Digital Society, 2009. ICDS '09 Third International Conference 168 173 #2

### Semantic Exchange of Medicinal Data: A Way Towards Open Healthcare Systems

### Puustjarvi, J and Puttstjarvi, L

### Engineering in Medicine and Biology Society, 2009. EMBC 2009. Annual International Conference of the IEEE, 1726-1729 #3

Interoperability of personal health records

### Lahteenmaki Jaakko; Leppanen, Juha and Kaijanranta, Hannu

### Information Technology: N Generations, 2009. ITNG '09. Sixth

International Conference; 308-313 #4

Healthcare Applications Interoperability through Implementation of HL7 Web Service Basic Profile

### Hussain, M; Afza M; Ahmad H. F.; Khalid, N and Ali, A

### Computer-Based Medical Systems, 2009. CBMS 2009. 22nd IEEE International Symposium; 1-6 #5

Ontology-based approach to ac hieve semantic mteroperability on exchanging and integrating information about the patient clinical evolution's

### Miyoshi, N, Ferreira A and Felipe J. C

### Computer-Based Medical Systems, 2009. CBMS 2009. 22nd IEEE International Symposium; 1-6 #6

Semantic biological image management and analysis

### Chubb C, Inagaki, Y Co man C, Cummings B and Sheu, P. C

Published PCT Application WO/2007/084502 describes an interoperable healthcare data exchange platform for gathering health records from a plurality of disparate locations which converts health records to a standard protocol and maps the converted health records to a standard heath terminology. A data store is operative for receiving and storing the mapped, converted health records.

Lähteenmäki, Jaakko, Leppänen, Juha, Kaijanranta, Hannu, “Interoperability of Personal Health Records” (2009) 31st Annual Int. Conference of the IEEE Engineering in Medicine and Biology Society, EMBC'09, Minneapolis, Minn., USA, 2-6 Sep. 2009, EMBC'09 DVD, 1726-1729 describes requirements related to exchanging non-clinical PHR information between services and an information exchange which utilizes a SOAP message for carrying the actual PHR content in a document which provides mechanisms to bind the contents to external vocabularies and ontologies to achieve semantic interoperability. The publication does not describe inclusion of clinical concepts in an ontology (as opposed to just classifications thereof) to facilitate mapping of a legacy concept to an ontology concept, thereby to provide legacy concept interoperability as opposed to classification level interoperability.

Miyoshi, N. Ferreira, A. Felipe, J. C., “Ontology-based approach to achieve semantic interoperability on exchanging and integrating information about the patient clinical evolution”, Computer-Based Medical Systems, 2009. CBMS 2009. 22nd IEEE International Symposium on Issue Date: 2-5 Aug. 2009 describes an ontology for a patient clinical evolution record, using the UMLS semantic network as an upper-level ontology, based on a clinical data structure, and attempts to use this ontology as a semantic connection between two distinct health databases in their data integration process.

Other documents representing the state of the art include:

Healthcare Services Specification Project (HSSP) Service Functional Model (SFM) Specification—Decision Support Service (DSS), Version 1.0, Sep. 27, 2006, available on the World Wide Web.

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide a decision making system including a system of logic including hierarchical semantic relationships, a plurality of systems of medical information which are provided in a plurality of local terminologies respectively, and decision making apparatus for transforming the medical information in the local terminologies to transformed information usable by the system of logic and for using the system of logic to make at least one decision based on the transformed information, without translating the system of logic into the plurality of local terminologies. The term “terminology” is intended to include any scheme for representing medical information. The following terms and other terms defined herein may be construed either in accordance with any definition thereof appearing in the prior art literature or in accordance with the specification, or as follows:
Classification Type—A base set of classifications which all others derive from. The existing classifications are:
   Candidate—represents a new population element entering the system.
   ActiveMember—represents a member of the population currently being monitored
   DormantMember—represents a member who is “sleeping” or currently active but not being monitored (in a dormant state)
Evaluation Task—an evaluation task combines a set of executable rules, an evaluation goal, activation, and a set of triggering rule subscriptions. When a member is associated with a task (by having a specific classification) the triggering rule subscriptions are sent to the Data Event Monitor for that member. When that task processing is activated, if that member has had any matching triggering rules fire, the task is sent to be processed (along with the member details).
Member—The population element of a specific Guard, each member is tagged with its population source and contains a list of classifications.
Member Classification—Guard evaluation tasks are grouped by classifications. If a member belongs to a specific classification, that member has certain tasks associated with him or her.
Population Source—the source of members for the Guard, could be an external list, an enrollment service, or a data event monitor.
Triggering Rule Subscription—subscription for the Abstract Rule Monitor, contains a Pattern Rule Identifier and a set of subscription arguments
Schedule—an alarm (scheduled or event based) used to activate processing for a particular evaluation task (or set of evaluation tasks).
DEM: data event monitor e.g. as described herein
EMPI: Conventional Enterprise Master Patient Index service.
Principal Index—AKA (also termed herein) Leading Index
VIA: a commercial Virtual Identity Aggregation service provided by DBMotion Inc., Israel
ACEI: angiotensin-converting enzyme inhibitors
LVS: Left Ventricular Systolic
LVSD: Left Ventricular Systolic Dysfunction
DBMotion: refers to functionality which is either commercially available from DBMotion Inc., Israel or is shown and described herein. Other definitions, acronyms, and abbreviations useful in understanding certain embodiments of the present invention, are provided in the table of FIG. 2.
In accordance with an aspect of the invention, there is provided a health information exchange system comprising an apparatus for archiving health information using a health information encoding procedure only if the health information fulfills a criterion of frequent use; and an apparatus for using a first procedure to respond to queries pertaining to the health information which fulfills the criterion of frequent use and using a second procedure to respond to queries not pertaining to the health information which fulfills the criterion of frequent use.

In accordance with an aspect of the invention, there is further provided a health information exchange system comprising ontological apparatus for defining and storing ontological link elements ontologically linking between individual health care information items within a first population of health care information items; an apparatus for receiving a second population of health care information items and for associating at least some individual items in the second population, with corresponding individual items within the first population of health care information items; and an apparatus for responding to queries regarding particular information items in the second population including translating the particular information items into items in the first population corresponding to the particular information items and using link elements linking the items in the first population corresponding to the particular information items to generate data pertaining to the particular information items in the second population.

In accordance with an embodiment of the invention, there is provided a system comprising an apparatus for making at least one health decision based on the queries.

In accordance with an embodiment of the invention, there is further provided a system also comprising apparatus for implementing the at least one health decision.

In accordance with an embodiment of the invention, there is further provided a system also comprising apparatus for making at least one health decision based on the queries.

In accordance with an embodiment of the invention, there is further provided a system also comprising apparatus for implementing the at least one health decision.

In accordance with an aspect of the invention, there is provided a health information exchange method comprising archiving health information using a health information encoding procedure only if the health information fulfills a criterion of frequent use; and using a first procedure to respond to queries pertaining to the health information which fulfills the criterion of frequent use and using a second procedure to respond to queries not pertaining to the health information which fulfills the criterion of frequent use. In accordance with an aspect of the invention, there is provided a health information exchange method comprising defining and storing link elements linking between individual health care information items within a first population of health care information items; receiving a second population of health care information items and associating at least some individual items in the second population, with corresponding individual items within the first population of health care information items; and responding to queries regarding particular information items in the second population including translating the particular information items into items in the first population corresponding to the particular information items and using link elements linking the items in the first population corresponding to the particular information items to generate data pertaining to the particular information items in the second population.

In accordance with an embodiment of the invention, there is further provided a method also comprising making at least one health decision based on the queries.

In accordance with an embodiment of the invention, there is still further provided a method also comprising implementing the at least one health decision.

In accordance with an embodiment of the invention, there is yet further provided a method also comprising making at least one health decision based on the queries.

In accordance with an embodiment of the invention, there is yet further provided a method also comprising implementing the at least one health decision.

In accordance with an aspect of the invention, there is provided a computer program product, comprising a computer usable medium having a computer readable program code embodied therein, the computer readable program code adapted to be executed to implement a health information exchange method comprising archiving health information using a health information encoding procedure only if the health information fulfills a criterion of frequent use; and using a first procedure to respond to queries pertaining to the health information which fulfills the criterion of frequent use and using a second procedure to respond to queries not pertaining to the health information which fulfills the criterion of frequent use.

In accordance with an aspect of the invention, there is yet further provided a computer program product, comprising a computer usable medium having a computer readable program code embodied therein, the computer readable program code adapted to be executed to implement a health information exchange method comprising defining and storing link elements linking between individual health care information items within a first population of health care information items; receiving a second population of health care information items and for associating at least some individual items in the second population, with corresponding individual items within the first population of health care information items; and responding to queries regarding particular information items in the second population including translating the particular information items into items in the first population corresponding to the particular information items and using link elements linking the items in the first population corresponding to the particular information items to generate data pertaining to the particular information items in the second population.

In accordance with an embodiment of the invention, there is yet further provided a computer program product wherein the method also comprises making at least one health decision based on the queries.

In accordance with an embodiment of the invention, there is yet further provided a computer program product wherein the method also comprises implementing the at least one health decision.

In accordance with an embodiment of the invention, there is yet further provided a computer program product wherein the method also comprises making at least one health decision based on the queries.

In accordance with an embodiment of the invention, there is yet further provided a computer program product wherein the method also comprises implementing the at least one health decision.

In accordance with an embodiment of the invention, there is yet further provided a method wherein the second population of health care information items are expressed in a local terminology and are mapped to a baseline terminology in which the first population of health care information items are expressed, to enable terminology interoperability at least when responding to queries.

In accordance with an embodiment of the invention, there is yet further provided a method wherein the baseline terminology is semantically enriched by associating semantic information therewith, the method also comprising generating conclusions about health information expressed in at least one local terminology by using the semantic information rather than by defining semantic relations for the local terminology.

In accordance with an embodiment of the invention, there is yet further provided a system in which only a subset of a universe of health information is archived.

In accordance with an embodiment of the invention, there is yet further provided a system wherein the apparatus for responding to queries uses a first procedure to respond to queries pertaining to the subset and uses a second procedure to respond to queries not pertaining to the universe of health information but not pertaining to the subset.

In accordance with an embodiment of the invention, there is yet further provided a system also including an end user interface allowing end users to define rules; and a decision support subsystem (DSS) interacting with the end user interface and using semantic capabilities of a baseline terminology in which the first population of health information items is encoded, to simplify definition of rules by the end users.

In accordance with an embodiment of the invention, there is yet further provided a system wherein the decision support subsystem comprises an Enterprise DSS which has a process cycle and which uses DSS rules to define all phases in the process cycle.

In accordance with an embodiment of the invention, there is yet further provided a method wherein the translating and the using is applied to a use case involving processing of Smart Guard Adapters, the processing including at least one of developing, defining and configuring.

In accordance with an embodiment of the invention, there is yet further provided a method wherein the translating and the using is applied to a use case involving a SmartWatch System, the use case including at least one of processing and monitoring health of the system.

In accordance with an embodiment of the invention, there is yet further provided a method wherein the translating and the using are applied to a use case involving Managing Guard runtime.

In accordance with an embodiment of the invention, there is yet further provided a method wherein the translating and the using are applied to a use case involving applying Guard changes.

In accordance with an embodiment of the invention, there is yet further provided a method wherein the translating and the using are applied to a use case involving task activation based upon a schedule.

In accordance with an embodiment of the invention, there is yet further provided a method wherein the translating and the using is applied to a use case involving identifying patients to be added to a defined population of patients.

In accordance with an embodiment of the invention, there is yet further provided a method wherein the translating and the using are applied to a use case involving monitoring a population of patients including determining if they need to be evaluated, evaluating them thereby to generate at least one evaluation result, and responding to the evaluation result.

In accordance with an embodiment of the invention, there is yet further provided a method wherein the health information encoding procedure includes mapping health information expressed in at least one local terminology to a baseline terminology to enable terminology interoperability and storing ontological information interrelating health information items expressed in the baseline terminology.

In accordance with an embodiment of the invention, there is yet further provided a system wherein the ontological apparatus includes interrelationships between clinical-level information items.

In accordance with an embodiment of the invention, there is yet further provided a system wherein the clinical-level information item comprises at least one health care information item specifying at least one of a disease, rather than only a class thereof, and a medication, rather than only a class thereof, such as “Left Ventricular Heart Failure”, rather than “Cardio-vascular disorder”, and “Amoxicillin 250 MG Oral Capsule [Amoxymed]”, rather than “Antibiotic”, respectively.

In accordance with an embodiment of the invention, there is yet further provided a system wherein the ontological apparatus maps at least one legacy concept expressed in local terminology to at least one ontology concept expressed in a baseline terminology thereby allowing queries on the level of a single legacy concept to be responded to, for example, the following legacy concept: (System: ICD9, Code: 428.9, Designation: HEART FAILURE NOS) may be mapped to the following Ontology concept: (System: SNOMED-CT; Code: 84114007; Designation: Heart failure (disorder). Very generic examples of classifications are “Disorder”, “Medicine”, “Procedure”; more specific classification examples are “Cardio-vascular disorder”, “Antibiotics” etc. Classifications do not identify a patient's clinical status; for example, it is not enough to say in clinical record that the patient has “Cardio-vascular disorder” as there are many of such and it is typically useful to know which one of them to decide how to treat it. Examples of clinical-level information items are “Left Ventricular Heart Failure”, “Amoxicillin 250 MG Oral Capsule [Amoxymed]”; these information items are sufficiently detailed to describe aspects of an individual patient's clinical status and/or treatment rather than mere classifications thereof. Also provided is a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1A is a simplified functional block diagram illustration of a health information exchange and integration system constructed and operative in accordance with certain embodiments of the present invention.

FIG. 1B is a table of sequence interaction descriptions useful in understanding the operation of the system of FIG. 1A according to certain embodiments of the present invention.

FIGS. 2 and 3 are a table and a diagram useful in understanding an embodiment of the CTS sub-system of FIG. 1A, a knowledge framework sub-system and a smart-watch sub-system, which interact with a core platform for processing medical information, such as the core platform product available from DBMotion Inc., Israel.

FIGS. 4A-8C are diagrams and other illustrations useful in understanding an embodiment of the knowledge framework sub-system of FIG. 1A.

FIGS. 9-13C are diagrams and other illustrations useful in understanding an example detailed implementation of the knowledge framework sub-unit of FIG. 1A.

FIGS. 14-17 are diagrams and other illustrations useful in understanding an embodiment of the Smart-watch sub-system of FIG. 1A.

FIGS. 18A-137 are diagrams and other illustrations which, particularly in conjunction with FIGS. 9-13, are useful in understanding an example health information exchange and integration system constructed and operative in accordance with certain embodiments of the present invention. Specifically:

FIGS. 18A-105 are diagrams and other illustrations useful in understanding an example implementation of the CTS sub-unit of FIG. 1A.

FIGS. 106A-137 are diagrams and other illustrations useful in understanding an example implementation of the smart-watch sub-unit of FIG. 1A. Specifically:

FIG. 106A is a simplified functional block diagram illustration of the smart-watch sub-unit constructed and operative to certain embodiments of the present invention.

FIG. 106B is a table describing operations, some or all of which may be performed by the system of FIG. 106A.

FIGS. 106C-114 are diagrams and other illustrations useful in understanding an example implementation of the smart-watch service unit of FIG. 106A.

FIGS. 115-123 are diagrams and other illustrations useful in understanding an example implementation of the data event monitor of FIG. 106A.

FIGS. 124-130 are diagrams and other illustrations useful in understanding an example implementation of the person identity service of FIG. 106A.

FIGS. 131-134 are diagrams and other illustrations useful in understanding an example implementation of the temporal monitor of FIG. 106A.

FIGS. 135-137 are diagrams and other illustrations useful in understanding an example implementation of the action manager of FIG. 106A.

FIG. 138 is a SmartWatch-wide high level use case diagram of SmartWatchService use cases and their associated actors provided in accordance with certain embodiments of the present invention.

FIG. 139 is a use-case focused diagram of the smart watch service illustrating SmartWatchService use cases provided in accordance with certain embodiments of the present invention.

FIG. 140 is a diagram of an example Knowledge-Module Entities Model from which a knowledge base repository for the KFW sub-system of FIG. 1A may be derived.

FIG. 141 is a table of typically conventional ontological relationships serving as an example of semantic relationships which may be used by the CTS subsystem of FIG. 1A.

FIGS. 142A-142B, taken together, are an example of a pattern rule comprising a subscription snippet, in XML format.

FIGS. 143A-143B, taken together, are an example of a pattern rule comprising a definition snippet, in XML format.

FIGS. 144A-153 are diagrams and other illustrations useful in understanding an example Enterprise Clinical Decision Support System which may utilize the SmartWatch subunit of FIG. 1A. In particular:

FIGS. 144A-144C illustrate an example HF (heart failure) patients classification including triggering rules and other characteristics for entry and exit tasks.

FIGS. 145A-145D illustrate example admitted HF patient sub-classifications, including triggering rules and other characteristics for entry and exit tasks.

FIGS. 146A-145B illustrate an example of an LVS function evaluation method, including triggering rules and other characteristics for a monitoring task.

FIGS. 147-150 illustrate an example ACEI or ARB for LVSD.

FIGS. 151-152B illustrate an example sub-classification for temp discharged HF patients including triggering rules and other characteristics for entry and exit tasks.

FIG. 153 is a table of Example vocabulary codes useful in the system of FIGS. 144A-153.

### DETAILED DESCRIPTION OF CERTAIN EMBODIMENTS

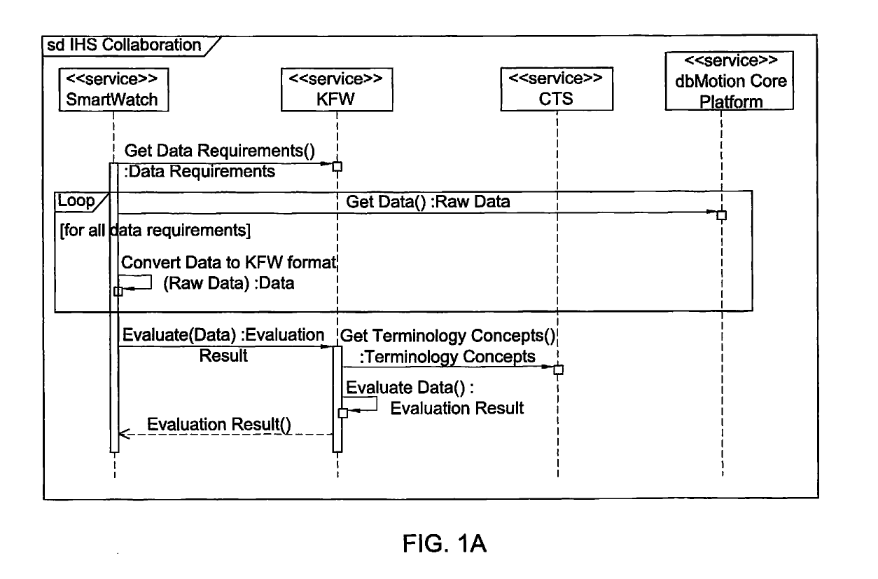

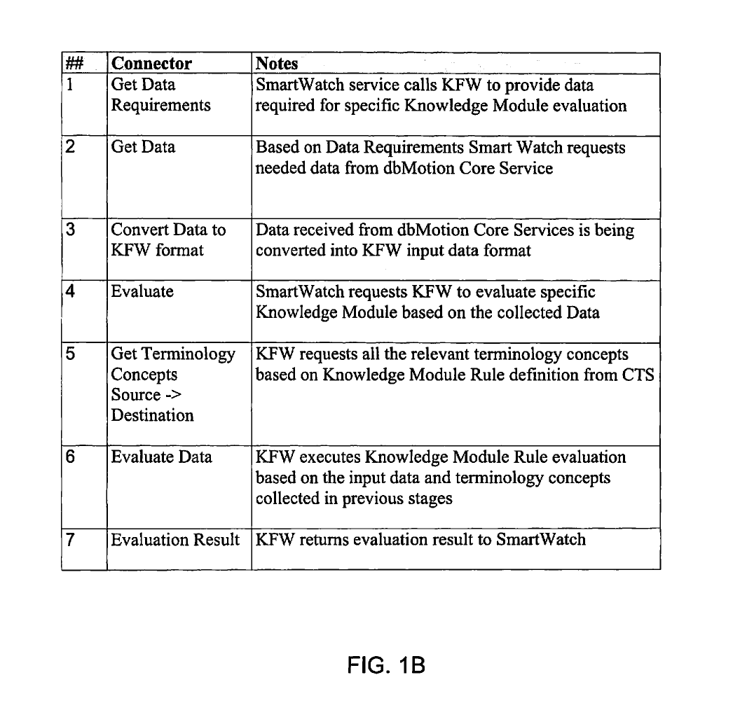

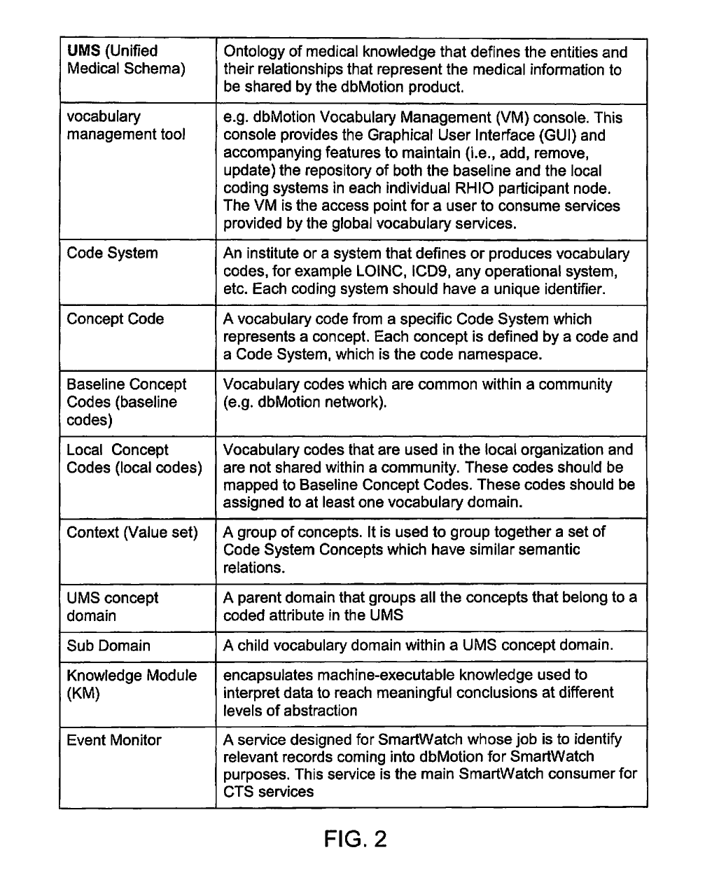

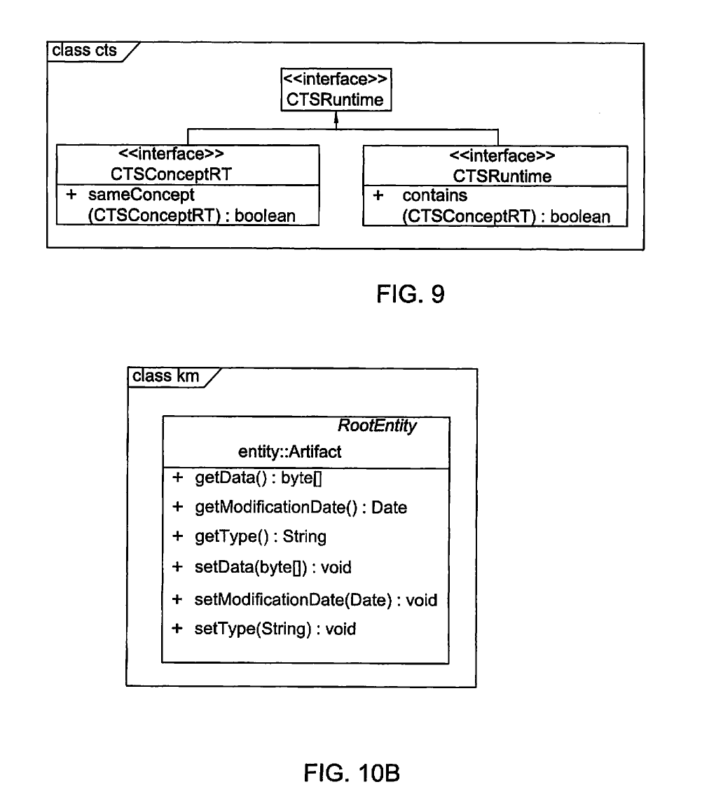

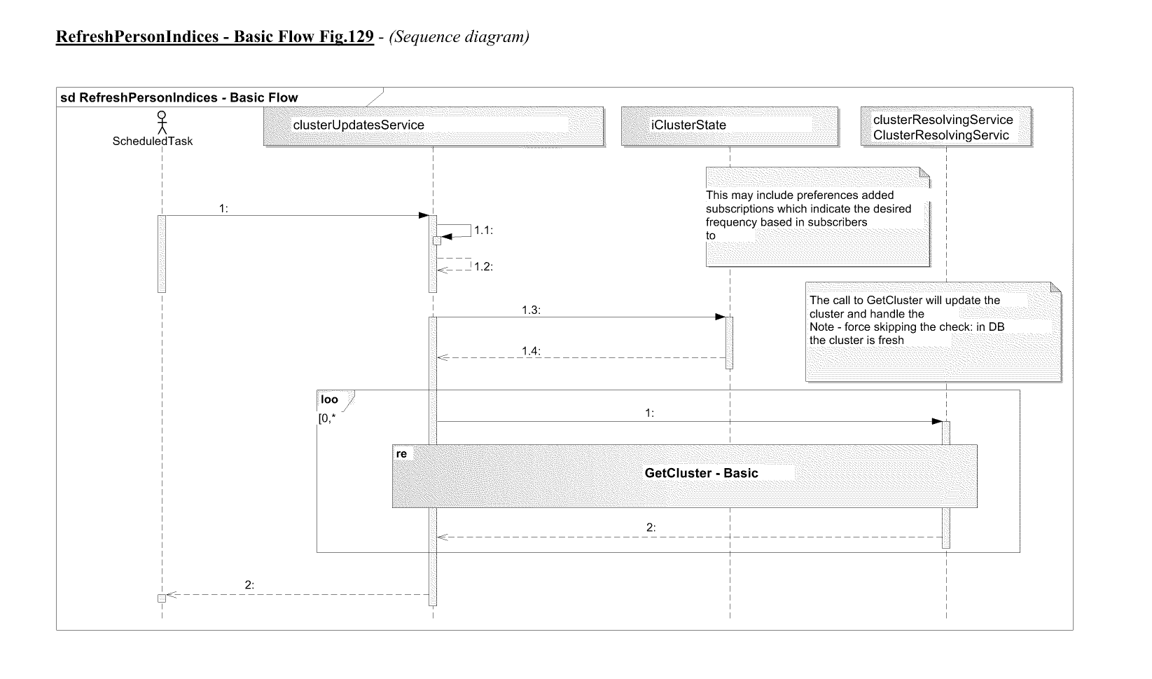

FIG. 1A is a simplified functional block diagram illustration of a health information exchange and integration system constructed and operative in accordance with certain embodiments of the present invention. FIG. 1B is a table of sequence interaction descriptions useful in understanding the operation of the system of FIG. 1A according to certain embodiments of the present invention. As shown, the health information exchange and integration system of FIG. 1A includes 3 typically symbiotic sub-systems namely a CTS sub-system, a knowledge framework sub-system and a smart-watch sub-system, which interact with a core platform for processing medical information, such as the core platform product available from DBMotion Inc., Israel. Embodiments of these subsystems are now described with reference to FIGS. 2-3, FIGS. 4A-8C and FIGS. 14-17 respectively. Detailed descriptions of example implementations of these three subsystems are described further on with reference to FIGS. 18A-105D, 9-13C and 106A-137 respectively.

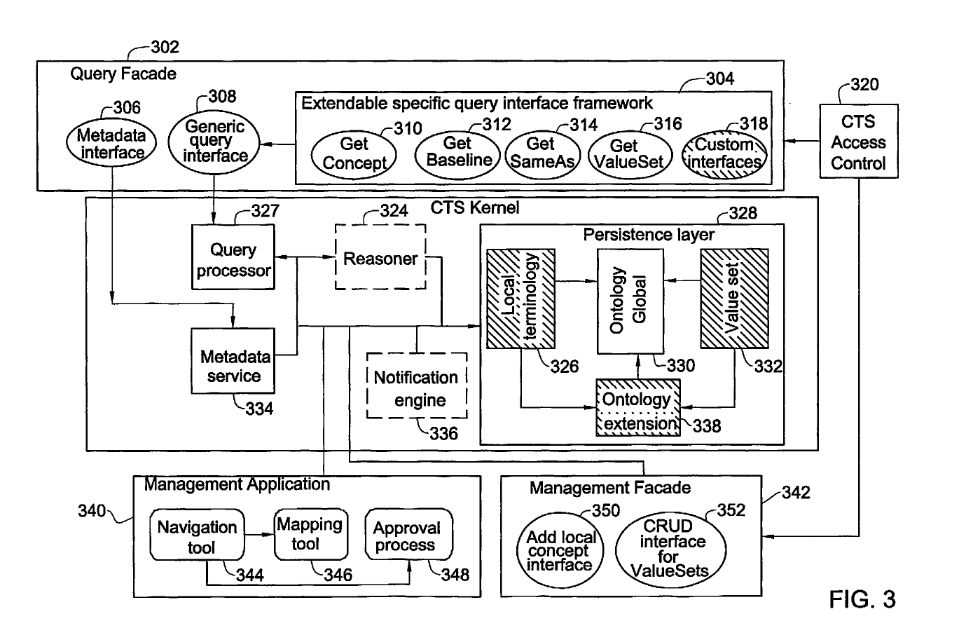

First, an embodiment of the CTS sub-system is now described generally with reference to FIGS. 2-3. The CTS sub-system is also termed herein the SeNS or “Semantic Network Services” and may also be termed “semantic framework” and may include some or all of the following units, each preceded by their reference numeral in FIG. 3: 302 Query Façade; 304 Extendable specific query interface framework; 306 Metadata interface; 308 Generic query interface; 310 Get Concept; 312 Get Baseline; 314 Get SameAs; 316 Get ValueSet; 318 Custom Interfaces; 320 CTS Access Control; 322 Query processor; 324 Reasoner; 326 Local terminology; 328 Persistence layer; 330 Global Ontology; 332 Value Set; 334 Metadata service; 336 Notification engine; 338 Ontology extension; 340 Management Application; 342 Management Façade; 344 Navigation tool; 346 Mapping tool; 348 Approval process; 350 Add local concept interface; 352 CRUD interface for ValueSets; and 354 CTS Kernel. Typically, the chief functional breakdown of the CTS subsystem's function is Ontology (contend), Querying and Management.

Possible considerations for designing the CTS subsystem of FIG. 1A are now described in detail.

The representation of medical information is a key issue in the use of computerized systems in healthcare. In everyday life, medical concepts are represented by words and phrases. This form of information representation allows a high degree of freedom but is difficult to use in computer systems. Phrases might be too long and are often inconsistent: ‘pain in lower abdomen’ could also be described as ‘complains of rerecurring pain in the lower part of the abdomen’. In order to avoid these problems, medical information saved in computer systems is codified. The process of codifying medical information involves the representation of medical concepts, such as observations or procedures, using a fixed code instead of free text.

A platform is described which addresses this by providing some or all of: robust information model, a repository of standard vocabularies, tools for searching for concepts, mapping tools to help map proprietary vocabularies to standard ones, tools for defining semantic neighborhoods and relation patterns between concepts, routine updates to vocabularies when released by the standards-development organization, and a set of semantic services such as some or all of: Managing local and Control Terminologies, Semantic Maps (mapping) between local and baseline (standard) concepts, Semantic Business Services, VPO Enrichment, Semantic Navigation (in Semantic Networks).

Semantic Interoperability includes ensuring that information exchanged between systems is understandable in the manner in which it was intended by the original creator of that information. It may enable systems to aggregate information from different sources and process it in a meaningful manner.

Semantic Interoperability between heterogeneous healthcare information systems is provided in accordance with certain embodiments. One of the primary obstacles to interoperability is the use of independent sets of terms and codes by the participating systems. When consumers of data (e.g. physicians, EMRs, workflows, Decision Support Systems, BI tools and more) refer to clinical concepts that originated from various sources, they cannot easily interpret, analyze, compare or rationalize this data for visualization. In other words, semantic information is lacking.

The problem of unified medical representation and clinical code mapping has become more and more crucial in the medical world. The effort of creating a global vocabulary and mapping local codes to baseline codes requires time, experience, and knowledge of clinical code standards and clinical terms. Therefore, it is desired to provide an ability to create such vocabulary artifacts easily, and to make the project of mapping flexible and controllable.

System goals may include some or all of:

A. Retrieve patient information: Typically, it is desired to bring together data from disparate clinical information systems in a uniform structure and semantics to support patient care, clinical decision support, and various secondary uses of clinical data such as research.

B. Semantic interoperability: Typically by creating solutions and services for a clinical decision support that makes use of the integrated, uniform data. The system described herein may comprise the integration point for data, and is privy to data that the various source systems are not. Thus, the system of the invention typically can provide enhanced decision support on top of the decision support that the source EMRs provide. This is done by creating solutions for the knowledge-representation and inference capabilities of existing commercial CDSSs.

An example of what may be achieved is the population of an electronic medical record or EMR A with an allergy—documented in EMR B—that patient Y has to medication X, the result of which is the ability of the decision-support component of EMR A to fire a drug-allergy alert when the physician writes a prescription for patient Y for a medication in the same allergy class as medication X. Unless EMR A understands the code used for medication X and has knowledge about the relationships between drugs and their allergy class, it cannot fire such an alert.

In order to accomplish the sharing of patient information and clinical decision support solutions, a semantic interoperability paradigm may be based on some or all of the following harmonized elements:

a. Unified Medical Schema—Ontology of medical knowledge that describes the information and semantics of a medical domain and maintains relations between different domains.

b. Vocabulary Ontology—A natural continuation of the UMS, which describes the medical terminology ontology. This Ontology utilizes and adheres to well-adopted and advanced standards and methodologies (such as SNOMED, LOINC, HL7 v3, UMLS etc.).

c. Common Terminology services (CTS)—Services that maintain cross-terminology mappings enabling interpretation and translation of information encoded in different terminology systems (such as but not limited to industry known systems e.g. SNOMED, LOINC, ICD and proprietary coding systems). CTS typically includes and incorporates Semantic Network Services (SeNS): services based on medical terminology ontology, providing semantic navigation capabilities that allow interpretation of medical information. Therefore, CTS and SeNS are used herein generally interchangeably.

The platform described herein typically enables clinicians to draw conclusions based on a meaningful and unambiguous presentation of information, and serves as the foundation for clinical rules and alerts based on the aggregated information. The system is typically vocabulary agnostic, working with a broad range of standards, coding methods, and vocabularies.

The first step in accomplishing the sharing of patient information and clinical decision support solutions may include Unified Medical Schema such as the UMS of DBMotion as a uniform structure for data. The UMS is, in the terminology of data modeling, a logical data model. The UMS may be created by using the HL7 version 3 Reference Information Model as a starting point.

As part of the implementation process of the above solution, human designers together study the structure of the data from the client's EMRs (and other systems to be integrated) and map or translate those structures to the unique structure of the UMS. For example, this process might involve looking at various HL7 v 2.x messages, finding various data elements such as drug code and medical record number and mapping the fields in the messages that contain these data elements to the appropriate data elements in the UMS. In this way, all the information in the network has one unique representation and thus can be shared among different users within different systems and organizations.

The Vocabulary Ontology describes the medical terminology network. The vocabulary ontology is based on a data model that represents concepts, concept relations, coding systems and contexts. The content of the ontology typically includes some or all of:
a. UMS, such as dbMotion UMS's, domains and related concepts together with coding systems and other attributes associated with them
b. relations between concepts to represent all logic employed by a particular medical application
c. Grouping of concepts for creating contexts.

This ontology may serve as a foundation for the CTS subsystem.

Accomplishing a uniform structure and semantics for data also typically relies upon a solution to the “vocabulary” problem, where different systems use different codes (or “words”) to refer to the same entities. For example, when two different EMRs (Cerner and EpicCare) use different codes for the class of medications known as atorvastatin 80 mg oral tablet: Cerner
7247, EpicCare—045772. Typically, the CTS subsystem includes some or all of the following functionalities:
a. Managing of local Terminologies for each operational system within all nodes defined.
b. Maintaining cross-terminology mappings
c. Enabling interpretation and translation of information encoded in different terminology systems (like industry known SNOMED, LOINC, ICD etc and proprietary coding systems)
d. Enabling definitions of categories and contexts for groups of concept codes.

This enables the system to store mappings of code systems in the CDR. For example, the following mappings may be created to the RxNorm code for atorvastatin 80 mg oral tablet (259255) to translate data between EMRs at UPMC: 7427 to 259255 and 045772 to 259255.

The CTS subsystem typically provides some or all of the following functionalities pertaining to relations between concepts and searching capabilities:
a. Providing semantic navigation capabilities that allows interpretation of medical information.
b. Providing relation patterns between different concepts.
c. Enabling search capabilities on the concepts tree.

Definitions, acronyms and abbreviations useful in understanding certain embodiments of the present invention e.g. as described in FIG. 3 and henceforth, are provided in the table of FIG. 2. An example business layer suitable for CTS Users is now described, including medical information retrieval and filtering functionalities thereof.

According to certain embodiments, when retrieving medical information there is a significant role to retrieving and interpreting the vocabulary codes bounded to the retrieved information most times in the context of a UMS domain. The business layer may decide what is the codes' information to be listed in the business output schema e.g. local code, baseline code, both, calculated typically according to different business rules, code's neighborhood, and hierarchy. In order to do so, the business typically online queries the CTS requesting the relevant information.

Another CTS use of the business layer may be for advanced filtering—when there is a need to retrieve information according to one concept code (e.g. “give me all WBC lab results”) or according to a context (e.g. “give me all beta blocker medications”). Another possible use is to retrieve all information that is related according to relation patterns (e.g. “give me all relevant information for the contra indication pattern”—which would result in all medications, conditions, procedures, etc that have contra indication to a certain drug).

A Data Integration layer may operate to recognize concept codes during loading and to load new concept code. When a code arrives through a message to the DIL, a query to the CTS typically results in information regarding this code if such exists or indication that this code is new. When a new code arrives through a message to the DIL, the new code is sent to the Vocabulary Ontology for further processing such as but not limited to being mapped to the right concept or adding new contexts.

When building a knowledge module, the knowledge expert may query the CTS™ and SeNS™ for various terminology operations (e.g., translation of a code between vocabularies, identification of semantic relationships between codes).

Example: KM decision logic—If the patient is treated with Coumadin Medication AND has a Diagnosis of Bioprosthetic Mitral valve AND the duration of the treatment is more than 3 months, then send message to stop Coumadin.

CTS interaction: Search medication—the knowledge engineer provides CTS with the name “Coumadin” and requests all relevant codes. The CTS may retrieve 34 different codes from which the user chooses the appropriate one, say Coumadin Tab 5 mg—RxNorm code—209081.

Relations—the knowledge engineer retrieves from the CTS all relations associated with the selected medication and selects the appropriate one: “May Prevent by” relation.

Diagnosis—the knowledge engineer navigates from Coumadin on the “May Prevent by” relation and may retrieve a list of Diagnosis. The user chooses, say, the Bioprosthetic Mitral valve diagnosis.

The knowledge engineer enters a suitable duration for the selected diagnosis (Bioprosthetic Mitral valve): 3 months. Then Action—the knowledge engineer writes the “Then” clause: send message to stop Coumadin.

Consumers of CTS services in SmartWatch, other than KFW, typically include the Event Monitor described herein. The Event Monitor typically receives triggering rules for which it needs to look for matching records for some reason. These triggering events come from clinical knowledge. Triggering rules are envisioned to be predicates over the data. Every such rule can be thought of as composed of two elements: a pattern rule such as “lab result whose code is x from code system y and whose value is greater than z” and subscription parameters—actual values to be filled into the pattern rule. In the above case the values may include x=SNOMED, y=11111 and z=15. Event Monitor may support a limited number of such pattern rules, and may monitor a large number of specific triggering rules using parameterized subscriptions to these pattern rules. Event Monitor typically does not make final decisions, but rather triggers the evaluation of the patient using KFW. For that reason, when at risk of ambiguity—it is usually better to have false positives (false alarms) over false negatives (missing a relevant record).

The action manager component is typically operative to communicate SmartWatch findings to the external world, to care providers and external systems. Thus, the Event Monitor gets the message across to the receiving end in a way that is as easy as possible, the Action Manager typically expects the CTS to convert in runtime from baseline terminology in which information was provided, into the terminology the external system uses, probably a local code system.

A third SmartWatch consumer for CTS may be a SmartGuard manager tool described herein, in which SmartGuards are defined. Within this tool rules are defined on which SmartWatch makes decisions and captures relevant pieces of information. Application-specific needs here may be similar to the application-specific KFW needs.

Vocabulary administrators may use the vocabulary management tool in order to manage all vocabulary aspects. A user, by using the mapping tool, may perform the actual mapping of the local concept codes to the dbMotion Vocabulary Ontology.

Vocabulary human experts typically include a specialist e.g. MD familiar in a clinical area serving as an authority for clinical terms and deciding whether mapping is correct. The Vocabulary experts use the vocabulary management tool to approve the mappers' suggested mapping using the vocabulary management tool and also may provide suggestions for improvement of the dbMotion Vocabulary Ontology.

The following processes I-IV, some of which may be provided in dbMotion core, and solutions that employ vocabulary services, are now described.

I. Loading Local Vocabulary Information

In order to represent the local data of each system and in order to be able to translate it to a common terminology, the local vocabulary information is typically located into commercially available dbMotion (e.g.) Vocabulary Ontology. The following steps may be followed, completely or in part:

a. Initial stage: In the Initial stage of pre-deployment, each organization provides dbMotion a list of all local coding systems with all their concept codes (manual process). All the local code systems' concept codes from the predefined file/s are imported to the dbMotion Vocabulary Ontology and each code is assigned to a vocabulary domain.

b. Production stage including an offline process and an online process, typically including loading of vocabulary codes on a fluent basis. The vocabulary elements can be loaded to the system both in offline process e.g. using a vocabulary management tool and\or in online process (automatic during messages loading using the Data Integration Layer).

Offline process: By using a vocabulary management tool typically with appropriate permissions, updates can be made to the vocabulary content both by using an import service or by manually influencing the vocabulary elements on the management tool.

As in the initial stage of pre-deployment, when there is an update in any local coding system, the updates or the whole list of codes can be transformed to a predefined file/s format in a manual process and may be imported to the Vocabulary Ontology using a vocabulary manager tool. Alternatively, when only a few changes occur, changes may be effected manually in the vocabulary management tool.

Deleted vocabulary elements: Obsolete local vocabulary elements that are not acting in any record in the CDR can be removed manually from the Vocabulary Ontology using a vocabulary manager tool.

Online process: When a new Local code enters a CDR through a message, it is loaded to the CDR and assigned to a pre-defined concept domain according to the message type and related field. The CDR contains only the Local Codes as received from the legacy systems. No mapping process may take place in the Data Integration process. The new local code is marked as new in the Vocabulary Ontology and an event is sent to the Event log for the Vocabulary administrator to monitor it on regular basis. The administrator can relate the concept to a UMS sub domain and map the code to the Vocabulary Ontology.

A code arriving in a message is always associated with a codeSystem and may also be associated with an effectiveDate for the cases when codes in the coding system are editable i.e. can change their meaning over time, such as ICD9 and CPT4 codes. The Vocabulary Ontology takes this into account.

II. Mapping Local Codes to the Ontology

Mapping allows a user to map between Local Concept codes and the Vocabulary Ontology (e.g. baseline concept code) in the context of UMS Domains. The process of mapping is executed using the vocabulary manager tool. For each UMS concept domain, the local code can be mapped to one entry point in the dbMotion Vocabulary Ontology. The mapper chooses local code or bulk of local codes for mapping. The mapper can apply different filters/parameters for the mapping. A mapping process that occurs in the Mapping Tool provides mapping suggestions to each of the selected codes with scoring. These suggestions can be approved/rejected by the Mapper. The mapping approval includes also the decision of what vocabulary domain to assign. Mapping to a post-coordinated baseline concept typically refers to mapping in which a combination of more than one baseline codes together give the exact mapping—an AND relation between a collection of baseline codes when mapped to a local code.

III. Vocabulary Management.

Suitable vocabulary management functionalities a-h, some or all of which may be provided, are now described.

a. Manage versions: When there is new version of a coding system, the version's validation start date is updated for any vocabulary object that was updated according to the new version updates. Until the new version is activated, the Vocabulary Ontology maintains both old and new information. When retrieving changed code information, the system may check if the retrieved code's information is up-to-date. Typically, only if it is, the information is retrieved.

b. Maintaining of concept codes: Concept codes are maintained on a regular basis. If changes occur in a coding system, this change may be analyzed and imported to the Vocabulary Ontology in a predefined format. The vocabulary manager tool may manage the different versions. When the change is of a baseline code, it is the responsibility of the commercially available dbMotion product to provide those updates when they occur. If it is a change in a local coding system, then it is the responsibility of each node separately.

c. Maintain concept relations to other concepts: The vocabulary manager tool may allow the change of relations between concepts—creating new relations and deleting existed relations. This change is effected in the level of the Vocabulary Ontology and is typically approved before being activated.

d. Maintain mapping of a local code to Ontology: The vocabulary manager tool may allow the changing of mapping of local codes to the Vocabulary Ontology. This change typically must be approved before being activated and versioned.

e. Maintain contexts/value sets: The vocabulary manager tool may allow the creation and update of contexts and value sets. Each change typically must be approved before being activated and versioned.

f. Maintaining UMS domain information: The vocabulary manager tool may allow the change of UMS domain information, when sub-domains are being updated. When updating a sub-domain, its related concept codes may no longer be relevant and other concept codes may now be relevant. When deleting sub-domain, the vocabulary administrator typically first decides what to do with all its related concept codes. All changes typically must be approved and versioned before being activated.

g. Publish changes to subscribers: Any change in a subscribed concept may be published to the subscribers in a predefined format.

h. Approval process: Each change in the Vocabulary Ontology is typically approved by authorized users. The vocabulary manager tool may allow and implement the approval process for each changed element.

IV. Semantic navigation: Querying procedures A-F, some or all of which may be employed by dbMotion core product and/or by the CTS subsystem, are now described:

A. Retrieve codes according to a given context: In each node, if the given context exists in its CDR, a process that generates the list of all valid concept codes that are assigned to this domain or to one of its sub-domains, is executed. For each of the generated codes, a process that retrieves the relevant data from a Vocabulary Ontology is executed.

B. Retrieve Codes according to a specific code within a specific context: In the initiator node, if the given code exist in the CDR's vocabulary domain, and is also assigned to the given domain or to one of its sub-domains, a process that retrieves the valid code's baselines is executed. This baseline code is then passed to all the network's nodes. In each node, a process that generates the list of the baseline's mapped local codes is executed. The mapped codes are all the local codes that are mapped to the baseline code. For each of the generated codes, typically including the baseline, a process that retrieves the relevant data from the CDR is executed. A relevant data is the information in the CDR that has the generated code in one of its predefined attributes.

C. Search for a concept: Locate and retrieve a certain vocabulary concept using a search service. This can be a string. Input Parameters may include some or all of the following:

1. Search string: a string (not case sensitive) that is the motivation of the search. Search typically finds items related to it.

2. Domains/sub domains context: limit the search to pre-defined domains and sub-domains. If null, search the entire database. Use the internal mapping/created list of domains.

3. Context string: limit the search to the provided context string.

4. Related codes relationship types: The output result may include the related codes/concepts as well. In the output, indicate those as “related” and provide the relation type. If null, no related concepts are retrieved, “All” may retrieve all related concepts.

5. Relation pattern: the searching is done according to the given relation pattern which defines the semantic navigation pattern.

6. Input language: the language in which the search string is provided.

7. Output language(s): The code/concept designation language(s).

8. Coding system(s) or abstract concept for result

9. Scoring cut off

10. Max results per search

D. Dynamic querying: A user might build a specific query. dbMotion SeNS™ may allow building of such a query, save it and enable to reuse it when appropriate.

E. Query control tool: In order to be able to build a query according to changing needs, dbMotion SeNS™ may include a query control tool. This tool may address all application-specific requirements for searching and querying using a dedicated GUI for this purpose. In this tool, the user may be able to effect some or all of the following functionalities: Build a dynamic query, and save it for later use; Use existing queries; Use a template for creating a query; Update existing queries; Navigate graphically in the dbMotion Vocabulary Ontology, in order to find, and select concepts; and Define Value set of concepts from a query result.

F. Mapping Tool: The CTS subsystem typically includes a mapping tool which allows a user to match between string, codes and phrases to the right place within the Vocabulary Ontology by using a dedicated GUI. In this tool, the user may be able to perform some or all of the following functionalities: Mapping local codes to standards (dbMotion Vocabulary Ontology) with high performance and quality; match the best suggested mapping according to a map ranking for each suggested mapping; and apply different search methods or algorithms as appropriate.

The term “Concept” as used hereinabove refers to or points to a terminology element that describes one atom of classification knowledge such as a specific drug or disease, like congestive heart failure. A “classification concept” points to a higher level, typically more general, knowledge element, such as a cardio-vascular disorder.

A “Node” as used hereinabove refers to a software deployment component that provides some or all of the system functionality described herein for an individual medical organization. A Node may contain one or more physical servers and is usually but not necessarily installed in each hospital within a medical enterprise. Each Node typically has its own Clinical Data Repository (CDR) that stores information collected from this specific facility.

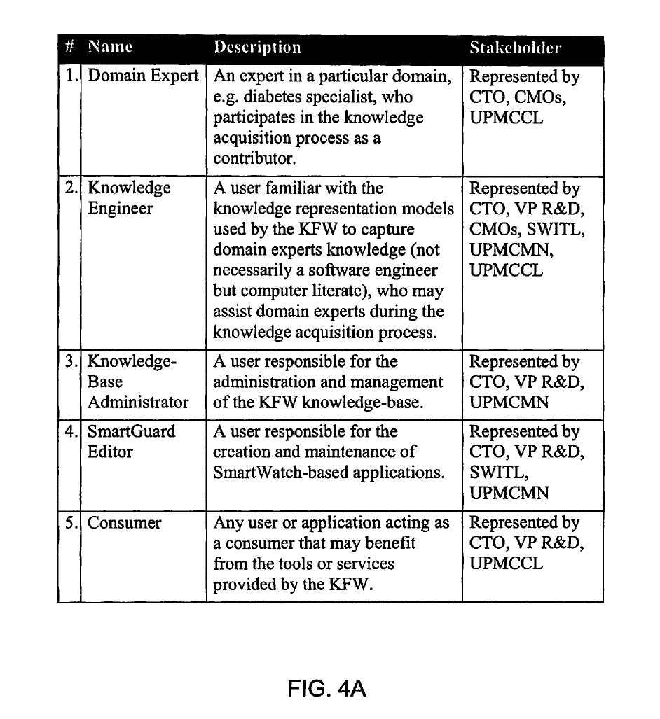

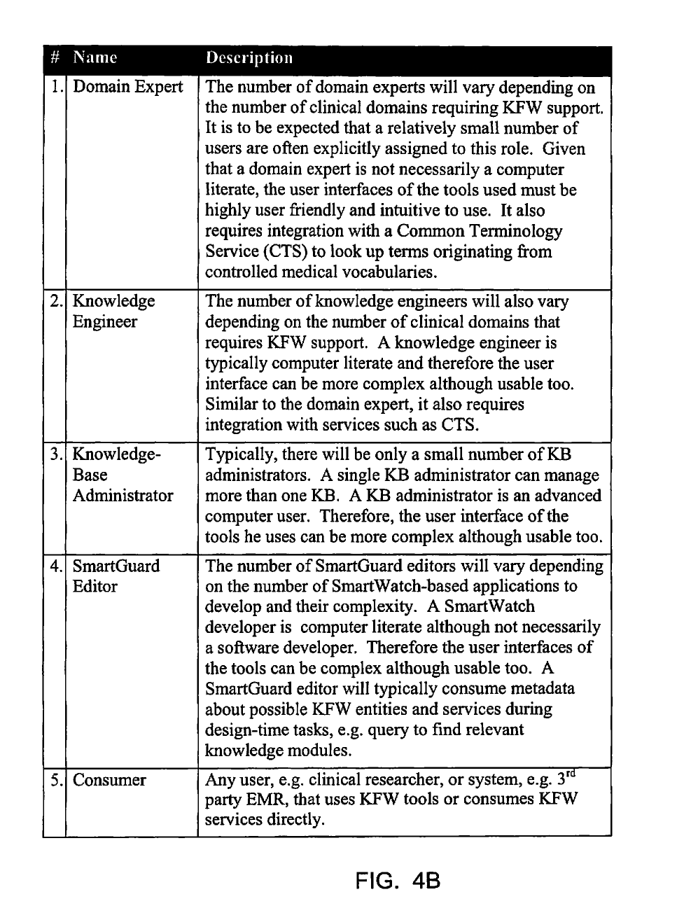

An embodiment of the knowledge framework sub-system is now described generally with reference to FIGS. 4A-8C. Specifically, an embodiment of the Knowledge Framework (KFW) of FIG. 1A is now described which includes capabilities used by stakeholders and target users. The KFW system may enable knowledge-based interpretation of clinical data to facilitate automatic decision support capabilities. The KFW may comprise a tool set, services, and repositories that enable its users and consumers to acquire, maintain, store, and apply knowledge to data in a meaningful way.

The system of the present invention, even without the knowledge framework, typically enables healthcare organizations to securely share and exchange medical information, creating a Virtual Patient Object (VPO) by logically connecting a group of care providers and organizations without enforcing data centralization or replacement of existing information systems. By sharing real-time medical information, medical staff can make clear critical decisions, thereby providing safer and more efficient healthcare.

The information flowing from the network shown and described herein can leverage development of services that go beyond sharing and exchange of information for purposes such as presentation. Moreover, to avoid overloading care providers with increasing amounts of raw data, it is desired to have services that can interpret raw data, e.g. hemoglobin lab test measurements, into more meaningful concepts at different levels of abstraction, e.g. anemia state, which is derived from consequent hemoglobin lab test results.

SmartWatch (SMW) enables continuous monitoring of a population, e.g. patients, within a defined medical information space. The SMW framework is utilized by application-specific and/or customer-specific Enterprise Clinical Decision Support Systems (ECDSS. These SMW-based ECDS systems, also known as SmartGuards, are outside the scope of certain embodiments of the present invention and suitably employ core platform abilities of certain embodiments of the present invention and services as well as consuming new services which may be provided by the KFW. For example, the core platform of certain embodiments of the present invention provides a unified holistic view of the patient clinical state manifested by the Virtual Patient Object (VPO) while the KFW provides the ability to interpret the data contained within the VPO to generate healthcare delivery recommendations.

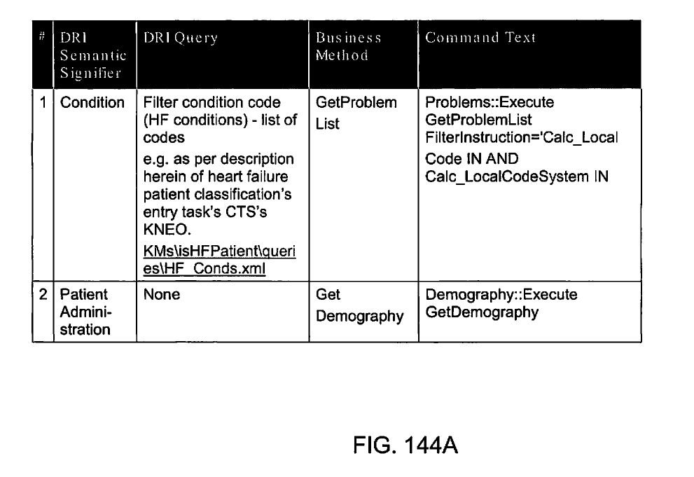

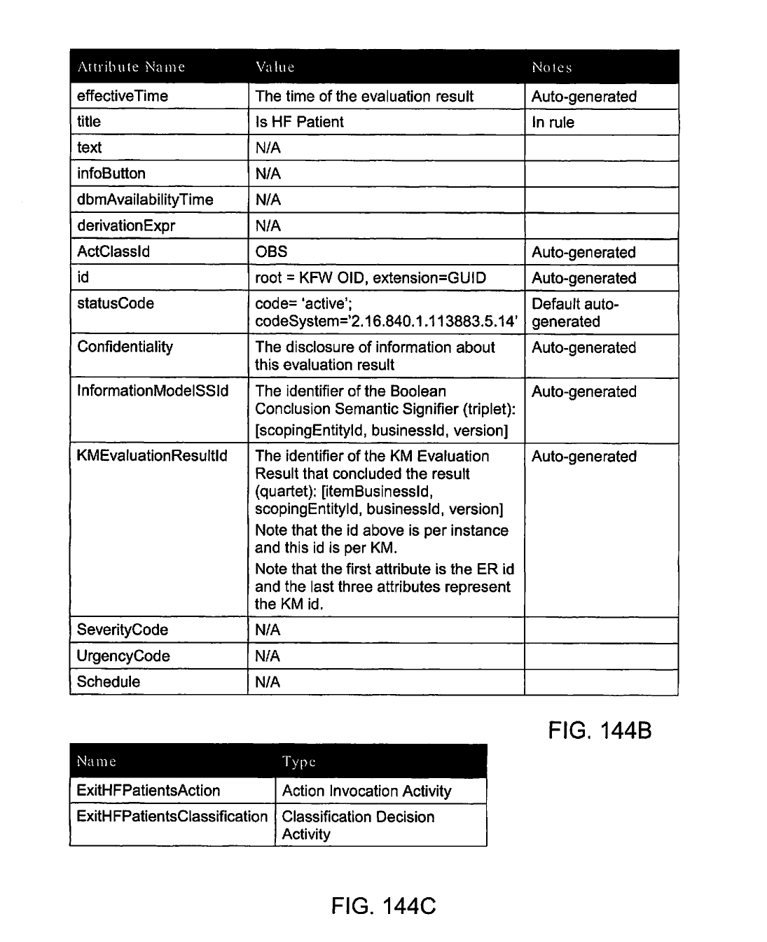

An example of an Enterprise Clinical Decision Support System which may utilize the SmartWatch subunit shown and described herein is described herein in detail with reference to FIGS. 144A-153.

Thus, the KFW may utilize the holistic view of a patient as captured in the VPO provided by certain embodiments of the present invention to enable knowledgeable abstraction of data to meaningful concepts. This data abstraction ability serves as a key vehicle to support the creation of clinical decision support services. For example, improve the quality of medical care by creating Enterprise Clinical Decision Support Systems (ECDSS) that consume data interpretation results to generate recommendations to care providers and administrators. Another example might be to generate a VPO schema recommendation that takes into consideration preferences such as clinician specialty, e.g. cardiologist, and patient clinical state, e.g. congestive heart failure (CHF), to address specific requests for information.

Another goal of the KFW according to some embodiments is to facilitate the dissemination and utilization of clinical expertise to improve the quality of care. Clinical expertise is accumulated by clinical experts at different medical domains over years of experience. The KFW may enable clinical experts to play an active role during the knowledge acquisition process while collaborating with other actors, e.g. knowledge engineers.

The KFW is typically operative to provide computerized support e.g. to one or more medical domain experts, researchers, clinicians, nurses, social workers, administrators, knowledge engineers and other, non-human consumers, such as EMR, workflow, CPOE process, another DSS, to interpret raw data in order to reach meaningful conclusions at different levels of abstractions otherwise hidden in the data. The KFW typically facilitates application of knowledge to data to reach meaningful concepts at different levels of abstractions which are useful in computerized clinical decision support.

Applications for this system extend throughout the healthcare community at large. It may be domain experts playing the role of knowledge editors to disseminate their valuable knowledge accumulated over years of practicing medicine, care providers benefiting from knowledge-based interpretation of data to improve the medical care they deliver, or healthcare applications developers using KFW services to create ECDSS applications. The common denominator for these diverse scenarios is an objective of acquisition and application of knowledge to data to reach meaningful concepts at different levels of abstraction, thereby improving the quality and safety of medical care, while potentially reducing overall clinical costs.

The ability to achieve this task capitalizes on the unique offering of the platform provided in accordance with certain embodiments of the present invention in the healthcare IT market as described hereinabove.

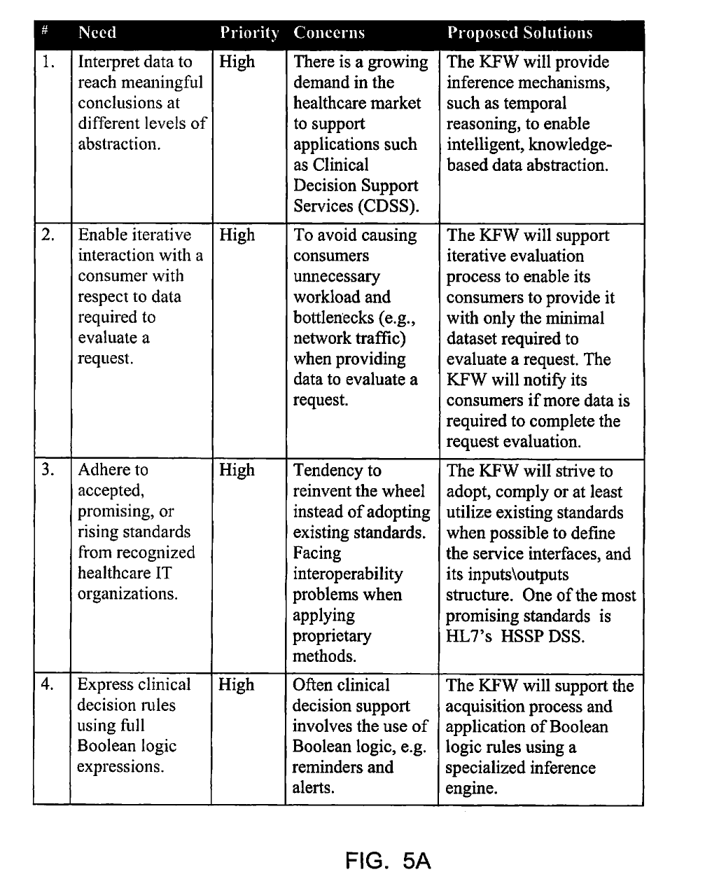

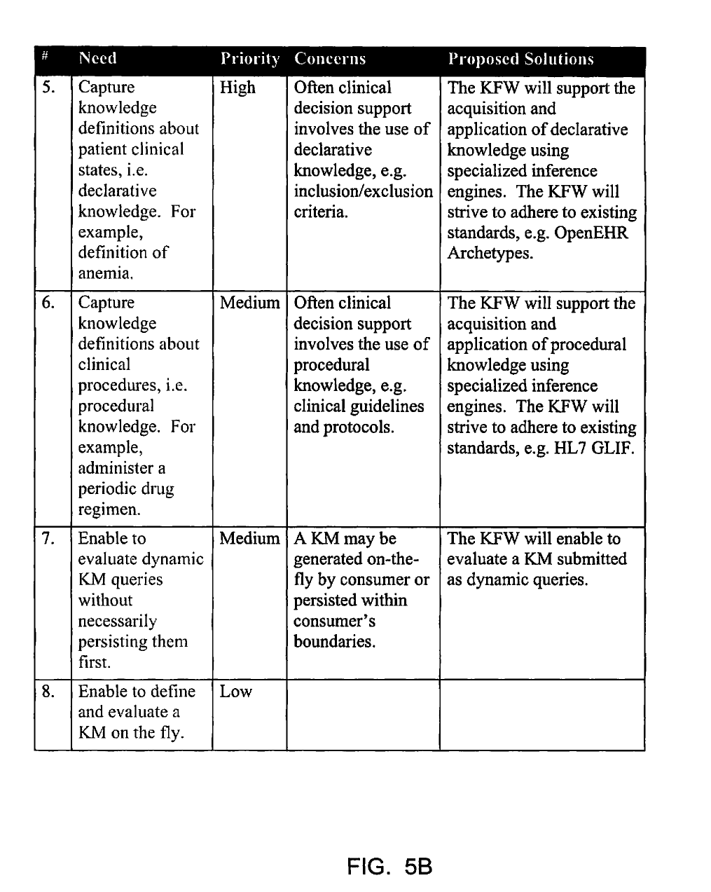

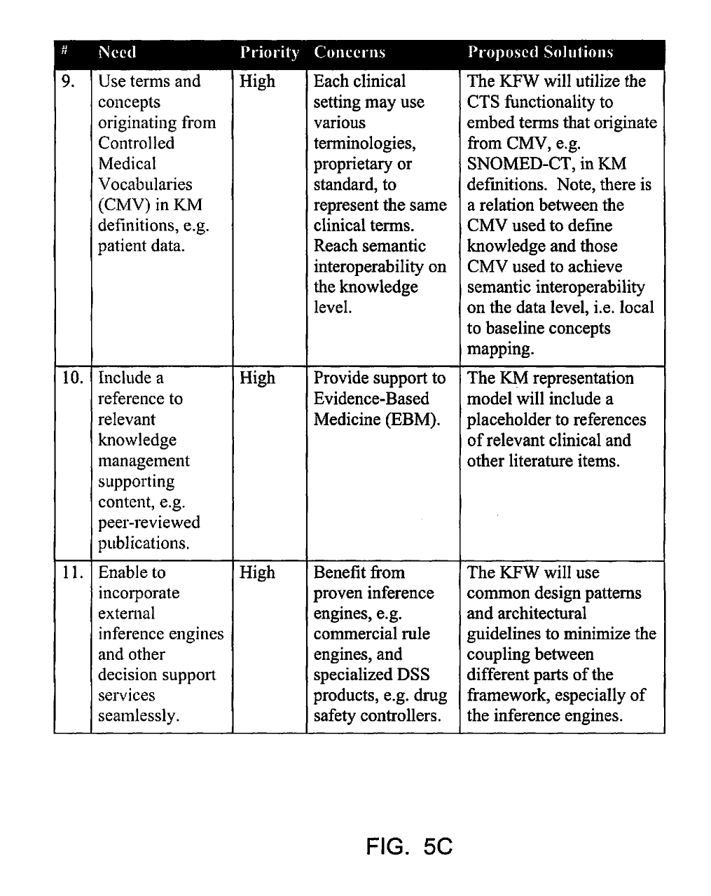

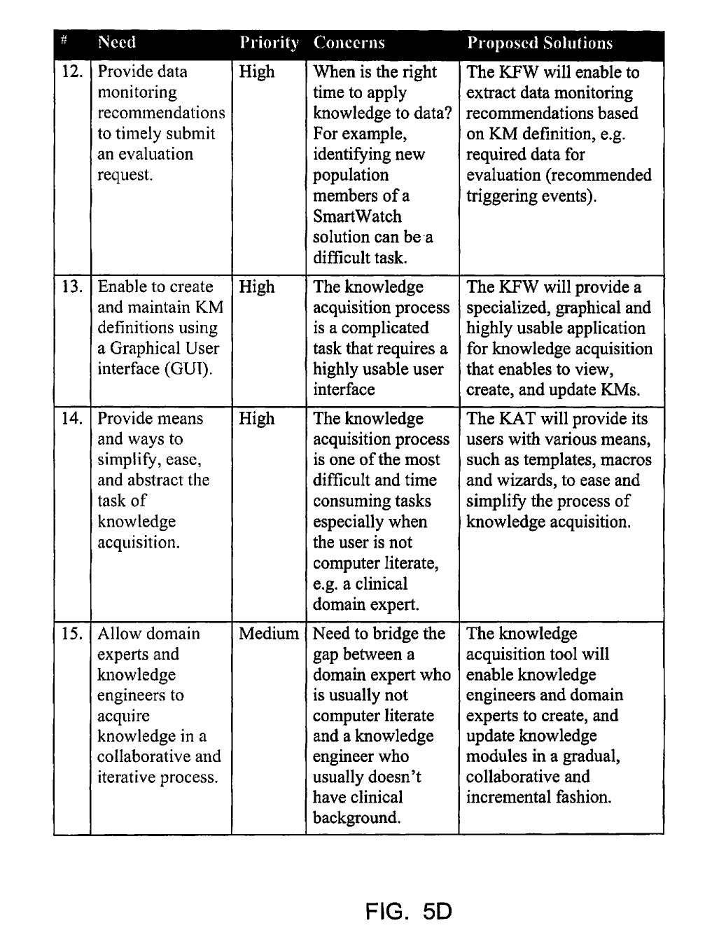

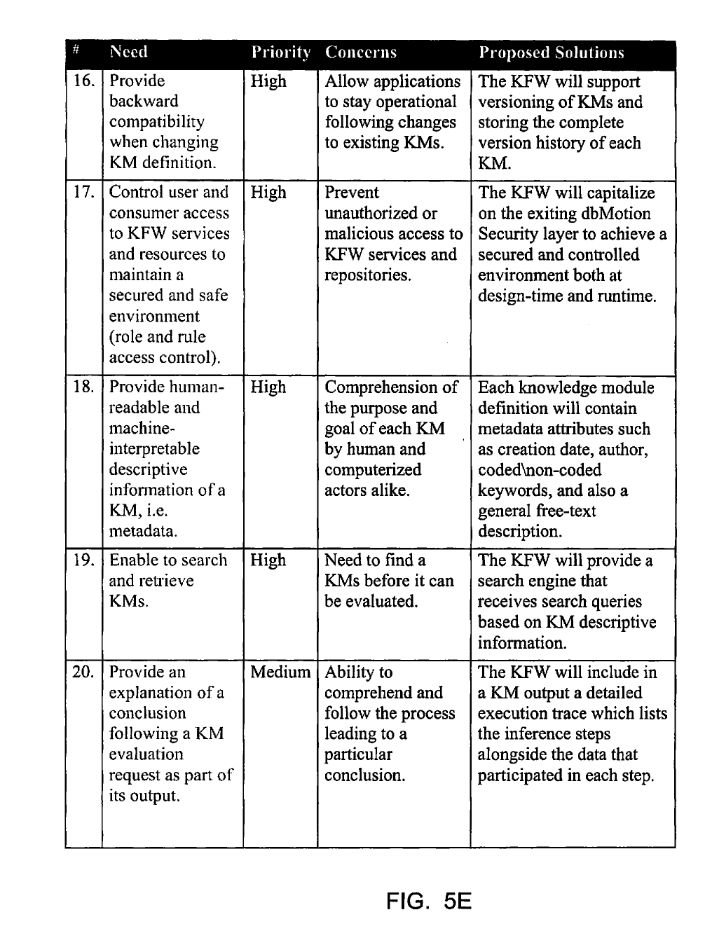

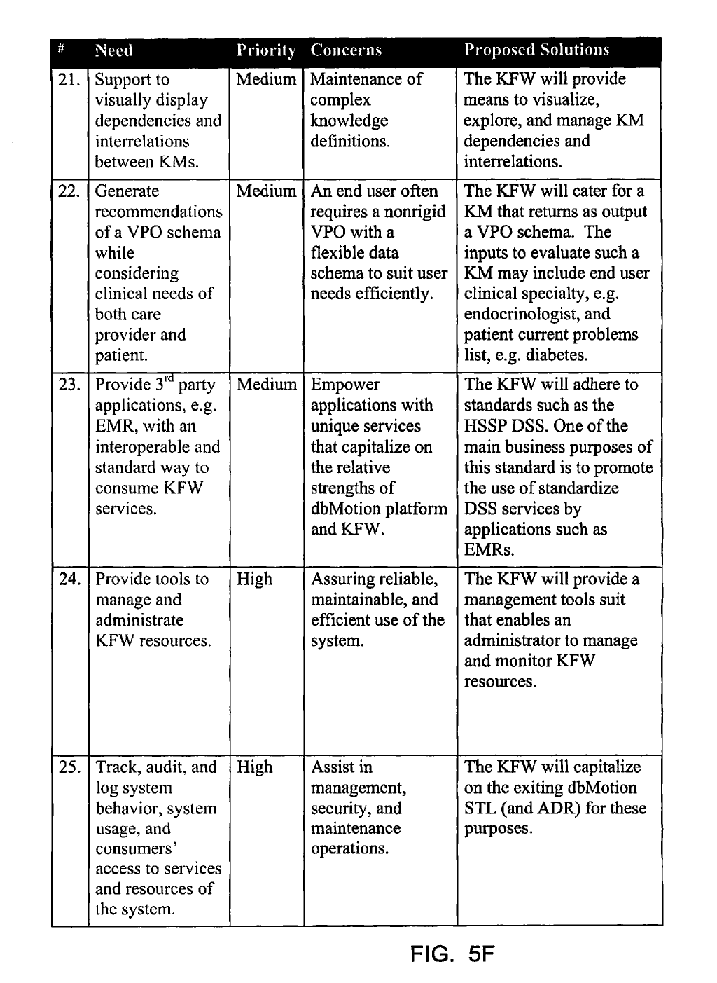

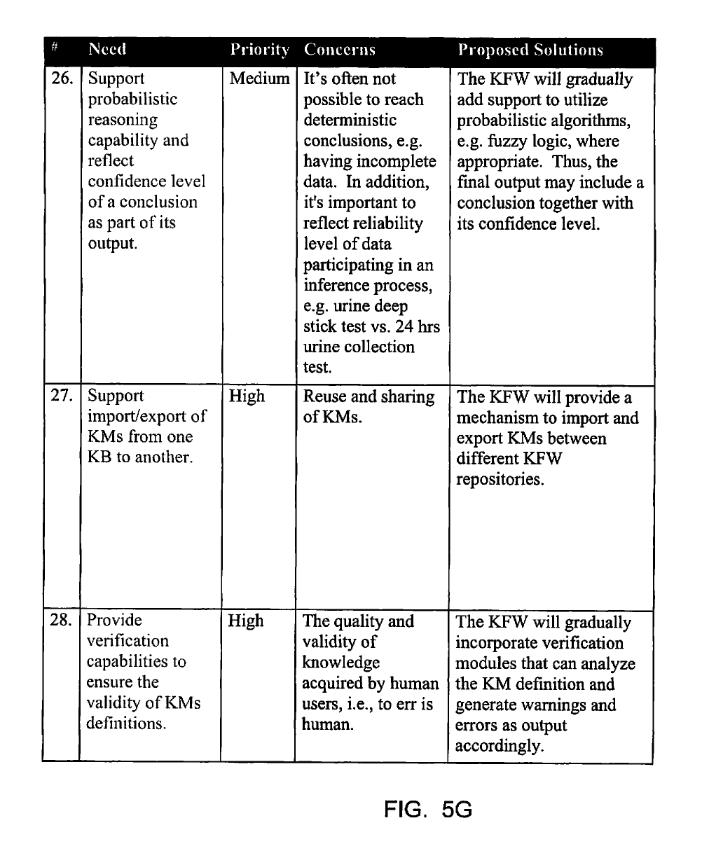

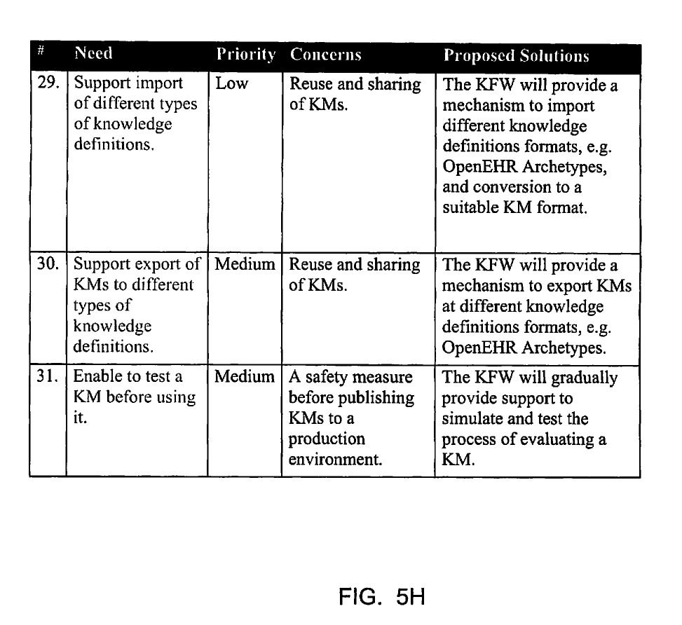

An example list of users is provided in the table of FIG. 4A. An example User environment is described in the table of FIG. 4B. Typical Key Stakeholder/User-defined Needs are set out in the table presented in FIGS. 5A-5H, taken together.

A high level description of the Knowledge Framework (KFW) capabilities, interfaces to consumers and the system configuration, now follows. Part of the KFW may rely on 3^{rd} party components. For example, one may incorporate an existing commercial rule engine instead of developing one ‘from scratch’.

The KFW typically utilizes services provided by the core platform shown and described herein. The KFW is responsible to provide services to acquire, maintain, store, and apply knowledge to data to reach meaningful conclusions at different levels of abstraction. The KFW may provide its services according to the Service Oriented Architecture (SOA) principles. These services may be available to systems shown and described herein and applications internally, e.g. business domains developed using Business Layer infrastructure shown and described herein, as well as to other healthcare IT applications externally, such as 3^{rd} party Electronic Medical Records (EMR).

SMW is a framework that enables continuous monitoring of a population, e.g. patients, within a defined medical information space. The SMW framework allows the development of Enterprise Clinical Decision Support Systems (ECDSS). These SMW-based ECDSS, also known as SmartGuards, capitalize on core platformabilities shown and described herein as well as consuming new services which may be provided by the KFW. For example, the core platform shown and described herein provides a holistic view of the patient clinical state manifested by the Virtual Patient Object (VPO) while the KFW provides the ability to interpret the data contained within the VPO to generate healthcare delivery recommendation.

The KFW may serve other components shown and described herein as well. For example, the business layer may consume its services as part of a business process modeled in a business domain and accessible through a business method. The business method outputs including the knowledge evaluation results generated by the KFW can be displayed using a Clinical View created using the Presentation Layer shown and described herein. In addition, a 3rd party EMR or other healthcare application can consume these same services of the KFW similarly.

The new system may interface with the existing platform core shown and described herein to utilize several of its existing services. These services may include but are not limited to:
The Security Layer—for services such as role\rule access control.
The Support and Testability Layer—for services such as auditing and logging.
The Common Terminology Service (CTS)—for services such as looking up terms originating from controlled medical vocabularies (e.g., SNOMED-CT).

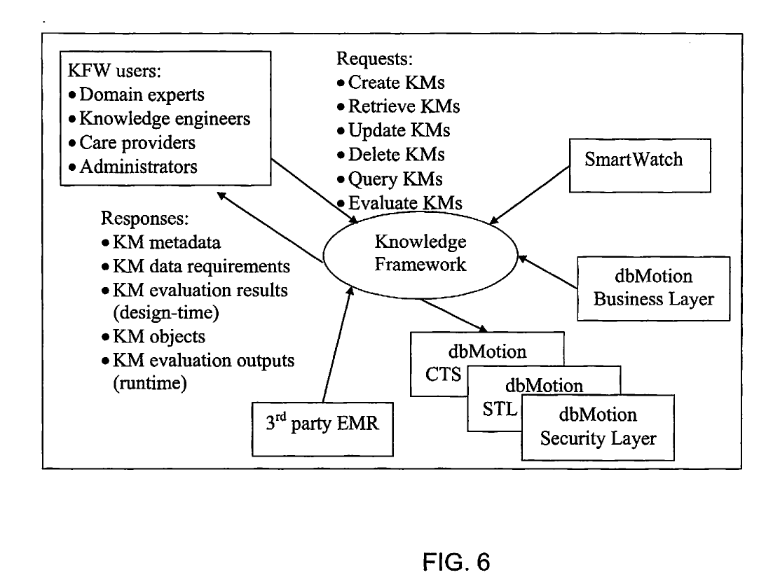

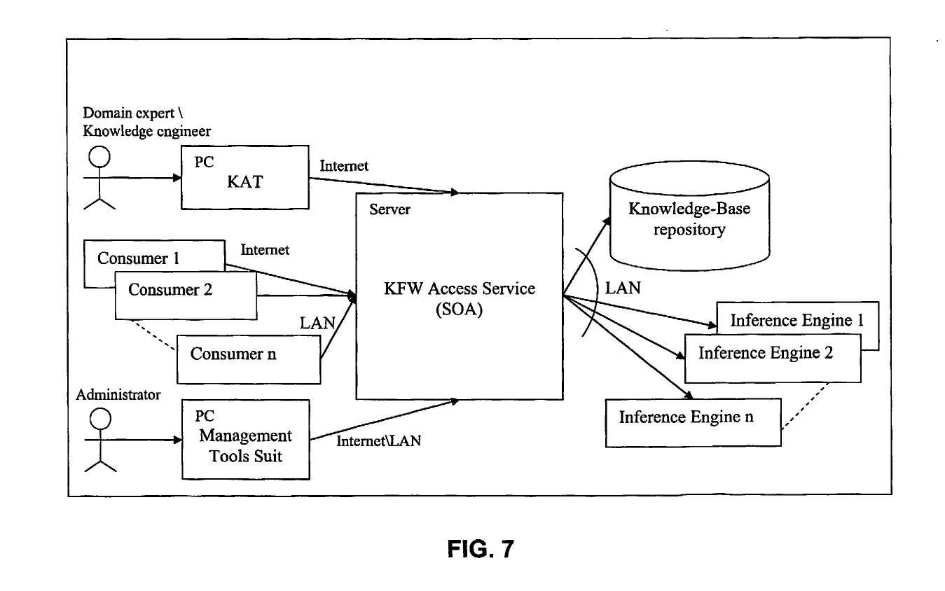

The KFW may provide SOA-based public interfaces to consume the services it provides, such as creating of a new Knowledge Module (KM) or evaluating a Knowledge Module giving specific patient data, to internal and external applications and authorized users of the system shown and described herein as shown in FIG. 6 which is a context diagram for the knowledge framework unit. The KFW System may comprise a Knowledge Acquisition Tool (KAT) and a suit of Management tools client components, a KFW Access Service, Knowledge-Base repository and one or more Inference Engines server components as illustrated in FIG. 7 which is a system overview of the knowledge framework according to certain embodiments. KFW main functional units may include some or all of: a management functional unit also termed herein “KAT” and “PCT management tools”, access service (SOA), knowledge base repository, PCT management tools suit, and inference engines.

Typically, a KM or Knowledge Module comprises a knowledge evaluation rule, an input data model, an output data mode and terminology/ontology elements that are used by the KM. The server component resides on a variety of servers including an application server that hosts the KFW Access Service, an application server that hosts one or more Inference Engines, such as but not limited to RatHat's JBoss Drools engine, and a data server that hosts the Knowledge-Base repository. The server component may interface with existing components shown and described herein e.g. as detailed previously. This interface is supported by the existing SDK shown and described herein, although it may be extended or even enriched with new functionality if application-specific requirements arise.

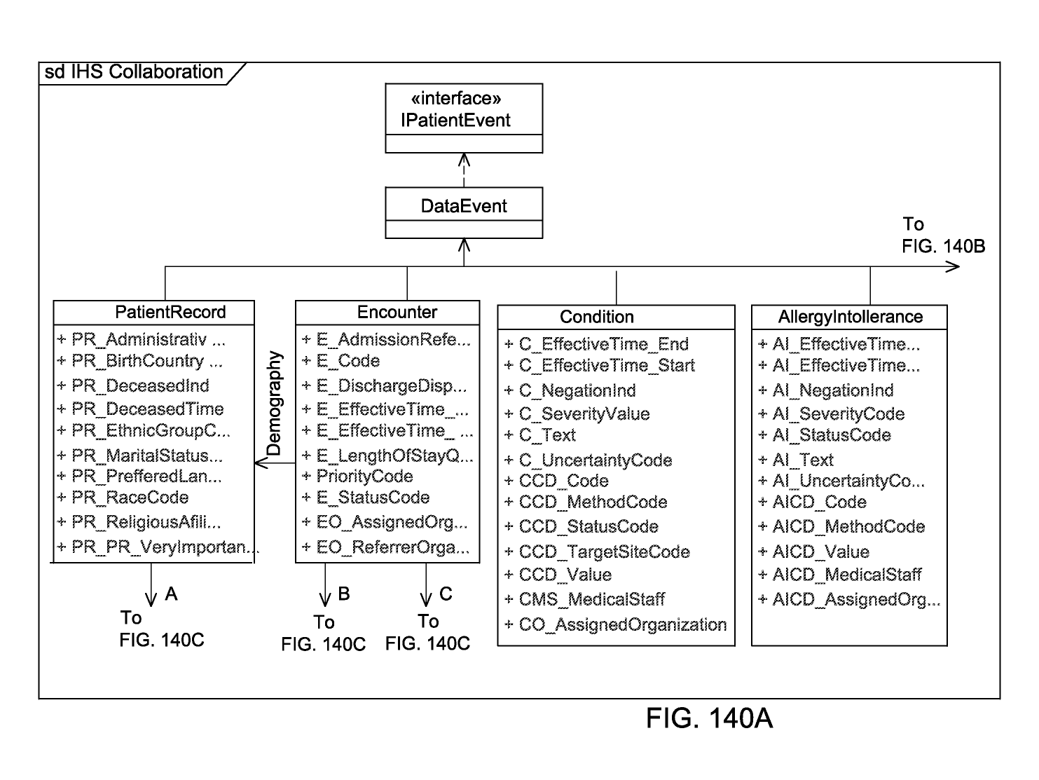

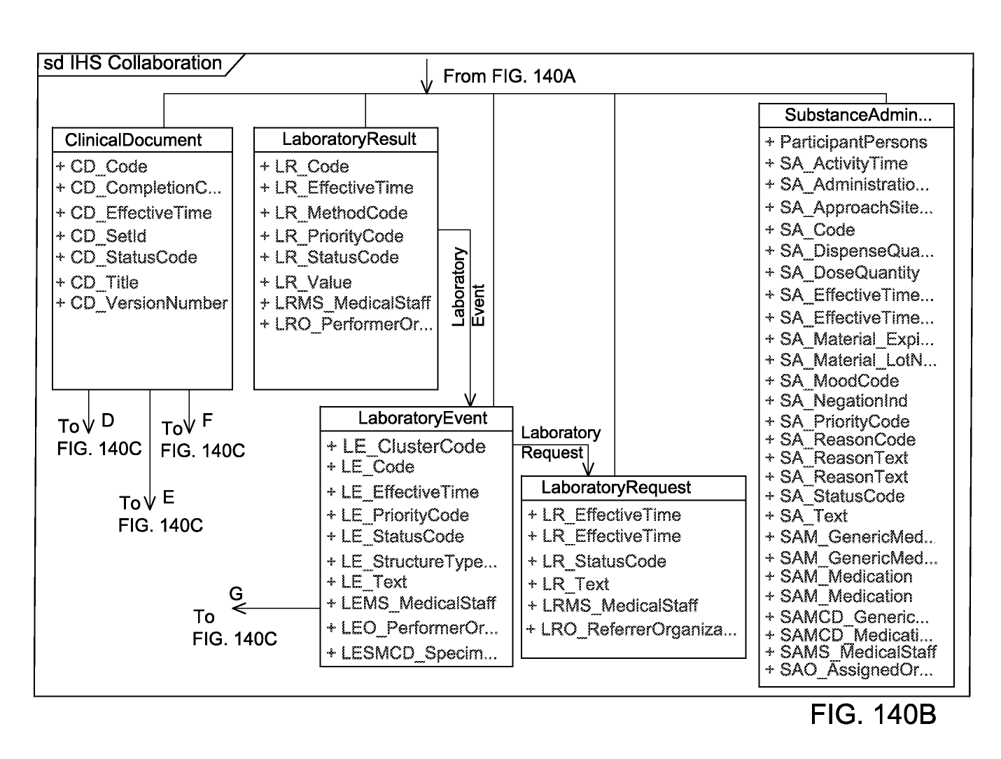

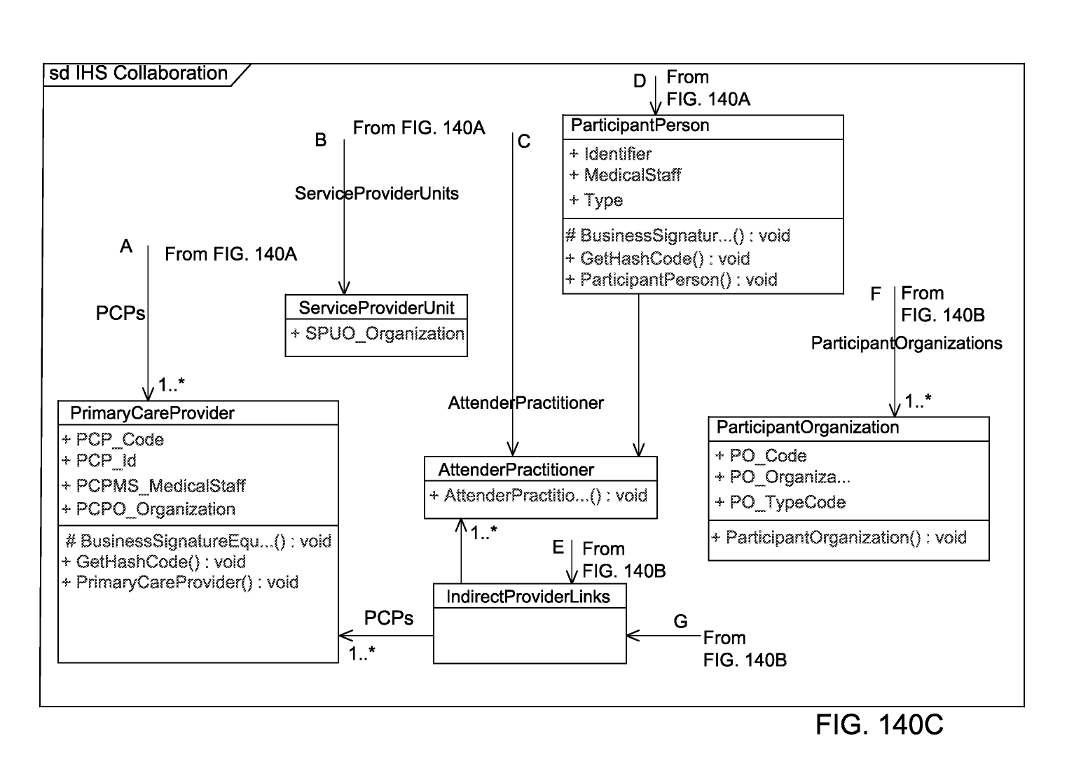

The management tools suit is an optional functionality. KFW's knowledge base repository may be derived from a suitable Knowledge-Module Entities Model such as, for example, that of FIG. 140 and a suitable programming technique, such as Hibernate, an open source Java persistence framework project, may be employed to convert business objects into DB structures, such that no DB modeling need be done explicitly. The client components reside on personal computers either as web-based thin clients or as full-blown desktop applications using technologies such as ASP.NET and SmartClient technologies respectively. Once the client component is installed on the PC, the user may access the KFW System from the PC through the network shown and described herein or via a secured Internet access following a successful authentication and authorization process.

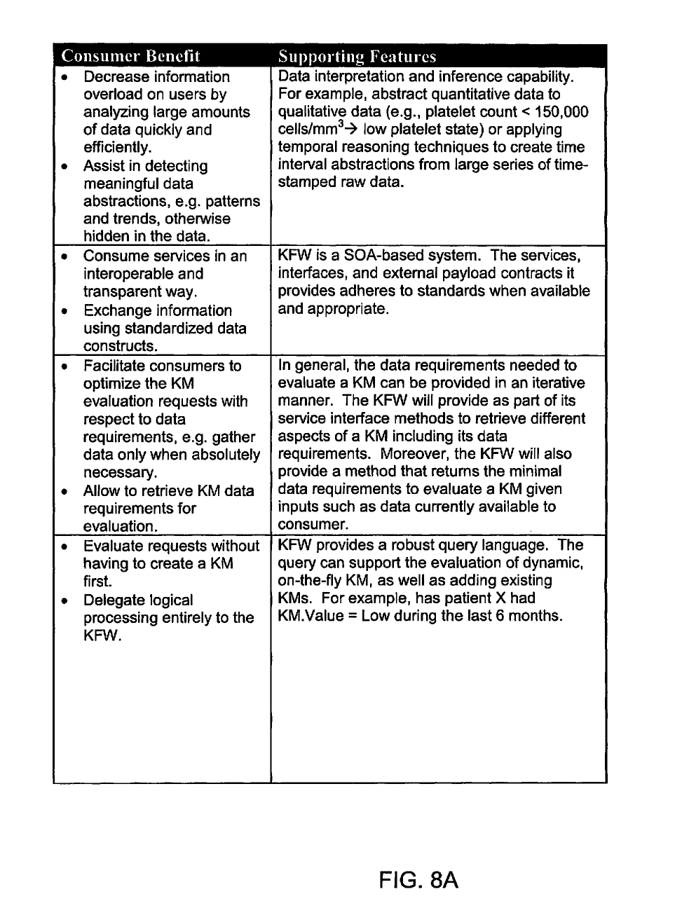

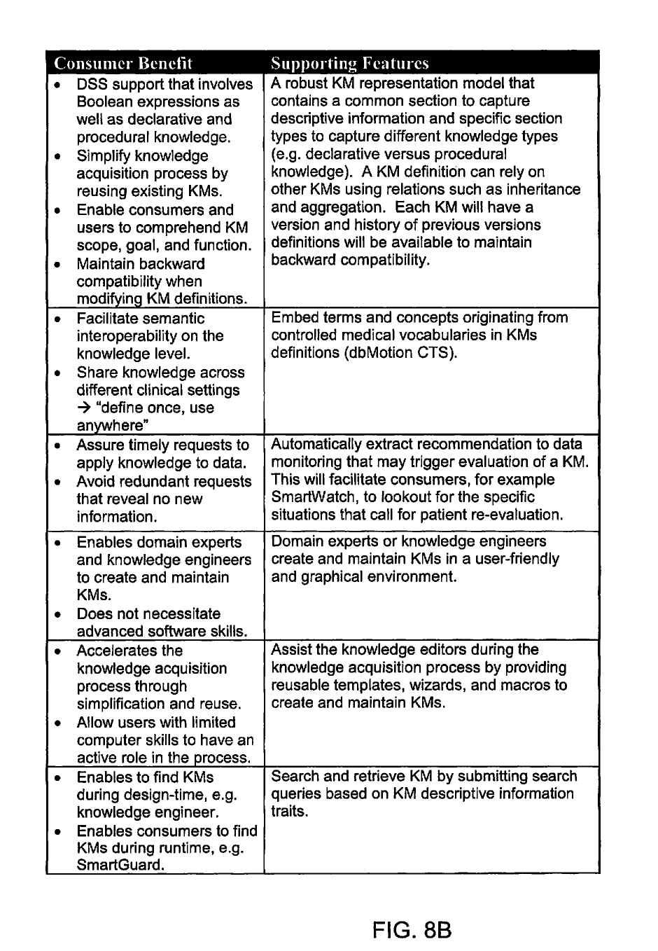

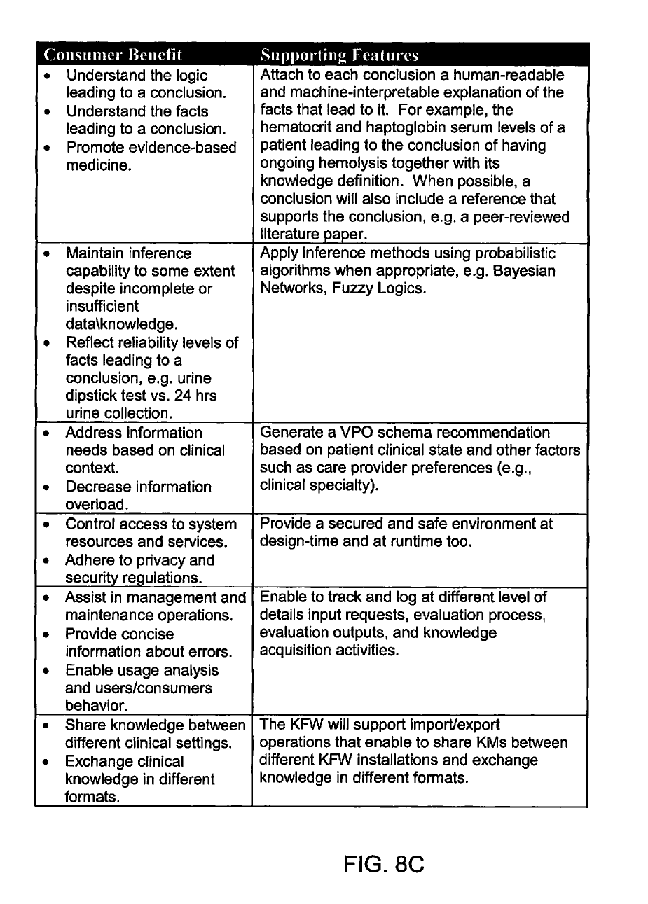

The table presented in FIGS. 8A-8C, taken together, identifies capabilities, all of which are typically but not necessarily provided, of the KFW System in terms of benefits and features. The features are further described hereinbelow.

Some or all of the following assumptions and dependencies typically characterize capabilities of certain embodiments of the KFW System:
The KFW consumer is solely responsible to collect the data which may be used to apply a Knowledge Module.
The KFW typically stores neither information being used for evaluations nor the results of (e.g. conclusions derived from) the evaluations. Generally, the term “persist” is used herein to refer to storing in service storage such as a database.
The KFW information model may be inspired from the UMS shown and described herein, but does not necessarily rely on it.
The Common Terminology Service (CTS) shown and described herein provides functionality which may be used to embed terms originating from controlled vocabularies, clinical (e.g., LOINC) or administrative (HL-7 Ethnicity), during the knowledge acquisition process. The functionality may include one or more of:
   Find concepts using different search criteria (e.g., name, type, and domain).
   Navigate through concept graph using semantic links, e.g. is_a or part_of associations.
   Obtain metadata of a particular concept, e.g. value range type (numeric or qualitative), unit of measure family.
The UMS information model and its derivations, such as baseline terminologies, are accessible electronically via the Reference Model shown and described herein or similar resource.
The knowledge acquisition process is performed by collaboration between domain experts and knowledge engineers.
Some of the KFW functionality may involve embedding commercially available software components e.g. commercial business rule engines such as Drools which is part of the commercial product JBoss distributed by RatHat. Some of the KFW functionality relies on existing components of the platform shown and described herein, e.g. STL and Security layers.

Features of the KFW System, according to certain embodiments, some or all of which may be provided, are now described:

FEAT8 Data interpretation and inference capability: The KFW may receive as input (1) an identifier of a Knowledge Module to evaluate, e.g. definition of chronic hypertension, and relevant patient data, e.g. blood pressure measurements. The KFW may process the data and knowledge using an inference engine of some kind, e.g. a temporal reasoning engine. As output, the KFW may generate a conclusion e.g. patient had chronic hypertension during last year.

FEAT8.1 Iterative Knowledge Module Evaluation Interaction: The KFW enables its consumers to provide it with the data it uses to perform a Knowledge Module evaluation in an iterative manner. Thus, a possible intermediate evaluation result is the fact that additional data is to be provided to complete the current evaluation request processing. Then, after the consumer collected the missing data, it sends another evaluation request to the KFW. The intermediate result may be marked as not final.

FEAT8.2 Inference Evaluation Explorer: Each conclusion result may optionally contain an explanation of the knowledge and facts that lead to it. This explanation may be in a human-readable and machine-interpretable format. One of the evaluation request arguments may explicitly direct the KFW whether to generate such an explanation or not as part of its output. For example, the hematocrit and haptoglobin serum levels of a patient, leading to the conclusion of having an ongoing hemolysis, may be presented together with the definition of what an ongoing hemolysis is.

FEAT8.3 Temporal Reasoning Capability: A special type of inference capability that the KFW may support is temporal reasoning. A common feature of many healthcare information types is having a time stamp. The valid time of a WBC lab test result, the request time to perform a MRI imaging study and gestation condition start time are only some examples. The temporal reasoning method enables to interpret large sets of time-stamped raw data into meaningful concepts at different levels of abstraction. This may include abstraction of individual time points to longitudinal time intervals, computation of trends and gradients from series of consequent measurements, and detection of different types of patterns, which may be otherwise hidden in the raw data.

FEAT8.4 Probabilistic Reasoning Capability: Another type of inference is undeterministic or probabilistic reasoning. Optionally, insufficient, incomplete, or less reliable data is input to an inference process. Or, non-deterministic data abstraction methods such as fuzzy logic may optionally be applied including reflecting the data quality implications on the final output in terms of confidence level. For these purposes exactly probabilistic algorithms, such as Bayesian Networks or Belief Networks, exist which reflect the data quality implications on the final output in terms of confidence level. This optional capability typically utilizes a specialized knowledge representation model that captures the probabilistic nature of the knowledge and corresponding inference mechanisms.

FEAT8.5 Context-Based VPO Schema Generator: A special type of evaluation result is a recommendation to an information schema of a Virtual Patient Object (VPO). A VPO schema can be generated when given as inputs the clinical state of a patient, e.g. current problem list, and possibly the preferences of a care provider, e.g. clinical specialty. This custom-tailored VPO may benefit the care provider by decreasing the amount of information to review during a care delivery session.

FEAT8.6 Knowledge Evaluation Simulator: A helpful feature to a knowledge editor is to simulate the evaluation process of a Knowledge Module. The simulator typically supports debug-like mode enabling to find problems in the Knowledge Module definition or inference engine. In addition, the simulator may have a capability to generate a representative data set that covers possible inference execution branches.

FEAT9 Robust Knowledge Module Representation Model

FEAT9.1 Descriptive Information Traits: A section common to all types of Knowledge Modules is the one that contains descriptive information about the Knowledge Module. The Knowledge Module metadata describes its scope, goal, function, etc. This may include its creation date, modification dates, authors, version details, and classification keywords, whether codified or not. This information serves as the basis to search and retrieve Knowledge Modules by submitting search queries that comprise the descriptive information traits.

FEAT9.2 Standard Boolean Expressions: Simple rule-based clinical knowledge is often expressed using straightforward Boolean expressions, i.e. and/or clauses. Thus, the KFW may support the representations of such expressions.

FEAT9.3 Declarative and Procedural Knowledge: Clinical knowledge can be divided into two main types, declarative and procedural knowledge. The declarative knowledge type defines meaningful clinical concepts related to the patient's clinical state. For example, blood pressure state Knowledge Module definition (i.e., low, medium, or high) comprises declaring possible quantitative ranges of diastolic and systolic blood pressure to each qualitative value. The procedural knowledge type usually defines clinical workflows and procedures. This may be for instance a recommendation of treatment for patients suffering from high blood pressure (e.g., routine blood pressure monitoring). It usually involves the explicit specification of control structure such as do-in-parallel, decision steps, or mandatory actions. The KFW may provide specific knowledge representation (KR) models to capture these two distinct types of knowledge to support a broad range of Clinical Decision Support Systems (CDSS). Moreover, the KR models used to capture these knowledge definitions may be based, or at least adhere, to existing healthcare standards such as HL7 GLIF for declarative and procedural knowledge respectively.

FEAT9.4 Terminologies and Vocabularies: A Knowledge Module definition often comprises terms and concepts originating from controlled medical vocabularies. These concepts are typically found both in the metadata section of a Knowledge Module, e.g. an applicable clinical state such as diabetes mellitus using coded keywords from SNOMED, and in its knowledge definition section, e.g. referring to a certain type of blood lab test such as WBC count using LOINC codes. Thus, the KR model of a Knowledge Module provides special placeholders enabling to embed terms and concepts during the knowledge acquisition process. Moreover, embedding terms and concepts originating from well-accepted and commonly-used terminologies facilitates sharing and reuse of Knowledge Modules at different clinical settings.

FEAT9.5 Interrelation between Knowledge Modules: A Knowledge Module definition often relates to knowledge definitions of other Knowledge Modules. To ease and simplify the knowledge acquisition process an ability to interrelate Knowledge Modules may be provided. Common Knowledge Module interrelations include inheritance and composition. For example, the Proteinuria state Knowledge Module (i.e., protein levels in urine) can be derived to capture gestational proteinuria without repeating the common knowledge parts. As another example, the HELLP syndrome Knowledge Module comprises hemolysis state, liver enzymes state, and platelet state Knowledge Modules, each being valuable on its own too. Thus, the KR may cater for this by enabling to base the definition of one Knowledge Module on other Knowledge Modules via common interrelations such as specialization (i.e., is-a) and composition (i.e., part-of).

FEAT9.6 Automatic Triggering Events Extraction: The evaluation process of a Knowledge Module may impose on the requesting consumer to perform preliminary operations, for example gathering data according to application-specific Knowledge Module data requirements, which are costly in terms of time and computational resources (e.g., network traffic). In addition, in some cases it is critical to evaluate a Knowledge Module as soon as one of its comprising data elements changes in the CDR. Therefore, from a Knowledge Module definition, a consumer may be able to automatically extract events, in terms of data changes in a CDR (e.g., arrival of a new WBC lab test message), which trigger the necessity to evaluate the Knowledge Module.

FEAT10 Knowledge Base Repository

FEAT10.1 Knowledge Module Search Engine: There may be a mechanism that enables to search and retrieve Knowledge Modules. During runtime, before requesting to evaluate a Knowledge Module, it first may be retrieved and explored to provide application-specific data requirements as input. During design-time, to maintain the Knowledge Module definition, a knowledge editor may be able to locate it before editing. The Knowledge Module search engine allows searching and retrieving of Knowledge Modules by submitting search queries. These search queries capitalize on the descriptive information section of a Knowledge Module. Two possible search queries are free-text search query or a context-based search query. The free text search query contains a single search string to be matched against any text-based section of a Knowledge Module. The context-based search query comprises a structured query, for example XML, which defines for each searchable attribute or trait of a Knowledge Module its expected value. For example, a search for Knowledge Modules of John Foster may use the Author descriptive information trait. Another example is a search for Knowledge Modules that expect to receive a certain LOINC-coded lab test typically using the data requirements' Knowledge Module attribute.

FEAT10.2 Knowledge Module Definition Import and Export Mechanism: A mechanism that enables to import and export Knowledge Module definitions in or out of a KB repository. An XML schema defines the Knowledge Module file format and allows a Knowledge Module to be imported from one KB and exported into another KB.

FEAT11 Knowledge Acquisition Tool: One of the KFW client components is the Knowledge Acquisition Tool (KAT) that facilitates domain experts and knowledge engineers, acting as knowledge editors, to collaboratively acquire, edit, and maintain the knowledge definitions and descriptive information of Knowledge Modules stored in the KFW knowledge-base repository. Besides knowledge editing capabilities, the KAT may contain several other features, as described hereinbelow.

FEAT11.2 UMS Explorer: The underlying clinical information model of the KFW is the UMS shown and described herein. Hence, the definition of any Knowledge Module typically comprises UMS entities such as LabResult, Diagnosis (type of Condition entity), and Medication. The UMS information model is relatively large in scope and contains diverse attributes, complex data types, and various relations between its entities. Thus, the KAT may contain a specialized module, named UMS Explorer, to explore the UMS information model and assist the knowledge editor to navigate and find UMS entities and attributes that comprise a Knowledge Module definition. The functionality expected of the UMS explorer includes: free-text search and context-based search of UMS entity and attribute (e.g., entities that use a certain vocabulary domain), descriptive information, and navigation according to relations (e.g., related-act).

FEAT11.3 Knowledge Module Explorer: A Knowledge Module definition may relate to another Knowledge Module. Different types of relations can exist between Knowledge Modules, including specialization (i.e., is-a) and aggregation (i.e., part-of). For example, the Hypertension Knowledge Module, which defines the clinical state of having elevated blood pressure, can be derived by another Knowledge Module to define gestational hypertension. Thus, the KAT may contain a specialized module, named Knowledge Module Explorer, to explore the KB repository and assist the knowledge editor to navigate and find Knowledge Modules during the knowledge acquisition process. The functionality expected of the Knowledge Module explorer includes: free-text search and context-based search of Knowledge Modules (e.g., all Knowledge Modules that use a certain SNOMED code), descriptive information, and navigation according to relations (e.g., is-a).

FEAT11.4 Concept Explorer: A Knowledge Module definition may contain terms and concepts originating from controlled medical vocabularies (e.g., LOINC code for WBC count). Different types of terminology relations exist serving different coding habits. For example, the SNOMED terminology is usually used to code diagnosis terms, signs and symptoms. Thus, the KAT may contain a specialized module, named Concept Explorer, to explore the variety of terminologies and assist the knowledge editor to navigate and find concepts to embed in a Knowledge Module definition. The functionality expected of the Concept explorer includes: free-text search and context-based search of concepts (e.g., diabetes code in SNOMED), descriptive information, and navigation according to relations (e.g., is-a), if such exist, between concepts.

FEAT12 Role and Rule Access Control: By capitalizing on the Security Layer shown and described herein, the KFW provides a secured and controlled environment at design-time and runtime. Users and consumers may be authenticated and receive authorization before accessing KFW services and knowledge. Special roles and rules may be defined for the KFW to cater for its unique services and protect its special resources. For example, a knowledge editor role may be defined as well as a rule determining who can edit a certain Knowledge Module.

FEAT13 Auditing and Logging: By capitalizing on the STL Layer shown and described herein, the KFW provides a robust and flexible audit and log capability. The level of auditing and logging can be changed according to different scenarios, for example testing vs. production. Special auditing and logging policies can be applied to different services and resources of the KFW, for instance applying a meticulous auditing and logging policy to knowledge creation and maintenance operations.

Applicable Standards: The KFW functionality is largely based on the functionality specified in the HSSP DSS SFM as described hereinabove to facilitate interoperation with KFW services.

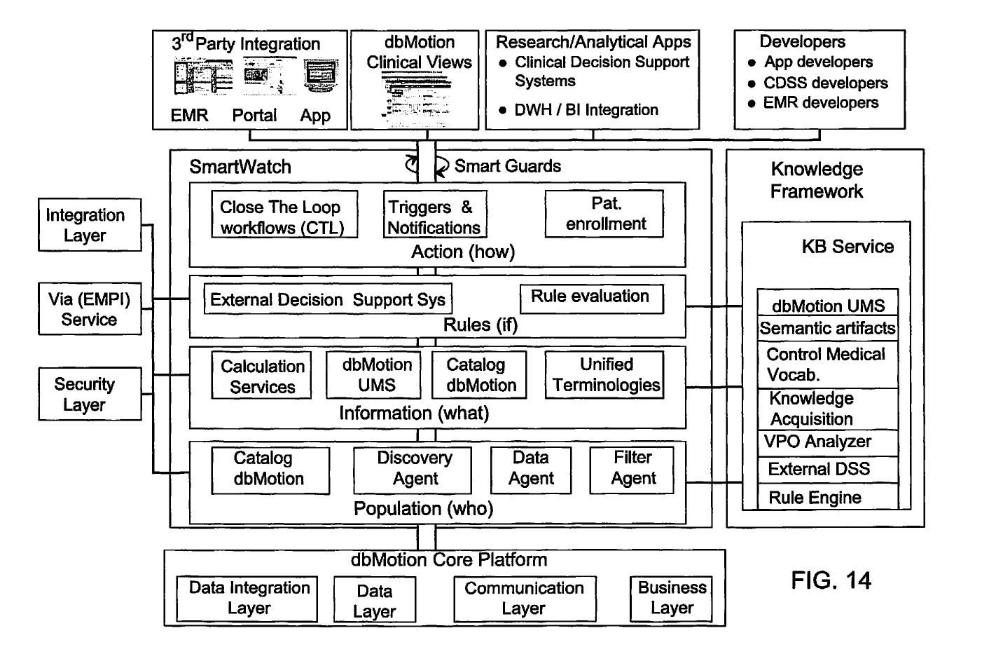

An embodiment of the smart-watch sub-system is now described generally with reference to FIGS. 14-17.

An embodiment of the Smartwatch subunit of FIG. 1A is now described with reference to FIGS. 14-17. By their nature, clinical decision support systems are very complex. The challenge of creating such systems is even greater in a heterogeneous and distributed environment where the data—the cornerstone of any decision support system—exists in different locations (often hard to access) with different structures, standards and terminologies, often lacking any common semantics. Many of the existing EMR systems provide a rich set of decision support functionalities but these rely on each system's limited data. Typically, an enterprise-wide decision support framework co-exists with the EMR CDSS modules.

There are substantial market opportunities created as a result of the above challenge in the context of increasing pressures from government, payers, employers and patients to improve and substantiate patient safety and treatment outcome while reducing costs. Focused efforts to improve care of patients with chronic diseases (e.g., CMS targets, pay for performance) seek to provide orchestration of care and related information across venues of care both within IDN's and across facilities not within the same organization. Realization of the promised benefits of electronic medical record (EMR) systems, ensuring completeness of the data used by the EMR's in assisting with clinical decision support and bridging the gap between care locations and facilities across the continuum of care with different EMR's employ interoperability solutions, including enterprise clinical decision support capabilities and services.

To enable automated decision support services at the enterprise level the dbMotion Platform product may be employed, thereby achieving interoperability, and presenting medical information from disparate sources as if it originated from one normalized source, using common representation, terminology and semantics. This enables the creation of an advanced infrastructure for an enterprise-wide clinical decision support framework termed herein the SmartWatch Subsystem.

The Enterprise Clinical Decision Support System (ECDSS), also termed herein the SmartWatch subsystem, may work in conjunction with the commercially available dbMotion platform. The SmartWatch subsystem addresses the challenge in such a way that no centralized database is mandatory, thus enabling enterprise decision support services both in a fully distributed as well as centralized model (and any hybrid in between). The SmartWatch subsystem is not intended to replace existing clinical decision support systems currently running within any of the existing EMRs, or any other systems in the organization. Instead, it aims to address problems that cannot be tackled by any operational/legacy system (e.g. EMR) that often has access only to a partial subset of the patient's clinical information.

The SmartWatch subsystem may facilitate both the design time and runtime activities involved in the creation and use of ECDSS. These activities may include some or all of: knowledge elicitation, eligibility determination, continuous patient monitoring providing timely alerts, notifications and more. Care providers are then able to carry out the appropriate actions, in a timely manner, thereby increasing the quality of healthcare and lowering costs that might arise from possible deterioration in a patient's condition.

SmartWatch does not aim to replace the physicians' role in complex decision making Instead it is targeted at giving help and support with decision making—performing time-consuming, data-driven or time-driven tasks, and bringing the human factor into the picture only when human involvement is inevitable.

The SmartWatch subsystem may rely on a built-in knowledge base, maintained by medical professionals. This knowledge base allows The SmartWatch subsystem definitions (matching rules, etc) to be set in an abstract, high level language, rather than having to code rules in computer language.

Definitions, Acronyms and Abbreviations used herein include:
SmartGuard:—A SmartWatch solution that is built to watch over a specific population. A live SmartWatch system may include many SmartGuards. SmartGuards are logically (and probably technically) separated from each other. One may envision the SmartGuard to be a set of configuration settings defining a SmartWatch vertical instance, the population involved, the information to be employed, the rules and actions that may be performed.

Population:—A set of patients grouped by some criteria. These criteria could be medical (people diagnosed as . . . ) encounter based (Currently hospitalized in ward . . . ) demography-based (people over 90) or any other UMS-based criteria. A population may also include other elements derived from dbMotion's UMS such as organizational units, physicians and so forth.

Information:—the set of data elements to be collected for a population member (a patient). Typically each SmartGuard would define different application-specific information needs.

EMPI:—Enterprise Master Person Index: Software that attempts to cluster patient records from separate applications (AKA operational systems) usually using probabilistic methods. An EMPI cluster contains a set of indexes, each representing a demographic record in an operational system.

Subscriber:—is an entity that signs up (to some SmartGuard) to be notified when a certain condition matches a population member. The subscriber may be a person, or another system.

HIPAA:—Health Insurance Portability and Accountability Act, which is the leading regulation in the United States for the use and disclosure of patient health information.

Population criteria:—the criteria that defines population membership. This may include, for example, inclusion/exclusion over UMS entities, or more complex rules which use other considerations such as time, age and so on.

The SmartWatch subunit may have some or all of the following properties and functionalities:
Population—The problems focus on populations of patients (or other entities) that share some characteristics such that monitoring them is beneficial.
Information—The relevant population is monitored for some limited set of clinical (or other) data elements—giving SmartWatch an advantage where information is scattered over an enterprise, in different systems and at disparate locations, possibly coded using different terminologies.
Rules—The population being watched is expected to be “ok” most of the time for most examined subjects (patients), the objective being to find the abnormal elements—to identify situations where some action is to be taken for a population member (patient). The problems that fall into the SmartWatch profile would usually involve clinical knowledge, introducing two complex issues:
   The ability to apply clinical knowledge to the raw data and derive decisions from it involves intelligent inference mechanisms & knowledge representation.
   Clinical knowledge changes constantly and therefore requires constant knowledge maintenance by knowledge experts.
Actions—the functionality of communicating monitoring results to the outside world. Many communication mechanisms can be envisioned to serve this, allowing much flexibility in implementation. Also, a possible need for workflow capabilities is recognized in order to allow escalation reminders and so on, in order to close the loop.
3 examples of tasks the SmartWatch subsystem may perform are now described:
1. Active monitoring of patient clinical condition in a distributed, semantically heterogonous environment The importance of monitoring patients' condition can be viewed for example in the context of chronic patients. In a typical chronic patient scenario, the target audience is identifiable, and so are the indicators to monitor. In such a scenario, monitoring is a long term process, and identifying an abnormality that leads to a corrective action can be of great value. However, this monitoring is greatly facilitated by computerized assistance: the number of patients can be very large. Patient data volume can be overwhelming. Events are not detectable locally—patients visit different hospitals, clinics, meet different caregivers. Lack of semantic interoperability, different data structures and languages exist. A typical multi-hospital environment introduces more difficulties such as different systems, usually distributed; different APIs; different semantics are used. No unique patient identifier exists.
Example: Monitor all diabetic patients—checking that their clinical diabetes indicators such as Lipid profile (LDL), Glucose, HA1C, Creatinine, urine micro-albumin and so forth are within range, and are performed promptly; making sure Eye exam (DRE) and foot exam are carried out promptly and so forth. When a certain test is not done within the timeframe, or results demand provider attention, SmartWatch may notify the local EMR, with a mail to the primary physician. This affects quality of healthcare. Poor monitoring may lead to complications, deterioration of patient condition, and potentially further treatment costs. Non-automatic monitoring is time-consuming and inefficient. Certain embodiments seek to provide a preemptive action leading to a care provider response to the patient's condition.
2. Gathering medical research data: When Collecting clinical data for research, such data sometimes needs to be de-identified. This affects researchers who may need to gather clinical data records to base their research on. The impact includes high costs of assembling research data from a variety of sources, cherry-picking patients that match the criteria, Inconsistency in patient records due to diverse source semantics, patient privacy issues, and wrong patient identification due to de-identification methods. Certain embodiments seek to eliminate or reduce any need to collect such data manually, improve data integrity by supplying an integrated patient record, and enhance patient privacy with automated patient records gathering, so patient identity is not disclosed to researchers in any way.
3. The task of Public health surveillance may include looking out for abnormal healthcare patterns on a large scale. This can be done by monitoring information sources such as ER visits, medication consumption, diagnoses and so on.
For example, an alert may be issued when, in one week, 5 patients from the same area (zip code) are suspected to be suffering from bacterial meningitis. This task typically affects disease control centers officials, ER managers and public health. Poor epidemic detection does not allow authorities to respond on a timely basis, resulting in the potential infection of more people, with higher treatment costs. The impact of the epidemic outburst may be drastically reduced, following corrective action, such as containment, before the epidemic gets out of hand.

The SmartWatch subsystem is a platform for developing services that facilitate an enterprise-wide clinical decision support system (ECDSS) that utilizes the Service Oriented Architecture (SOA) environment provided by the dbMotion platform. The subsystem is geared to identify a target population according to eligibility rules, and monitor the state of the target population members over time, according to another set of monitoring rules, and eventually trigger proper actions such as alerts or reminders when a rule is matched.

The subsystem may facilitate both the design time and runtime activities involved in the creation and use of ECDSS. These activities include knowledge elicitation, eligibility determination, monitoring patient state continuously, providing timely alerts, notifications and more. Consequently, care providers can carry out suitable actions when appropriate, thereby increasing the quality of healthcare and lowering costs arising from deterioration in the patients' condition.

The SmartWatch subsystem is intended to rely on a built-in knowledge base, maintained by medical professionals. This knowledge base allows the SmartWatch subsystem definitions (matching rules, etc) to be set in an abstract, high level language, rather than having to code rules in computer language.

The SmartWatch subsystem can serve as a complementary framework that may benefit other systems. Currently, cutting edge EMR systems provide CDSS capabilities usually during data entry (i.e. in real time) although they are dependent on the data available to the EMR itself In contrast, SmartWatch's design enables retrospective CDSS capabilities offering a near real-time response. Thus, a preferred model for The SmartWatch subsystem is one of synergy in which the SmartWatch subsystem provides a continual monitoring of clinical information and notification services to other applications.

SmartWatch does not aim to replace the physicians' role in complex decision making, but to provide help and support in decision making by performing time-consuming, data-driven or time-driven tasks, and bringing the human factor into the picture only when needed.

The SmartWatch model may include 4 logical layers as follows:
1. Population The Population layer defines and manages the target population to be monitored. This is accomplished either with eligibility criteria that define the population boundaries and detect new population members automatically, or by letting users enroll members directly.
2. Information The Information layer controls information to be gathered and processed for the population members, once their membership has been established. This information can be used later by other (higher) layers, for example for rule evaluation or within an action's output message. Required information, if any, is not necessarily static, and may change in accordance with the member state, as different stages of analysis may employ different data elements.
3. Rules The Rules layer defines the conditions for which any action may be taken for population members. It defines the abnormal behavior that The SmartWatch subsystem monitors for its population members.
4. Actions
   The Actions layer handles actions that may be taken when a population member (patient) matches a rule, usually when some abnormal condition has been identified. Actions typically comprise a workflow detailing reminders, escalation procedures, and close-the-loop functionalities and may include services to deliver messages using standard channels to humans or other IT systems.

A high level conceptual view of SmartWatch, based on the 4 layers mentioned above is illustrated in FIG. 14. As illustrated, there is communication between the 4 logical SmartWatch layers. Each layer depends on preceding layer artifacts. In addition, SmartWatch communicates with dbMotion platform services such as security services, EMPI, and the management layer. Also illustrated is the dependency of SmartWatch on the Knowledge Framework in supporting clinical decision making.

SmartWatch may employ several storage elements that include SmartWatch Metadata, in which the SmartGuard (the SmartWatch Solution) properties are persisted, population and possibly VPO storage, in which the population and information are stored. The Knowledge Framework may add storage—a knowledge base—of its own. The VPO storage system is used to store ePHI, and for that reason careful thought may be taken on how to store them without compromising patient and business security and privacy. SmartWatch provides services to external parties, allowing complementary applications to fit in and form a solution.

The knowledge-framework role is to allow SmartGuards to be defined in terms of clinical concepts and abstractions, rather than referring directly to raw UMS data. The knowledge-framework may be able to connect a concept, or a knowledge module, to data and to a suitable computation mechanism.

The SmartGuard can be thought of as a single SmartWatch subsystem solution, monitoring a specific population. The SmartWatch subsystem may host several SmartGuards running simultaneously. Each such SmartGuard may contain all the details it uses in order to operate: the population criteria, information to be employed, the rules to be matched, and the actions to take when rules fire.

SmartGuards are the context for retrieving information between hospitals. To make sure that no unauthorized query is performed in a hospital repository, SmartGuards may require hospital approval to operate.

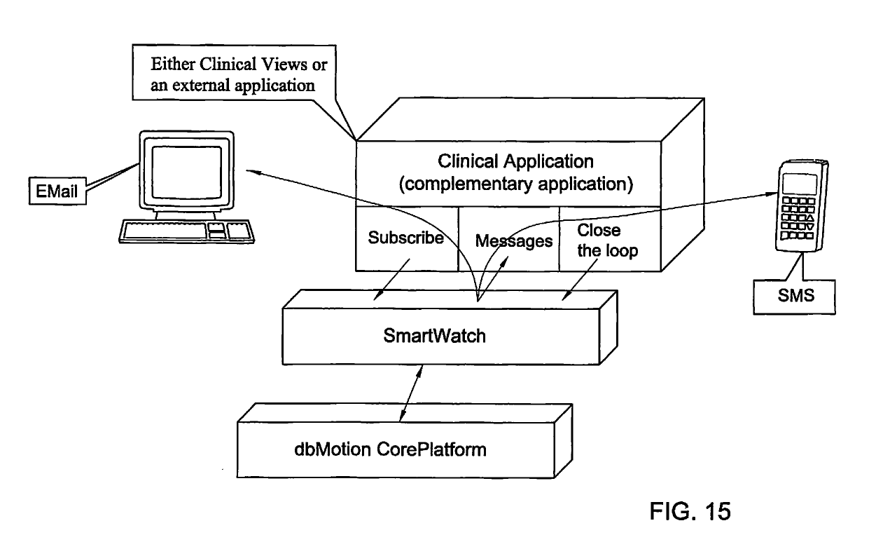

SmartWatch is a framework, which provides services, and therefore employs additional components to form a comprehensive solution. FIG. 15 presents such a solution that includes a dbMotion platform that provides the application-specific required data for the SmartGuards, SmartWatch itself, and a clinical application that users interact with in their daily routine, such as a CPOE or EMR. This clinical application interacts with SmartWatch, and provides the user with a subscription mechanism, a message viewer (e.g., view SmartWatch patient messages within the patient file; action items for the physician after login to the system and so on), and an ability to close the loop (e.g. by marking a checkbox verifying that the message was addressed, by simply viewing the message, or by initiating a process tracking the patient condition). None of these interfaces is mandatory, but failing to provide one may result in the creation of a partial solution only.

A clinical application as shown in FIG. 15 may be referred to here as a complementary application. This document assumes the existence of such an application, provided by dbMotion or by an external provider, to form a complete solution. Also shown in FIG. 15 are messages sent to users directly, via for example SMS or Email protocols. Messages sent to human users in this form, would usually be accompanied by a corresponding message to the complementary application, while providing elementary information and directing the user to view the full message details in the complementary application.

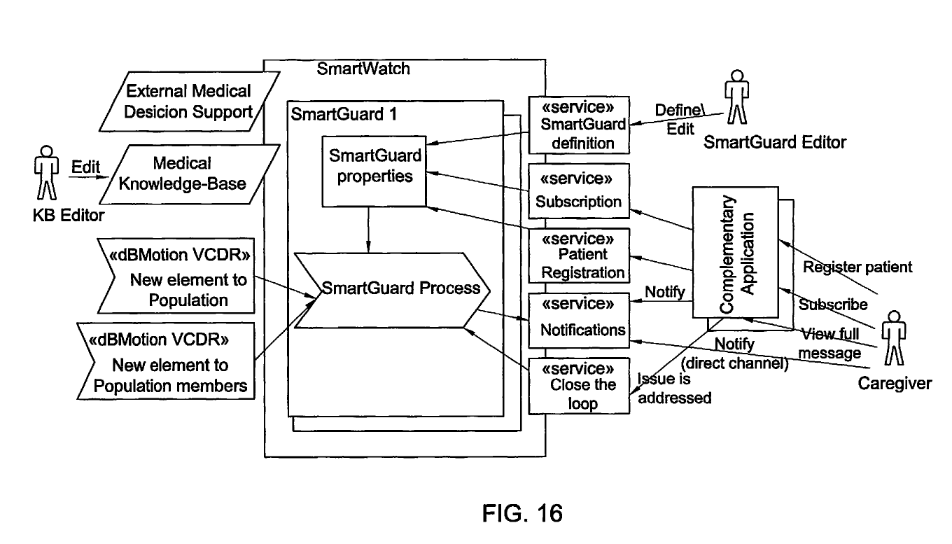

FIG. 16 presents a domain model for SmartWatch, implying both its static service-oriented structure, as well as the dynamic processes involved. It shows SmartWatch containing several SmartGuards, maintaining their properties through services, as well as the dynamic messages coming into the SmartGuard process from dbMotion network, and out of the process to users and systems. Also shown is a clinical knowledge base, and its editor, CDSS that may be called by SmartWatch during patient records analysis.

Some or all of the following functionalities, and associated supporting features, may be provided:
Patient condition monitoring: Physicians gain a monitoring tool for their patients that relieves them of certain tedious tasks, allowing them to concentrate on more complex cases. In a pay-for-performance environment, physicians/clinics gain actual income when SmartWatch helps them to meet suitable quality measures. For this functionality, associated supporting features may include some or all of the following:
   User direct notifications
   Alerts to external, complementary applications
   Reminders & Escalation notifications
   Mandatory message properties
   SmartGuard definition tools
   Additional pluggable workflows
   Subscription service
Population enrollment service
Close the loop capabilities
Researchers may greatly benefit from a tool that gathers comprehensive, semantically coherent, research-oriented patient records from distributed systems. This eliminates the effort of piling up research data from various inconsistent sources, and the need to reconstruct de-identified patients' records into virtual patients. For this functionality, associated supporting features may include some or all of:
   Alerts to external, complementary applications
   SmartGuard definition tools
   SmartGuards rely on high level medical abstract concepts
   Subscription service
   Research purposes output service
Public health surveillance
A SmartGuard monitors admission records to ER, identifying abnormal patterns in a patient's condition, alerting a possible epidemic. A benefit of this is public health, but hospitals and regional/national disease control centers also benefit from task automation.

For this functionality, associated supporting features may include some or all of:
User direct notifications
Alerts to external, complementary applications
Reminders & Escalation notifications
Mandatory message properties
SmartGuard definition tools
Additional pluggable workflows
Subscription service
Close the loop services

According to certain embodiments of the invention SmartWatch relies on the dbMotion infrastructure as its main data source and relies on some or all of the following dbMotion Services: Security, Auditing and Logging (STL, CEB).

This may enhance re-use of any needed functionality which already exists in a dbMotion product. SmartWatch relies on its decision logic in the Knowledge Framework component for modeling clinical knowledge, and in applying that knowledge to patient data. SmartWatch is a service-based product, that assumes the existence of complementary applications (not necessarily part of the basic SmartWatch) from which users can actually subscribe to SmartGuards, view the artifacts—resulting messages, and let SmartWatch know when the issue is covered (close the loop). SmartWatch analysis assumes the existence of an EMPI service, with a one-to-one relationship between the EMPI cluster and the virtual patient SmartWatch refers to. Even if there are more than one (several) clusters returned from the EMPI, SmartWatch may use only one of them. If the EMPI clustering quality is poor, SmartWatch's decision quality may be affected, as it may miss patient records or be confused by records actually related to another patient.

According to certain embodiments of the invention, SmartWatch assumes each EMPI vendor supplies the “member-of” functionality, whose input is an index and its output is the cluster the input belongs to, along with all cluster indexes. This converts an operational system patient index into a virtual patient which contains all indexes in the cluster. SmartWatch assumes that EMPI vendors do not supply a change log service, detailing clusters whose state has changed. However, if such a service is available, keeping up with patient EMPI state may be made much easier and may simplify the process.

The system need not provide an application (GUI) for managing the actions and states related to population members. Instead it may only provide SOA based infrastructure that may enable developing such capabilities.

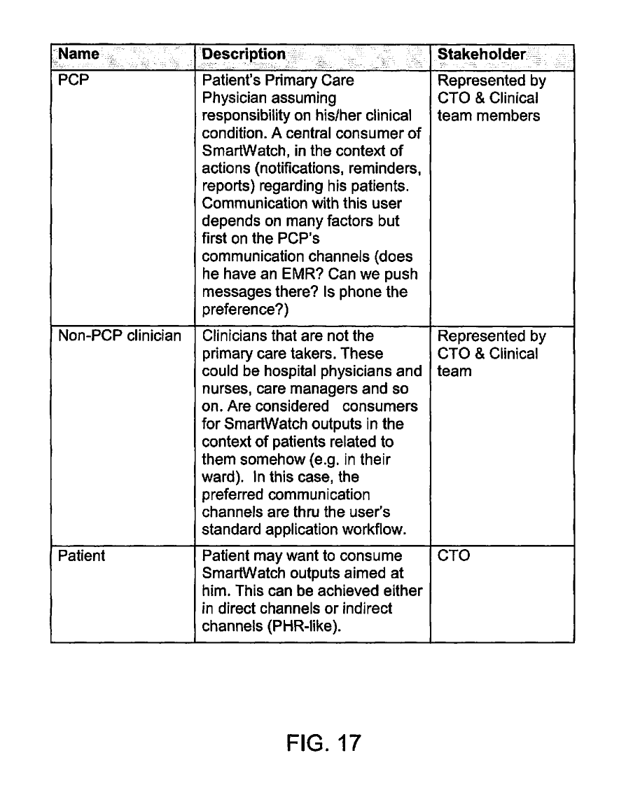

Possible Consumers for the SmartWatch subunit are described in the table of FIG. 17. User environment: In general, the expert, Super User category is envisioned using networked, personal computers. This is a small, predefined set of users:
The SmartGuard editor user role may use a designated application to configure the SmartGuards he/she is authoring. This application may be the SmartWatch management tool or a similar tool.
The SmartGuard/SmartWatch administrator role is envisioned using the SmartWatch management tool to perform administrative, maintenance, monitoring and configuration of a SmartWatch product implementation. This includes tasks like review & approval of SmartGuards before they actually run, viewing status & operation statistics (e.g. population size, number of actions taken, exceptional conditions etc). This user type may exist in any dbMotion node.

As far as the Consumer category is concerned, the situation is far less clear. This is envisioned as an area that includes many professional services with customization & configuration, aimed at getting to end-users in the most effective way to meet their needs with working modes in the specific project rather than the “one suit fits all” product approach. This statement implies that users may be working in any kind of electronic environment, from mobile phones, thru PDAs, networked personal computers, mainframe terminals to fax machines. The following is a classification of delivery methods that may be useful:
Direct, standard delivery channels (e-Mails, SMS, fax and so on).
Complementary application that may be the users' working environment, to present the SmartGuard's output. Such an application may be a commercial EMR, dbMotion Clinical Views™, or some other proprietary clinical application.

In addition, the following factors (among others) may be considered in deciding which channels are best in a given situation:
Urgency level—Life threatening messages may be accompanied by a text message to the relevant physicians' mobile device, while less urgent messages may be pushed to an application queue, to be presented to the next caregiver.
Enterprise preferences—Enterprise policy may prefer to send notifications to its physicians' mobile devices, or to a reliable follow up mechanism/EMR system. Each implementation may include a configuration stage during which it may be decided how and where the notifications are addressed.
Personal preferences—Consumer-type users in general and PCPs in particular, may have different levels of automation in their offices. Also, the nature of their activities may dictate out-of-office hours during which a physician would prefer to be notified through a mobile device. These typically simplified constraints may require a diversity of abilities to receive and respond to notifications.
   Time factors—An SMS message at night time may either be rescheduled to a reasonable time, or sent to the on-shift physician who is currently responsible for the patient.

Medical records may be gathered for specified groups of patients (population), providing proactive messages based on the records collected. SmartWatch may provide an enterprise-wide view of patients and an ability to analyze the information, apply rules to them, and as a result perform actions in which messages are sent to external actors to respond to SmartWatch findings. The response time (measured starting from an event happening in real life, and ending as user views the resulting message) expectation is at most near real-time.

SmartWatch may be supplied with an existing content that covers common medical cases.

This content is to be supplied in the form of existing definitions of populations, related knowledge and actions, packaged as a set of SmartGuards. This means that each SmartGuard may be a deployable unit, packed and deployed together.

Some or all of the following functionalities I-VI may be provided to facilitate identification and management of populations:
I. SmartWatch may support population discovery by several, parallel methods, as detailed below. The fact that population members are discovered by different mechanisms may not impact the rest of the layers. i.e. in a given SmartGuard there may be population members (patients or other) that were discovered automatically and others that were enrolled by their physician, but the rest of the SmartGuard flow may work the same for all cases. Therefore, some or all of the following population discovery mechanisms 1-5 may be provided:
   1. Automatic population discovery by eligibility criteria: SmartWatch is typically able to discover patients (or other UMS entities) as matching the SmartGuard criteria by using knowledge from the Knowledge Framework (triggering events).
   2. Population based on external list: In some cases the population could be known to an external system that can provide a prepared list of patients to work with. SmartWatch may provide an interface that enables project specific implementation to push patients into a population. For example, the list of admitted patients may be accessible using a db view generated from an ADT system.
   3. Patient enrolled in population by care provider: optionally, SmartWatch may allow consumers (e.g. care providers) to enroll patients into some SmartGuard population. This requirement arises from two scenarios: scenario 1)—let physicians register their patients to an existing population, for which they are not qualified by the eligibility criteria—imagine a SmartGuard watching over CHF male patients over 65, and a physician who wants to add his patient to this population even though he is just 62—enabling human decision making to override the computer logic; scenario 2)—a SmartGuard that is voluntary, includes no eligibility criteria, and is based on patients/physicians deliberate enrollment—for example, monitoring the influence of a new drug, a diet and so forth. This requirement, if provided, probably involves much customization to supply users with tools to perform such an enrollment (for example search and choose leading record; enroll button from patient file). SmartWatch may provide an interface for adding patients to a population (high priority), together with tool (GUI). This tool may also be useful for testing.
   4. Patient enrolment in a population by patients themselves—SmartWatch may enable patients to enroll themselves in a SmartGuard solution.
   5. Patients pushed between SmartGuards: it may be useful to move patients between SmartGuards when they fit some pattern. SmartWatch may therefore enable a SmartGuard action to add patients to another SG population. For example, a population that monitors elderly patients (over 65) may push patients to another SmartGuard that are related to age criteria.
II. Partially matched population: In defining SmartGuard's population eligibility criteria, it is very likely that even though certain patients do not qualify for the population, they may not be excluded from it and may be added in the future. Some examples: a lab result is missing, but might be provided shortly; age—the patient is too young and may qualify in x days; patient identity may change to add an index that carries with it the data which may be used to qualify for the SmartGuard. The requirement is typically not to lose such patients, and to somehow put the system into a “sleeping mode” (for these patients), waiting for the missing condition to occur.
III. Online connection as a SmartWatch population information source: SmartWatch typically utilizes the dbMotion core product, using it as its information source. However, it cannot assume the dbMotion CDR as the sole information source. It also addresses information sources that are available thru dbMotion online connections as well. A list of application-specific requirements from an information source may be assembled as well as a list of scenarios that could not be supported in such a case. Examples for online information sources are medications thru RxHub, claims data (P4P BUC), and Pan-Canadian standard.
IV. STRQ55 Run as background process and on demand: SmartWatch may be able to run as a background process, expected to perform most of its data fetching activities outside working hours whenever possible, in order to avoid network overload. The schedule in which SmartWatch collects data depends on the SmartGuard it is working for. These schedules are typically adjustable per SmartGuard. However, it may also be possible to make SmartWatch run a specific SmartGuard on demand (immediately) regardless of the defined schedule.
V. SmartWatch observations do not have to be patient-centric: dbMotion is also capable of collecting data on medical elements that are not actual patients; SmartWatch may exploit this to monitor entities that are not patients as well. Although most populations described in this document relate to patients, it may be understood in the broader sense of UMS-entity centric. For example SmartWatch may also observe the patient capacity of a ward, where the observation is ward-centric; or the usage of some set of expensive medication, where the population is medication-centric.
VI. Find mass Trends: SmartWatch may be able to identify events resulting from an accumulation in some population, rather than focusing on the individual patient. Example: disease control scenario, in which the event is—X people of the same zip code area are hospitalized within N days and diagnosed with diagnosis D.

SmartWatch may depend on the knowledge framework in formulating & executing its clinical rules and decisions. Functionalities of the knowledge framework which may interact with SmartWatch or otherwise be used thereby, may include some or all of the following functionalities A-G:
A. Separation of the knowledge (Knowledge Framework) from the execution & delivery engines (SmartWatch). Separation may be desirable for some or all of the following reasons 1-3:
1. Allow clinical knowledge & software engines to be separately maintained and released.
The clinical knowledge that would be modeled for SmartWatch has a different timeline to the software updates. The knowledge changes are driven by clinical innovations and discoveries whose timeline cannot always be planned (such as taking a drug off the shelves). The engines on the other hand, are managed in software lifecycles, driven by new application-specific requirements, performance issues and so on. For this reason it is highly desirable to have the ability to deliver knowledge updates on a parallel track to software updates.
2. Clinical professionals may actively participate in knowledge modeling & elicitation.
One problem with incorporating clinical knowledge into code written by programmers is the poor communication that arises, resulting in modeling errors. Knowledge Framework application-specific requirements in the long run typically incorporate the ability of clinical subject matter experts to model and validate the content. Therefore, Knowledge Framework may provide a tool for knowledge management/acquisition.
3. Managing and changing the knowledge at project level: Knowledge customization at the customer level may facilitate SmartWatch solutions in areas where clinical consensus is lacking This ability may assist in overcoming out-of-consensus situations where the knowledge involved in the out-of-the-box solution is not accepted by customers' subject matter experts, by allowing local experts to alter the knowledge as they see fit. Therefore, SmartWatch and Knowledge Framework may enable managing and changing the knowledge at project level (rather than by product level). Furthermore, such changes may not affect the original out-of-the-box components, but may be done on the “Save as . . . ” version of the implementation project, in order to minimize compatibility issues in the future.
B. Probabilistic decision logic: The clinical decision support may involve, where appropriate, probabilistic capabilities.
Such probabilistic capabilities may be used where either the decision model dictates directly, or in cases where there are grey areas, for example, age weighed against other clinical indicators (patient is not 65, she is 64.95 but has strong indicators). In such cases, the decision (e.g. whether to invoke an action, to include or exclude some patient in the population) can be made using a threshold which is a property of the SmartGuard. In a way, the threshold value determines the balance between possible false positives (threshold it set too low, which may result in high rate actions to be taken based on false interpretations) and false negatives (threshold is set too high, missing true actions whose score was not high enough). Setting such a threshold depends on the nature of the SmartGuard—the risks involved in each kind of error, the impact of each and more.
C. Knowledge may be stated using normalized concepts represented in controlled medical vocabularies.
Have the knowledge presented in baseline codes, based on known standards. Using local vocabularies would make the knowledge non-transferable. In addition, baseline codes may to be used for distributing rules for the event monitor.
D. Rules may include full Boolean logic operators & expressions.
E. Time-dependent rules: Many situations may include time aspects in which SmartWatch may initiate a revisit to patient information driven by time related conditions, for example, verifying that a certain test is performed every 3 months. Simply waiting for the test to show up may be inappropriate.
F. The decision support logic may be backed up with references & explanations based on individual data.
In order to persuade consumers of the correctness of SmartWatch recommendations, an explanation documenting the decision support logic may be employed. This may include a reference to information on which the knowledge was modeled, as well as an explanation about how this knowledge was applied to the patient data—resulting in the recommendation. Such information may be sent to consumers in the message or viewed in an audit report. The purpose is to show who the knowledge authority is (society, expert, guideline, CMS, P4P) and to show how the system reached the conclusion.
G. User Defined Logic: In contrast to enterprise-defined rules to which an end-user can only subscribe, without the ability to change the rule logic, SmartWatch may also allow a user (physician) the ability to define his own rules, or refine an existing rule.

During a SmartGuard operation, actions are invoked, typically including various means to get a message across, making sure SmartWatch's recommendations reach the user in the most suitable way for him/her, within the specific context and, if necessary, making sure it is properly handled. This calls for a very powerful, flexible set of services for taking advanced actions. This may be a combination of out-of-the-box solutions and ‘application blocks’ as well as an environment to code a per-case/need workflow/process. An example set of requirements suitable for implementing this includes some or all of the following requirements 1-20:

1. SmartWatch message typically contains sufficient information for the recipient to understand it: SmartWatch actions' output could be a readable message, sent to human actors via e-mail, fax, SMS and so on; or a message to other electronic systems, such as EMR, ClinicalViews, Database and so on, perhaps serving as a trigger to some process (integrated into the EMR workflows, integrated into the provider/patient portal/PHE etc). In either case, the message typically includes sufficient semantic information and should conform to the relevant standards to make it understandable for the receiving actor (human or application).
2. SmartWatch outcomes as part of the VPO: SmartWatch's recommendations may remain, in the long run, as part of the VPO, accessible to dbMotion consumers in the same way as any other patient related information. One possibility for implementation might be for any recommendation generated by SmartWatch to be documented in the UMS. A new UMS domain may be built to accommodate the new information, following the HL7 RIM principles. The information may include some of SmartWatch metadata as well. For example, link the action (alert/notification) class linked (many-to-one) to a SmartGuard class linked with creator class and so on.
3. Close the loop capabilities: SmartWatch may raise issues so important to the patient's well-being that an Email or SMS to the primary physician are not appropriate. Such a message is typically accompanied by some mechanism that verifies proper actions have been taken, or at least that the issue was dismissed by a proper authority. SmartWatch keeps track of the events it sends, and provides a service that allows the receiving application to notify SmartWatch that the issue has been addressed (loop is closed). This service may also be able to supply a list of non-closed issues for a consumer. The details of when to remind, how escalation is handled and so on, can be part of the SmartGuard properties, although actual interaction with the user is made by the receiving application.
“Remind Me” mode: In cases where the action channels include acknowledgment from a human user, a desired ability is for the user to ask to be reminded at a later time. This is helpful when the SmartWatch outcomes encourage a care provider to do something that he/she prefers to postpone. In this case, a ‘remind me’ service can be very helpful. SmartWatch may provide a service that enables the receiving application to utilize such a “remind me” functionality.
Escalation workflow: An optional escalation process may be provided within the actions workflow to make sure issues raised by SmartWatch are addressed, by directing the message to another recipient after a predefined timeframe in which no response is received. Such a process may verify that the previous message was acknowledged and action has been taken in a timely manner. A system-defined need for such a step is introduced from communication reliability limitation (it is possible to ensure a fax is sent, but how can one verify that it was read?) and from physician availability (sent a message to a physician's EMR but she is on vacation)—for example, if the physician has not taken any action on an urgent case, the case may be escalated to her manager 24 hours later. SmartWatch may provide a service that may enable the receiving application to utilize such functionality.
4. Narrative (free text) simple messages: In cases where an output message from SmartWatch actions is aimed at a human actor, the message may be expressed as a narrative text that describes the recommendation. For example “Patient belongs to XXXX population. It is highly recommended to perform the following blood tests . . . ”
5. Narrative (free text) complex messages: When an output message from SmartWatch actions is aimed at a human actor, the message may be expressed as a narrative text that describes the recommendation and the logic behind it, and uses dynamic data to formulate the message. For example “Patient belongs to XXXX population. Based on <yy parameter> and <xx parameter it is highly recommended to perform the following blood tests: <recommendation ZZZ> . . . ”
6. EMR Empowerment: Most typically, the preferred way for care providers to consume SmartWatch outcome is within the application they use from day-to-day—mostly the EMR they use for standard activities (workflow, CPOE, etc). This is why interaction with the EMR, allowing SmartWatch to use the EMR to get the message across, is useful.
7. Structured messages: When an output message from SmartWatch actions is intended for another system, the message may be formatted in a structured format, so as to enable other systems to consume it. The message may contain semantics as appropriate, such that the information delivered to the consumer is understandable by the SmartGuard definition.
8. Use Healthcare IT standards as SmartWatch output format: Wherever possible, in interacting with other systems, adhere to/comply with relevant recognized healthcare IT standards, such as CCD, CDA, HL7 V2/3 etc.
9. Built in mechanism to standard delivery channels: The out-of-the-box offering may include the ability to send secured messages to standard devices and protocols such as SMS, email, fax. A lower priority channel, which may be useful for communication with patients, can be paper-based mail.
10. Out-of-the-box actions workflow: SmartWatch may come with a set of out-of-the-box action solutions, and with ‘application blocks’. SmartWatch may allow the configuration/customization of the out-of-box action solutions to meet customer needs.
11. Provider identity resolving/PCP service: When SmartWatch sends a message to a patient's care provider (in most cases the PCP), it is typically operative to correctly identify the relation between the patient and his provider. This PCP service is envisioned as part of dbMotion Core product, but it is crucial to SmartWatch.
12. Action workflows and messages which are context-sensitive: Message format (text, color) and delivery method may depend on the context in which the message is sent, including, for example, the recipient role, urgency, time of day, and delivery method. The goal is to get to the consumers, mostly care providers, in a way most convenient to them, non-disruptive to their daily tasks. For example, when sending the output of a SmartGuard (e.g. alert/notification) as SMS and/or email, the choices may be smart and have some logic/workflow/rule based capabilities (e.g. not sending an SMS to physician X on Saturdays and Sundays between 09:00 to 17:00). SmartWatch therefore may have some basic business rule capabilities for this non-clinical logic (clinical knowledge is managed by Knowledge Framework).
13. Paper/Fax messages: Some recipients of messages and reports may not be connected to the dbMotion network or only be loosely connected. Such a mode may only permit simple, one-way communication by fax or paper-based reports sent by mail. For example, transfer of care use cases introduces nursing homes as an actor that is a) not affiliated with the dbMotion network; b) not computerized in almost any way. A fax may be a good means of communication for such cases. Note may be taken as to how to obtain these contact details (e.g. recipient registry or Subscription) and how to tie them to the patient records. Another example relates to agencies to which reports may be delivered. An alternative simpler scenario could be when the paper report is electronically transmitted to a person, who is then responsible to fax/mail it to the target facility.
14. SmartReports capabilities: SmartWatch is typically able to generate a report with the SmartGuard result/outcome. This may include all relevant information for the consumer/user. This report may be sent (as an option) automatically to a given printer/fax or be saved (as PDF for example). The report may be either patient specific or contain a batch of patients. Batching patients is useful for all the Use Cases that are classified as Reporting Use Cases in many scenarios. Example 1—preparation of a report for a physician of all his patients whose Coumadin-related evaluation points are due this week (with all information which may be used to make the call) allows him to get the job done much more efficiently than referring to them individually. Example 2—report to the authorities of quality performance/measures.
SmartWatch is typically operative to: 1. enable report generation, using standard reporting tools (e.g. MS Excel). 2. Provide basic/simple out of the box report generation capabilities.
15. Patient de-identification and re-identification: When sending messages to some systems or external agents there is a recognized need for patient de-identification, in order to maintain patient privacy and comply with HIPAA regulations. This de-identification may be performed in such a way that allows SmartWatch to reconstruct the patient identity (re-identify). De-identification omits any identifying patient details (names, addresses, phone numbers and so on), or replaces these with gibberish details. The de-identification procedure is consistent in that it yields the same result when applied again on the same input info. The de-identification method (in which fields may be scrambled/omitted from the message) may be customizable per project. Usage example 1: A SmartGuard for research purposes, either to identify eligible people or to gather data; Usage example 2—P4P measures computation may assume aggregation in some BI tool, where patient identity is irrelevant—however the ability to drill down back to the patient is desirable (assuming user's security privileges are adequate) which typically requires de-identification. There is great demand for such a service in many other domains of the dbMotion Core product. It may therefore be designed as a service that can be consumed by other layers/modules.
16. Action's result urgency level: Actions taken and resulting messages may include an urgency level property indicating the urgency with which the message may be treated. An outgoing message should be marked with a proper urgency level indicating the impact of the delivery of that message. SmartWatch findings may be life-saving, but may also be less urgent, and may be treated accordingly. Urgency level may also be a subscription parameter (wants to be notified for very important items) or influence the delivery method (e.g. sometimes must send an SMS in a life-threatening issue). Such “lookup values” management functionality can be designed to use dbMotion Core Vocabulary Management and/or CTS.
17. Confidence measure: As a decision support tool in a world of different semantics, units, possible missing information, and patient identification issues—a confidence measure may be assigned for each message. Such measures can also serve (similarly to urgency level) in determining the appropriate message delivery.
18. Sending Messages to remote node recipients/subscribers: SmartWatch may support subscribers coming from different nodes. Securing subscription of users not from the local SmartWatch Node is usually a provided functionality, if there are anticipated issues with securing subscribers that the node, managing a SmartGuard, cannot authenticate & authorize.
19. SmartWatch may have a subscription mechanism which allows consumers (e.g. physicians, health plans, external firms & agencies) to subscribe to get notifications from a given SmartGuard. Subscription information may include some filtering logic (a specific patient, all my patients, urgency level conditions, confidence measure threshold) contact information (fax number, email, . . . ) as well as preferences (e.g. preferred method of communication, time-of-day/day of week constraints)

A possible business model is a customer paying per notification he receives. To accomplish this, SmartWatch keeps track of how many notifications each recipient/system receives, and stops sending notifications when the contract expires in a manner which may depend on urgency level. Another option (less realistic) is to limit a consumer subscription to a population whose size is limited by the consumer contract. A possible solution can control notifications based on dbMotion core Event Log counters.

An enterprise may define mandatory notifications that a physician must receive, without voluntary registration. At the same time, it may be possible to define notifications that a physician actively subscribes/un-subscribes to. SmartWatch typically supports all 3 of the following options: a. mandatory, b. opt-in and c. opt-out. Note that opt-in/opt-out options rely on having a subscription/un-subscription mechanism.

20. Activate EMR Workflows: In some cases, it might be beneficial for SmartWatch to initiate the ordering of new tests (e.g. laboratory tests). For example when confidence level is low, some new test may clarify the picture. This can be achieved in many ways, including notifying the PCP or integrating into EMR workflows. Optionally, SmartWatch is able to integrate directly with the EMR or Clinical Systems. Alternatively, SmartWatch is able to trigger EMR/Clinical System Worflows.

The importance and difficulty of achieving high adoption rates is known. Some or all of the following requirements A-C may be provided in this context, including software requirements from the infrastructure, as well as guidelines or best practice for the solutions to be built on that infrastructure:

A. Enable feedback from users: In an interaction with users, SmartWatch may allow a user to provide feedback that can be considered for future product refinement. This applies to SmartWatch and Knowledge Framework management tools (SmartGuard editor, Knowledge acquisition tool, control room) as well as to interaction through messages, and interaction integrated into the care-provider workflow (EMR empowerment). Feedback may include user response (free text) as well as internal information (application info, SmartGuard info . . . ). The feedback may be sent to dbMotion and the relevant IT owner. One simple example for such interaction is to provide the user who receives the message an email address to send his feedback. A more advanced solution is a web form to submit his feedback which may also include the context of that specific message. A possible solution could utilize dbMotion Core ADR.
B. Fit into clinician workflow: A decision support tool typically has its recommendations integrated into the clinicians' application in a way that is not disruptive and is context-sensitive. This is mostly relevant for SmartWatch solutions built on top of the framework—but the framework may facilitate it, for example, by providing the infrastructure for EMR empowerment as described herein.
C. Look for knowledge consensus and knowledge authority: When building a SmartGuard (SmartWatch vertical solution) the question of knowledge consensus may arise. Many clinical scenarios are difficult in this regard and it may be hard to achieve users' acceptance of decision support recommendations based on knowledge resources they doubt. An independent knowledge authority such as medical associations and societies that publish their best practice care plan may be helpful.

SmartWatch and SmartGuard System Management Requirements may include one or more of the following requirements 1-9:

1. SmartGuard activation: SmartWatch typically has the ability to start and stop SmartGuards independently of one another. When stopping a SmartGuard and restarting it at a later time special caution should be taken in making sure that no input events are lost in the process (all relevant records that were inserted during the time the SmartGuard was down are revisited when the SmartGuard is activated).
2. SmartGuard Expiration Date: One of the SmartGuard attributes may be Expired Date. If such a date is defined for the SmartGuard, it may stop automatically when the date is reached.
3. Monitoring tools—Auditing, Logging: SmartWatch typically employs a set of monitoring tools and a consistent auditing and logging methodology with tools to assist in tracking activities over time—for example, alerts the system sent over time, to whom, sees that the loops were properly closed and so on. This would greatly help in evaluating the ROI of a given SmartGuard SmartWatch and leverage the existing tools provided by the dbMotion product.
4. SmartWatch Control Room: The monitoring and system management tools may be part of the larger concept, the Control Room. Someone sitting in the SW (virtual/physical) control room and in front of one/a few screens is able to manage the whole operation: track log, activate/de-activate SmartGuard s, see/correct errors etc. Such an application may track all activities in the different SmartGuards and monitor their operation—track ALL the activities in the SmartWatch network, enable deactivate/activate SmartGuards, audit the various types of errors (and act on them), filter all the active SmartGuards, see the status and all relevant information for each one.
5. Document and manage all changes made to the system after deployment: SmartWatch may follow common practice in the content management field in order to make sure that the SmartGuard metadata and related knowledge always have the most updated information, versioning, and so on. Several examples: approval date, owner (company, person), update dates etc (Content Management). SmartWatch can utilize the existing dbMotion core product mechanisms for management change (mainly the Reference Model).
6. Maintain SmartGuard integrity: SmartWatch relies on a suitable source such as the dbMotion core product as an information source, and is typically made aware of changes in dbMotion. Such changes, low down, could be for unrelated reasons, where the people making a change are unaware of the effect it may have on SmartGuards that hover above and consume the data and the chance that a change may affect some SmartGuard function in the wrong way. The outcome can be false negative which may be potentially dangerous. Semantic changes—for example changing business rules and/or data modeling decisions without changing the structure—are handled with caution. Examples of dbMotion changes that can affect SmartWatch: changes in the UMS, business methods, mapping in terminologies, archetype, KW, lab values (and many more). These changes can easily give rise to a malfunctioning SmartGuard. A possible solution utilizes the dbMotion Reference Model system to maintain SmartGuard integrity. The reference model manages the overall dbMotion system configuration and the relations between the dbMotion components. The importance of the Reference Model in this case goes way beyond the implementation domain (project Vs product).
7. Search capabilities in SmartWatch metadata: SmartWatch may provide the ability to query the SmartWatch metadata repository for SmartGuards based on some topic, keyword or clinical term (using some vocabulary). For example, a list of all SmartGuards related to hypertension.
8. SmartGuard feasibility testing: Once a SmartWatch is defined, estimation may be made of population size, verifying that the SmartGuard is feasible. This information may be considered for SmartGuard approval (in each node). For business security, this information is not exposed across nodes.
9. SmartGuard full description: A description of the SmartGuard in free text:—e.g. what is the population?, what information is gathered? and why?—the decision logic process, the actions that are taken. This may be a generated report, but may include meta data text pieces that were captured along the way.

Security & privacy requirements may include some or all of the following requirements 1-12:

### 1. General:

Users are authenticated prior to accessing the system. Users are authorized for the operation they perform. Access to any storage system is secured. Secured Communication may be established for ePHI. In any case where patient data is used for research purposes, all patient identifying properties may be removed from it (de-identification). Every significant action in the system that relates to a covered entity (patient) may be recorded.

2. Actions may protect patient privacy. Since SmartWatch has the potential to distribute patients' data outside the dbMotion world and to non-authorized users, it may provide means to protect patient confidentiality with regard to information that is included in notifications and the actors who receive them. SmartWatch should have authorizing tools that verify who receives patient-related notifications, and a security methodology for SmartGuard development, configuration and deployment. A methodology is useful to prevent overlooking patient privacy. The authorizing tools are employed to facilitate verification that outgoing messages are authorized. The SmartGuard may always send the minimal data set that is relevant to the context of the specific SmartGuard.
3. Subscription security authorization: SmartWatch enforces authorization for subscribing to SmartWatch actions to get messages, to avoid unauthorized access to confidential patient information as a result of notification
4. SmartWatch management tools security and auditing: SmartWatch controls access to its management tools and audit user activities for several reasons: a) sensitive information may be accessible to users of these tools, for example through auditing messages sent b) changing security-related settings can cause HIPAA violation (for example if patient consent policy setting is altered) and c) changing SmartWatch settings definitions may jeopardize the proper functioning of the system. As to the question of who may stop and start SmartGuards, this is typically done only by an authorized administrator and is audited. Deactivating a SmartGuard can have severe implications if clinicians rely on its actions. SmartWatch may therefore provide and manage secure access (authentication and authorization) to Smart Watch management tools.
5. Access data across the enterprise (using dbMotion) in a secure manner: SmartWatch is typically operative to access data across the enterprise (using dbMotion) in a secure manner, utilizing a secure channel, authentication and authorization—for example, a need to prevent SmartWatch from accessing unauthorized data domains.
6. Enterprise business security: SmartWatch introduces an amplification of all the barriers found in the dbMotion core with regard to ownership. While the ‘per-patient and only for-patient-at-the-point-of-care’ argument usually works in the patient centric viewer model of dbMotion core, this will not always be the case with SmartWatch. The customers concerned (hospitals) may have doubt about querying their CDRs/operational systems in a ‘batch-mode’ (in contrast to treatment-based context implied when a clinician views patient ePHI) which may be mitigated by a federated model and a mechanism that guarantees to some degree that the data is used for the purposes agreed upon only. This concern is greater in a RHIO setting where SmartWatch has the potential of revealing too much business-sensitive information between hospitals/organizations that may be business competitors. SmartWatch may therefore enable the customer to manage and control access to his data repositories.
7. Securing SmartWatch storage: The SmartWatch process may involve short-term or long-term storage of ePHI. The storage devices are secured. Furthermore, customers may require enforcing regulations that prevent duplication or centralized storage of identifiable ePHIs.
8. Auditing: SmartWatch may enable auditing of all operations that relate in any way to accessing patient information (ePHI). An audit entry may include details of the user, the time the operation took place, and the ability to generate audit reports—with the option to audit any changes in SmartGuard settings, any operation in SmartGuard or SW management, and any message that was sent. In addition, audit of SmartWatch Actions may include ALL the information about a recommendation/notification/alert, including its content and narrative explanation (mainly for medico-legal reasons).
9. Notifications over unsecured delivery channels: SmartWatch may be designed to deliver messages to both secured systems and to people over potentially unsecured channels such as Email, Fax or SMS. Provisions are typically made both for protecting patient privacy in the message content and for technologically securing the channel. For example, Email could be signed and encrypted, an SMS message may include partial, non-confidential information, directing the user to view the full notification in a secured system, to which the message was sent in parallel. The recommended practice is using secure channels only.
10. Patient consent to be incorporated into the SmartWatch process: SmartWatch may find a way to take into account patient consent considerations when deciding on including a patient in a SmartGuard. Policies can be established at enterprise or SmartGuard level that may include (but are not limited to) opt-in, opt-out, no consent required. SmartWatch may utilize the dbMotion core PAS.
11. SmartGuards from using ePHI retrieved under a different role/contract, or ePHI retrieved under different authorization settings (i.e. role/contract): SmartGuard may use information it was not authorized to view. In other words, data sharing between SmartGuards can put patients' privacy at risk unless they share the same authorization level (for example, the same role/contract which means they have exactly the same permission).
12. Use existing dbMotion Core Security System and Auditing System: SmartWatch may use dbMotion Product Security and Auditing, as much as possible, for meeting security and privacy needs. This may reduce costs in the SmartWatch Product Development, and simplify the work of the customer security admin—using the same tools and settings both for dbMotion and SmartWatch. This means that SmartWatch may not have its own Security Layer, but rather utilize dbMotion core security.

Since there are many cases where there is no cross-enterprise unique patient identifier, patient identity is not deterministic. This may impose some or all of the following constraints 1-3 on SmartWatch:

1. SmartWatch cannot assume patient clustering is stable.

When using records collected at different points in time, SmartWatch cannot assume that patient identity has not changed, i.e. that the patient's cluster as determined by the EMPI system is the same as before. Special note is taken for the join/add operation (when a person's identity is added to the EMPI cluster), which is hard to spot. Therefore, SmartWatch typically employs cluster consistency procedures to verify that the patient cluster has not changed along the way.

2. Patient enrollment scenario.

When a physician selects a patient cluster/index retrieved from the EMPI system—the selection may be stored in SmartWatch. Proposal: save a leading index whose cluster may be used as the virtual patient.

3. SmartWatch may be able to work in an environment that has a unique patient identifier for all systems, without EMPI. This applies to some European countries and Israel.

Other design considerations may include the following considerations 1-7:
1. Any audit entry may include the relevant unique SmartGuard identifier as well as the date and time. All the SW's auditing and tracking may utilize the dbMotion core STL & ADR (CEB).
2. Population size limits constraint. Since population primary criteria are a matter of configuration, it is potentially possible to define very large populations that include all patients (i.e. age >0). Such a population might have a significant effect on the system performance—both dbMotion and SmartWatch, and practically hang the system while collecting data for it. For this reason, constraints may be set on either population size (data may not be collected for a population with over 10 k members), or on the rate of collecting the data (allow collecting data for 1 k members per day). Similar constraints may be set to interaction with external systems, especially EMPI providers. Another solution could be a testing methodology and tools to identify such large populations.
3. Knowledge-level adjustability: The clinical knowledge SmartWatch uses ought to be adjustable at the customer site by knowledge engineers with a clinical background, using a knowledge acquisition tool/archetype designer, e.g. as described herein with reference to FIGS. 4A-8C.
4. System-integrator-level adjustability: SmartWatch may allow much space for the Project Implementation Team (system integrator level) customization & configuration with regard to the following aspects:
5. It is envisioned that much customization may be carried out in the action layer, since the external systems and preferred communication methods may vary greatly between customers. The Action Manager is therefore typically flexible and adaptive and offers ready-made communication tools, best practices with regard to actions' workflow SDK's. The Action Manager may be generally prepared for customization by the Project Implementation team.
6. The ability to create and modify SmartGuards may be available at least at the system integrator level. Preferably, most activities should be performed by the customer's administrator level. The functionality includes a set of tools that allows the system integrator to configure the criteria defining the patients to collect data for, the data to collect, calculations on that data, the rules applied on them, actions to be taken when patient data matches the rules' logic, and a ‘close the loop’ workflow. Some guidelines that may help in this regard are the use of templates; allowing their creation based on an existing SmartGuard (save as, e.g.); following the 4 layer path which makes sense to clinicians; SDK and Application Blocks.
7. Taking into account the fact that the infrastructure cannot be developed to support any future need ahead of time, all SmartWatch components may be extensible. Some examples are the ability to communicate to proprietary delivery channels, a need to monitor triggering events that were not supported in the original design and supporting implementation with no CDR.

Testability requirements may include some or all of the following requirements 1-5:
1. SmartGuard test mode: SmartWatch may provide a testing mode to facilitate the construction of new SmartGuards or changes to existing ones. This may be beneficial both in the development environment as well as on the customer side. When working in such a mode, the SmartGuard may be limited in some ways, for example in its outside communication capabilities. The test mode may be applied at the SmartGuard level, allowing a tested SmartGuard to run side-by-side with production SmartGuards.
2. Enable Automatic Testing thru SOA: Some GUI capabilities may also be provided through services, in order to allow these server-side functionalities to be tested using automatic testing implemented by program tools.
3. Test-dedicated tracking events (STL) to promote testing processes: SmartWatch may add entries to STL for test purposes, at each major step along the way, to allow testers to track process progress. Preferably, STL may be triggered on entry and exit of each major function, stating status and duration. However, logging level configuration may be enabled (so in production there may be less system events than in debug mode). A similar methodology to the system events tracking in the dbMotion product may be used.
4. Log messages verbose mode: SmartWatch may supply a verbose mode in which state variables, input parameters, intermediate computation results and so on can be written to log files. This may help in testing and debugging (during the development phase) and may also be helpful in analyzing problems at an operational site.
5. Allow offline testing using test data emulator: Because during SmartGuard development, a dbMotion network and other components (DSS, EMPI) might not be available, and since it may be hard to provide meaningful data for a variety of SmartGuards, it may be possible to replace dbMotion, VIA, and KFW with test data simulators—preferably existing dbMotion Product simulators.

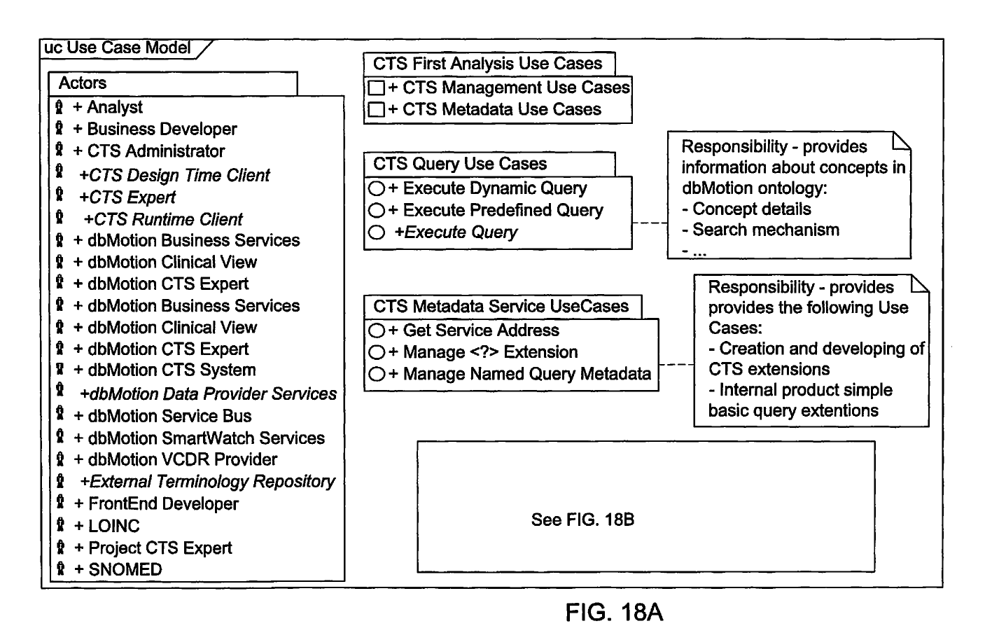

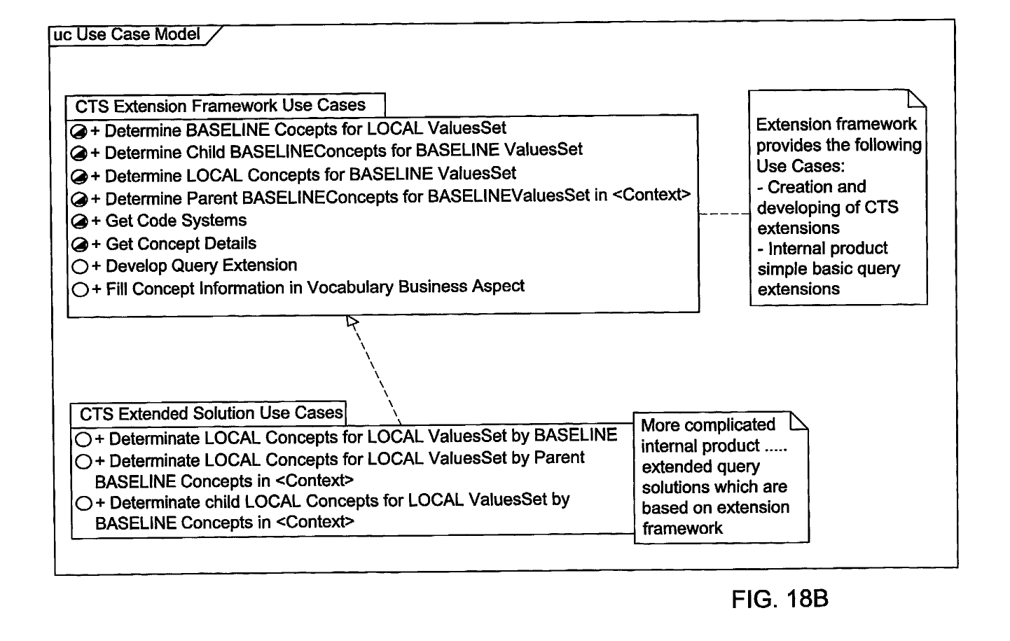

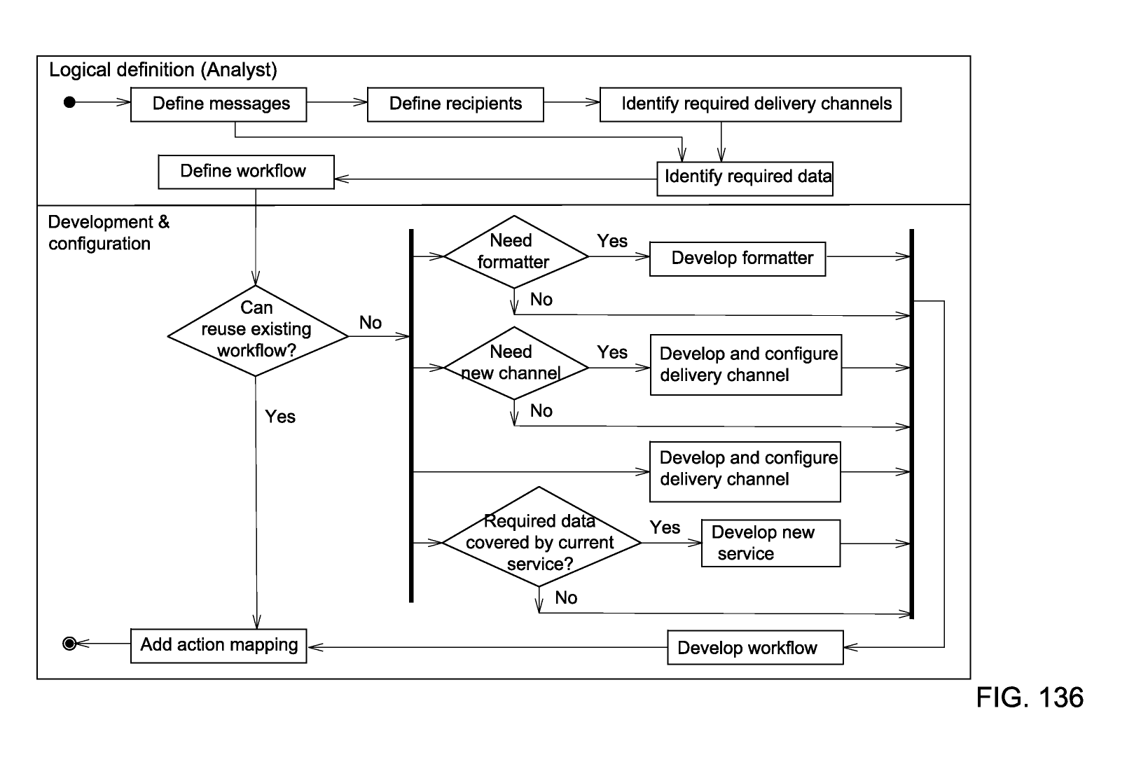

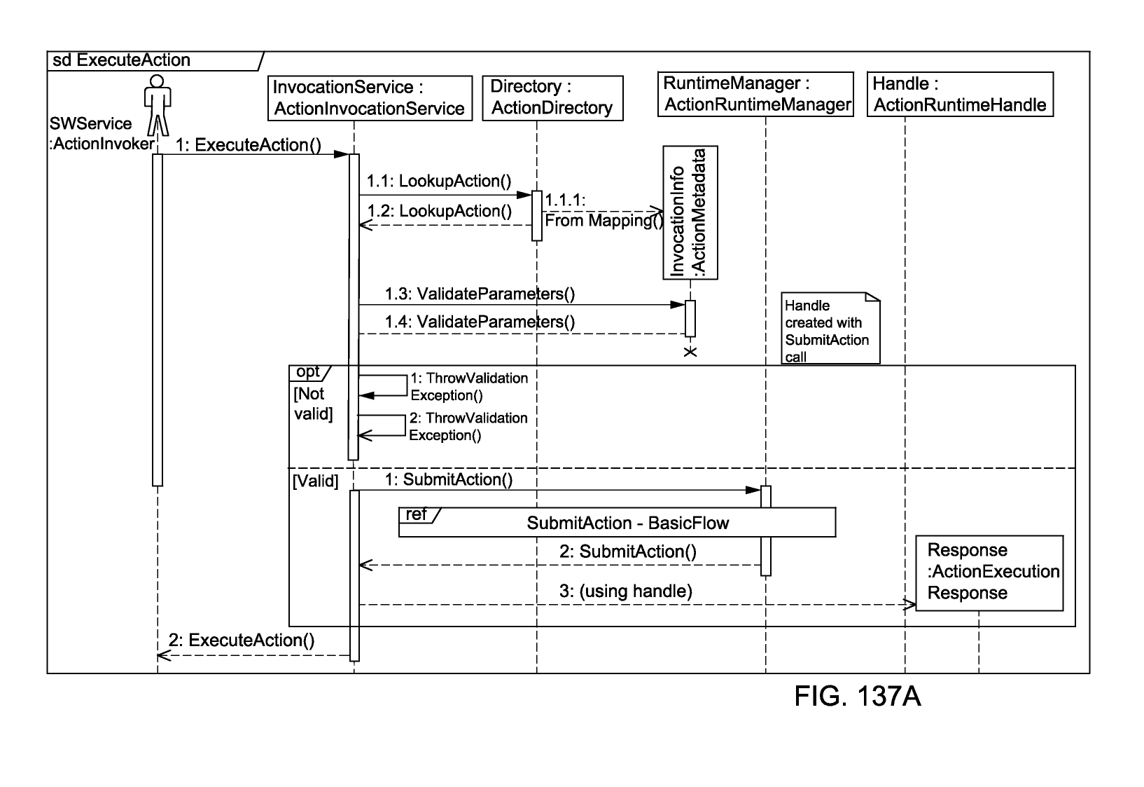

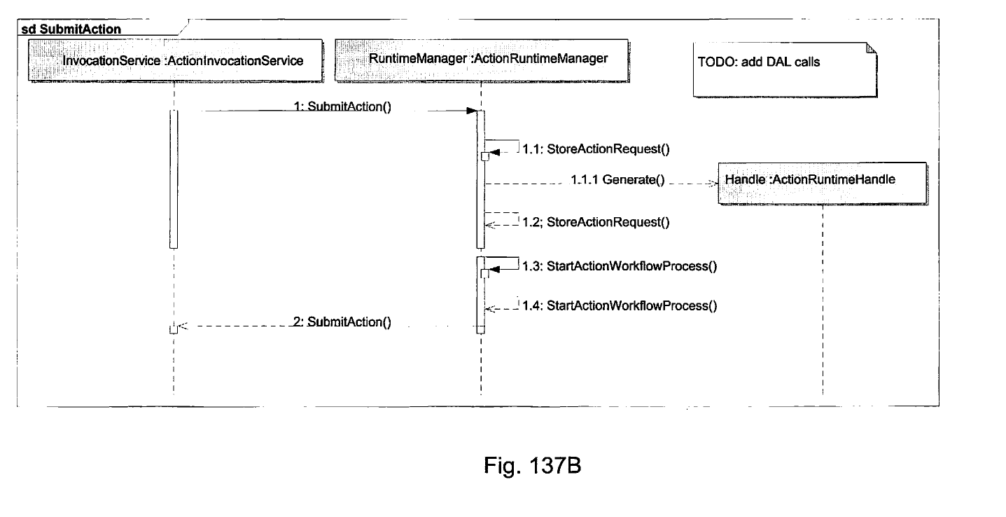

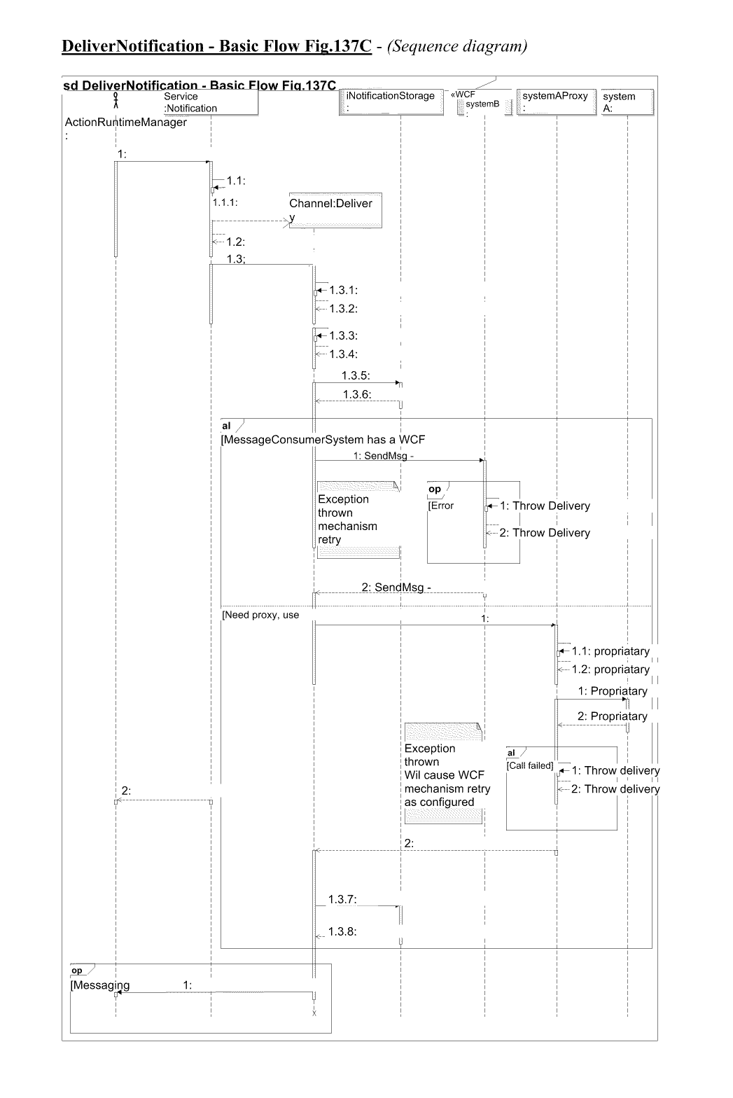

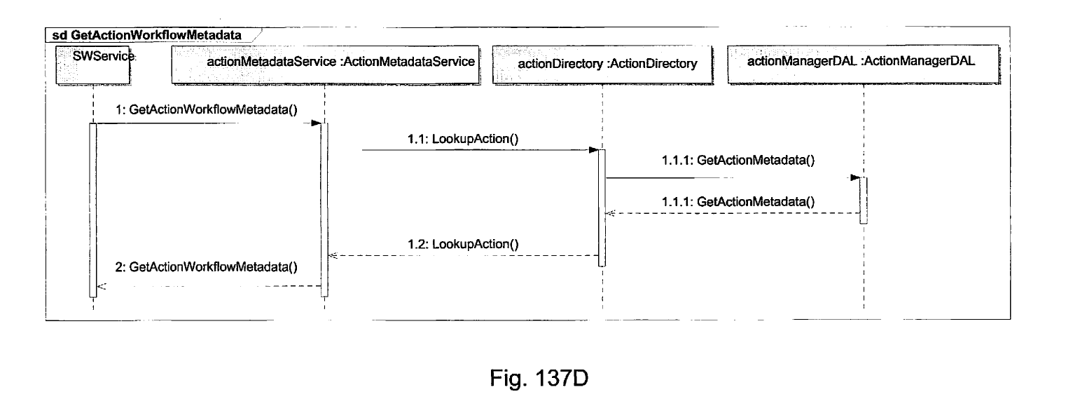

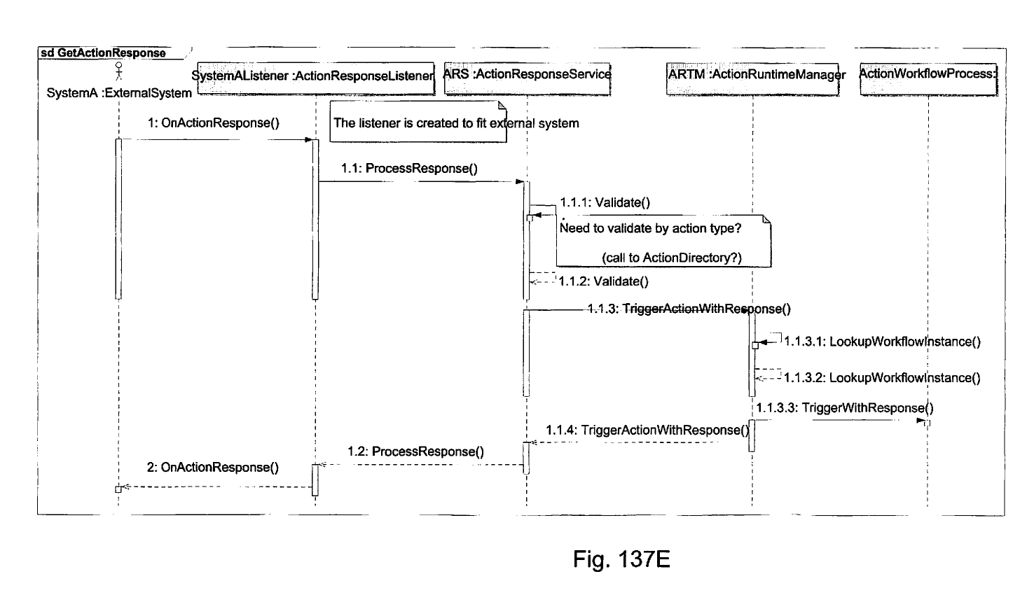

An example of health information exchange and integration system constructed and operative in accordance with certain embodiments of the present invention is now described with reference to FIGS. 18A-137 which may operate in conjunction with healthcare information integration software commercially available from dbMotion Inc., US Steel Tower, 600 Grant Street, Suite 22017, Pittsburgh, Pa. 15219, such as dbMotion's service oriented architecture (SOA) based dbMotion™ Solution.

Unified Modeling Language (UML) is a standardized general-purpose modeling language in the field of software engineering used in generating the above drawings. The standard is managed, and was created by, the Object Management Group. UML includes a set of graphic notation techniques to create visual models of systems with software components.

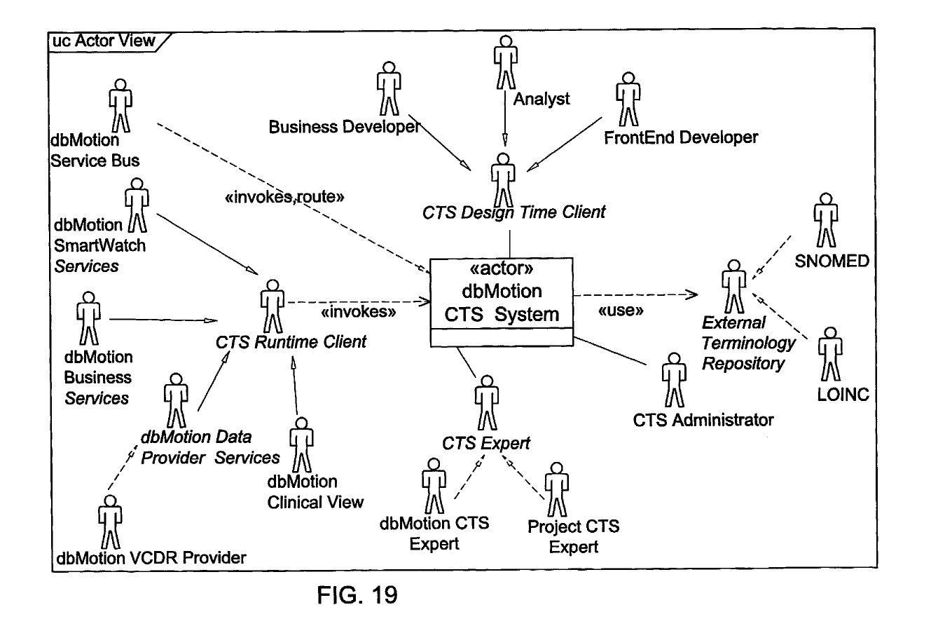

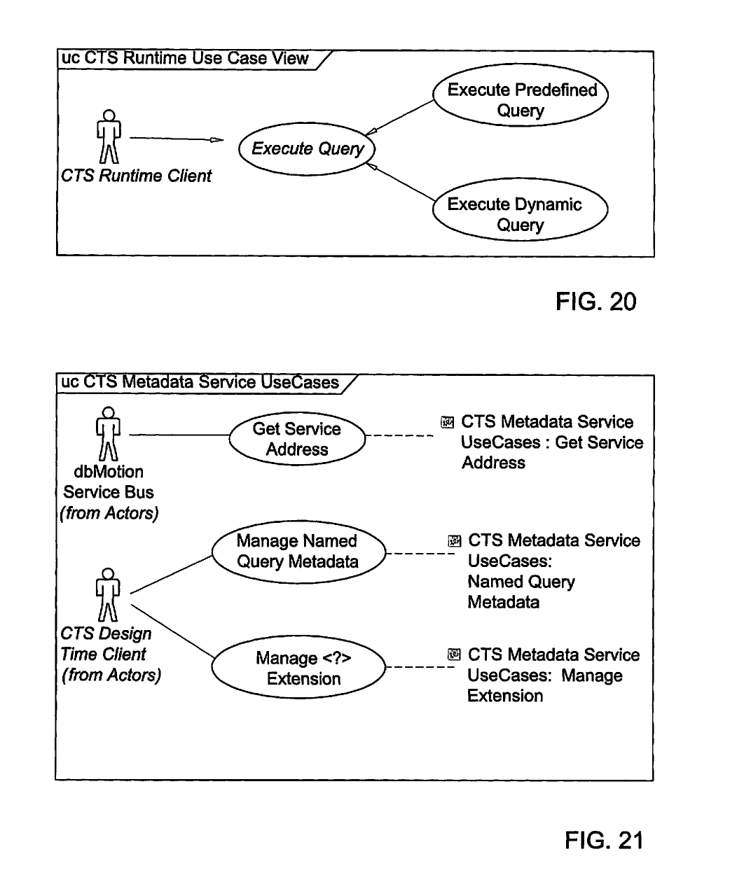

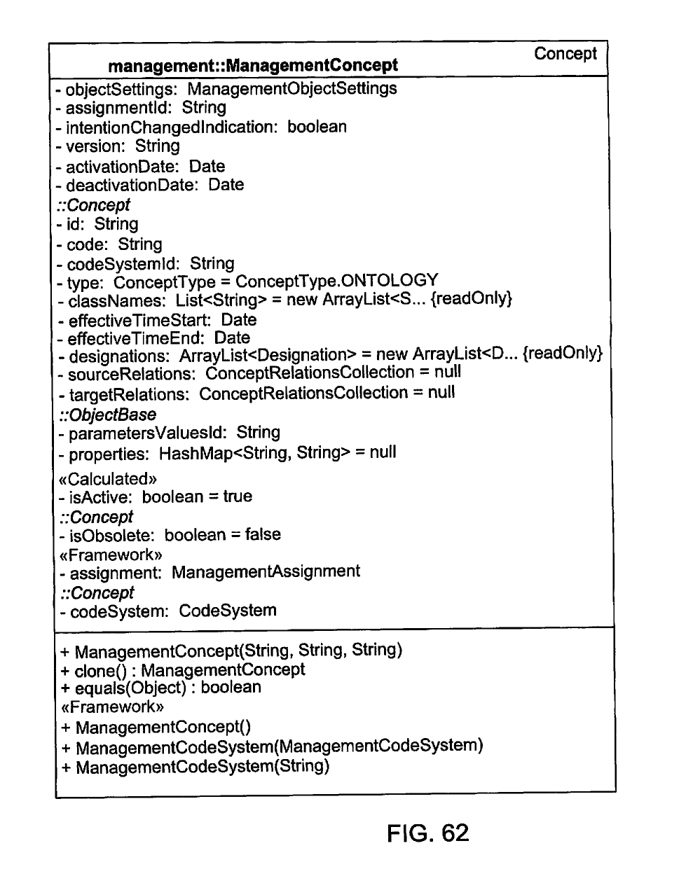

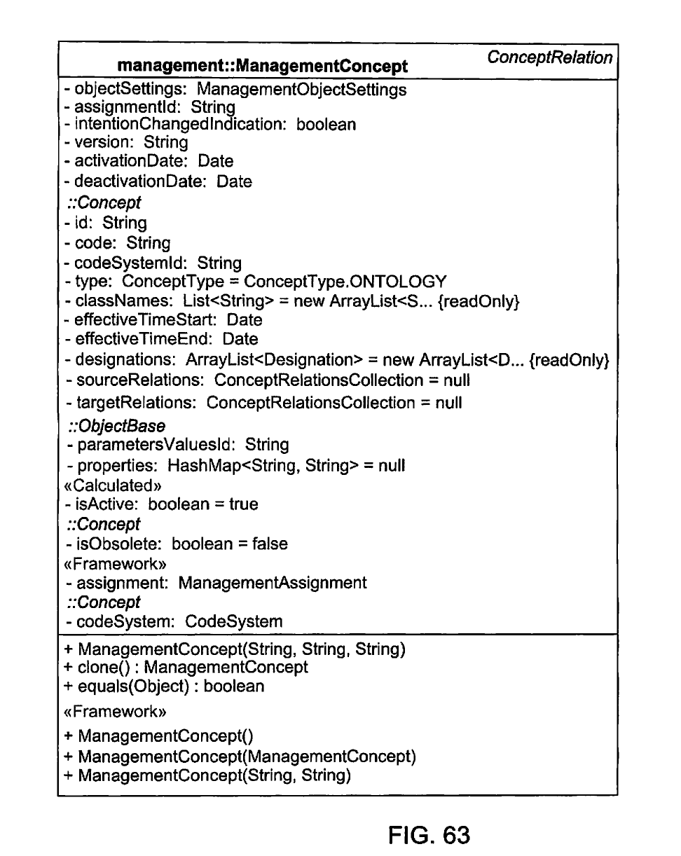

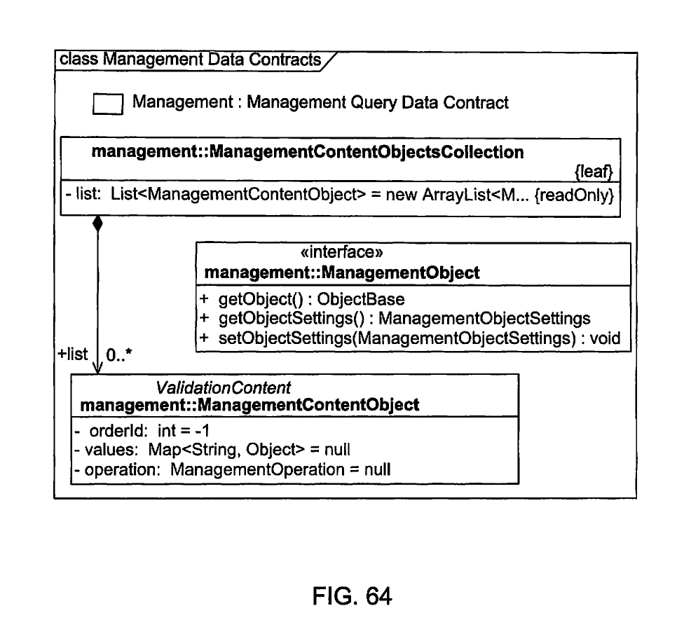

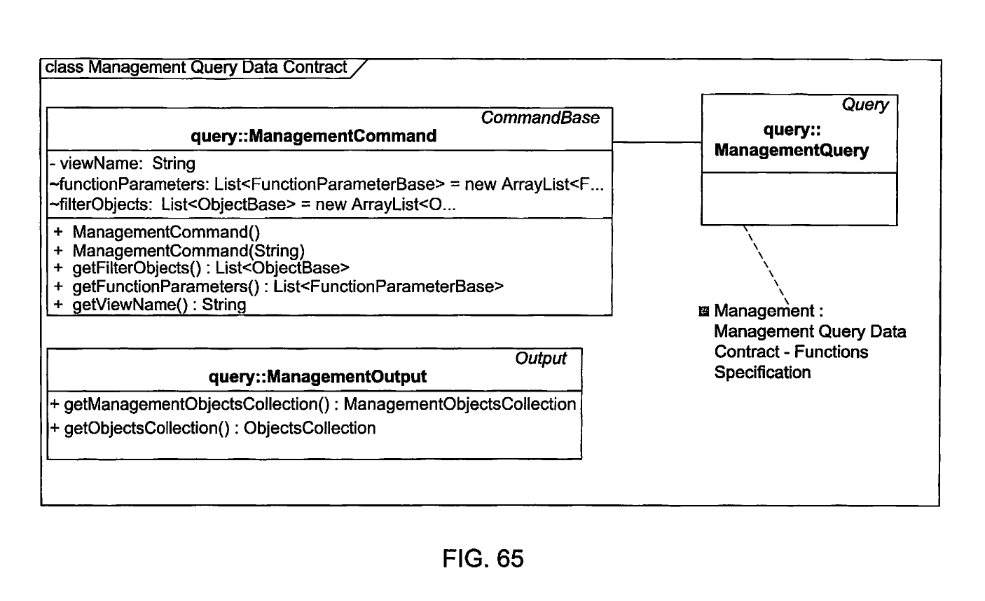

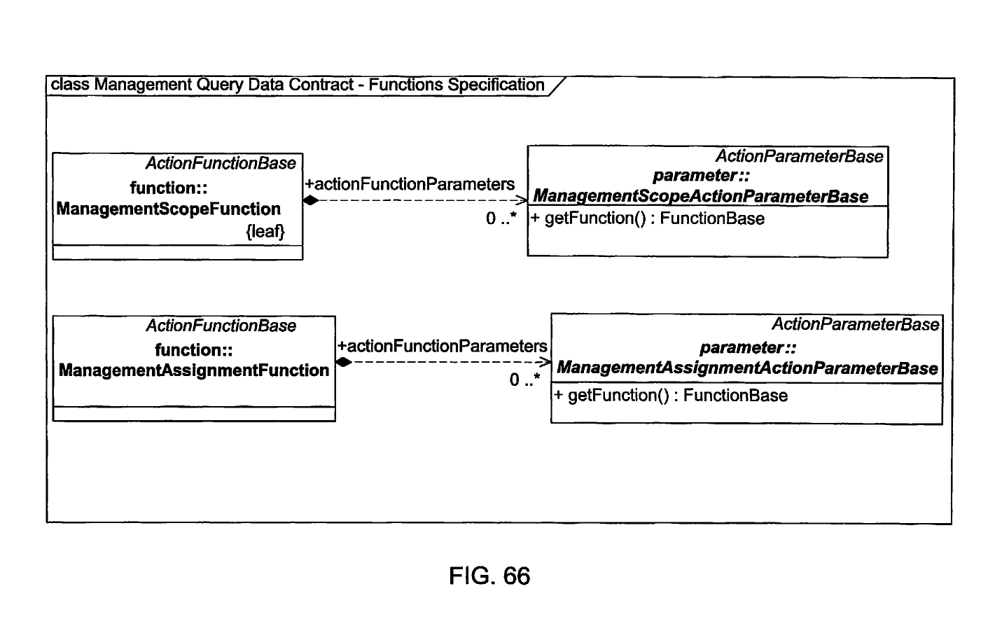

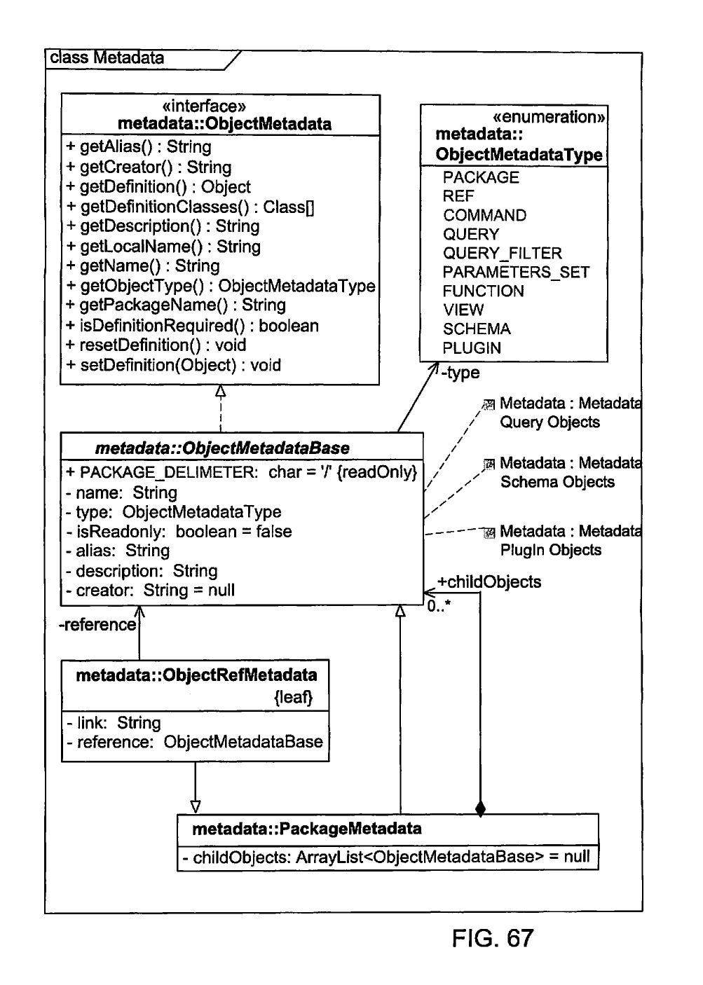

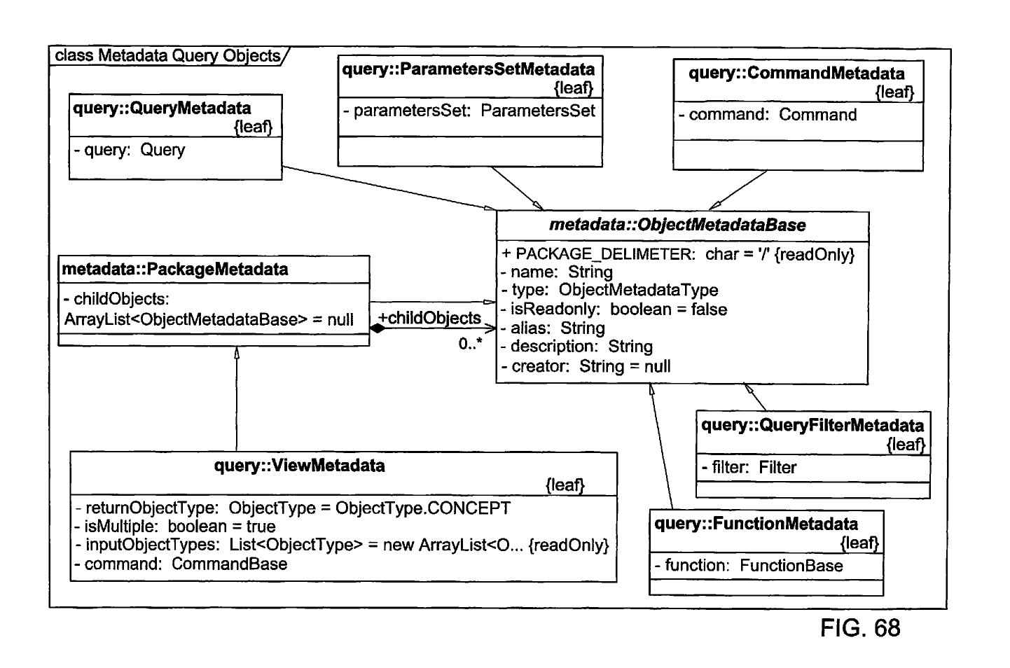

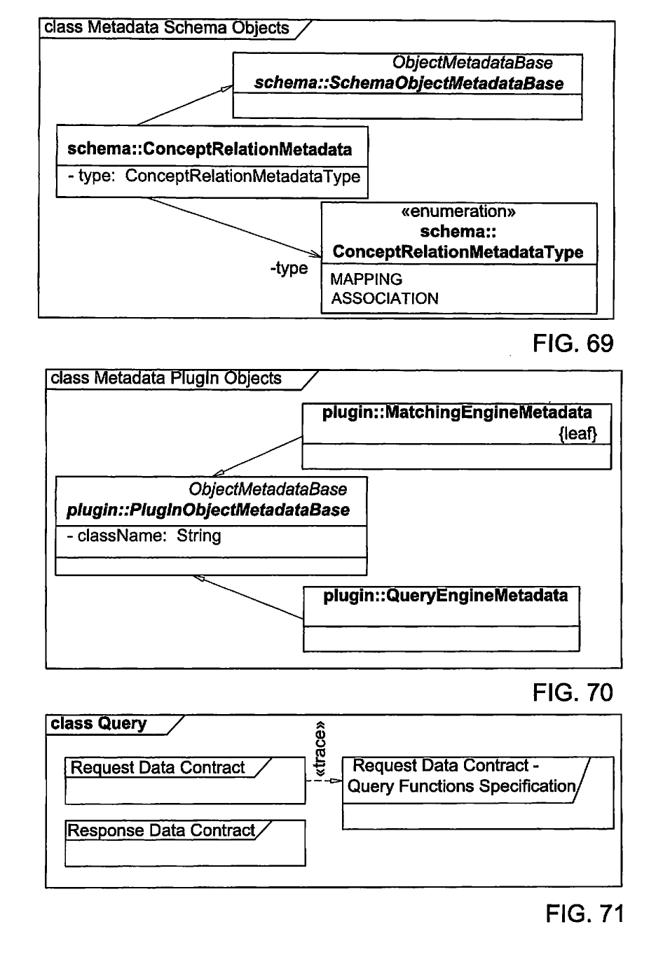

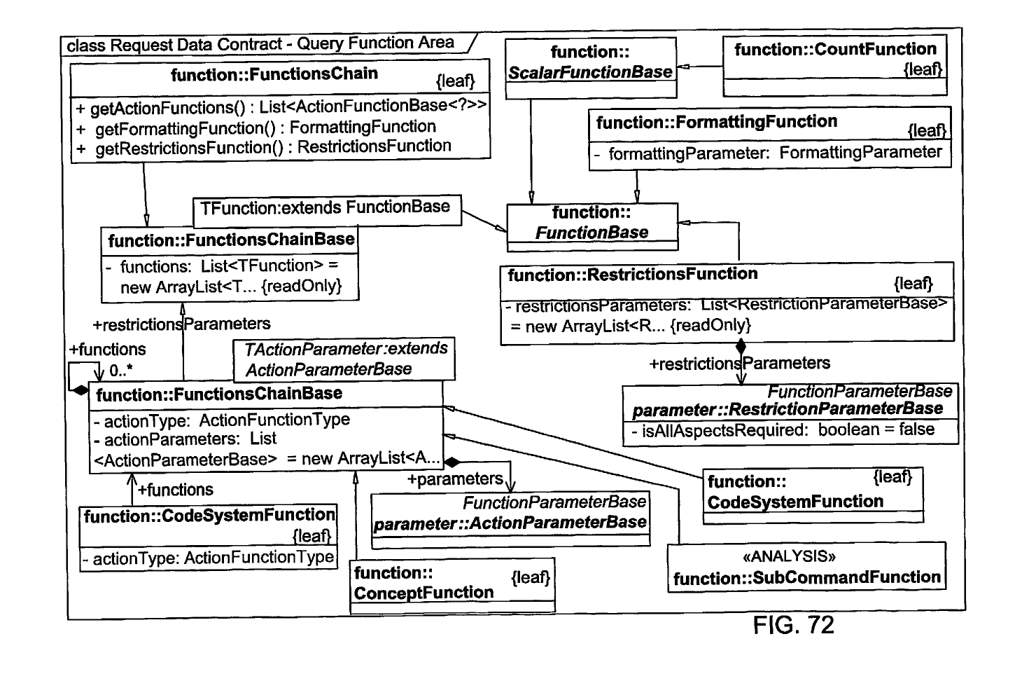

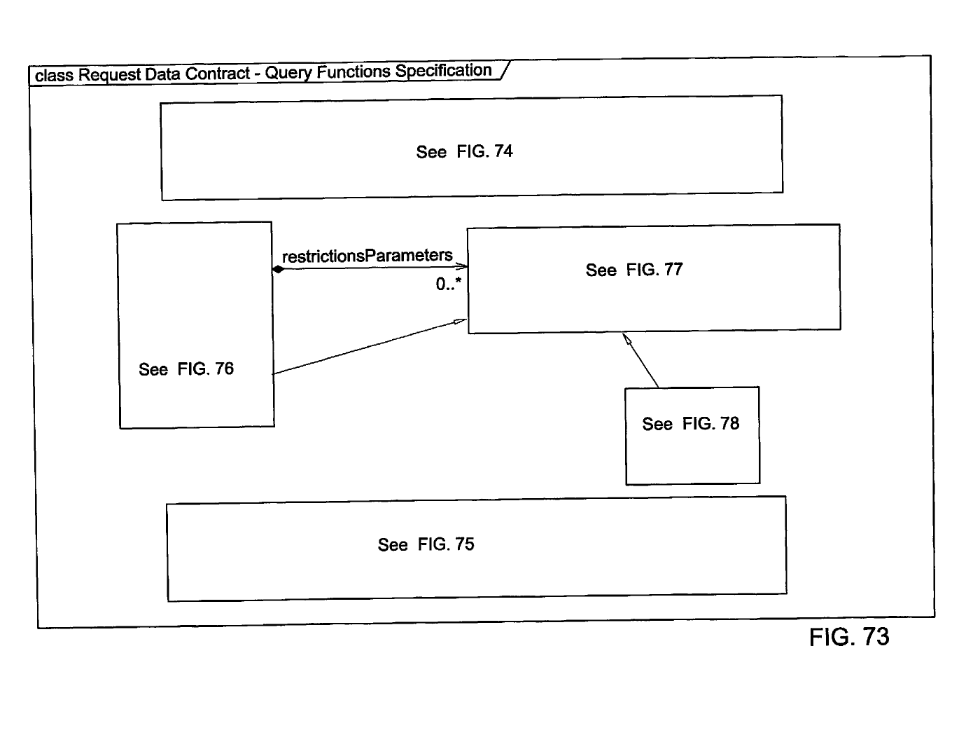

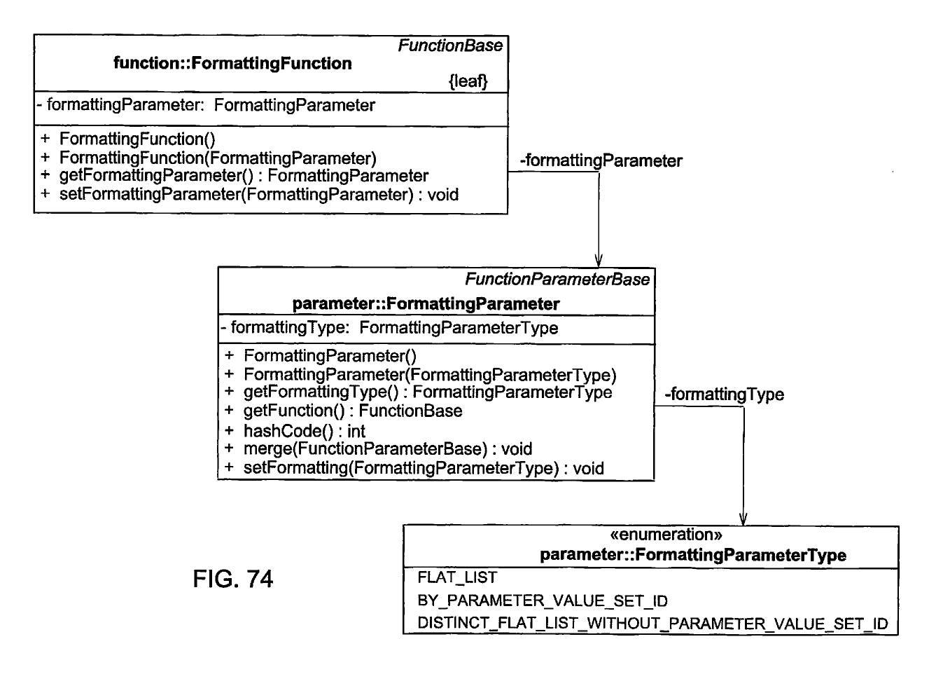

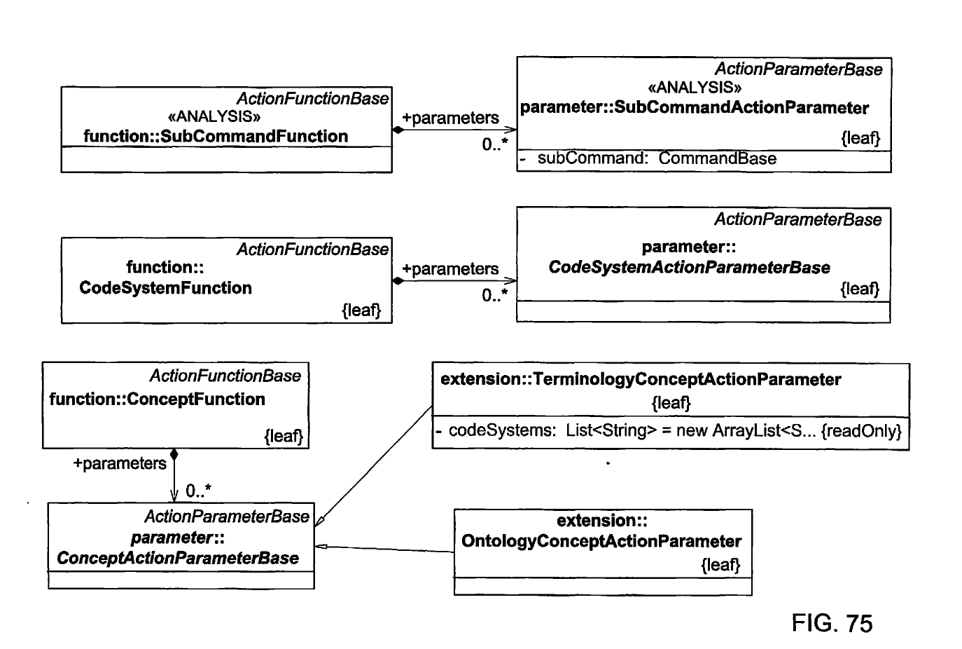

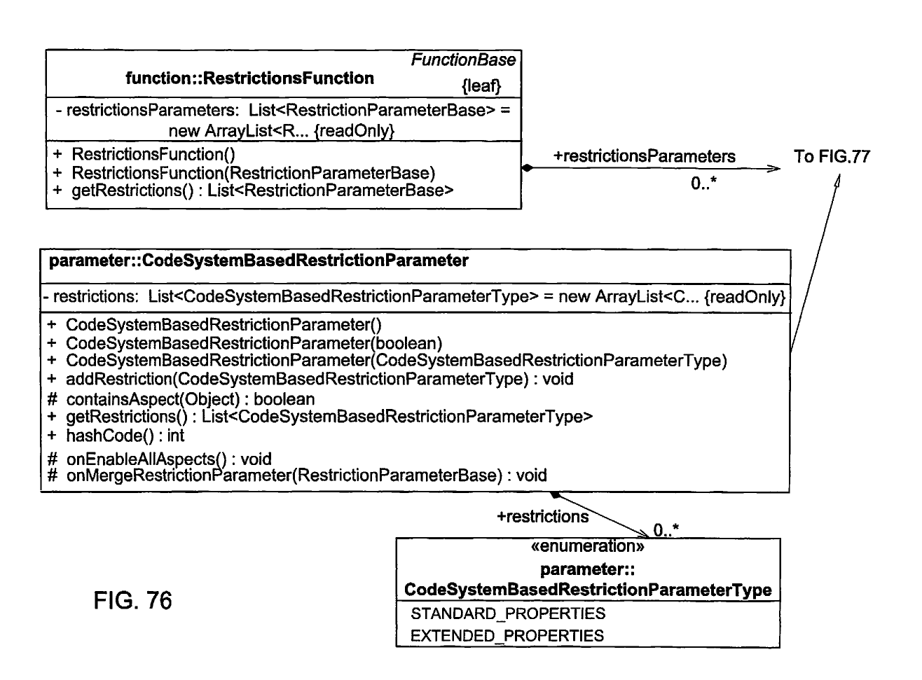

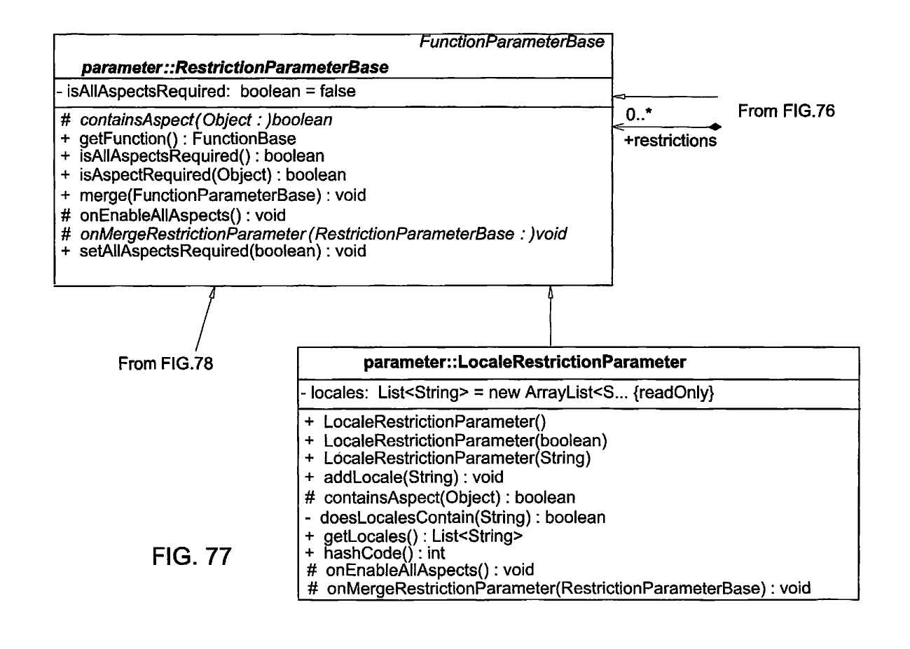

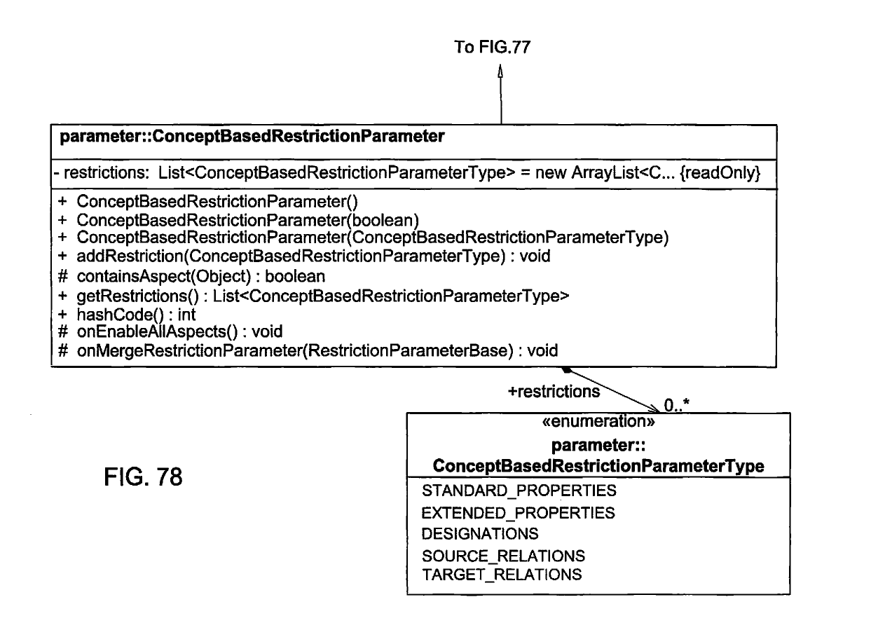

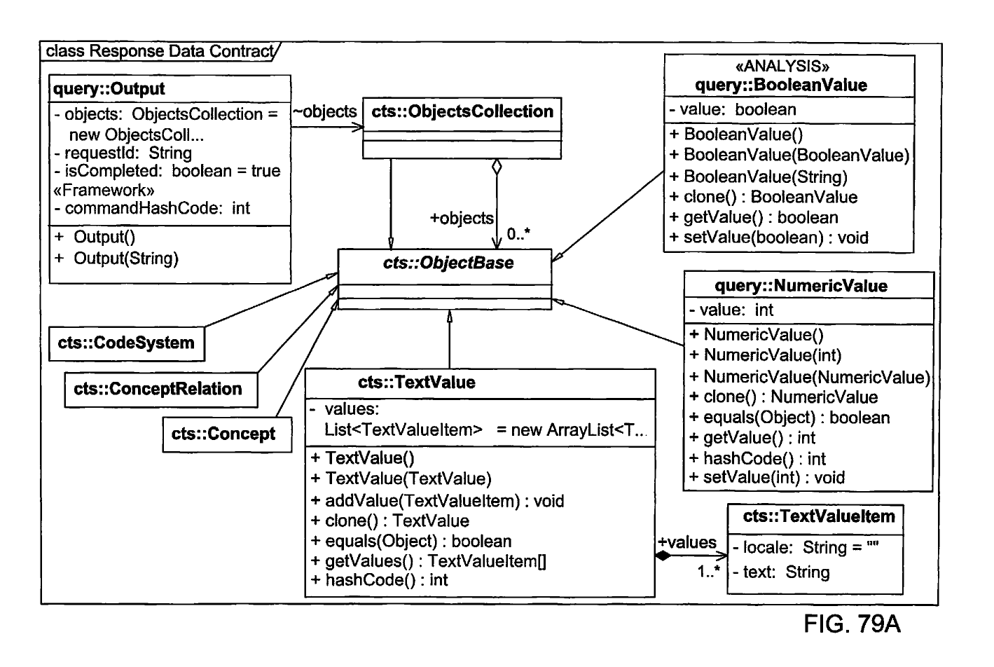

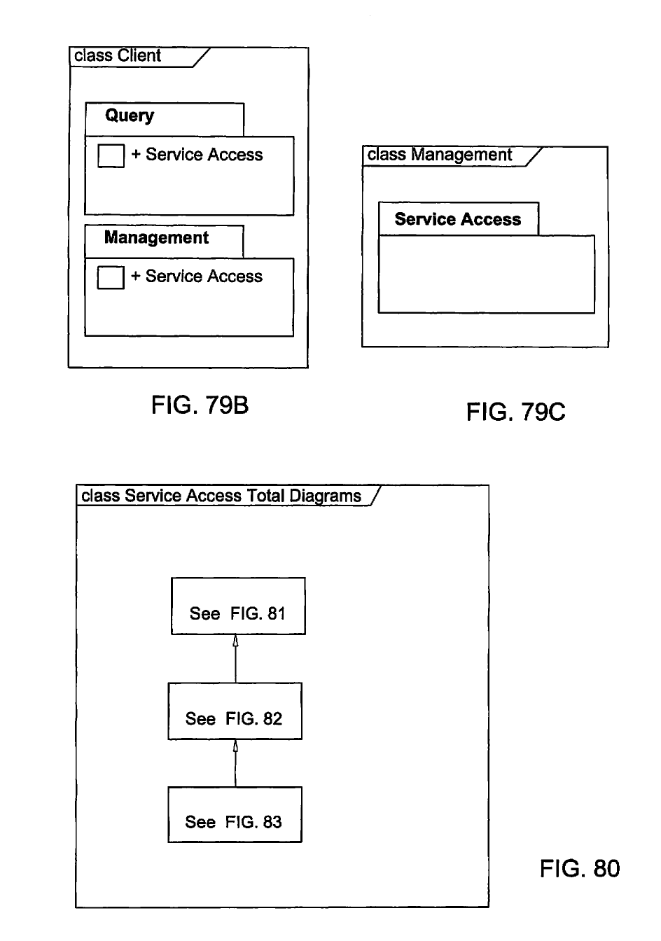

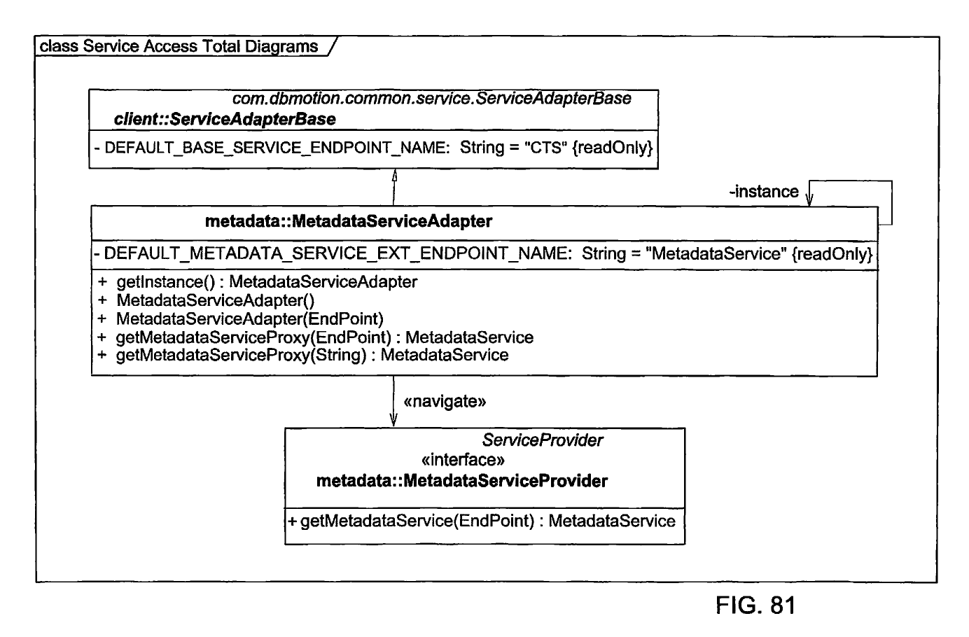

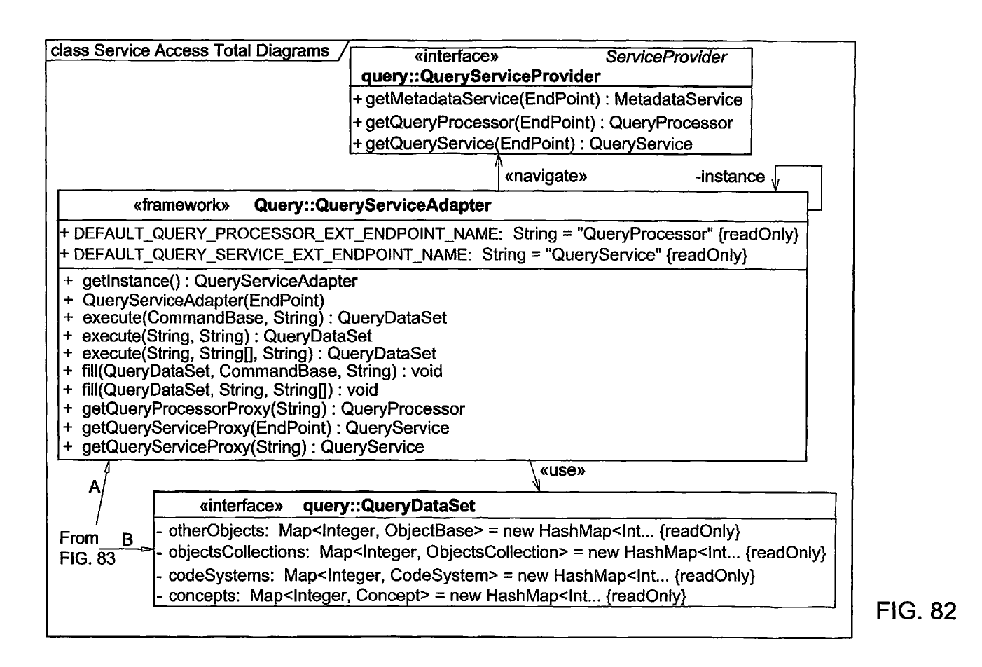

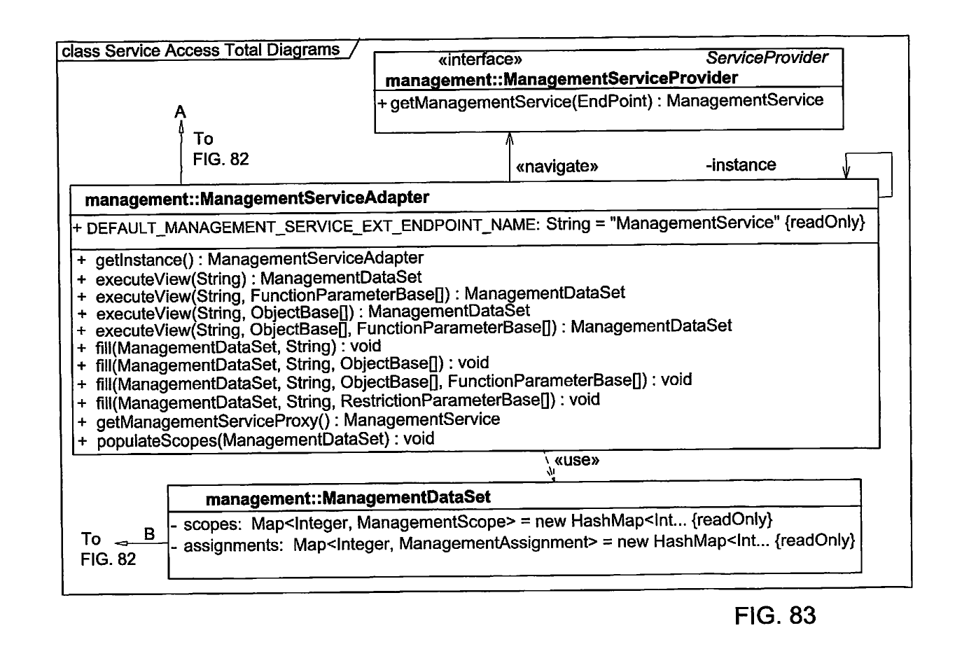

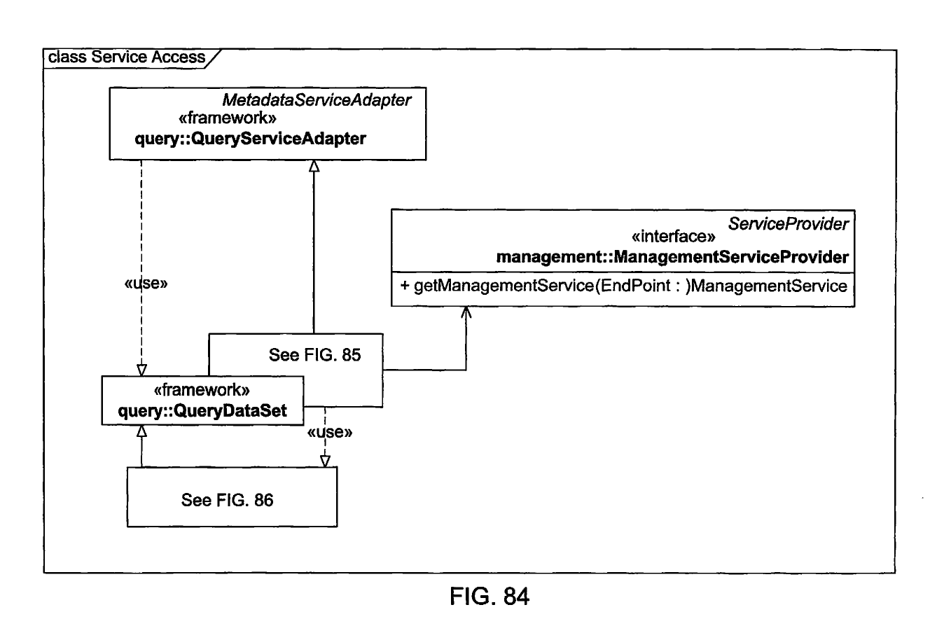

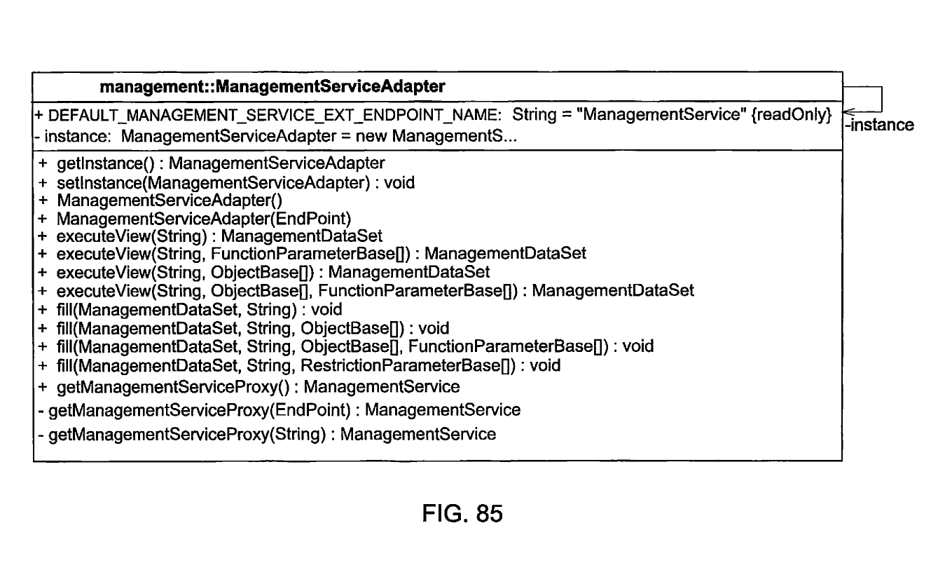

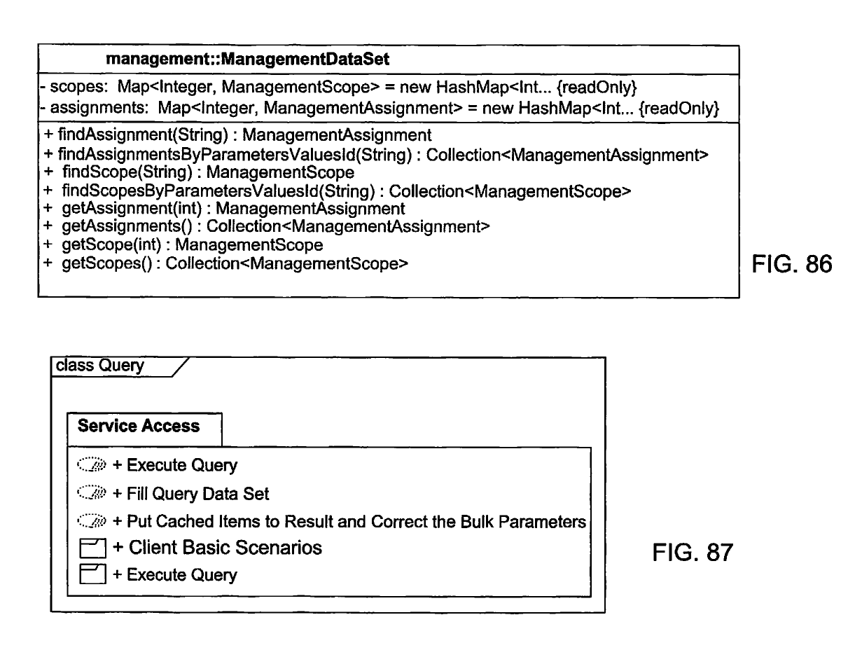

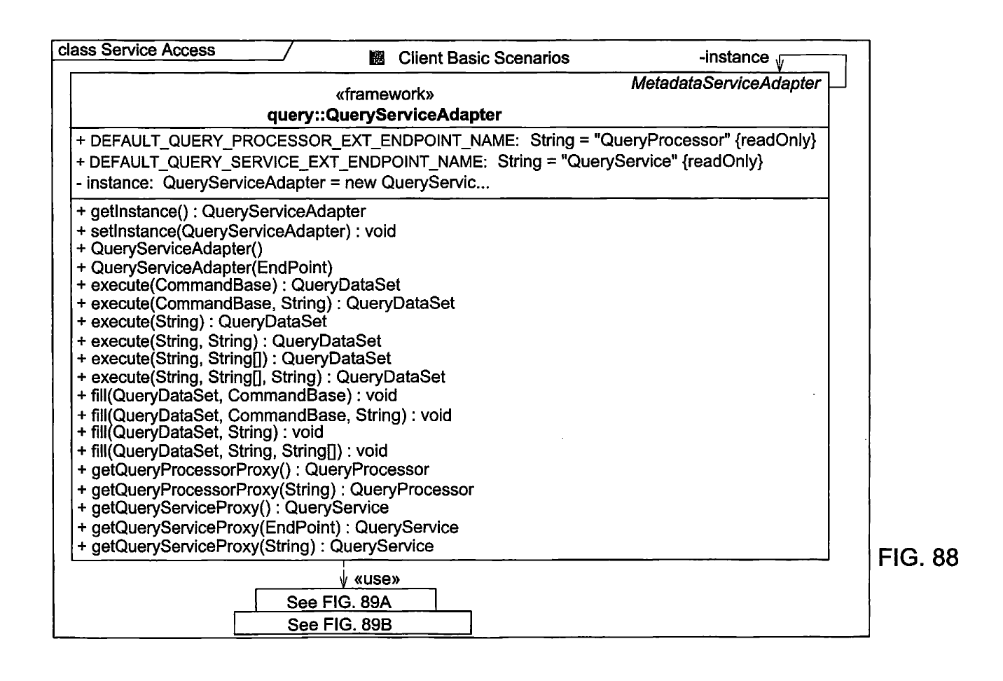

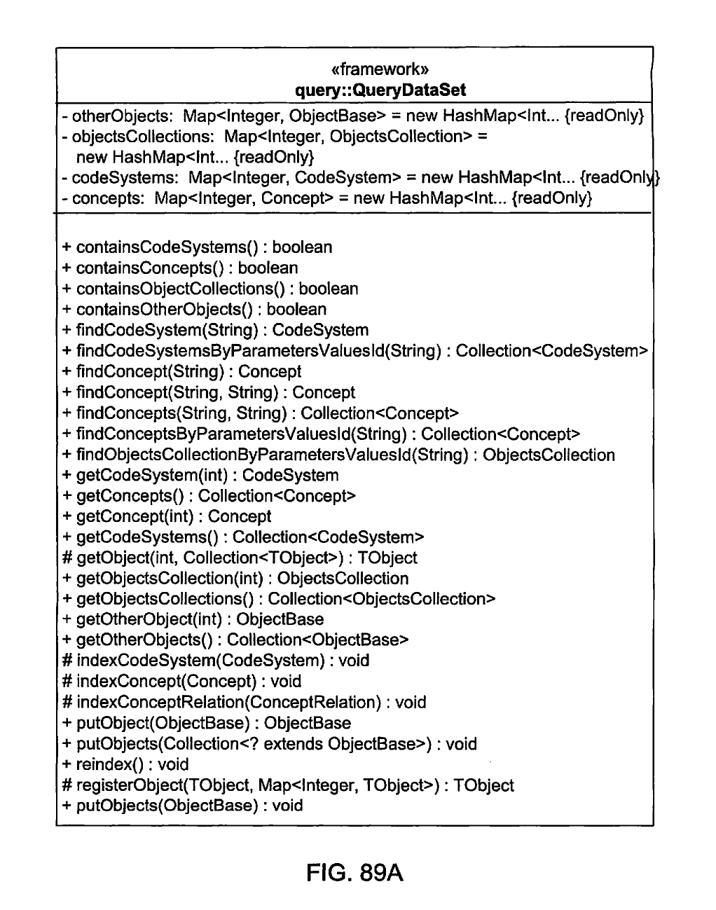

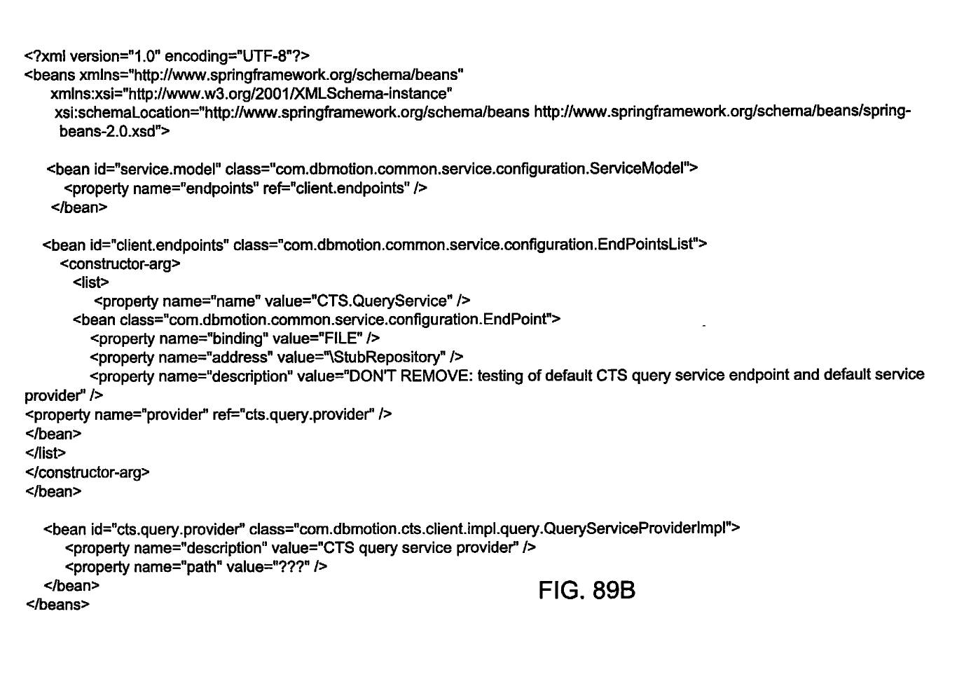

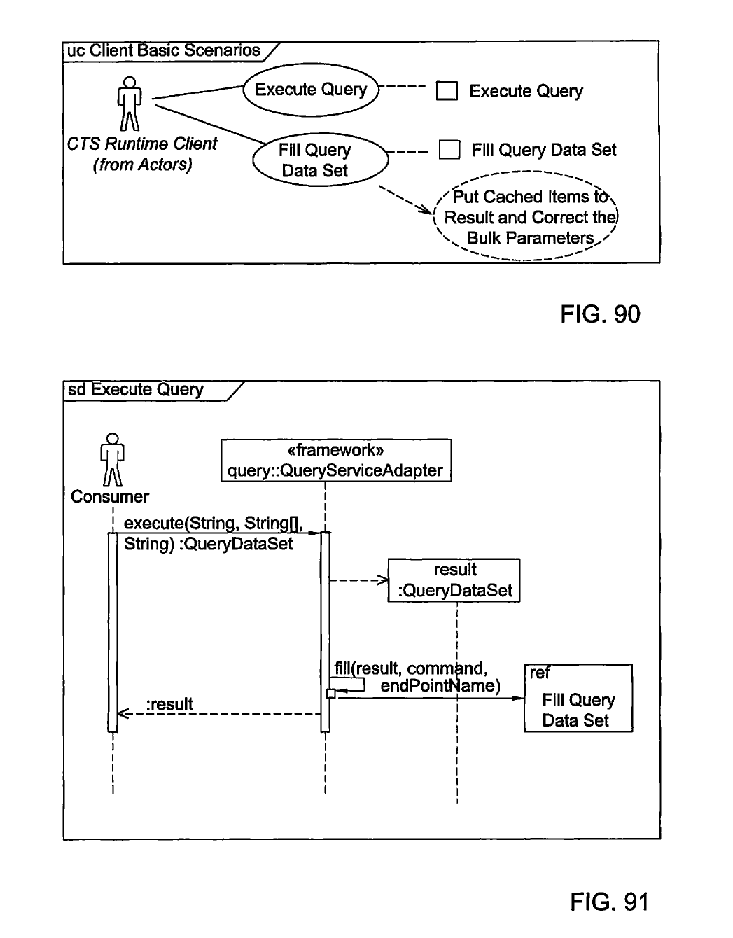

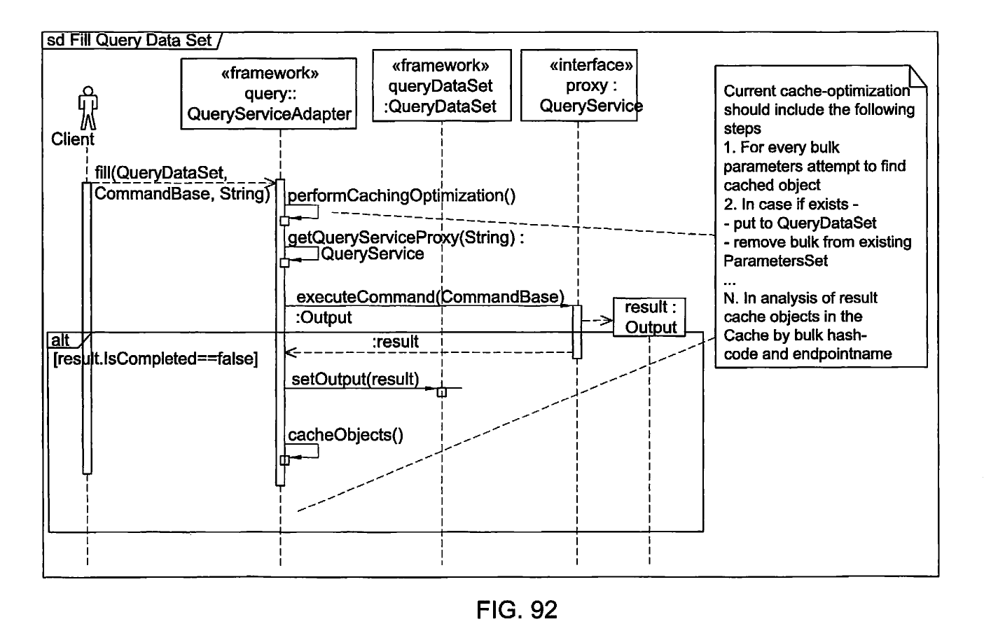

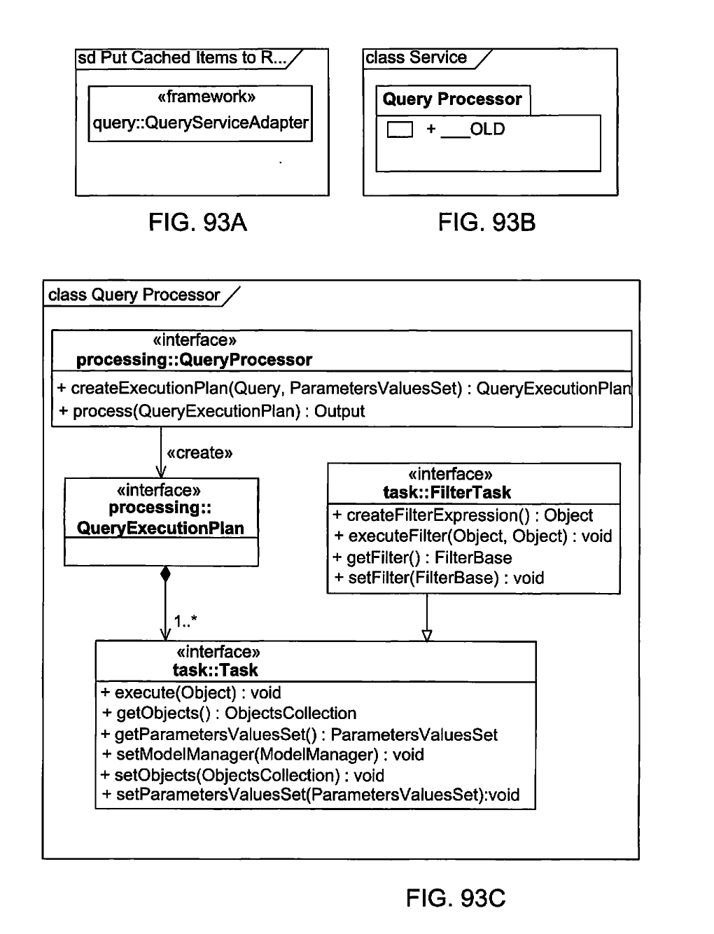

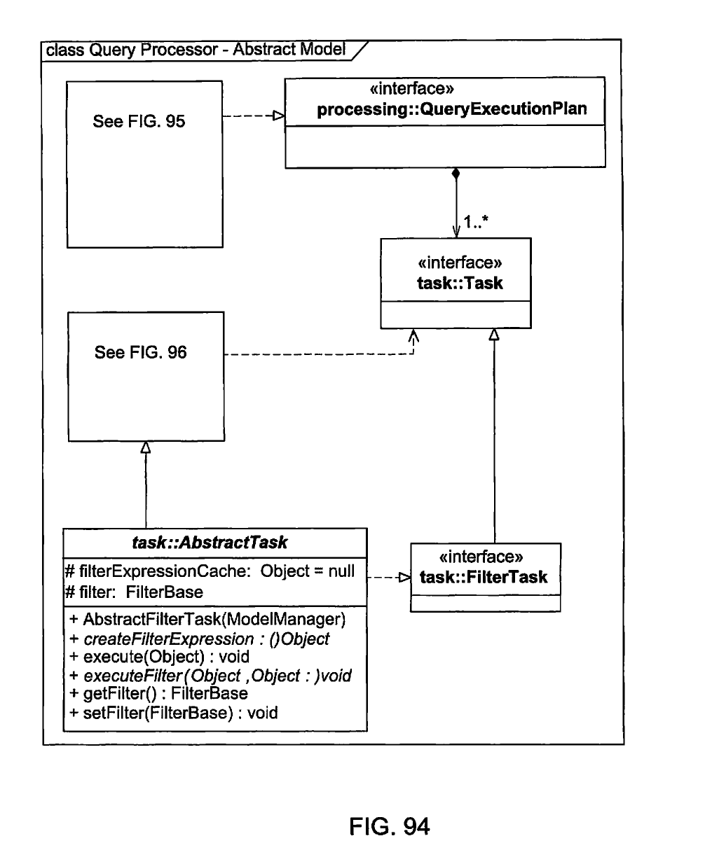

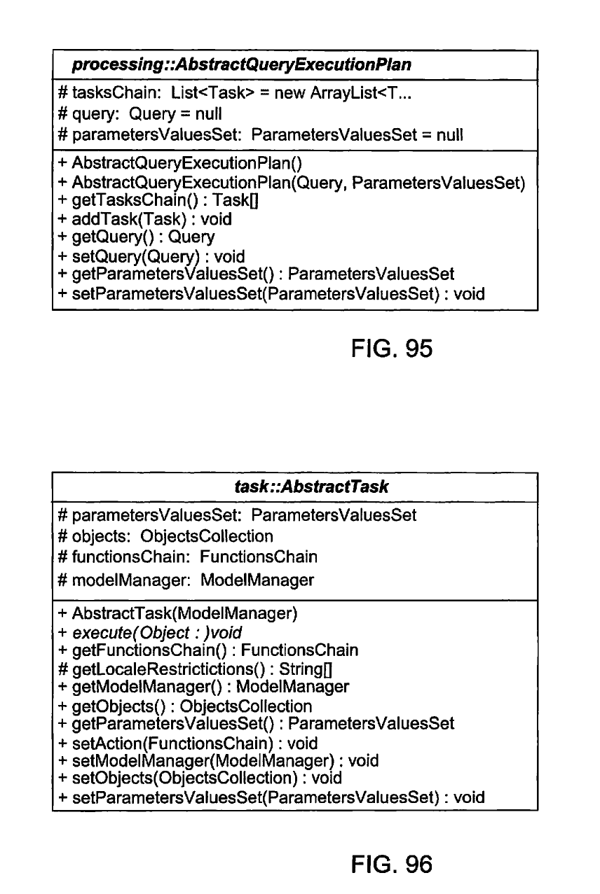

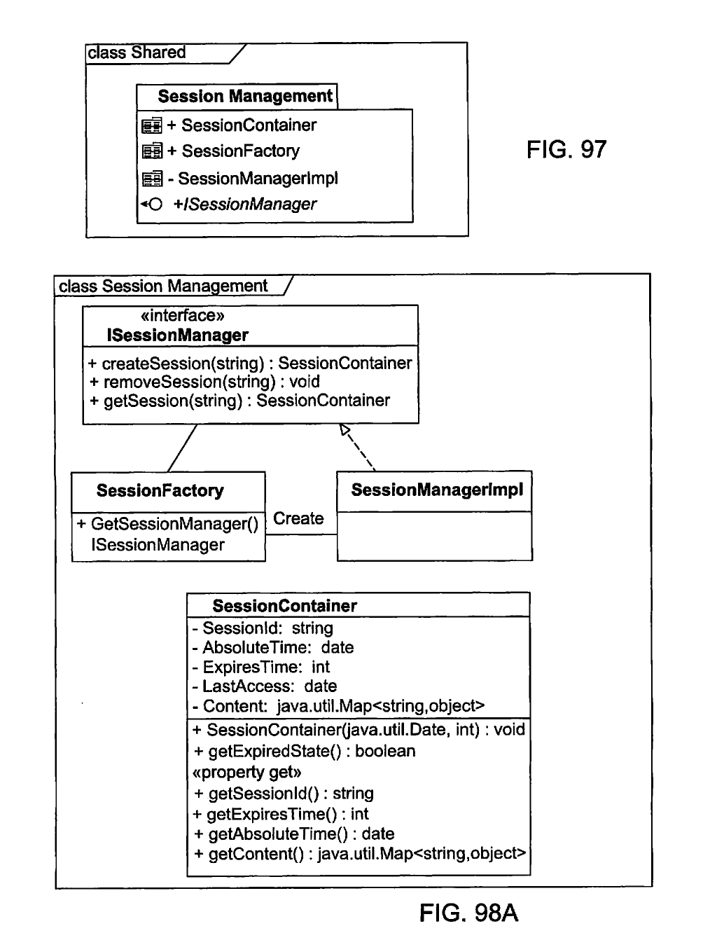

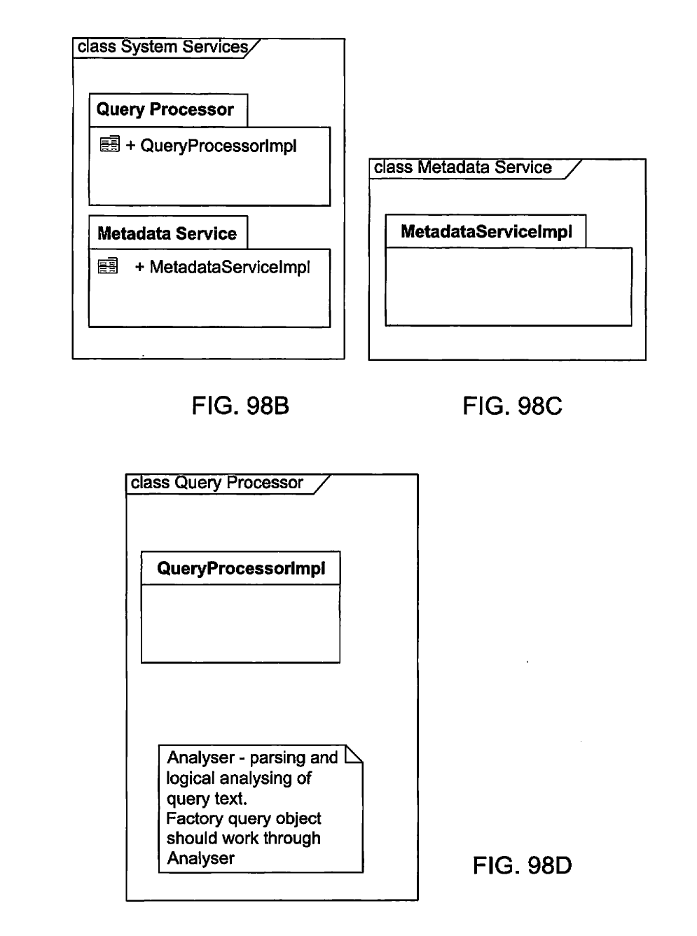

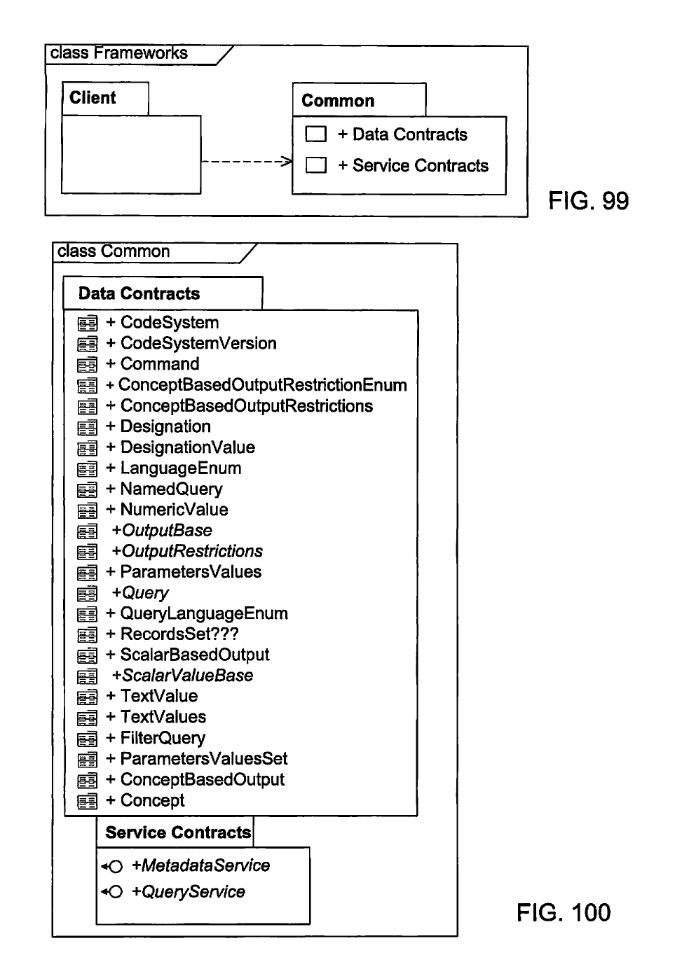

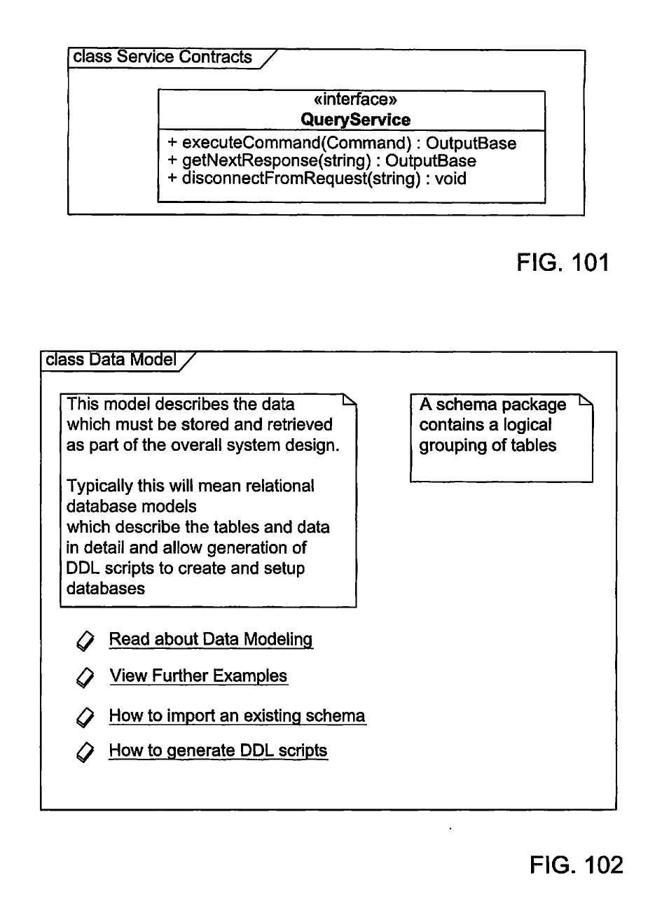

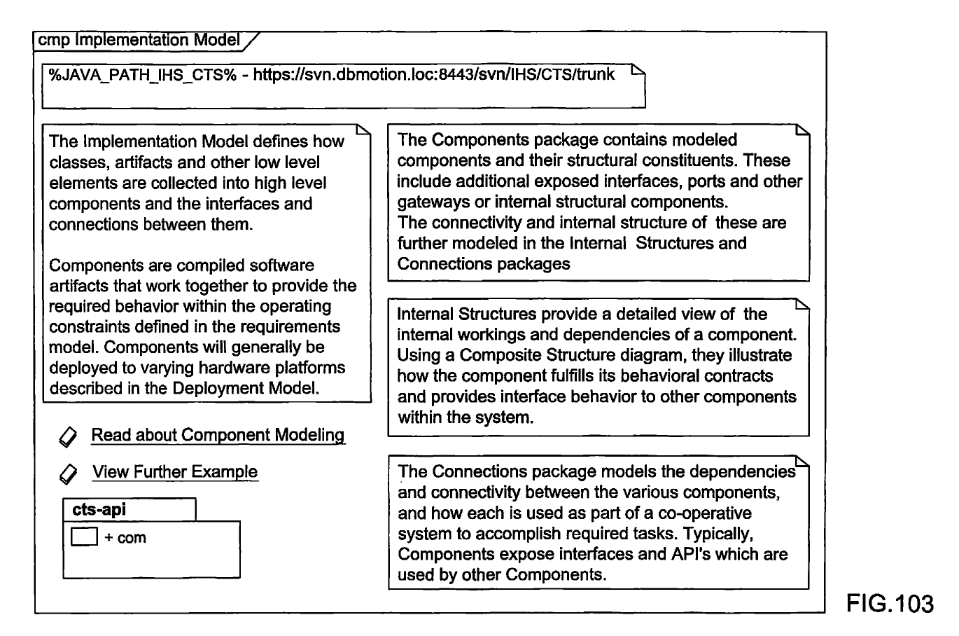

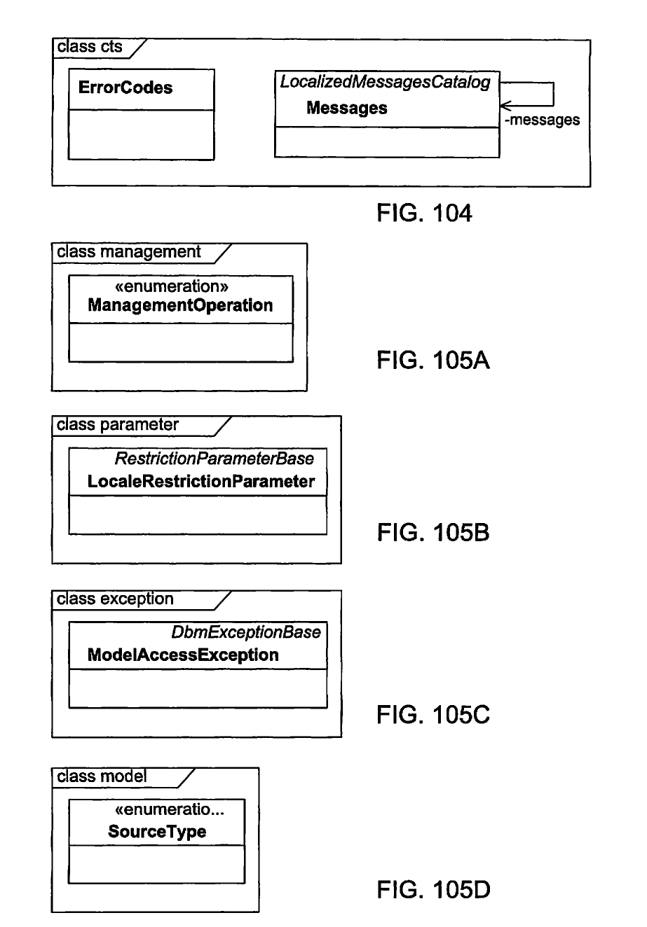

The CTS sub-unit of the example health information exchange and integration system is first described with reference to FIGS. 18A-105D. Specifically, FIGS. 18A-18B, taken together, illustrate a Use Case Model—(Use Case diagram). FIG. 19 illustrates an Actor View—(Use Case diagram). FIG. 20 illustrates a CTS Runtime Use Case View—(Use Case diagram). FIG. 21 illustrates CTS Metadata Service UseCases—(Use Case diagram). FIG. 22 illustrates a Get Service Address functionality (Use Case diagram). FIG. 23 illustrates a Manage Extension functionality—(Use Case diagram). FIG. 24 illustrates a Manage Named Query Metadata functionality—(Use Case diagram). FIG. 25 illustrates CTS Extension Use Cases—(Use Case diagram). FIG. 26 illustrates a Fill Concept Information in Vocabulary Business Aspect—(Activity diagram). FIG. 27 illustrates CTS Extended Solution Use Cases—(Use Case diagram). FIG. 28 illustrates CTS First Analysis Use Cases—(Package diagram). FIG. 29 illustrates a CTS Management Use Case View—(Use Case diagram).

FIG. 30 illustrates an Add Local Code functionality—(Activity diagram). FIG. 31 illustrates a CTS Metadata Use Case View—(Use Case diagram). FIG. 32 illustrates a Design Model—(Logical diagram). FIG. 33 illustrates a Logical Model—(Logical diagram). FIG. 34 illustrates a System—(Logical diagram). FIG. 35 illustrates Services—(Package diagram). FIG. 36 illustrates a Query Service—(Logical diagram). FIG. 37 illustrates Service Contracts—(Logical diagram). FIG. 38 illustrates an Execute Command functionality—(Sequence diagram). FIG. 39 illustrates a Get Next Response functionality—(Sequence diagram). FIG. 40 illustrates a Query Processor—(Logical diagram). FIG. 41 illustrates a Service Contract—(Logical diagram). FIG. 42 illustrates Metadata Services—(Logical diagram). FIG. 43 illustrates an Information Service—(Logical diagram). FIG. 44 illustrates a Management functionality—(Package diagram). FIG. 45 illustrates an Analysis functionality—(Package diagram). FIG. 46 illustrates Business Entities—(Logical diagram). FIG. 47 illustrates a Client—(Logical diagram). FIG. 48A illustrates a Service—(Logical diagram). FIG. 48B illustrates Tools—(Logical diagram). FIG. 49 illustrates a Framework—(Logical diagram).

FIGS. 50A and 50B illustrate a Tool API—(Logical diagram). FIG. 51 illustrates a Shared—(Logical diagram). FIGS. 52-57, taken together, illustrate an Information Model—(Logical diagram). FIGS. 58-63, taken together, illustrate a Management Information Model—(Logical diagram). FIG. 64 illustrates Management Data Contracts—(Logical diagram). FIG. 65 illustrates Management Query Data Contract—(Logical diagram). FIG. 66 illustrates a Management Query Data Contract—Functions Specification—(Logical diagram). FIG. 67 illustrates Metadata—(Logical diagram). FIG. 68 illustrates Metadata Query Objects—(Logical diagram). FIG. 69 illustrates Metadata Schema Objects—(Logical diagram).

FIG. 70 illustrates Metadata PlugIn Objects—(Logical diagram). FIG. 71 illustrates a Query—(Logical diagram). FIG. 72 illustrates a Request Data Contract—Query Function Area—(Logical diagram). FIGS. 73-78, taken together, illustrate a Request Data Contract—Query Functions Specification—(Logical diagram). FIG. 79A illustrates a Response Data Contract—(Logical diagram). FIG. 79B illustrates a Client—(Logical diagram). FIGS. 80-83, taken together, illustrate Service Access Total Diagrams—(Logical diagram). FIG. 79C illustrates a Management functionality—(Logical diagram). FIGS. 84-86, taken together, illustrate Service Access functionality—(Logical diagram). FIG. 87 illustrates a Query—(Logical diagram). FIGS. 88-89B, taken together, illustrate a Service Access—(Logical diagram).

FIG. 90 illustrates Client Basic Scenarios—(Use Case diagram). FIG. 91 illustrates Execute Query functionality—(Sequence diagram). FIG. 92 illustrates a Fill Query Data Set—(Sequence diagram). FIG. 93A illustrates a Put Cached Items to Result and Correct the Bulk Parameters—(Sequence diagram). FIG. 93B illustrates a Service—(Logical diagram). FIG. 93C a Query Processor—(Logical diagram). FIGS. 94-96, taken together, illustrate a Query Processor—Abstract Model—(Logical diagram). FIG. 97 illustrates a Shared functionality—(Logical diagram). FIG. 98A illustrates a Session Management functionality—(Logical diagram). FIG. 98B illustrates System Services—(Logical diagram). FIG. 98C illustrates a Metadata Service—(Logical diagram). FIG. 98D illustrates a Query Processor—(Logical diagram). FIG. 99 illustrates Frameworks—(Logical diagram).

FIG. 100 illustrates a Common functionality—(Logical diagram). FIG. 101 illustrates Service Contracts—(Logical diagram). FIG. 102 illustrates a Data Model—(Logical diagram). FIG. 103 illustrates an Implementation Model—(Component diagram). FIG. 104 illustrates a CTS (Logical diagram). FIG. 105A illustrates a management functionality—(Logical diagram). FIG. 105B illustrates a parameter—(Logical diagram). FIG. 105C illustrates an exception—(Logical diagram). FIG. 105D illustrates a model—(Logical diagram).

In FIG. 18A, the CTS query use case Responsibility may include that it provides information about concepts in dbMotion ontology including Concept details and/or Search mechanism. Tthe CTS metadata service use case Responsibility may include that it provides metadata information about CTS service for consumer-services for integration in the design and runtime. An Extension framework may provide the following Use Cases: Creation and developing of CTS extensions; and/or Internal product simple basic query extensions.

In FIG. 27, the first determining step may include some or all of the following operations:
1. For local ValueSet determinate baseline concepts
2. For baseline concepts determinate parent baseline concepts in the specific context
3. For parent baseline concepts determinate all local concepts.

The second determining step may include some or all of the following operations:
1. For local ValueSet determinate baseline concepts
2. For baseline concepts determinate child baseline concepts in the specific ontext
3. For previous resulting baseline concepts determinate local concepts.

In FIG. 32, the Design Model may include at least the Logical Model and the Data Model. The Logical model included the System and Framework sections. Both may include classes and artifacts which define the structure of the code used in the application under development.

In FIG. 33, the Logical Model is a model of the software system under construction. It may include Classes which generally have a direct relationship to source code or other software artifacts that can be grouped together into executable components. The System package contains the classes and artifacts which are being built or designed as part of the current model. The Frameworks package generally contains classes and components that have been designed and built earlier and are being reused as part of the current project.

In FIG. 92, current cache—optimization may include the following steps:
1. For every bulk parameters attempt to find cached object
2. In case it exists—put to QueryDataSet and remove bulk from existing ParametersS et.

In analysis of result, may cache objects in the Cache by bulk hash-code and endpointname. In FIG. 98D, an Analyser may be operative for parsing and logical analyzing of query text. Factory query object may work through Analyser.

In FIG. 102, typically a schema package contains a logical grouping of tablets. This model describes the data which must be stored and retrieved as part of the overall system design. Typically this will mean relational database models which describe the tables and data in detail and allow generation of DDL scripts to create and setup databases.

In FIG. 103, typically, the implementation Model defines how classes, artifacts and other low level elements are collected into high level components and the interfaces and connections between them. Components are compiled software artifacts that work together to provide the required behavior within the operating constraints defined in the requirements model. Components may be deployed to varying hardware platforms e.g. as described in the Deployment Model. The Components package contains modeled components and their structural constituents. These include additional exposed interfaces, ports and other gateways or internal structural components. The connectivity and internal structure of these are further modeled in the internal Structures and Connections packages

Internal structures provide a detailed view of possible internal workings and dependencies of a component. Using a Composite Structure diagram, they illustrate how the component fulfils its behavioral contracts and provides interface behavior to other components within the system. The Connections package models the dependencies and connectivity between the various components, and how each is used as part of a co-operative system to accomplish required tasks. Typically, Components expose interfaces and API's which are used by other Components.

The knowledge framework sub-unit of the example health information exchange and integration system is now described, referring back to FIGS. 9-13C. The illustrated embodiment is an example implementation of the KFW subunit of FIG. 1A which is not intended to be limiting.

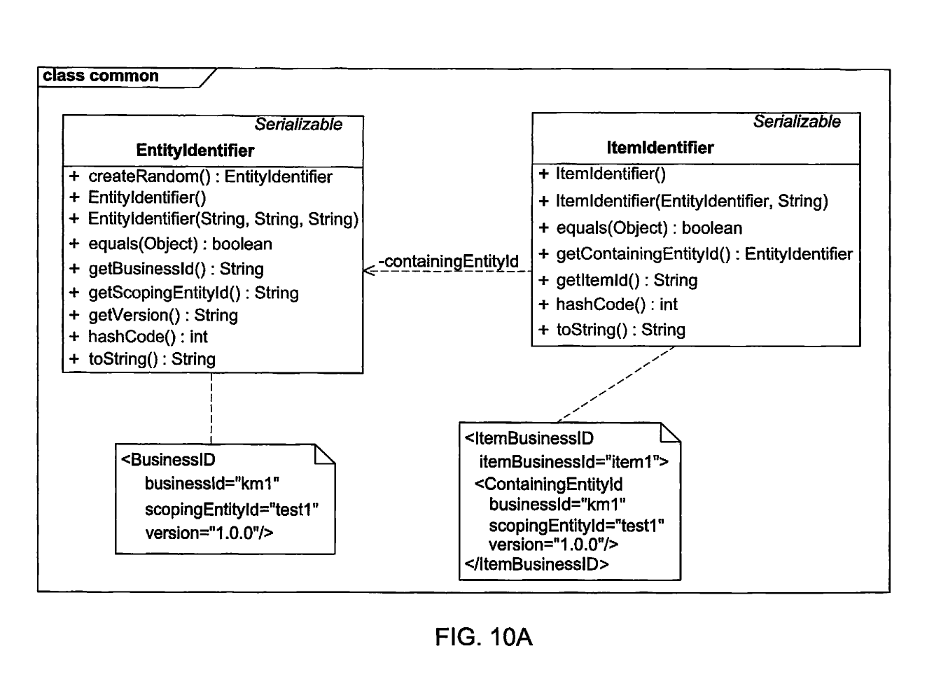

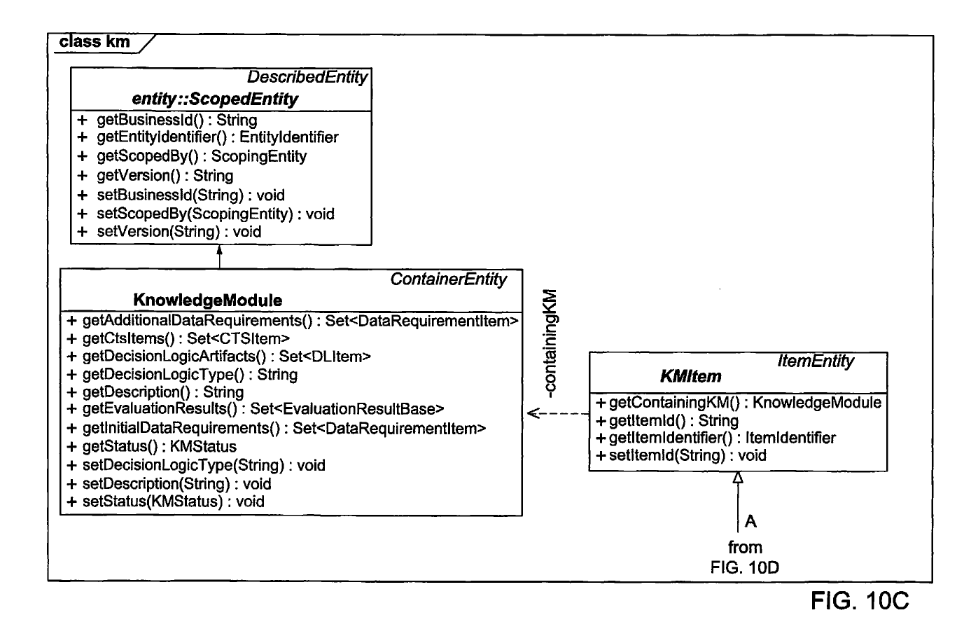

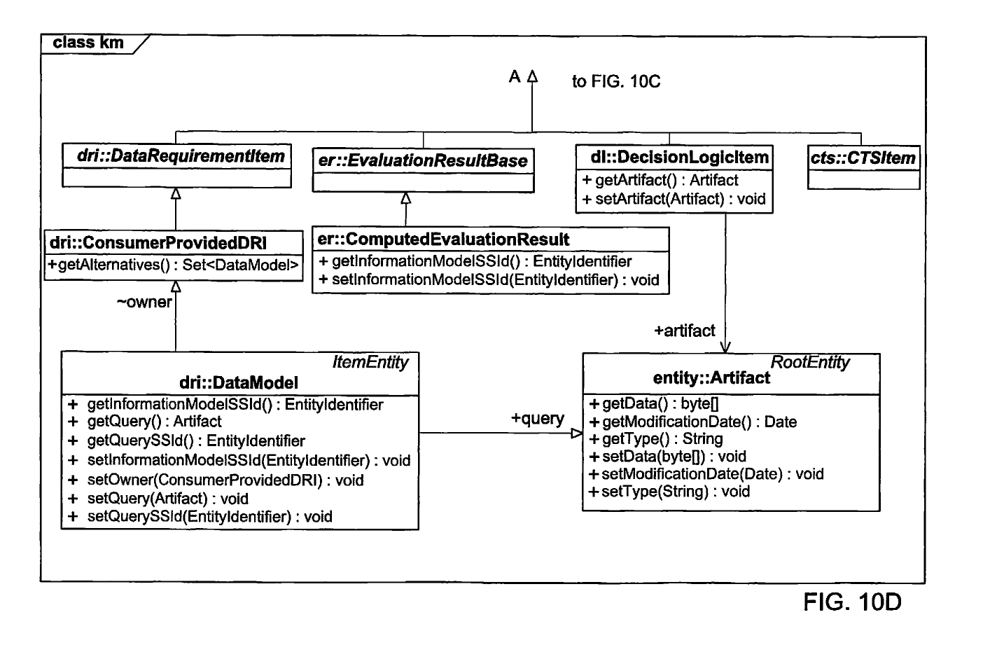

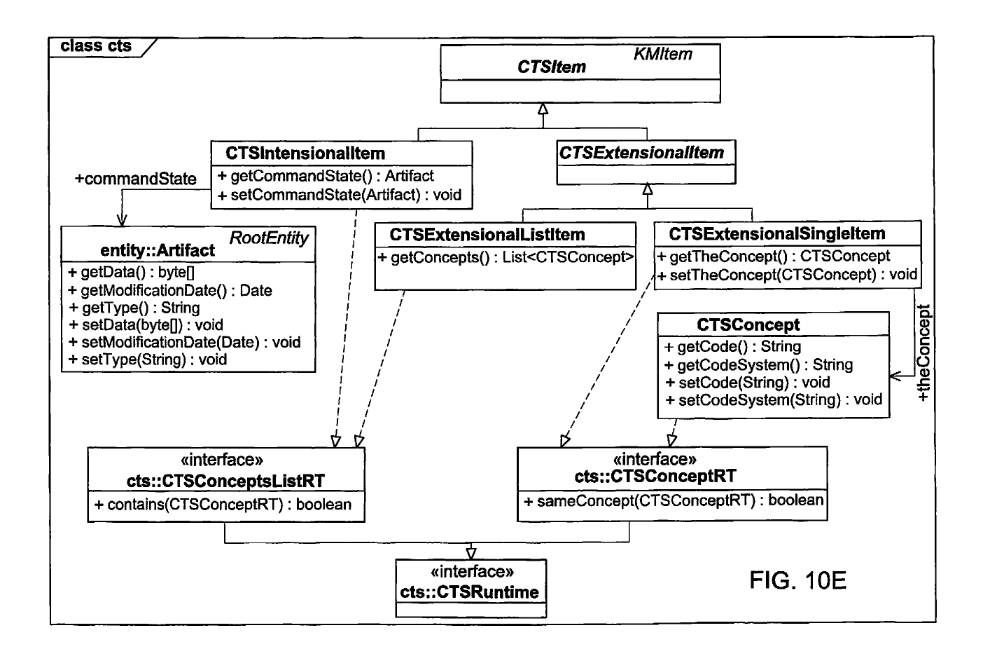

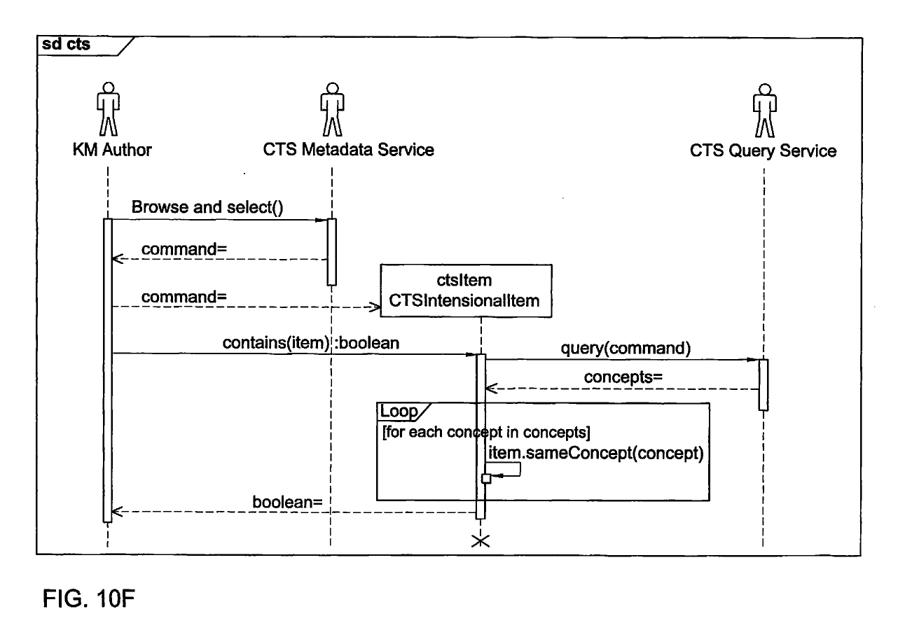

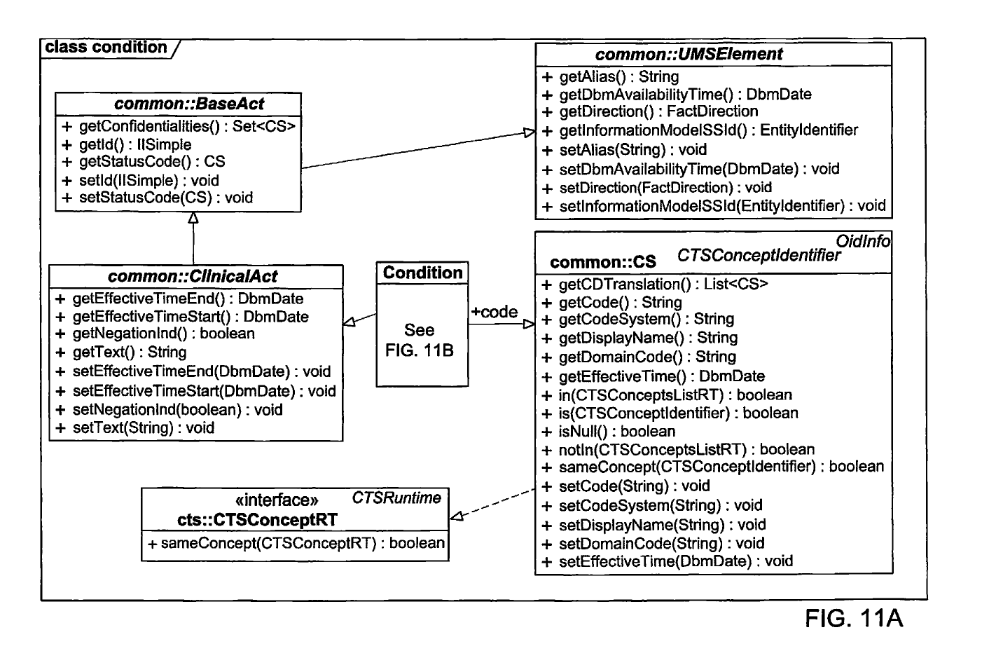

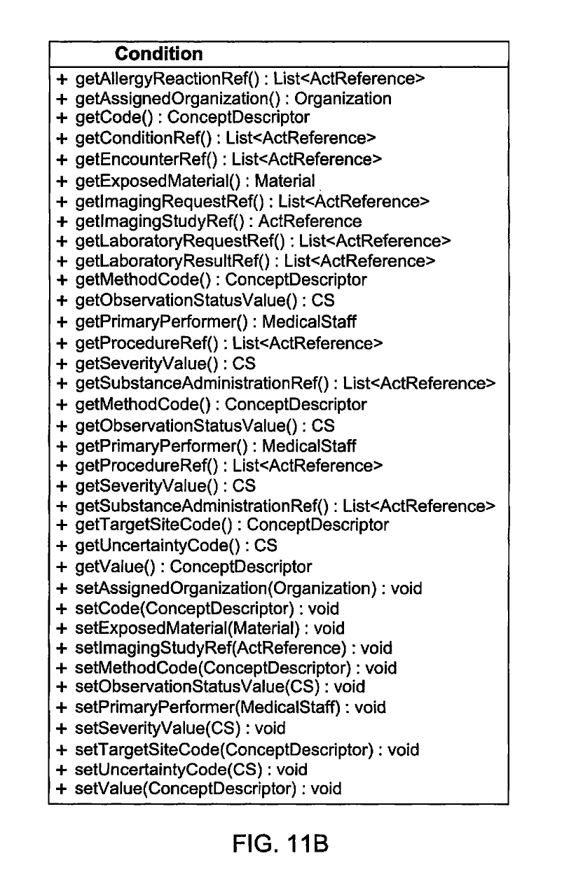

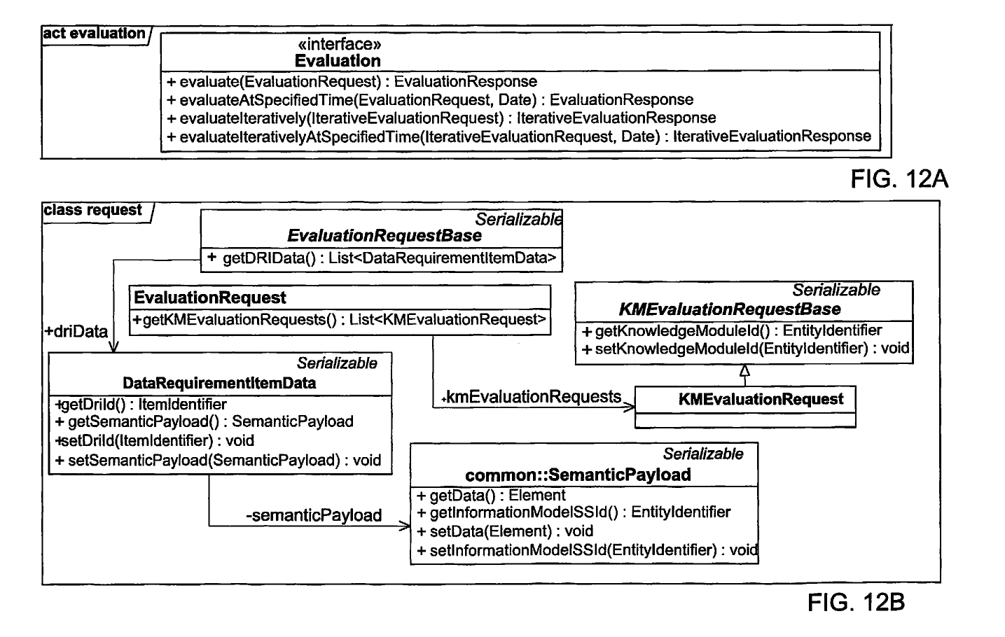

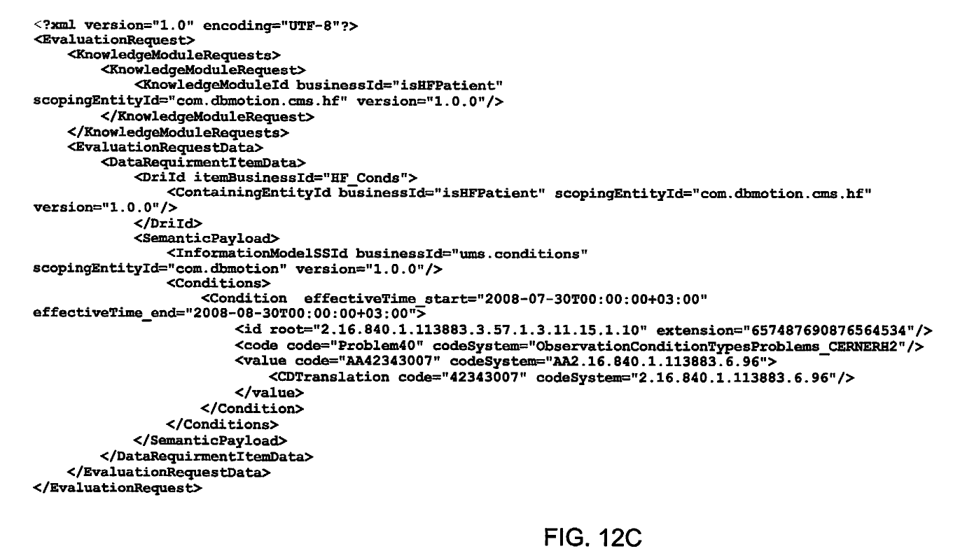

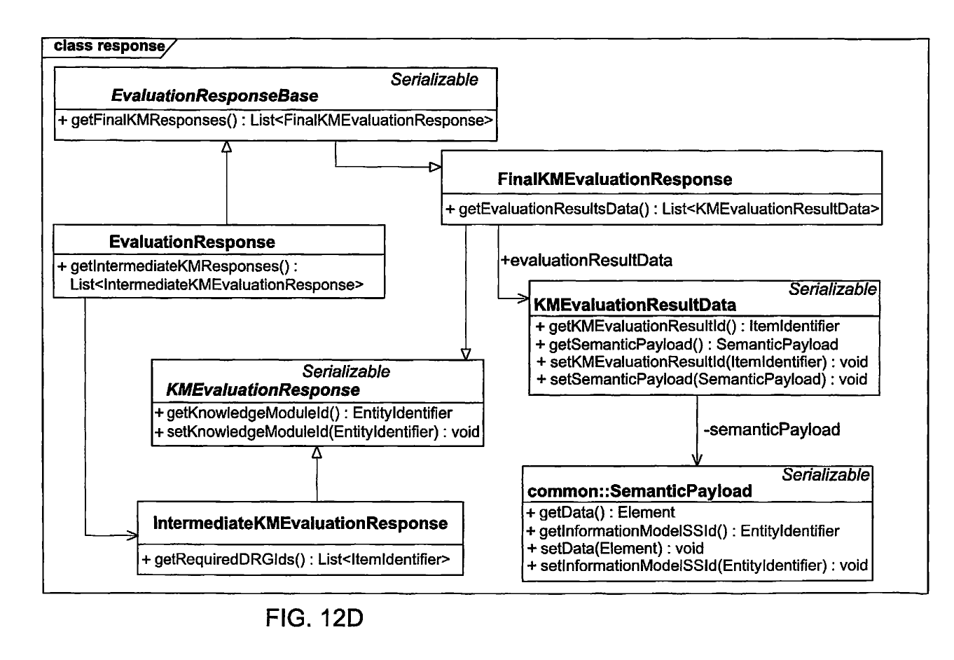

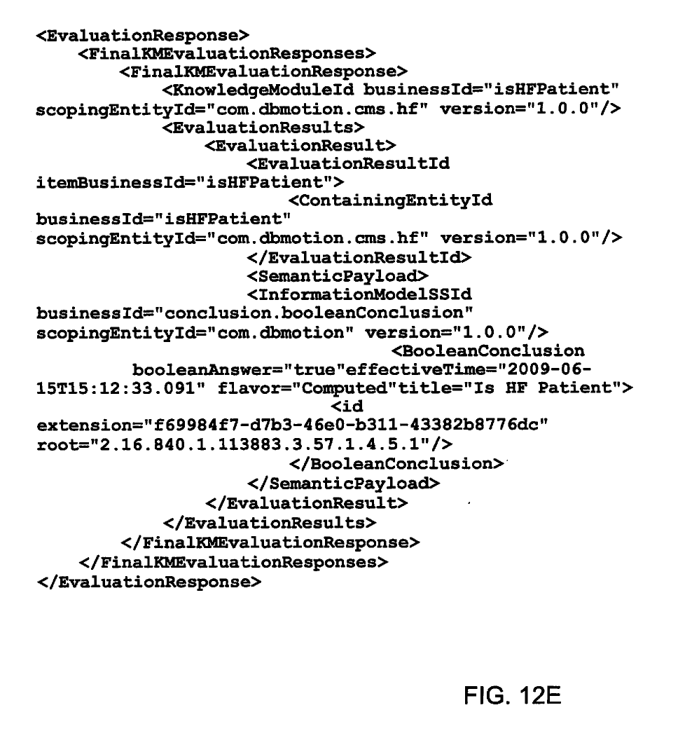

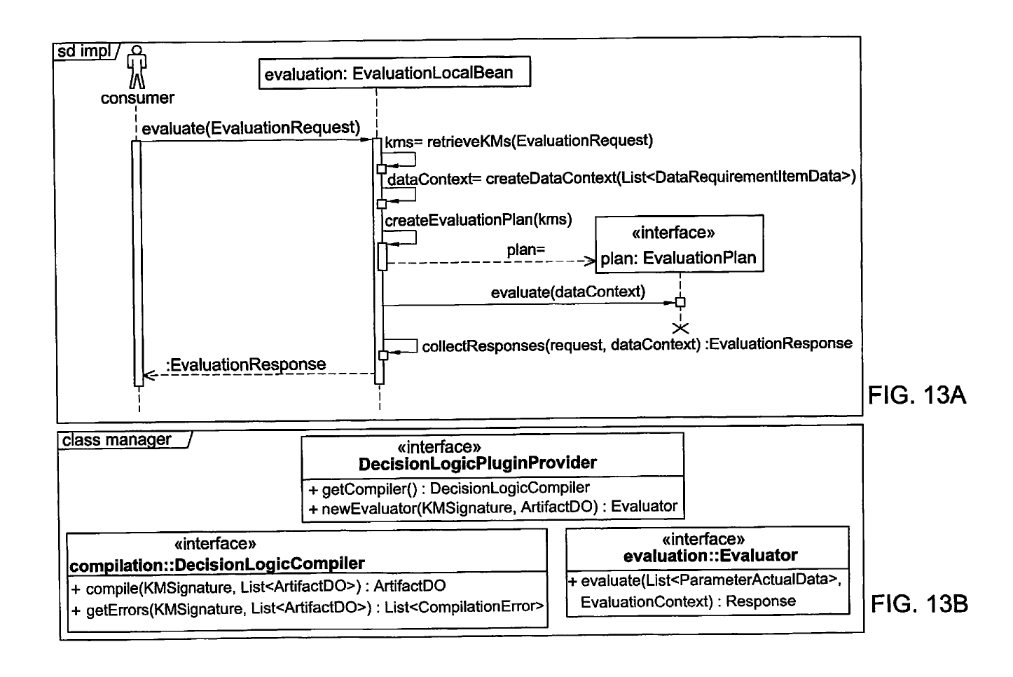

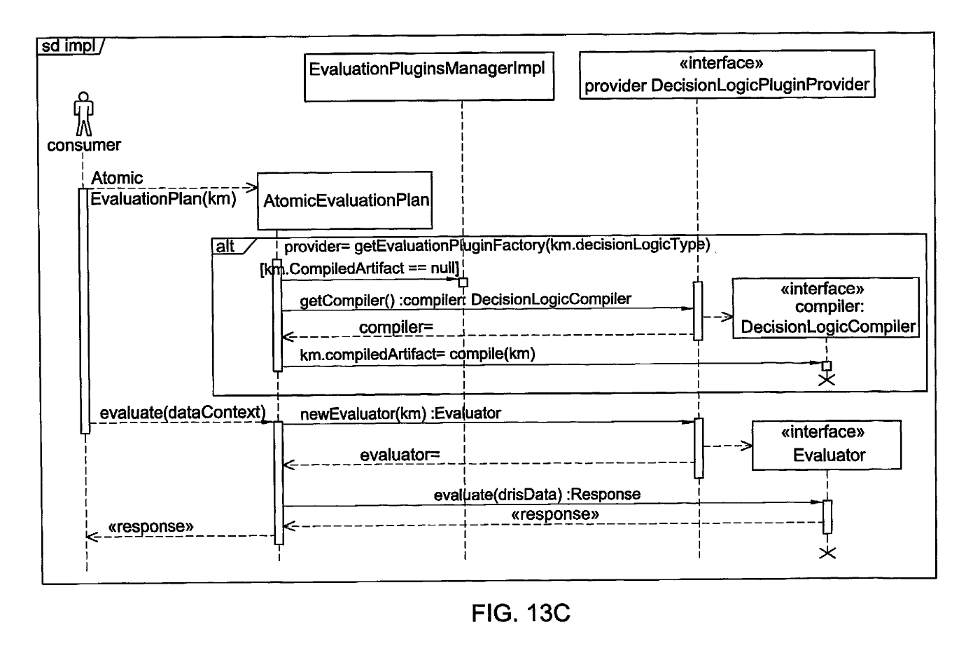

Specifically, the implementation's CTS Runtime Interfaces are described with reference to FIG. 9. A Knowledge-Framework and Knowledge-Module Static Model are described, including business identifiers described with reference to FIG. 10A, an artifact described with reference to FIG. 10B, and a knowledge-Module Entities Model described with reference to FIGS. 10C-10F. A KFW Business-Object-Model (BOM) is described with reference to FIGS. 11A and 11B. A KFW Evaluation Interface is described generally with reference to FIG. 12A. An Evaluation Request for the KFW Evaluation Interface of FIG. 12A is described with reference to FIGS. 12B-12C. An Evaluation Response for the KFW Evaluation Interface of FIG. 12A is described with reference to FIGS. 12D-12E. A KFW-Evaluation Process described with reference to FIG. 13A. An Evaluation Plug-in Mechanism is described with reference to FIGS. 13B-13C.

Generally, in the example implementation, Knowledge-Framework (KFW) is a decision-support service. KFW manages and evaluates Knowledge-Module (KM) entities. A KM contains a piece of clinical business-logic. A KM has a well defined contract: a set of specified input data and a set of results. KMs are modular and can be re-used, i.e., the output of one KM, can be used as input for another one. The body of a KM is its decision-logic. The decision-logic is based on input data and set the KM evaluation-results. The decision-logic is created and managed by knowledge-experts (e.g., clinicians). The decision-logic may use CTS ontology concepts. These concepts are defined implicitly as queries (commands) over dbMotion's CTS ontology only.

At runtime, KFW consumers send requests to evaluate actual patient data. The raw patient data is stored in dbMotion database using its local terminology. Before the data (e.g., a lab result) reach KFW service, the data is pre-processed and enriched with a mapping to dbMotion's CTS ontology. As a computation of the requested KM starts, KFW asks CTS to evaluate the pre-defined CTS queries. CTS returns a list of CTS ontology concepts. During the KM's decision-logic evaluation, KFW may check whether the patient actual data corresponds to one of the concepts in the result of the expected query.

Example CTS Runtime Interfaces are now described with reference to FIG. 9. KFW defines the following interfaces and allowed operations on CTS objects:
a. CTSRuntime: a marker interface.
b. CTSConceptRT: represents a single CTS concept identifier. sameConcept(CTSConceptRT other): returns true if the other concept is equivalent to this concept.
c. CTSConceptListRT: represents a list of CTS concepts. Contains(CTSConceptRT item): returns true if this list contains the given item.

A Knowledge-Framework and Knowledge-Module Static Model is now described. Business Identifiers: FW identifies its entities using identifiers, e.g. two types of identifiers, (a) and (b), as shown in FIG. 10A:
a. EntityIdentitifer: identifies main entities and may include:
   ScopingEntityld: a scope of ids (similar to namespace)
   Businessld: business id of the entity within the scoping entity
   Version: version of the entity
b. Itemldentifier: for entities that are composed in main entities. May include:
   ContainingEntityld: the id of the containing entity
   ItemId: unique id of this item within the containing entity

Artifact, e.g. as shown in FIG. 10B, is used to store not-structured data or data that KFW is agnostic to its structure.

An example Knowledge-Module Entities Model is illustrated in the class KM diagram formed by FIGS. 10C and 10D, taken together as indicated by the arrows. KFW internally operates on ‘Entities’. KFW-Entities is an object-model mapped to a relational database. The main entity in KFW is the ‘KnowledgeModule’ (KM). A KM extends from ‘ScopedEntity’ and hence is identified by an ‘EntityIdentifier’ (see above). A KM may include some or all of the following members:
a. DecisionLogicType—determines the type of the decision-logic used in this KM. These are examples for possible values: ‘decision-table’, ‘rules’, ‘Java code’ etc.
b. Status—determines the status of the KM. Example values are: ‘draft’, ‘in_production’, ‘obsolete’ etc.
c. InitialDataRequirements: a set of DataRequirementItems (DRIs) employed in a particular application, when evaluating a KM. A DRI is a KMItem, and hence is identified by an ‘ItemIdentifier’ (see above). Each DRI specifies one named data-input of the KM, e.g., ‘last year encounters’. The DRI is specified in one or more alternate DataModels. Each model format of the expected DRI data is defined by referencing a particular xml type in an xml schema (e.g., ‘encounters’ xml type). In addition, the DataModel can also constraint the returned data by specifying a query (the internal structure of the query is not in the scope of KFW). Typically, a Data model may be defined in one of dbMotion's schemas, using dbMotion's query language.
d. AdditionalDataRequirements: an optional set of DRIs that may be required. For example, if certain patient data is rarely needed by the KM and is expensive to collect, it may be defined as a DRI in AdditionalDataRequirement. Example: an initial call to evaluate a KM may contain only InitialDataRequirements (those that are easy to collect). Only if KFW failed to reach a conclusion using this data, the KFW response may contain a requirement for these AdditionalDataRequirements.

e. EvaluationResults: a set of evaluation-results. Each evaluation result declares the format of the returned data. This set is the output signature of a KM. For example, if a KM returns a yes/no answer it may have one evaluation-result of type Boolean. An evaluation-result can be computed in this KM, or propagated from the evaluation of another dependent KM.
f. DecisionLogicItems: a set of abstract source artifacts that defines the KM decision-logic. For example, it can be an Excel file that defines a decision-table. Or it can be a Java program that parses the input data and computes an evaluation-result. The actual type of the decision-logic artifacts depends on the value of DecisionLogicType attribute on the KM level.
g. CTSItems: a set of abstract items specifying one or more CTS ontology concepts e.g. as shown in FIG. 10E. CTSIntensionalItem uses an Artifact e.g. as described above to specify a CTS command.

A CTS command is the main object to query CTS, e.g. as illustrated in FIG. 10F. In FIG. 10F, typically, the command state is created at design-time by browsing CTS metadata service and selecting (or creating) a command. The command is saved in an artifact. When calling contains(CTSConceptRT item) method, the ctsItem calls CTS Query Service passing the command. CTS returns a flat list of CTS ontology concepts that satisfy the command. Finally, the method checks if the given item is included in this result list.

CTSExtensionalListItem typically comprises a hard-coded list of CTS ontology concepts and implements the contains° operation. CTSIntensionalSingleItem typically comprises a hard-coded single CTS ontology concept and implements the sameConcept( ) operation.

A suitable KFW Business-Object-Model (BOM) is now described. As described above, at runtime KFW evaluates patient data. The data reaches KFW service as xml documents (in dbMotion's format) and is transformed internally into (Java) objects. The model of this data is called the ‘Business-Object-Model’, or BOM in short. For example, Condition is a class in the BOM. The BOM may refer to CTS concepts. For example, Condition.Code is coded using CS class. CS class represents a CTS concept. At its root level it contains code and codeSystem attributes to identify a concept in a local terminology. The CDTranslations composition contains translations of this concept to other terminologies. In particular, this collection contains the translation to dbMotion's CTS ontology.

CS class also implements the CTSConceptRT interface. Hence, operations sameConcept( ) and contains( ) that were defined on KM CTSItems can be applied on BOM attribute values. The sameConcept(other) method in CS class is implemented by comparing the other.code+codeSystem attributes to CS root level attributes, or by finding an element in CDTranslations that satisfies sameConcept(other). FIG. 11 is a diagram of an example class condition.

An example KFW Evaluation Interface is now described. Typically, KFW exposes several interfaces. The evaluation interface of FIG. 12A is an example of a suitable interaction between KFW service and CTS. The interface of FIG. 12A defines four evaluation methods. The flow in all methods may be similar, so for simplicity only the flow of the first method—evaluate( ) is described hereinbelow. The method receives an EvaluationRequest and returns an EvaluationResponse. An example EvalutionRequest is now described with reference to FIG. 12B. In FIG. 12B, KMEvaluationRequests includes a list of KM ids to evaluate in this request. DRIData includes a list of patient data to use in the evaluation. Each DRI in the request object refers to DRI of an existing KM (using DRI ID). The data itself is enveloped in a SemanticPayload which includes a payload of data in xml element format. The informationModelSSId specifies the actual format of the data.

FIG. 12C is an example of an EvaluationRequest in xml format. This is a request to evaluate a single KM, with a single DataRequirmentItemData (DRIData) of type ‘Conditions’ which contains (in this example) a single ‘Condition’. Condition.value is a CS element that carries a local (i.e., from legacy system) concept code. In addition, CDTranslation element specifies a mapping to a dbMotion's ontology concept. This translated code may correspond to the CTS codes expected by the KM.CTSItems.

An example EvaluationResponse is now described with reference to FIG. 12D. In FIG. 12B:
FinalKMEvaluationResponses: a collection of responses for KMs that KFW service has successfully reached a final result.
   KnowledgeModuleId: the id of the KM that this response refers to
   EvaluationResultsData: a collection of evaluation result data. One item per an EvalutionResultItem in the referenced Km.
      EvaluationResultId: the id of the referenced EvalutionResultItem
      SemanticPayload: the data itself, in the format declared by the EvalutionResultItem
IntermediateKMEvaluationResponses: a collection of responses for KMs that KFW service could not reach a final result, probably, because of missing data.
   RequiredDRIIds: a collection of KM DataRequirementItem Ids that are missing for reaching a final result of this KM.

FIG. 12E illustrates an example of a KM evaluation result.

An example of a KFW-Evaluation Process is now described. As described above, one runtime use-case of the KFW service is ‘evaluate’. The evaluate method receives an EvaluationRequest and returns an EvaluationResponse (both were described above). FIG. 13A is a top level simplified flow diagram of an example evaluation process. EvaluationLocalBean is the class that implements the Evaluation interface. Typically:
1. The consumer sends EvaluationRequest messages to the bean.
2. The request contains pointers to the KMs to evaluate. Hence, the first step is to retrieve the KM entities from the database.
3. A DataContext is created. The DataContext initially contains all the DRIData provided by the consumer. During the process, computed evaluation-result data are accumulated on this DataContext.
4. An EvaluationPlan is created. The problem is that an EvaluationRequest may comprise one or more KMs that can have inter-dependencies. KFW has to determine a sequence of KMs to evaluate. A plan serves as a strategy of the KM evaluation sequence. For example, one may assume this knowledge base: [a, b, c->a, b] (i.e., km c depends on the outputs of kms a and b), then on runtime KFW receives a request to evaluate km c. One option is to evaluate the KMs in this sequence: [a, b, c]. Another strategy might be [a|b, c] (i.e., to compute a and b in parallel and to compute c).
5. The plan is executed with the dataContext. During the plan execution evaluationResult data are accumulated in the dataContext.
6. An EvaluationResponse is assembled by looking at which KMs were originally requested and the actual data is collected from the dataContext.

An Evaluation Plug-in Mechanism is now described which is useful in the process of evaluating a single KM. As described herein with reference to the KM static model, KM decision-logic is stored in artifacts. The KFW supports a mechanism to plug-in new decision-logic types. For example, the decision-logic can be declared in rules, or using a decision-table. The plug-in mechanism that evaluates a particular KM is determined by its KM.DecisionLogicType attribute value. Hence, KFW holds a map were the keys are decisionLogicTypes and the values are DecisionLogicPluginProvider objects. For performance reasons, the KM decision-logic artifacts are compiled into a plug-in proprietary form. This compiled form is also stored in the KM static model in a special artifact. FIG. 13B is a diagram of an example class manager. In the embodiment of FIG. 13B:
DecisionLogicPluginProvider: a factory object that provides appropriate compilation and evaluation plug-ins.
   getCompiler( ) returns a DecisionLogicCompiler object
   newEvaluator( ) receives a KMSignature and a compiled artifact and returns a new Evaluator.
DecisionLogicCompiler: an object that knows to compile source artifacts in a specific decision-logic format
   Compile( ) returns a new artifact that contains the compiled form of the source artifacts
   getErrors( ) returns a list of errors in the source artifacts.
Evaluator: an object that evaluates requests and returns responses.

A typical KFW—plug-in evaluation process is illustrated in FIG. 13C in which an AtomicEvaluationPlan is the implementation class of EvaluationPlan interface for evaluating a single KM. A KM entity is passed in the constructor call. If the KM does not contain a compiled artifact, the sources have to be compiled. In practice, a compiled artifact is usually already set in production systems (it may be null only during the KM authoring stage). valuationPluginManagerImpl is a singleton object that contains a map of decisionLogicType strings to DecisionLogicPluginProvider objects. This map is initialized from configuration. The plan asks the provider to get a compiler object. The compiler gets the KM entity and returns a compiled artifact. This compiled artifact is stored.

When the plan is executed, the plan asks the provider to provide an Evaluator object. The Evaluator object is constructed from KM entity (expecting a not null compiledArtifact). The Evaluator.evaluate( ) method is called passing the driData (extracted from the request). The evaluator is state-less and the same evaluator can be used several times to evaluate different requests of the same KM.

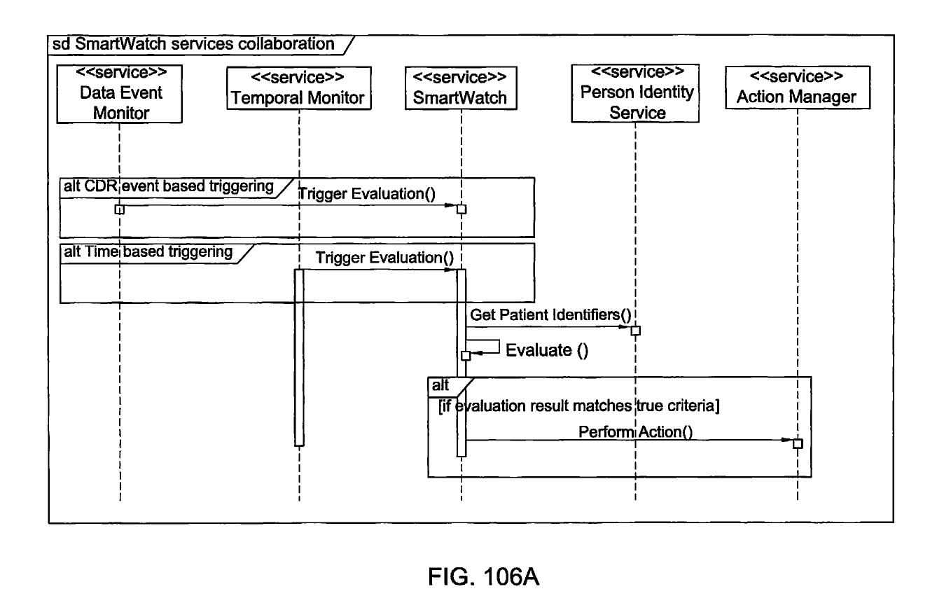

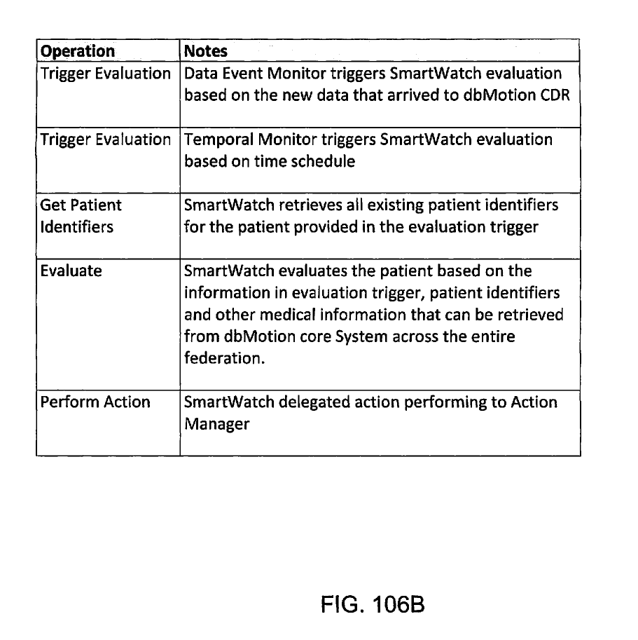

The SmartWatch sub-unit of the example health information exchange and integration system of FIG. 1A is now described with reference to FIGS. 106A-137. FIG. 106A is a simplified functional block diagram illustration of the SmartWatch sub-unit constructed and operative to certain embodiments of the present invention. FIG. 106B is a table describing operations, some or all of which may be performed by the system of FIG. 106A.

As shown in FIG. 106A, the SmartWatch sub-unit of FIG. 1A typically includes some or all of a SmartWatchservice unit, a data event monitor, a person identity service, a temporal monitor and an action manager. These functional units are now described in detail herein, with reference to FIGS. 106C-114, 115-123, 124-130, 131-134, 135-137 respectively. Various architectural views are provided, such as one or more, as appropriate, of the following UML-defined view: use-case view, a logical view, a process view, a deployment view, an implementation view and a data view, where:
1. Use-Case Model: Describes the actors and use cases for a system which may be software-implemented
2. Design Model: Describes the design elements of the system, how they cooperate to realize system use-cases; how they trace to requirements if any, user experience and key analysis elements; and how they map into implementation elements
3. Implementation Models: Describe the implementation elements of the system.
4. Deployment Model: Describes the deployment structure of the system.

The architecture of the SmartWatch service unit is typically designed to be a focal point of lifetime management/storage of all Guard instances and to concurrently process multiple Guard evaluation tasks for an assortment of member/task combinations, all as described in detail below.

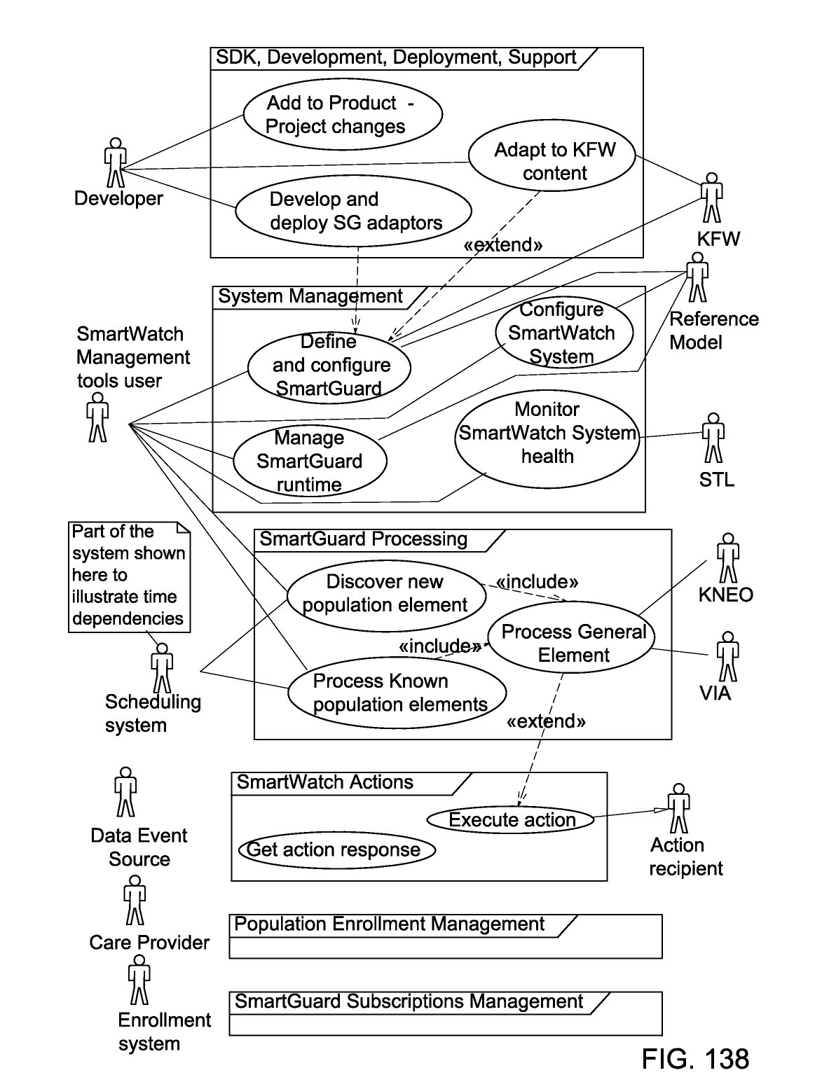

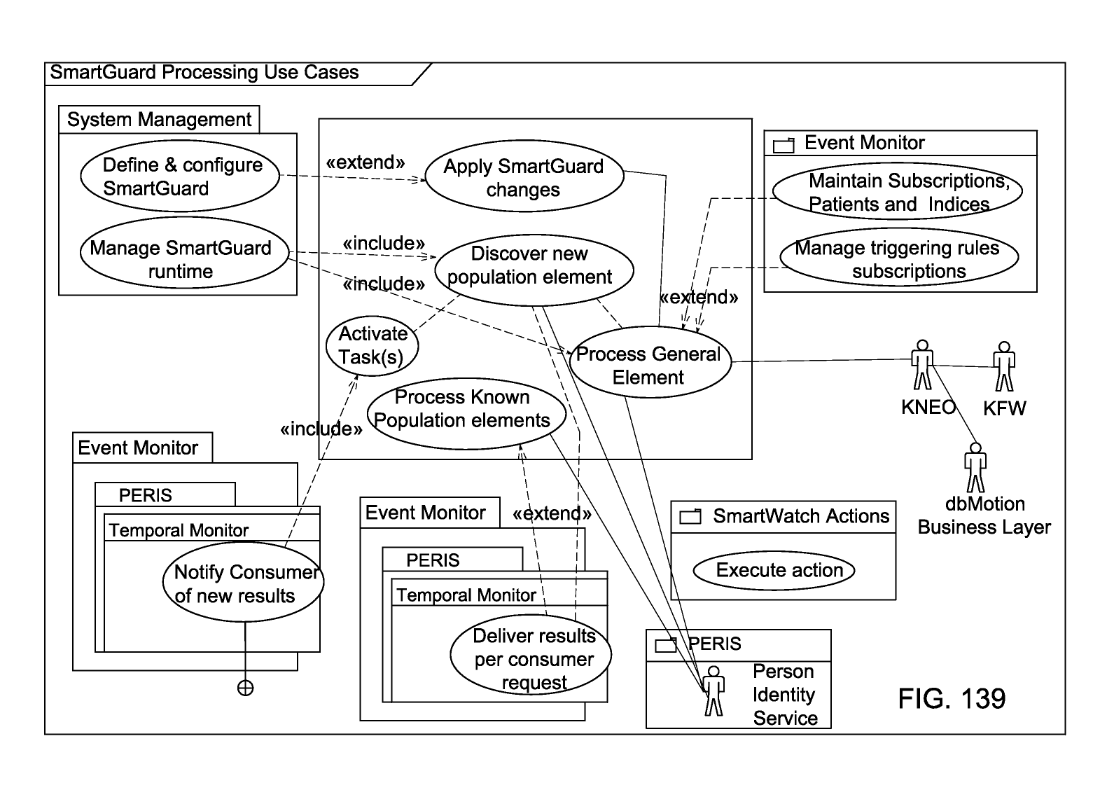

Use-Case View: Certain SmartWatchService use cases illustrating functions of the service based upon its population processing activities, some or all of which functions may be provided in any given embodiment, are now described. These use cases, referred to herein as use cases (i)-(x), and their associated actors are shown in the SmartWatch-wide high level use case diagram of FIG. 138 and in the use-case focused diagram of the SmartWatchservice of FIG. 139. The following use-cases employ multiple applications of the SmartWatch system, which may include SmartWatch Management GUI, Person Identity Service, and other components of the total system.

I. Develop and Deploy SmartGuard (Also Termed herein SG) Adapters
New population discovery mechanisms
New identity change behavior
   ii. Define & Configure Guard
Register and validate Guard configuration
Check-out Guard configuration
Supplying metadata for SmartWatch Management GUI
   iii. Configure SmartWatch System
   iv. Manage Guard runtime
A Guard administrator may be able to activate and deactivate a Guard, in addition to viewing the Guards current status (i.e. Active or Inactive). Activities included in this use-case would be: Activating and Deactivating a Guard and Viewing Guard current execution status and log.
   v. Monitor SmartWatch System Health
Activities included in this use-case would be maintaining and reporting Guard runtime performance count.
   vi. Apply Guard Changes
In this use case SmartWatch reconciles changes to existing population members, such as splits/joins as defined in conventional EMPI systems, which may affect previous decisions (activity executions). Activities included in this use case would be, given a new version of a Guard, reconciling changes to recognized members.
   vii. Discover New Population Element
SmartWatch looks for candidates to be added to the population and joins them into the population if they fit. Smart Guard definition determines what may be required for a patient to fit the population; the decision could be based on eligibility criteria from KFW, an external db view or some other source. The following activities are typically included in this use case:
a. Retrieving Candidates from the Data Event Monitor (or other population source)
b. Retrieving patient indexes using a conventional EMPI system and using identity monitor c. Filtering for duplicate indexes on fired subscriptions
d. Verifying candidates are not already a part of the population
e. Pushing a member into a default classification
   viii. Process Known Population Element

SmartWatchService monitors its current population members by determining if they need to be evaluated, evaluating them, and responding to an evaluation result. Activities included in this use case may be: Retrieving applicable members from monitors (based upon triggering rules which have fired); and Filtering for duplicate members.

ix. Process General Population Element
This represents a primary processing use case for this service. The SmartWatchService evaluates a patient within the context of a specific Guard. The goal includes determining classification eligibility (e.g. entry criteria). Activities included in this use case may include some or all of:
a. Retrieving (aggregating) rules to evaluate based upon the patient and classification(s) and evaluating them
b. Stepping a member into a classification and accumulating monitoring activities
c. Stepping a member out of a classification and removing associated monitoring activities
d. Updating triggering rule subscriptions
e. Handling monitoring activities (e.g. Action Invocation Request, Triggering Rules Subscriptions)
f. Remove a patient from the population
   x. Activate Task
This use case encompasses SmartWatchService's activation needs based upon a schedule; however according to an alternative embodiment, triggering is by the event monitor when new results are waiting. Still another alternative embodiment includes activating from an external application (GUI tool or command line). Activities included in this use case would be:
   a. Wake-up according to flow
   b. Find the appropriate task
   c. Begin processing member or population discovery

Architectural Design Elements are now described (logical view), e.g. as shown in overview in FIG. 106C. Typically, two layers, a business logic layer and a data access layer, share a common set of entities.

The business logic layer (BLL) of the SmartWatchService contains a group of managers that perform at least certain functionalities of SmartWatchService. The MonitorBrokerManager orchestrates requests from the other managers within the business logic layer to the external monitors for triggering rule matching and subscribing services. The ServiceBrokerManager orchestrates requests to other external services. The CallbackManager serves as a point for external services to send information to the SmartWatchService. Services for the business logic layer may include some or all of:

a. GuardExecutionManager—The guard execution manager coordinates both discovery of a new member for a guard, and retrieving triggered rules for monitoring a guard's population.b. GuardManager—Manages all of the Guards and their runtime/lifecycle information. This manager can activate or de-activate a guard, or set it to another intermediate runtime status. This manager also performs lifetime management operations on an individual

Guard, such as loading, activating, and deleting Guard instances.c. GuardMemberManager—The guard member manager performs operations on individual guard members. It coordinates member classification changes, in addition to registering and activating subscriptions for member monitoring through the MonitorBrokerManager.d. MemberProcessingManager—The processing manager receives items which contain both a member and a list of tasks that are to be processed for them. Each task contains a list of rules which are to be evaluated. The MemberProcessingManager communicates with a Rule Evaluator to complete this, and returns a set of activities to execute for each member. An example of an activity could be to change a member's classification, or the send an action to the ActionManager. The Data Access Layer typically handles storage for various entities. Entities stored here may include some or all of:
a. Individual population members and virtual patient objects.
b. Bookmarks (operation history)
c. Metadata information for SmartWatchService and the Guards
d. Guard processing itemsExample use-case implementations or realizations for the above SmartWatch Wide Use-Cases (i)-(x) are now described: i. Develop and Deploy Smart Guard Adaptersmay include:
a. Development of new population providers for a Guard population source b. Development of new Identity Change Strategy for Guard population source
c. Development of new types of activities
d. Changes in Business Object Model (i.e. modifying an existing action, creating new activities)
   ii. Define & Configure Guard: User registers a new Guard configuration. Guard configuration classes are validated for conformity to basic rules e.g. whether valid activations are present and whether a population source exists. A guard runtime structure is built from the configuration classes. A second implicit validation takes place during this phase, in which the service verifies that the configuration aliases are valid, that no cyclical sources exist and that no member classifications contain invalid tasks. A guard's detail structure is also built from this configuration. The details include the current lifecycle and runtime state, in addition to the default guard properties taken from the configuration.

Supplying metadata for SmartWatch management GUI is a scenario which may be supported by the SmartWatchMetaData service as this service evolves to a concrete representation. The metadata service may expose metadata from the service or configuration file. iii. Configure SmartWatch System—this use case is self-explanatory.

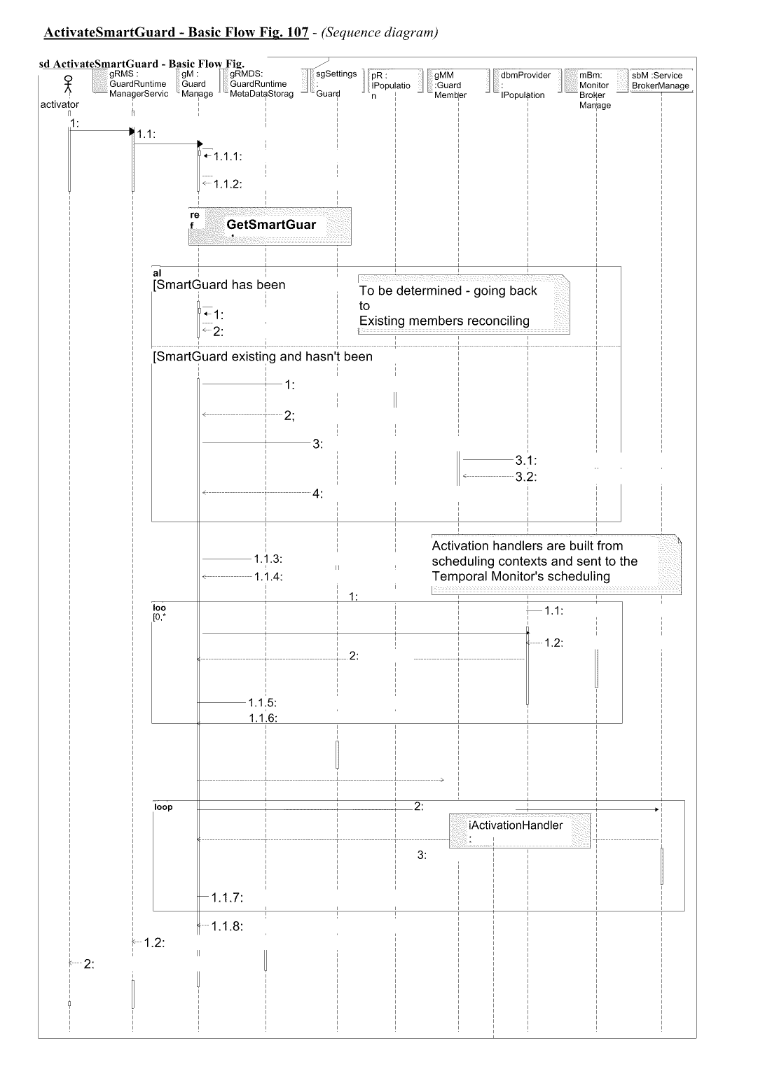

iv. Manage Guard runtime: Typically, the User activates a Guard, e.g. as shown herein in FIG. 107. Guard activation may comprise some or all of the following steps, suitably ordered e.g. as follows:
a. The Guard's details are pulled from the existing list
b. If the guard has been modified, some reconciliation takes place (including verifying that the existing members, classification, configurations are still valid)
c. If the Guard is currently in “inactive”, or “halted” state—any current members have their triggering rules re-activated. This is done through the GuardMemberManager.
d. The triggering rules for the population source are re-activated. In case this is the first activation, the provider may register them first and then activate.
e. The Guard's runtime status is changed to active: A user de-activates a Guard. Guard de-activation may comprise some or all of the following steps, suitably ordered e.g. as follows:
a. The guard's details are retrieved based upon the provided guard identifier.
b. The guard's activation schedules are removed from the Temporal Monitor through a call to ServiceBrokerManager
c. The triggering rules for a guard's members are deactivated
d. The triggering rules for each of the guard's population providers are deactivated
e. The guard's runtime state is changed to inactive.

The system may View Guard execution status and log.

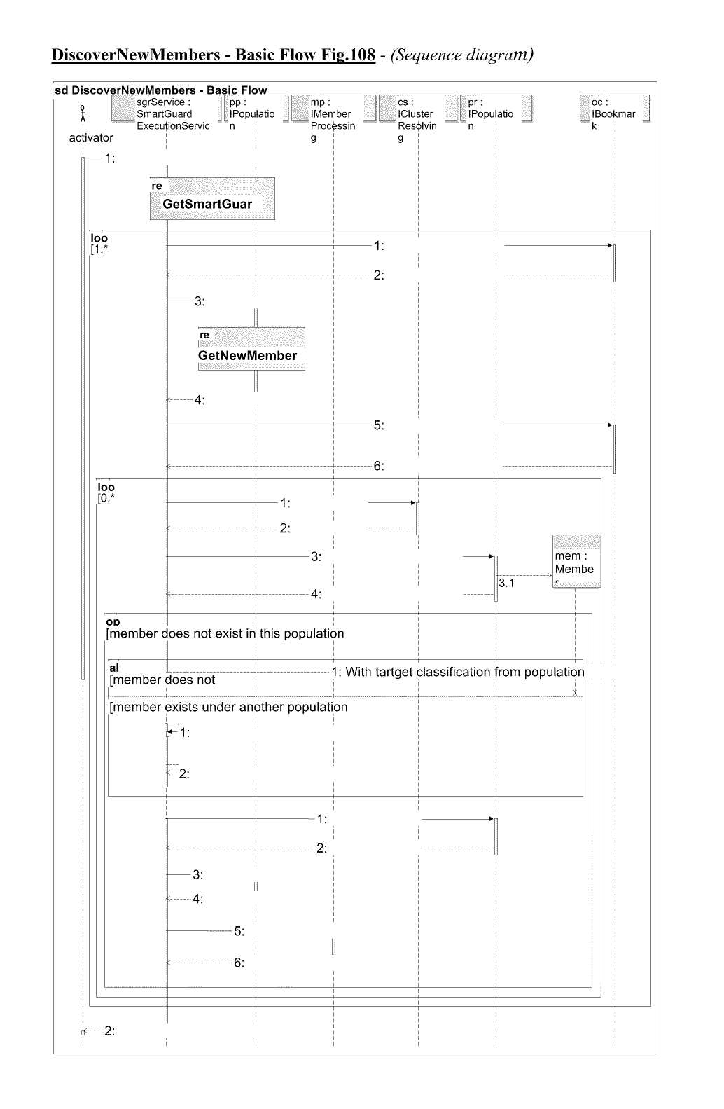

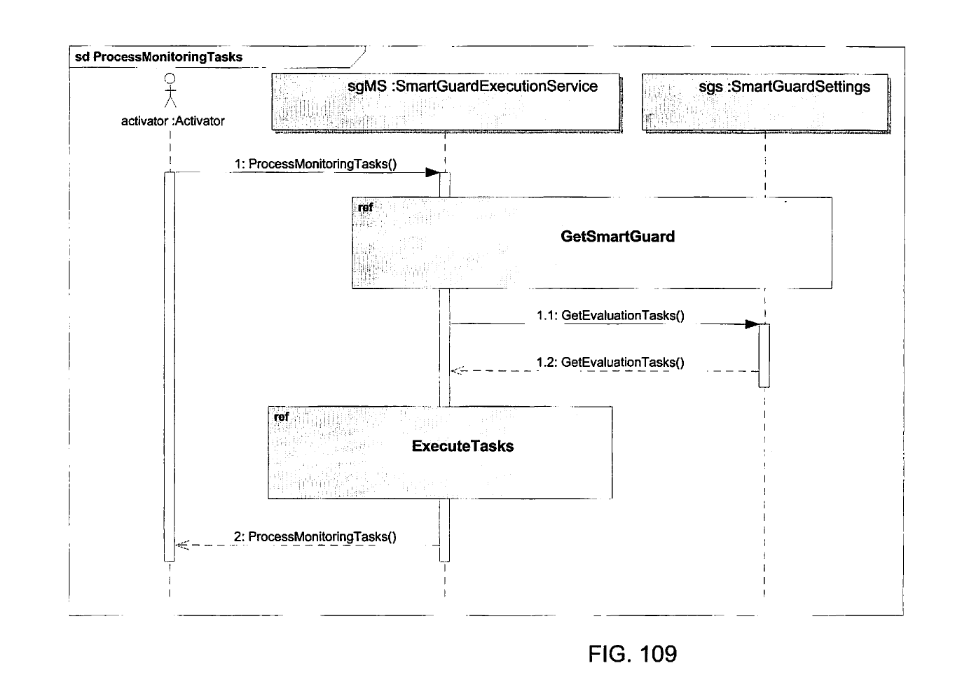

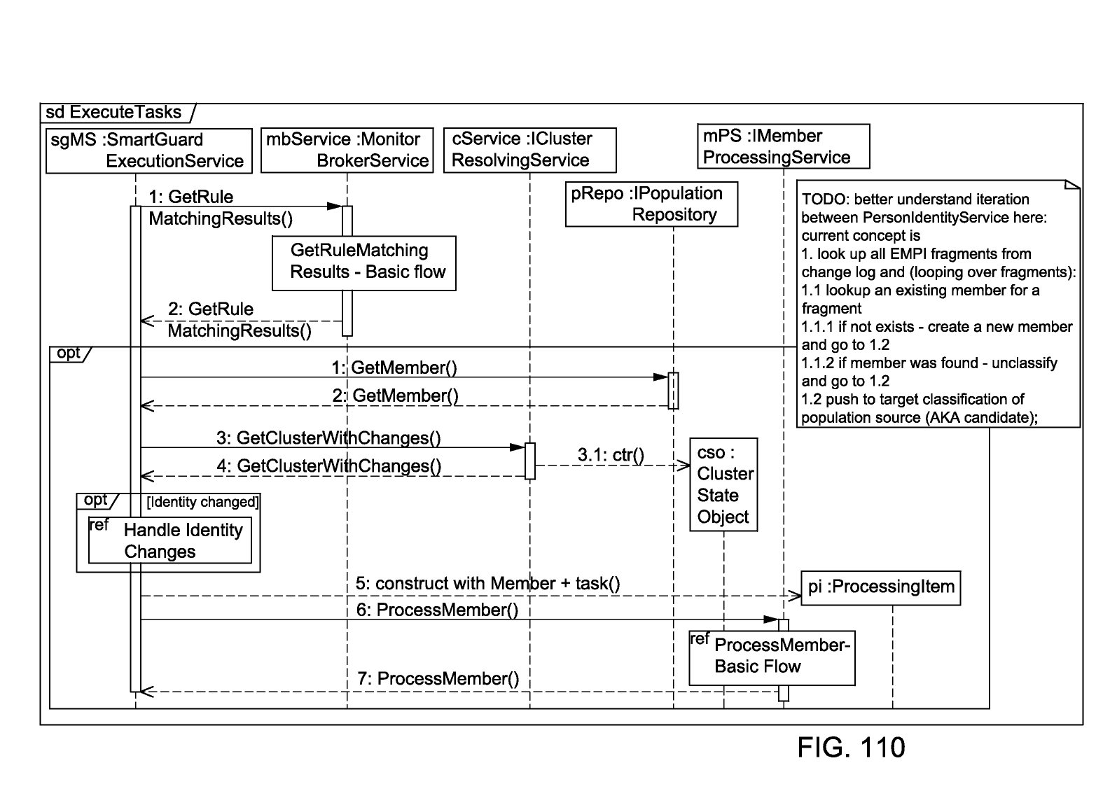

v. Monitor SmartWatch system health e.g. Maintain and report Guard runtime performance count—this use case is self-explanatory.
vi. Apply Guard Changes—this use case is self-explanatory. Guard (or SmartGuard) is a term used herein to identify the instance. SmartWatch handles many instances of evaluations. Each such instance typically includes various evaluations such as, for example, population definition, monitoring definition, actions definition.
vii. Discover New Population Element, e.g. as shown herein in FIG. 108. Discovery of a new population element may comprise some or all of the following steps, suitably ordered e.g. as follows:
a. Discover new population element is called directly by the user or by a callback from activation.
b. For each population source configured under the Guard, the service retrieves the new patients.
c. The new patients are added to an exclusion list for each population source
d. For each potential new member the cluster is retrieved from the Person Identity Service
e. Duplicate patient clusters are joined (filtered)
f. Patients existing within the Guard's population source are filtered
g. The patient is added to the Guard's collection of members
h. The new member is given the initial classification targeted by the population source
i. The new member is pushed into the processing queue with the list of applicable tasks from the classification just set.
   viii. Process Known Population Element, e.g. as shown herein in FIGS. 109 and 110.

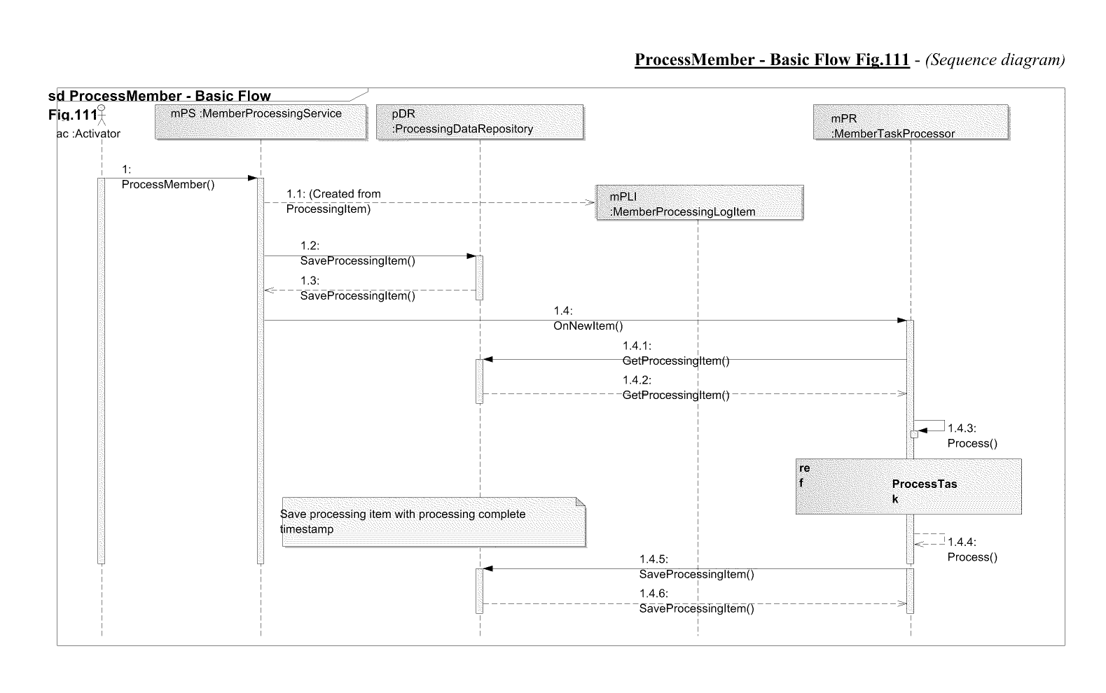

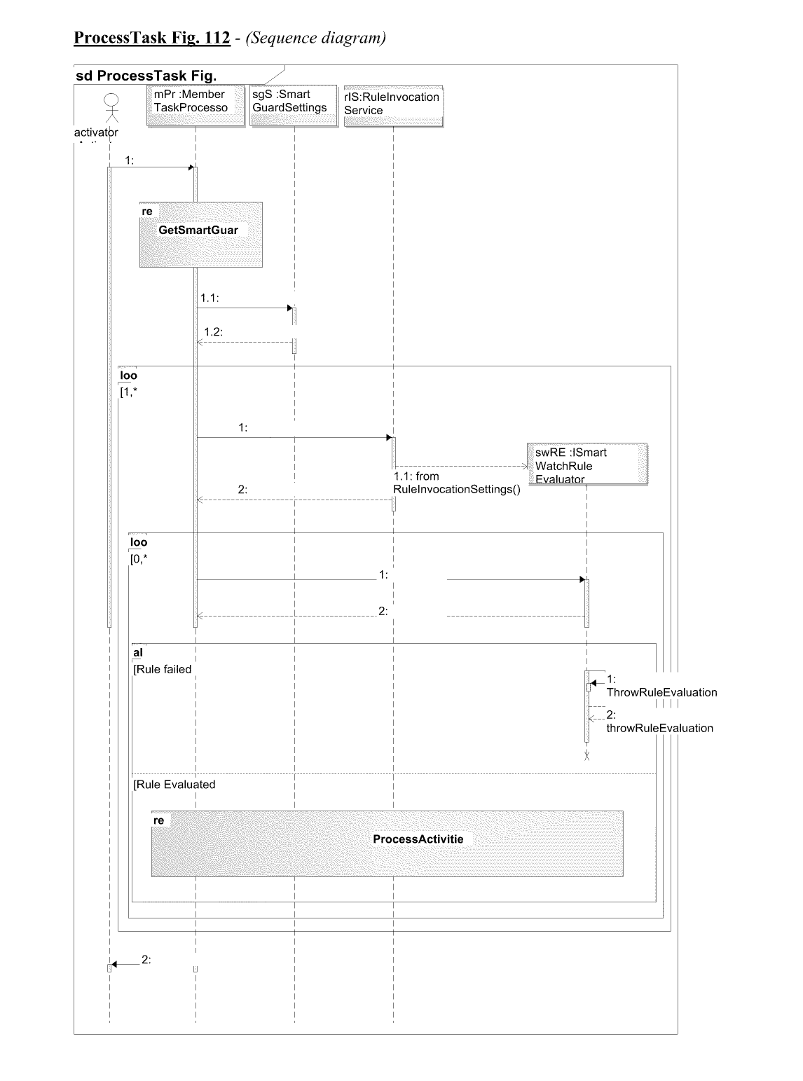

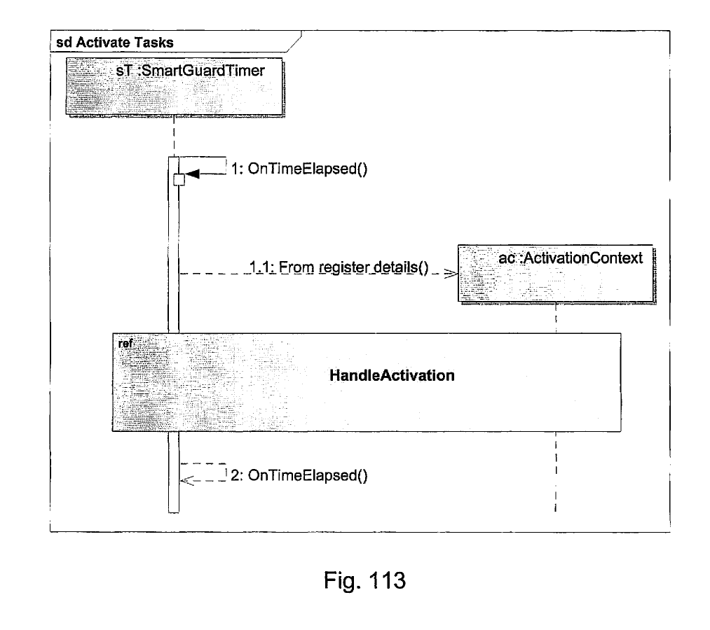

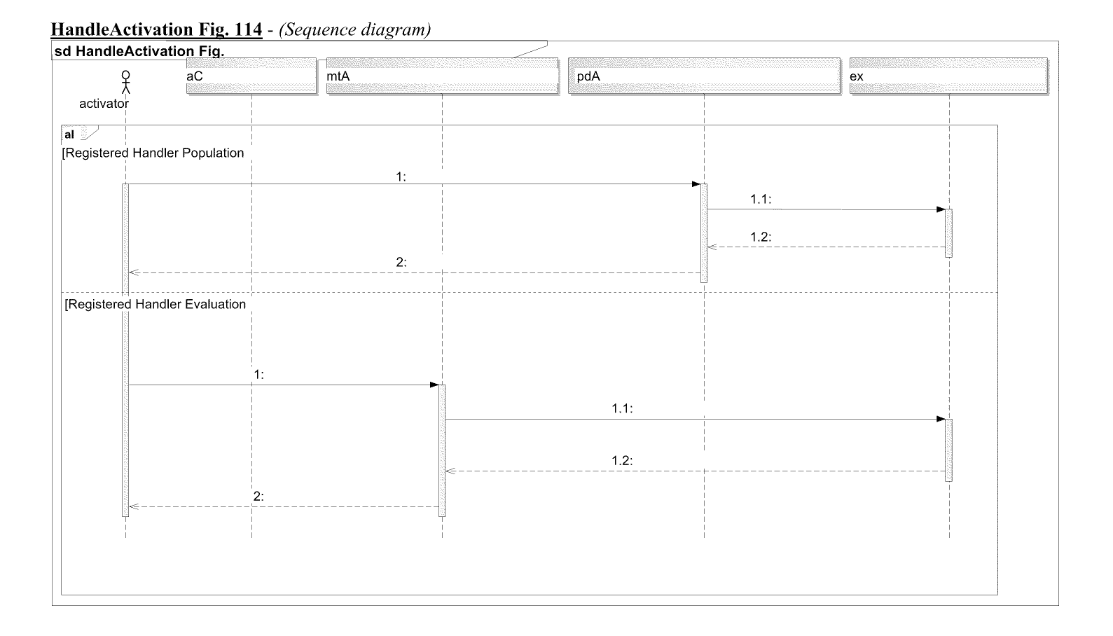

Processing of a known population element may comprise some or all of the following steps, suitably ordered e.g. as follows:
a. Process is triggered by user or activation (timer or monitor)
b. Check for temporal triggering rules which fired for subscribed events
c. Check for data event triggering rules which fired for subscribed events
d. Check for identity triggering rules that fired.
e. For each result—check for identity changes and handle as appropriate. Unclassify the current member and add to initial classification (re-evaluation of all classifications). If appropriate—add new members for split cluster fragments.
f. Check for data changes (updates/deletes) which might change past recommendations
g. The member is pushed into the processing queue with the list of applicable tasks
   ix. Process General Population Element, e.g. as shown herein in FIGS. 111-112. Processing of a general population element may comprise some or all of the following steps, suitably ordered e.g. as follows:
a. Get applicable tasks based upon Guard and member classification
b. Execute Task Rule (Knowledge Module or hard-coded rule) e.g.:
   b-1. Invoke KNEO to evaluation knowledge module
   b-2. KNEO invokes the KFW to evaluation the knowledge module
   b-3. Store the patient VPO returned.
KNEO (KNowledge Evaluation Orchestration) is a functionality within SmartWatch which simplifies SMW communication with KFW since in order to execute KM in KFW, SmartWatch typically collects patient data, which may optionally, as a design choice, be effected by a separate service, namely KNEO.c. Receive evaluation result and handle activities, activity could be of any of the following types:
   c-1: Registering a specialized triggering rule
   c-2: Invoke an action
   c-3: Step in or out of a classification (see Re-classification Activity)
d. Log all activities
   Re-Classification Activity may include any or all of the following:
a. Add or remove a member to the classification based upon the evaluation result.
b. Analyze member's current classification status. If the member is not a part of any existing classification, Unsubscribe from Person Identity Service and Unsubscribe from applicable Monitors. If the member is a part of an existing classification, and the classifications have changed.
c. Collect applicable classification triggering rules including Update triggering rule subscriptions
d. Update patient process history and Guard run history
   x. Activate Task: Cause a specific task to be activated by schedule or by callback e.g. as shown herein in FIGS. 113 and 114.

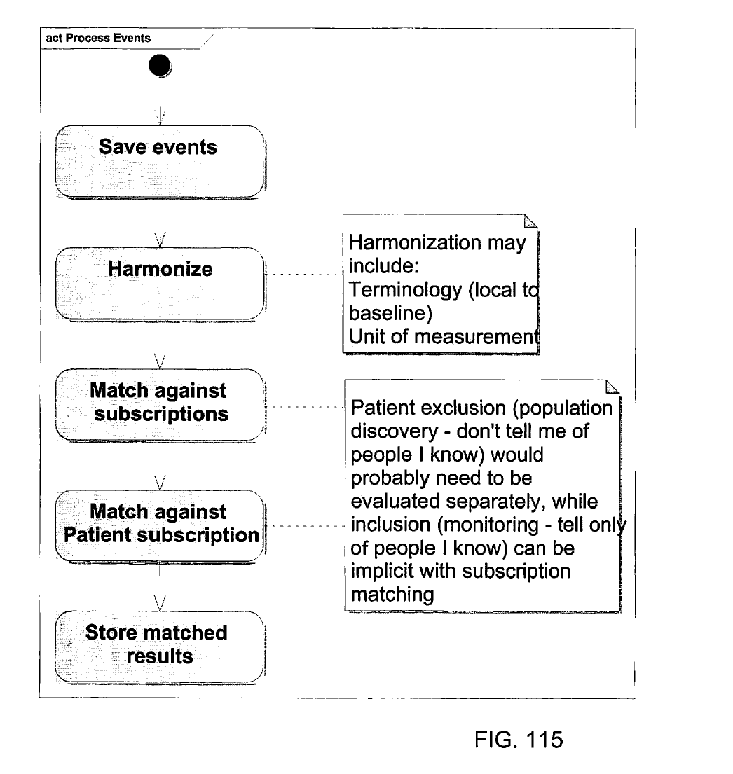

The data event monitor is now described with reference to FIGS. 115-123. An architectural overview of certain embodiments of the data event monitor, using different architectural views to depict different aspects of the system, is now provided. The data event monitor (DEM) and Temporal Monitors typically provide a way to trigger patient evaluations in SMW. Any suitable implementation of such triggers may be employed, which may differ from those specifically described herein e.g. due to specifics of the interlaying system such as how the CDR is built and what other capabilities are. For example, triggering may occur when the incoming message is being processed rather than as described herein.

The following use cases may be provided:

i. Manage triggering rules subscriptions (add/remove subsections to pattern rules): Accept subscription changes from consumers, and reflect them in the subscription database. This may include new subscriptions, along with the patient indices (for either inclusion or exclusion). This also handles updates such as removing triggering rules from patients and changes to the triggering rules for patients. The subscription information typically includes enough information to allow the consumer to pull results later on with a different level of granularity (SmartGuard, classification, Task, member). This information is typically reflected in the results as well.
ii. Maintain Subscription's patients and indices: When there are EMPI (Enterprise Master Patient Index) changes of a known member, “fix” all of the subscriptions to ensure that the correct patients continue to be monitored. In terms of population management, when a member is added to or removed from the Smart Guard, this use case changes the patient list while retaining the actual subscription.

Use cases iii and iv are both “Collect events” use cases which map CDR data to an event object model e.g. that of FIG. 140 which is a diagram of an example of one suitable event object model. Typically, a suitable event object model is generated for each medical domain. Each domain typically comprises a realm of medicine such as Encounters, Labs, Medications, Documents, Imaging, Immunization, Allergies, and Pathology. Encounters typically include any type of physician visit, either to a home doctor (PCP) or as admission into hospital.

iii. Collect new events: This use case gets “latest” events from a data source such as the CDR for processing, either in push or pull mode. A typical event would arrive from the CDR, but there is the option to receive events from other sources.
iv. Collect old events (also termed herein “bootstrap scenario”): Get events from the data provider from any timeframe for processing (“Bootstrap” scenario). These events are to be tagged in order to be matched only against the set of subscriber/pattern rules that “missed” them (either a new Smart Guard or a freshly reactivated one as described herein with reference to the Control rule execution use case. This operation is performed at the subscriber level, for all of the subscriber's subscriptions.
Use cases v-vii are all “Deliver results” use cases.
v. Deliver results per consumer request (consumer pulls results): When a consumer requests results from the data event monitor, a use case may provide such results. It is the consumer's responsibility to ask for the start and end points of the results.
vi. Notify Consumer of new results: “Pings” the consumer when there are results waiting for it. This may be configured to only ping any given consumer at a certain interval (no more than once every 30 minutes, for example).
vii. Process Events: As shown in FIG. 115, this use case covers the “event processing chain” in the data event monitor. When data events enter this chain, this use case may harmonize the data (terminology & unit of measure), determine what subscriptions are fired by the data, and store the results of the matching operation.
viii. Maintain pattern rules: General maintenance of the pattern rules that the data event monitor can support. These may include creating new stored procedures for matching, defining pattern rule parameters, and mapping the two together. Three components are ultimately used by the Data Event Manager, also termed herein “data event monitor”, when matching events to subscriptions: Rules Processors, Event Working Tables, and Subscription Tables. The Rules Processors make the various Event Working Tables/Subscription Tables pairings meaningful.
ix. Control rule execution (stop/start at the subscriber level)
In this use case, the Data Event Monitor allows to stop or start the rule execution. When starting over, there is a need to collect all events that were missed during the time in which the rules were deactivated (similar to the bootstrap scenario).

Example implementations or realizations of the above data event monitor use-cases (i)-(ix), other than where self-explanatory, are now described.

i. Manage triggering rules subscriptions (add/remove subsections to pattern rules)

When monitoring data for new subscriptions, historical events may or may not be looked at, going as far back as is predetermined to be appropriate, according to the application. Subscriber accesses the subscription service. Subscriber may provide:
a. Pattern rule
b. Patient Indices, including the instructions for inclusion (population monitoring) or exclusion (population discovery).
c. Subscription Information (parameters for the pattern rules).
d. Ping Interval—What is the minimum time allowed between pings from the event monitor when triggering rules fire. This may be the anti-flood mechanism.

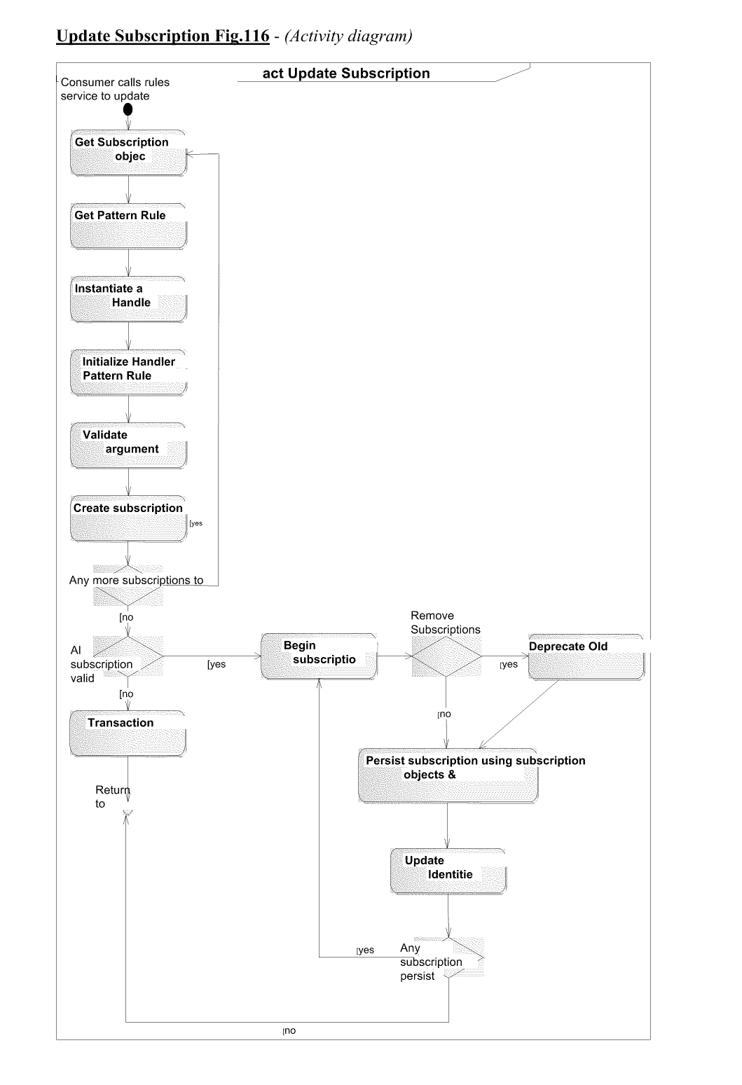

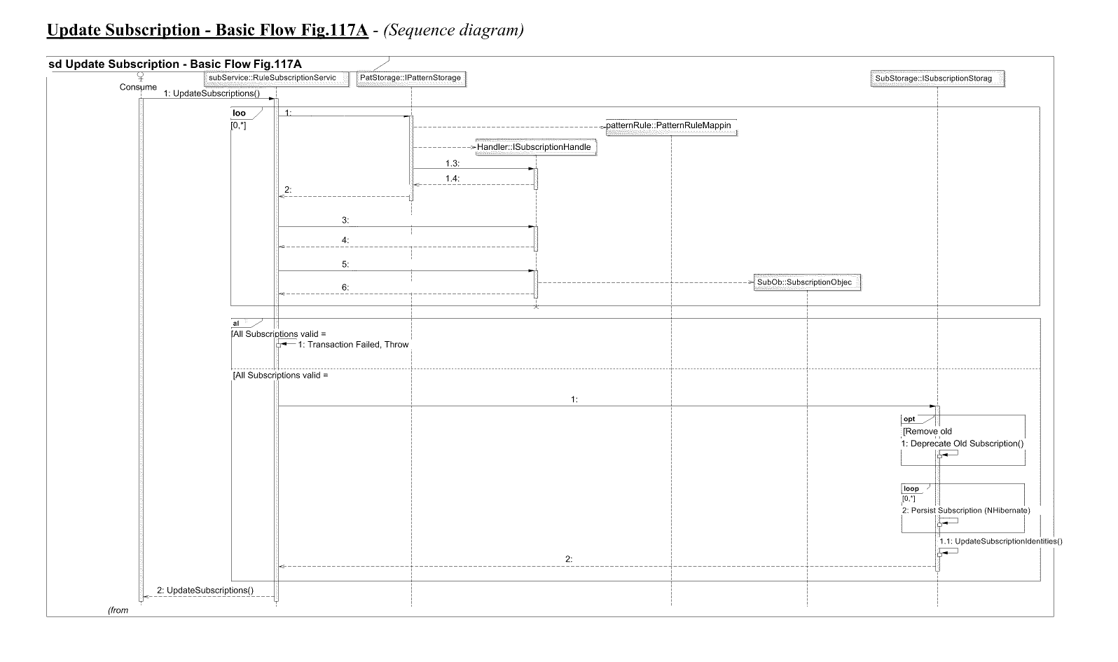

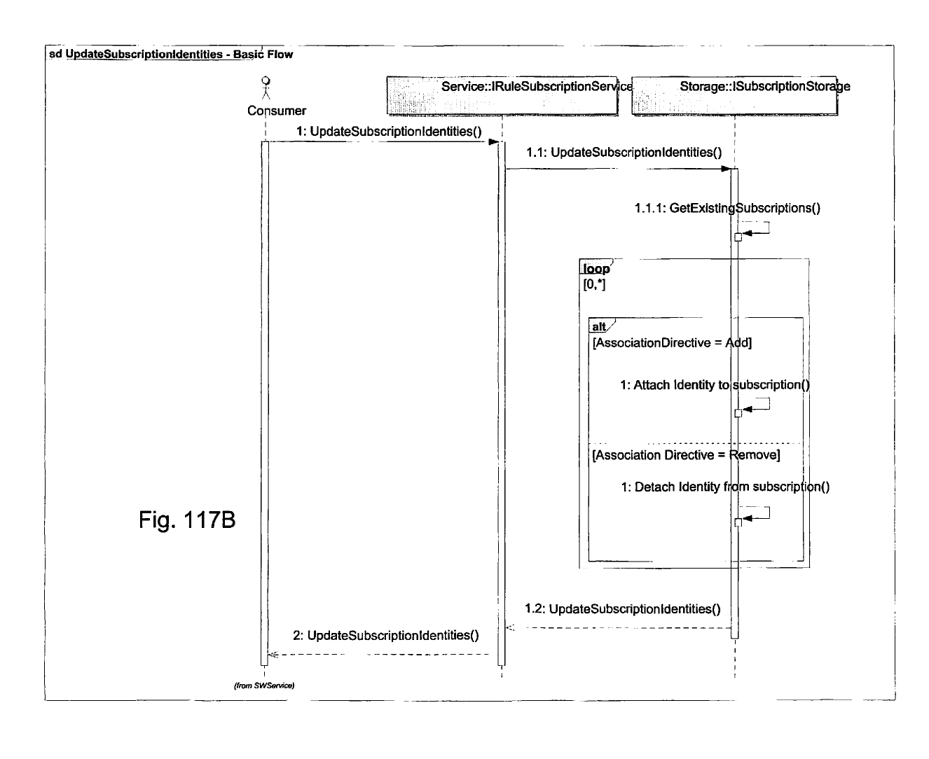

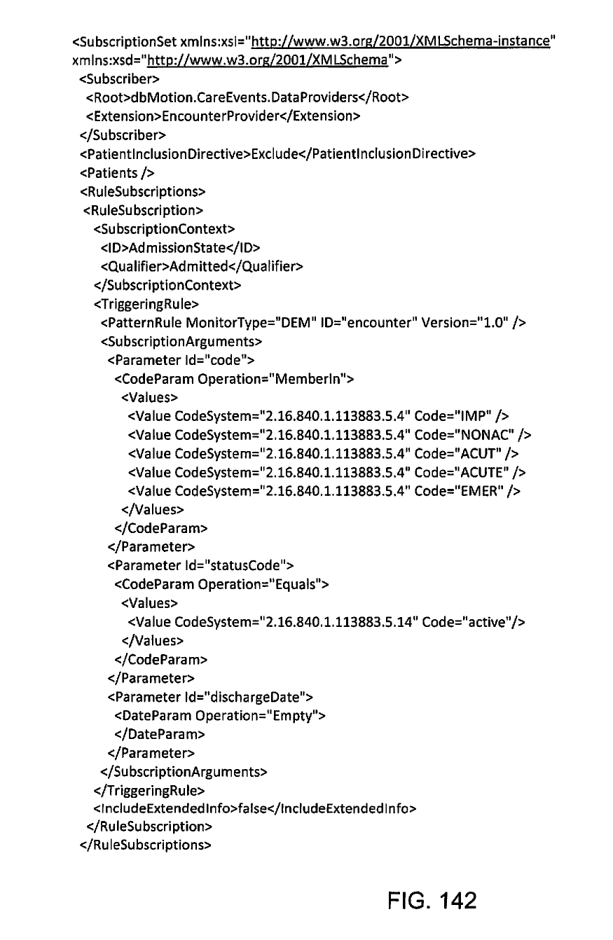

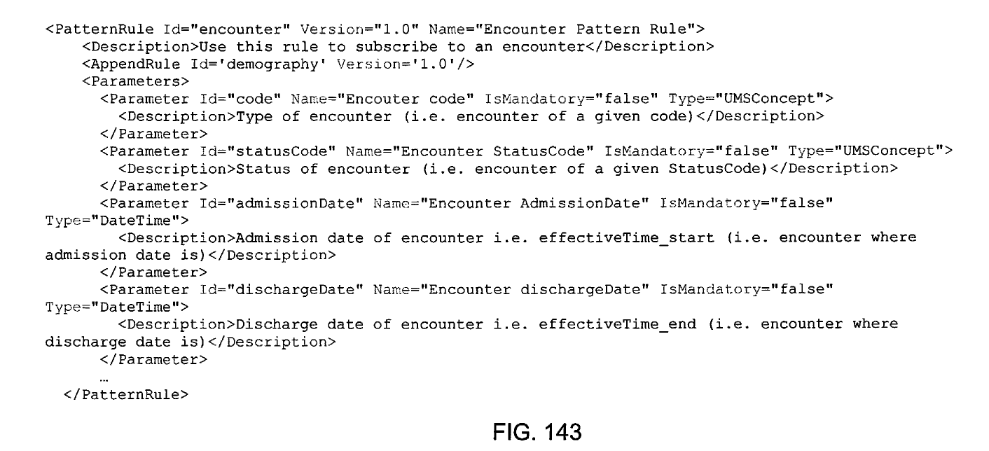

Processing may include the following operations:
a. Look up pattern rule.
   FIG. 142 is an example of a pattern rule comprising a subscription snippet, in XML format. FIG. 143 is an example of a pattern rule comprising a definition snippet, in XML format. It is appreciated that the above are merely examples of pattern rules which allow other suitable application-specific pattern rules to be developed analogously, and are not intended to be limiting, but are rather merely illustrative.
b. Validate subscription against pattern rules.
c. Detect triggering rule changes to existing patient—subscriber associations
d. Delete irrelevant triggering rules.
e. Persist the actual triggering rules: Include information that may allow subscriber to later pull results with desired levels of granularity, such as SmartGuard, classification, task, member. The event monitor may mirror this type of information in the results.
f. Attach patient ids to the triggering rules for inclusion or exclusion.
g. Begin monitoring data for these rules.
Updates may be performed, e.g. as illustrated herein the diagrams of FIGS. 116-117A.
Deprecate triggering rules from patients (cease using these, without actually deleting them), e.g.:
   a. Receive subscriber id, member id, triggering rule, task, classification code, pattern rule parameters.
   b. Get subscription handler for that rule.
   c. Deprecate the rules in the database.
      ii. Maintain Subscription's patients and indices e.g. as illustrated in the diagram of FIG. 117B. Typically, the following occurs:
a. Consumer notifies Subscription Service that there are EMPI (Enterprise Master Patient Index) changes for a member. Update the patient indices in the patient subscription tables.
b. Consumer notifies Subscription Service that a member may be added-to, or removed-from a subscription. Add/Remove the member association to the subscription.

Historical events may or may not be looked at for these scenarios, going as far back as is predetermined depending on the application. Reference is made in this connection to FIGS. 117A-117B which are diagrams illustrating a basic flow of UpdateSubscription and UpdateSubscriptionIdentities functionalities respectively.

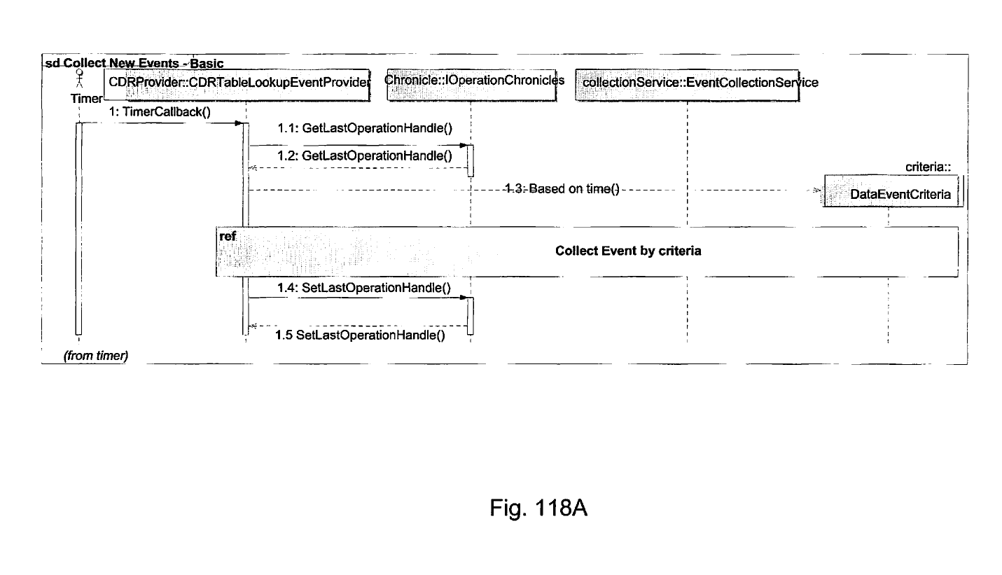

iii. Collect new events e.g. as per the diagrams of FIGS. 118A-118B. Event collection service manages all of the events that it gets from the providers. Providers work uncoupled from the Event Collection Service by knowing how to collect data from whatever source they are in charge of Modes may include a Push mode which is operative to receive data from source in real-time (ala CEBEventListener); and a Pull mode which is operative to retrieve proactively from source (ala CDR).

At a desired frequency such as once per half hour, new events are collected from the source using a suitable conventional event collecting functionality such as the TableLookupEventProvider or OnlineCommandEventLoader Functionalities mentioned in FIG. 118A. Record retrieval may be based on a sort of handle, which can be: timestamps, record number, or other identifier of the information source. Activation is time-based. OnlineCommandEventLoader adheres to the Online Source's policies. For example, proof may be demanded that the patient is actually being treated by a user of SmartWatch. The Event Provider maps the new event data into the object model, and passes the object(s) to the Event Collection Service. Events are stored in an event table, based on a suitable event object model such as the example illustrated in FIG. 140. Events receive a batch number from the batch manager. The Process Events use case is initiated. FIG. 118A is a diagram of a basic flow of a new event collection functionality. FIG. 118B is a diagram of a basic flow of a by-criteria event collection functionality.

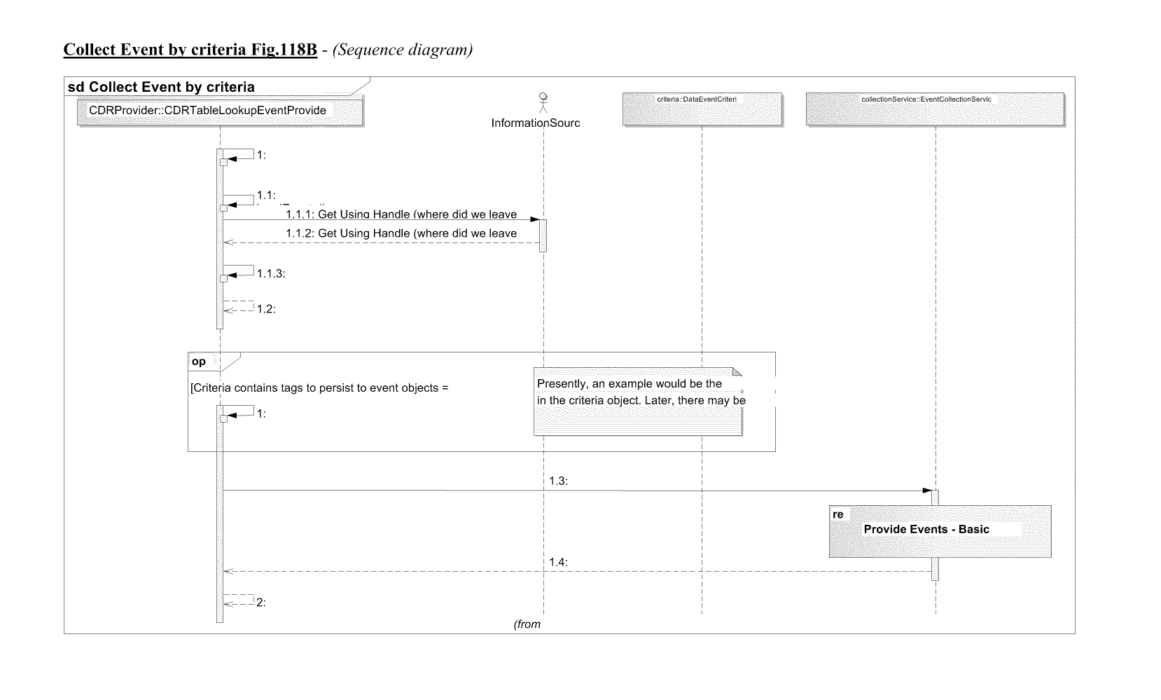

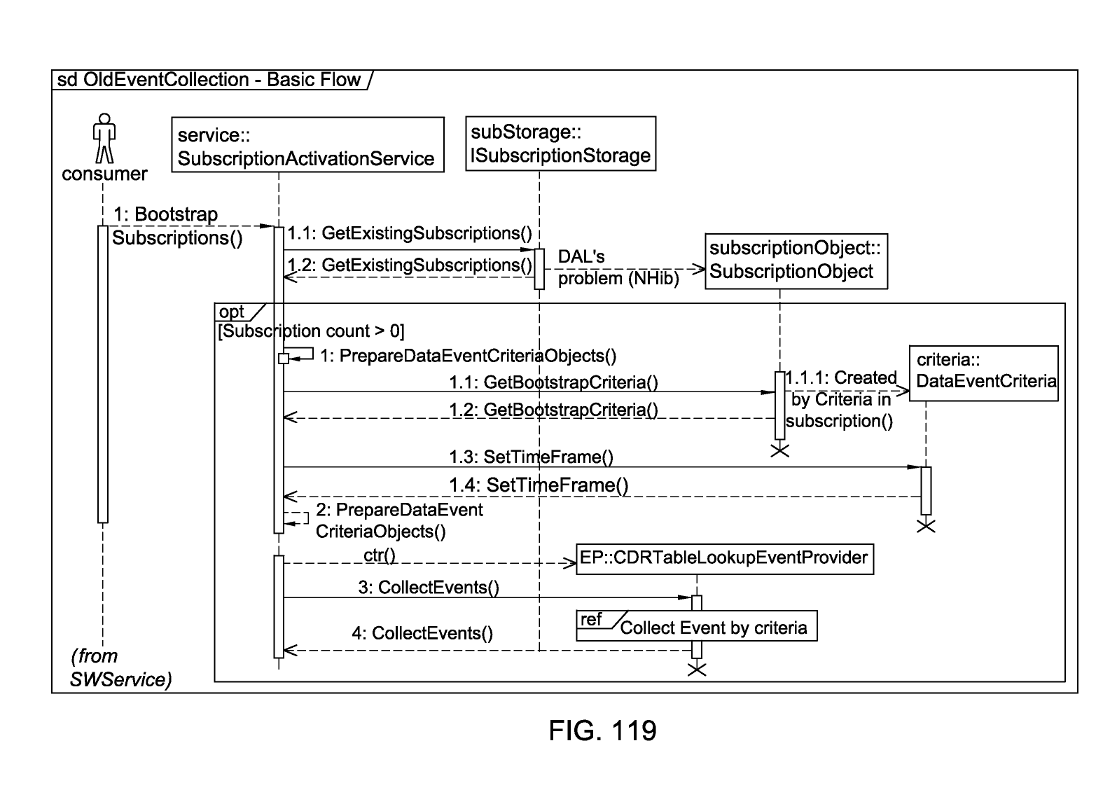

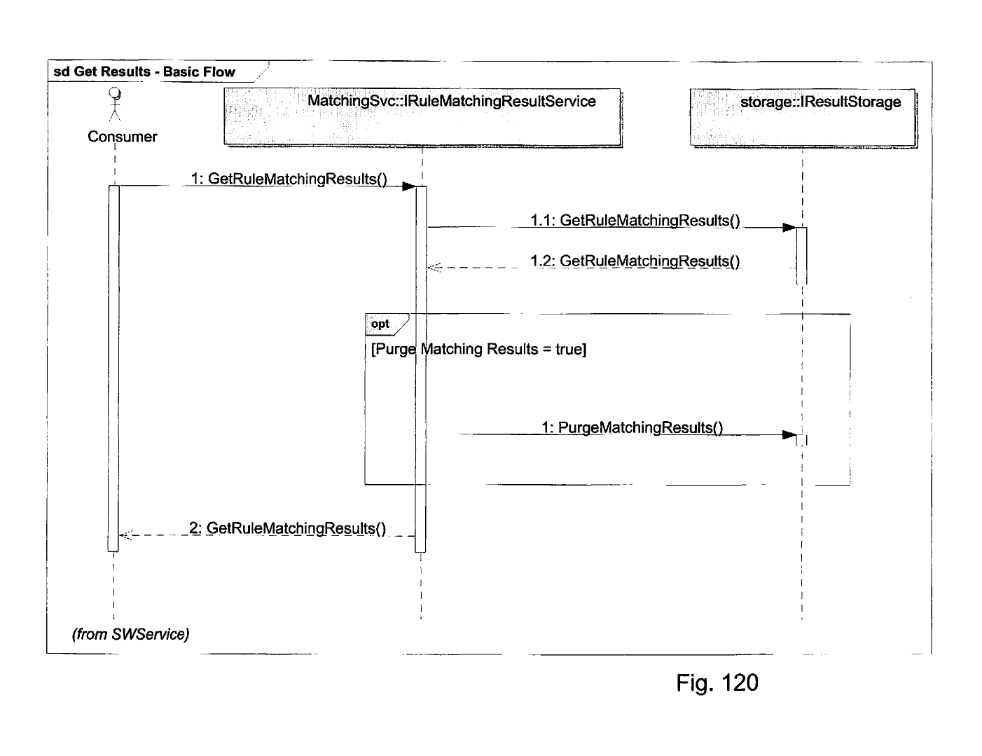

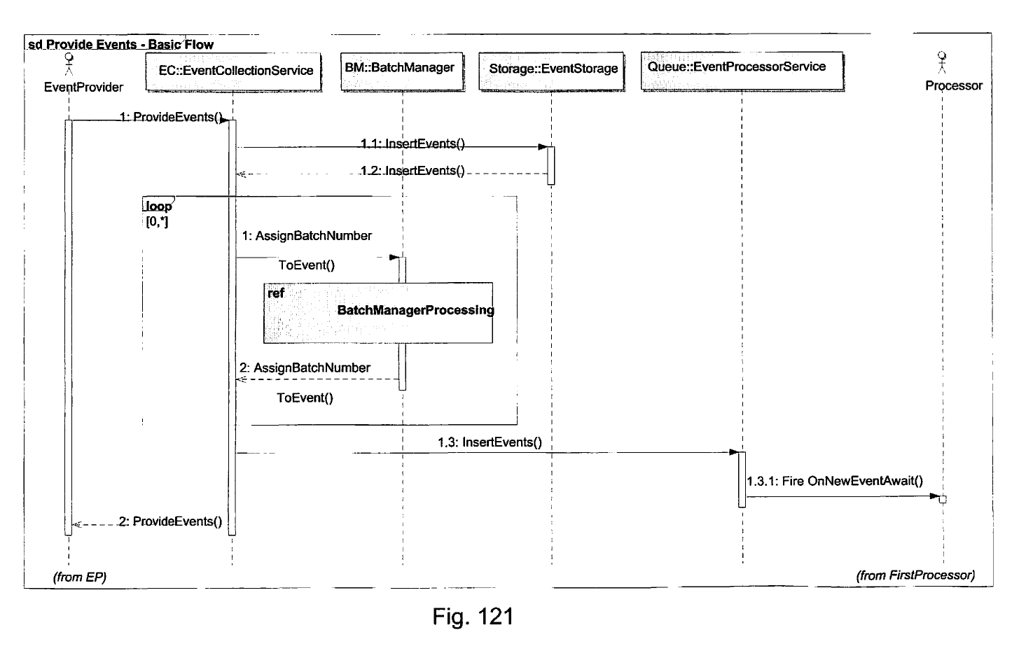

iv. Collect old events (also termed herein “bootstrap scenario”), e.g. as per the diagram of FIG. 119 which illustrates a basic flow for an old event collection process. Typically, consumer instructs Data Event Monitor to collect and process all data events based on a timeframe (issues a “Bootstrap” command). Note that the subscription may already exist separately before a Bootstrap is requested. All subscriptions for a subscriber are bootstrapped. Query the Data Provider for the events, typically by performing some or all of the following steps, suitably ordered e.g. as shown:
a. Use the DataEventCriteria object to define the event set.
b. Insert these into a suitably constructed event working table(s) tagged so as to indicate that the operation is for BootstrapSubscription ID X. Subscription ID links back to the Subscriber.
c. Get Batch ID from batch manager.
d. Harmonization and Matching proceed as normal, and when the “bootstrap” exclusion phase later runs within the matching processor, it may strip out any results for events that were triggered by any other subscription ID.
   v. Deliver results per consumer request (consumer pulls results), e.g. as shown herein in the diagram of FIG. 120. Results, when delivered, may be sent at the subscriber level, or at a more finer-grained level, such as results for a specific task for a subscriber. Consumer requests Data Event Monitor Service for results; the operation may include the following steps:
a. Consumer provides “bookmark.”
b. In the SmartWatch system, the bookmark is the batch number of the last batch that was Closed during the last results retrieval. When the Data Event Monitor is called for more results with this batch number, it increments the number, and provides results from batch+1 onward, to the new most-recently-closed batch.
c. Query Results table for tasks that fit the consumer's timeframe.
d. Only results in “Closed” batches are eligible.
e. Provide the requested results.
   vi. Notify Consumer of new results, typically including:
a. Continuously monitor the results database for undelivered, closed events. Ping subscriber if the minimum interval has passed since the last ping.
b. When the batch manager closes a batch, raise event that Batch X is closed.
c. Event Handler looks at every result, and identifies the subscription id's for subscriptions and the ping time, if any. Attempt to add subscriber to “ping list” along with when the ping may happen. Set a timer at the subscriber level so that the ping will sound when it is supposed to. If the subscriber is already on the “ping list”, then if the pinging interval for this subscription is supposed to happen sooner than the “time left” on the ping list for that subscriber, overwrite the entry on the ping list. Otherwise, do nothing.
d. When a timer pops up from the pinging list, ping the subscriber.
   vii. Process Events e.g. as shown herein in FIG. 121.

This Use Case is realized by the processor chain. As new data events enter the queue, a Harmonizer picks them up and harmonizes events, including some or all of:
a. Terminology Mapping
b. Unit of Measure (convert to baseline)
c. Split pertinent events into multiple events as appropriate.
d. Notify batch manager
e. Drop events from processing chain as appropriate.
f. Notify batch manager
g. Mark event as “harmonized” in the working event table(s).

A Matcher then performs some or all of the following operations:

a. Monitors its “working tables”, namely various tables where events are stored to be later “matched” against subscriptions in subscription tables.

b. Waits until any table fills up with X records (configurable), or until Y seconds (configurable) pass, whichever comes first.

c. Runs all pattern rule processors against the events in a table, and the subscriptions that work with those events. An example of a pattern rule processor might be a stored procedure in the working table.

d. Rule Processors are “keyed” in such a way as to say what working tables they support, and what subscription tables they support.

e. For discovery triggering rules, the matcher may compare the results against the members that the subscribers already have in the populations, and may remove these results from the final result set.

f. Another removal step is the “bootstrap removal phase,” where the matching processor removes results that were generated by subscriptions other than the subscription for which the event is keyed.

g. Another removal step is performed for deactivated subscriptions. This is typically performed as a separate step because patient monitoring rules abstract the individual patient when doing the matching, and only join them after the rule fires.

h. Results are delivered to the results table.

FIG. 121 is a diagram showing a basic flow for an event provision process operative in accordance with one embodiment of the present invention.

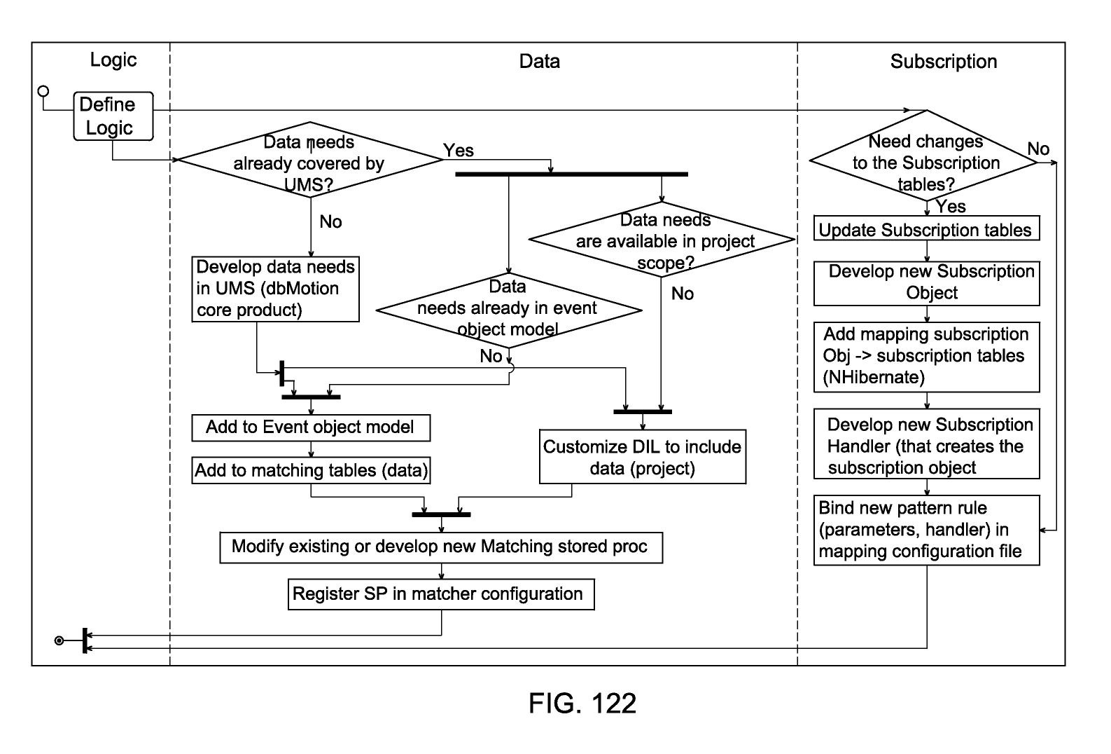

viii. Maintain pattern rules e.g. as shown herein in the diagram of FIG. 122.

a. A New Pattern Rule is designed, typically by a human operator and translated into a Rules Processor (for example, a stored procedure).

b. Determine what Event Working tables and Subscription tables the new pattern rule “works” with.

c. Create new Event Working tables and Subscription tables if appropriate.

d. Define the compatible data types for the operands in the triggering rules within any Rules Processor.

e. Map the results of this process to some tables used to expose the pattern rules and parameters they accept. Also map a handler for the subscription service to push subscriptions into the working tables, all e.g. as shown in the diagram of FIG. 122.

ix. Control rule execution (stop/start at the subscriber level)

a. Subscriber orders a “stop” for its subscriptions. This may affect all subscriptions that the subscriber has. Persist the “IsActive” field for each subscription object to false.

b. Consumer orders a “start” for a subscription. Persist the “IsActive” field for each subscription object to true. Operation may be similar to the bootstrap scenario described above.

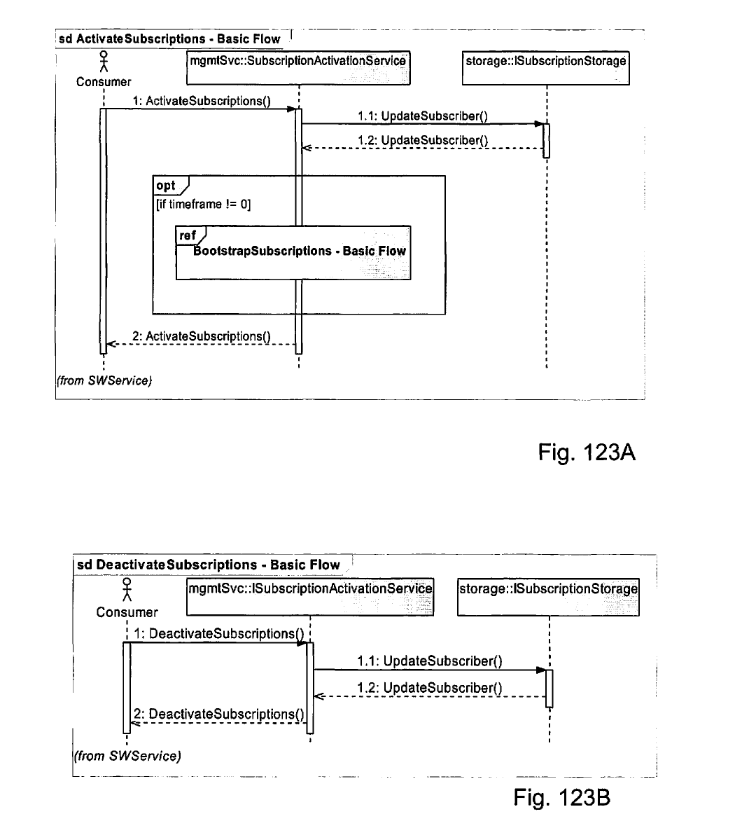

FIGS. 123A and 123B are subscription activation and de-activation basic flows, useful for implementing control rule execution use case (ix) according to certain embodiments of the present invention.

The SmartWatch Person Identity Service of FIG. 1A is now described, according to certain embodiments of the present invention, with reference to FIGS. 14-17. As described herein, SmartWatch is operative to achieve automated decision support focused around population with common characteristics. SmartWatch relies on the functionality of gathering clinical data from diverse systems. SmartWatch is designed to operate under a significant design constraint—the reality in which a patient does not have a unique identifier across the enterprise. To meet this constraint—SmartWatch communicates with conventional EMPI (Enterprise Master Patient Index) systems that know how to cluster patient identifiers (indexes) based mostly on probabilistic algorithms. The SmartWatch Person Identity Service serves as an arbitrator between SmartWatch and conventional EMPI systems.

The Person Identity Service is typically different to VIA, which is a commercial Virtual Identity Aggregation service provided by DBMotion, Israel. While VIA is an abstraction layer from concrete EMPI vendor implementation allowing dbMotion components to make an EMPI call using a unified API, Person Identity Service (PERIS), on the other hand, implements at least one additional functionality that is not part of the services proposed by EMPI vendors namely a subscription capability to effect changes in person identity.

The Person Identity Service is typically operative to:

a. receive EMPI (Enterprise Master Patient Index) clustering information about specific sets of people (patients) e.g. up to date cluster state information (on demand) and clustering changes information (publish subscriber pattern).

b. Mediate the above capabilities of an EMPI provider such as Initiate.

c. Minimize calls to EMPI provider. Since a central consumer of the service is SmartWatch—an automated system—the load may be significantly more difficult than human users making requests.

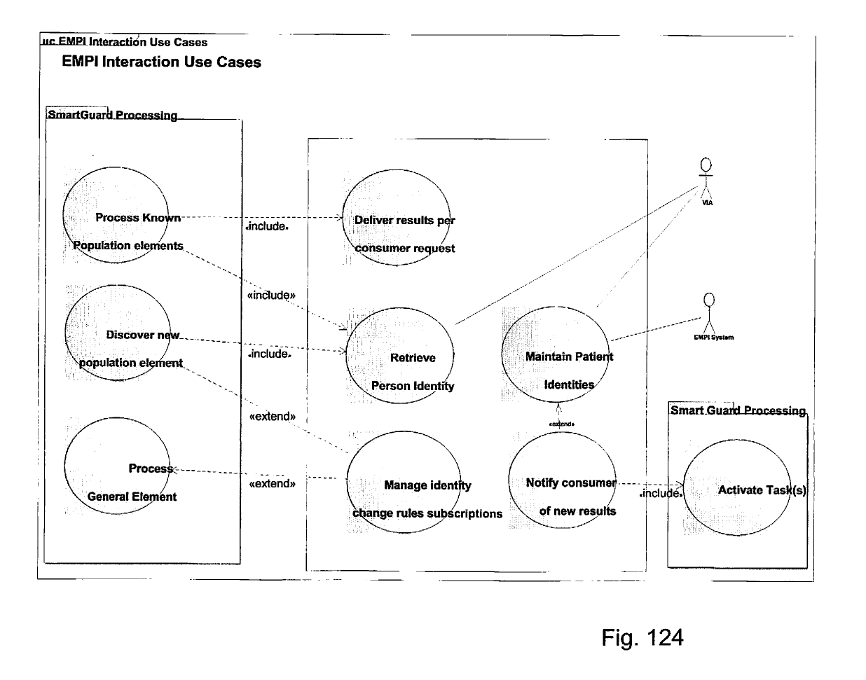

EMPI (Enterprise Master Patient Index) clustering changes over time is a constraint stemming from the nature of the distributed healthcare environment without a unique patient identifier. Since EMPI cluster changes, the service is operative to help its consumer(s) such as SmartWatch manages the information it keeps for the long run on patients, in various points in time, as such changes may change decisions being made. A Use-Case View of the Person Identity Service is shown in FIG. 124. Some or all of the following use cases may be provided:

i. Retrieve Person Identity (Cluster): When the system is requested by its consumer to retrieve a person current cluster—the set of indexes that are currently clustered together according to the EMPI (Enterprise Master Patient Index) provider. The entry point is an index, related to as the principal index, and the outcome is the set of indexes currently associated with it by the EMPI provider. Unlike search operations in VIA (a commercial Virtual Identity Aggregation service provided by DBMotion, Israel)—there is no human user making decisions—the EMPI provider is the sole authority according to which later decisions are made.

ii. Manage identity change rules subscriptions (ARM): Accept subscription changes from consumers, and reflect them in the subscription database. This may include new subscriptions and modifications to existing subscriptions. The subscriptions are meant to allow service consumers to be aware of changes to identity changes of persons (patients) that the consumer is interested in. For example, the consumer (SmartWatch Service) would like to be notified whenever EMPI (Enterprise Master Patient Index) system has made any change to a given patient of his (a member) such as join or split. The subscription includes a person index that identifies the person for the consumer and is also termed herein the “principal index”.

Use cases iii and iv are Deliver results use cases (ARM).

iii. Deliver results per consumer request (consumer pulls results): When a consumer requests for results from the service, this use case may provide those results. It is typically the consumer's responsibility to ask for the start and end points of the results.

iv. Notify Consumer of new results: “Pings” the consumer when there are results waiting.

This may be configured to only ping any given consumer at a certain interval (no more than once every 30 minutes, for example).

v. Maintain Patient Identities: synchronizes system's knowledge of person cluster state with the EMPI (Enterprise Master Patient Index) provider. Several workflows may be employed here, depending on the capabilities of the EMPI provider, on performance requirements and allowed latency. Workflows may include: receiving regular updates on all person identity changes from EMPI provider (push updates); receive a snapshot of the cluster database from EMPI provider (push snapshot); proactively request cluster state for selected person(s)—whose state was not checked for a relatively long period of time (pull proactively); or some hybrid of the above.

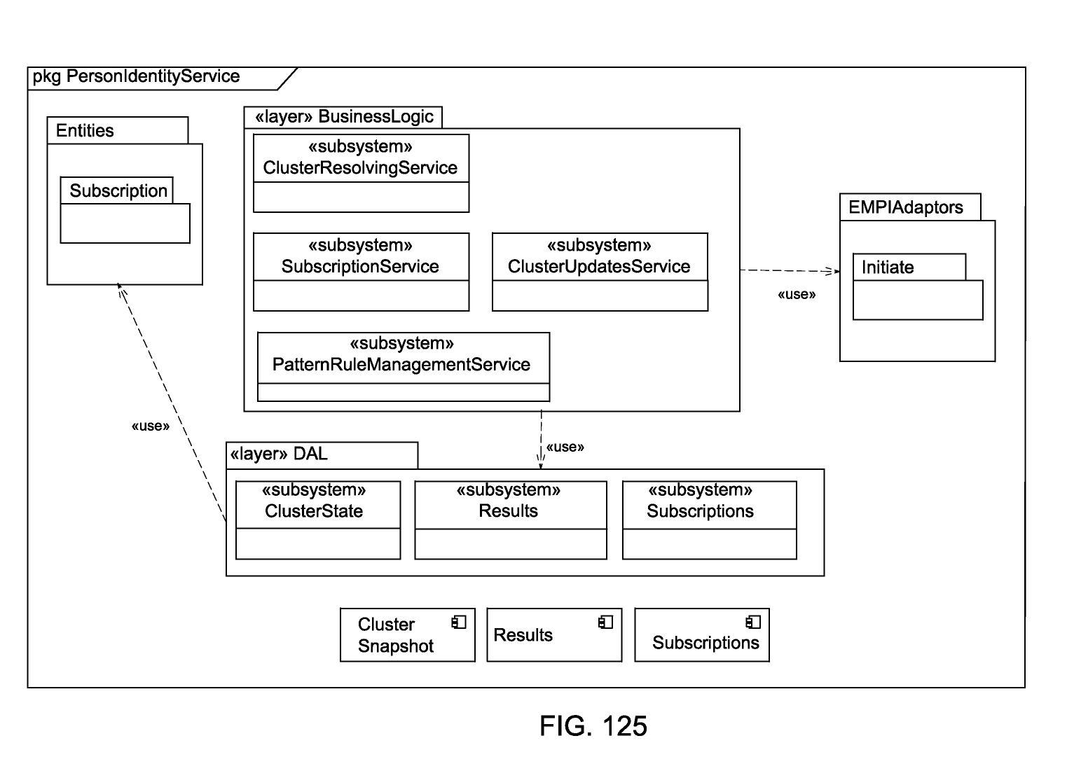

The diagram of FIG. 125 illustrates the significant design packages and subsystems of the service. The design packages of FIG. 125 typically include:

a. Business Logic Layer: implements the business logic and provides the services described above.

b. ClusterResolvingService: allows consumers to retrieve a person cluster which comprises a set of indexes that currently represent the same person according to an EMPI (Enterprise Master Patient Index) provider. This call may yield a call to EMPI provider (EMPI-Get), but may also be resolved within the service itself, in the case the cluster is already known and reasonably up-to-date. Consumers may specify a time interval, which defines what reasonably up-to-date means from their perspective.

c. ClusterResolvingService: a service which allows EMPI (Enterprise Master Patient Index) providers, or some mediator process on their behalf, to communicate clustering changes to the system.

d. SubscriptionService: implements publish subscriber pattern, allowing consumers to subscribe to identity change rules for selected people that they are interested in. The subscription includes a principal person index as the identifier of the person of interest.

e. Data Layer: A layer which handles the storage of the various entities in order for the system to function. Entities to be stored may include Subscriptions & subscribers (people of interest to subscribers); Indexes and their current clusters; and Results (i.e. indexes which changed and the subscriber relations.)

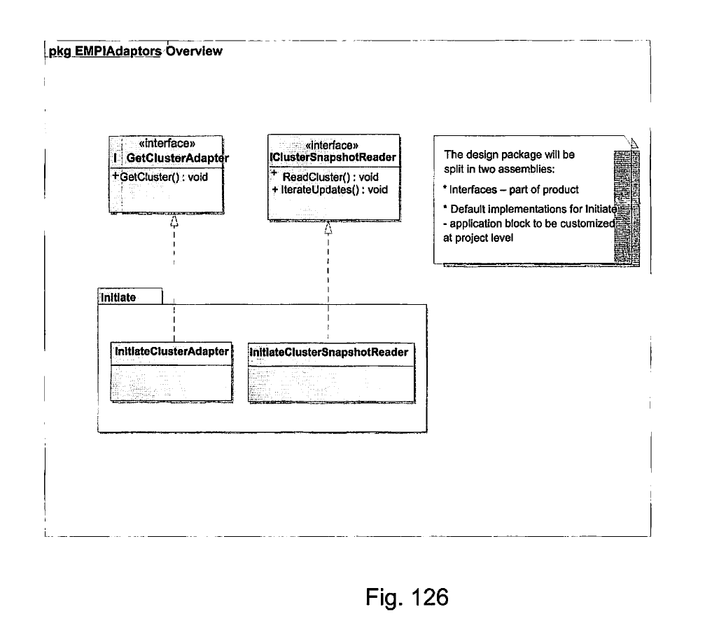

f. EMPI (Enterprise Master Patient Index) Adaptors: A package (typically a shared dll), overviewed in FIG. 126, which contains interface as well as an out-of-the-box adapter operative to retrieve a cluster from the EMPI provider. The EMPI adaptors package abstracts away from the system the exact details of how a “get” operation that retrieves a cluster given an index is performed in the specific project. The implementing classes may be customized at the project level to accommodate the different EMPI configurations at different customer sites.

Example implementations or realizations of the above use-cases are now described, except where self-explanatory.

i. Retrieve Person Identity (Cluster): a call is made to ClusterResolvingService. Within such a call the service may first check whether the cluster can be found at the DAL, and whether it is “fresh” enough for consumer requirements if any. If not, the cluster is retrieved from EMPI (Enterprise Master Patient Index) provider, stored and returned to consumer. In parallel, this starts an analysis process of cluster changes by the changes manager, one embodiment of which is illustrated in FIGS. 127A-127B.

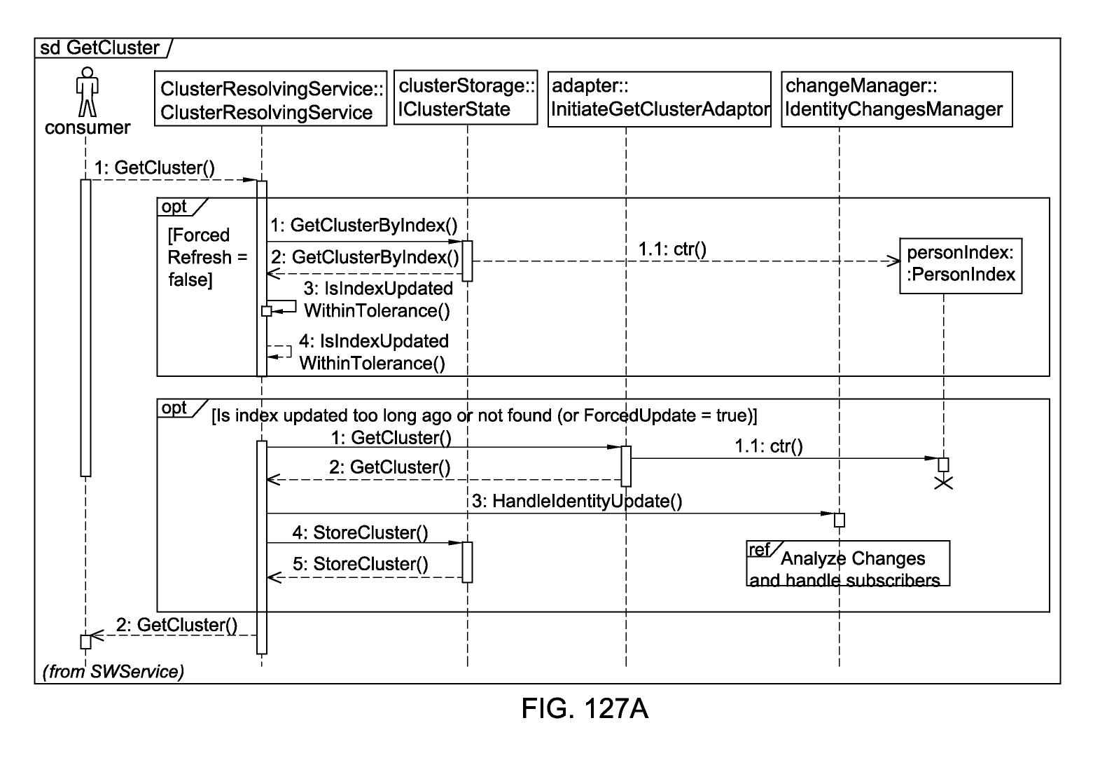

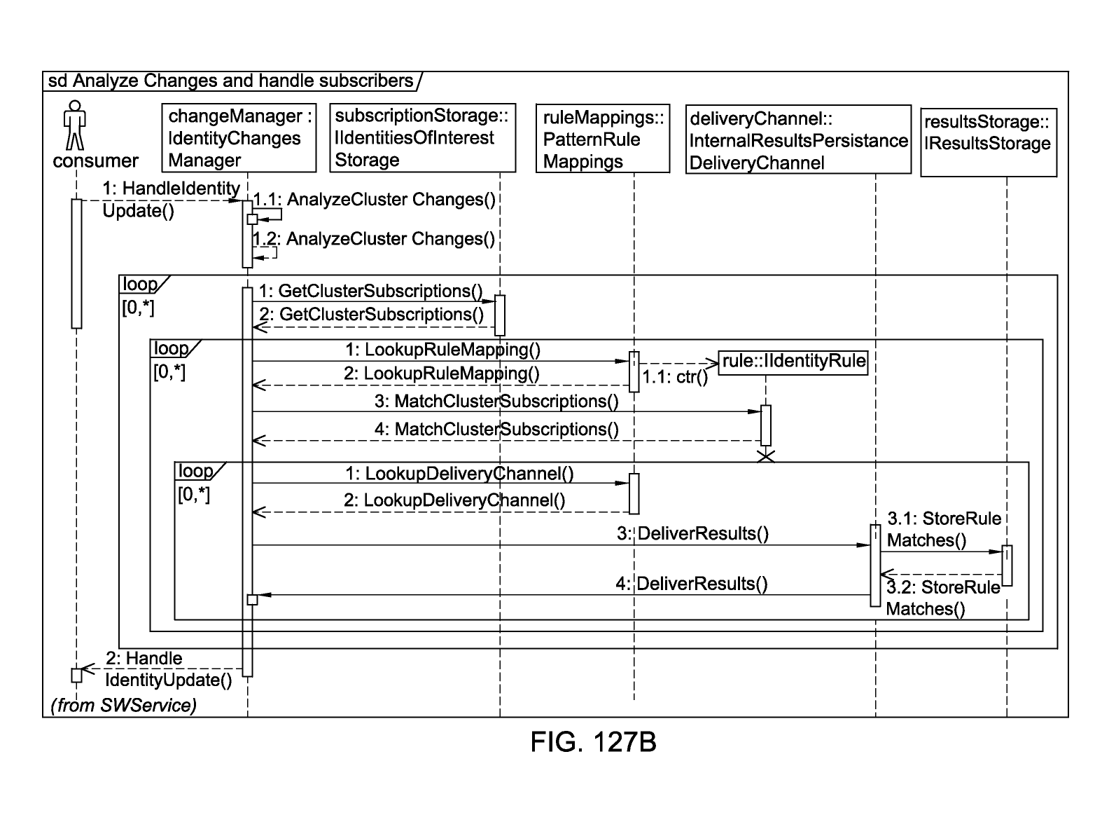

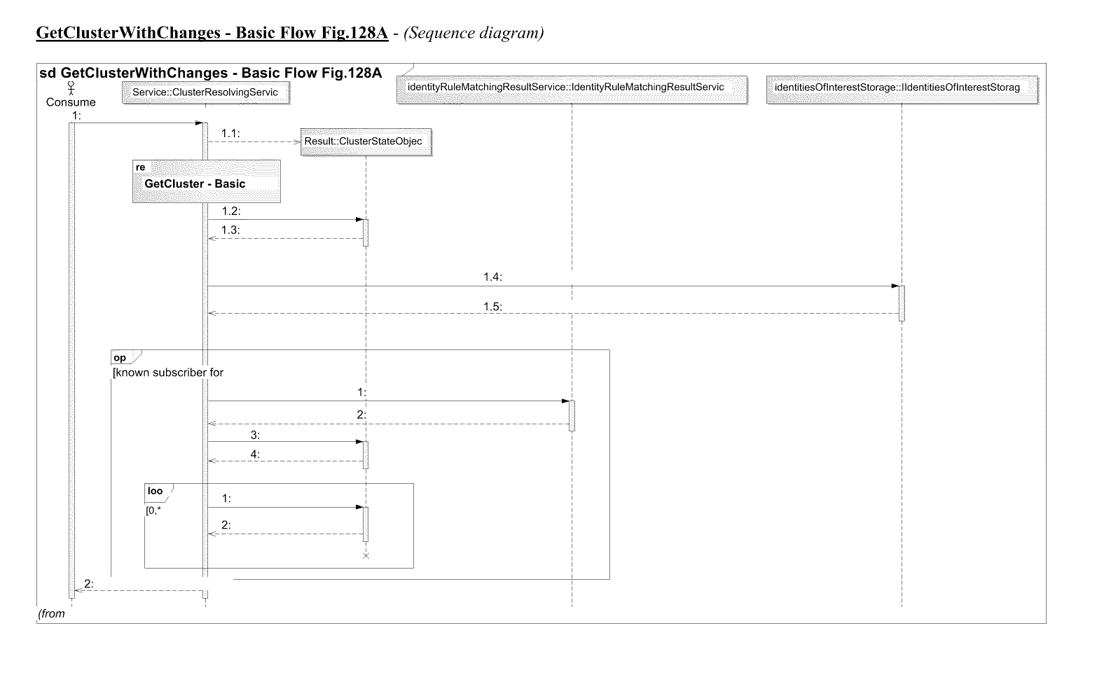

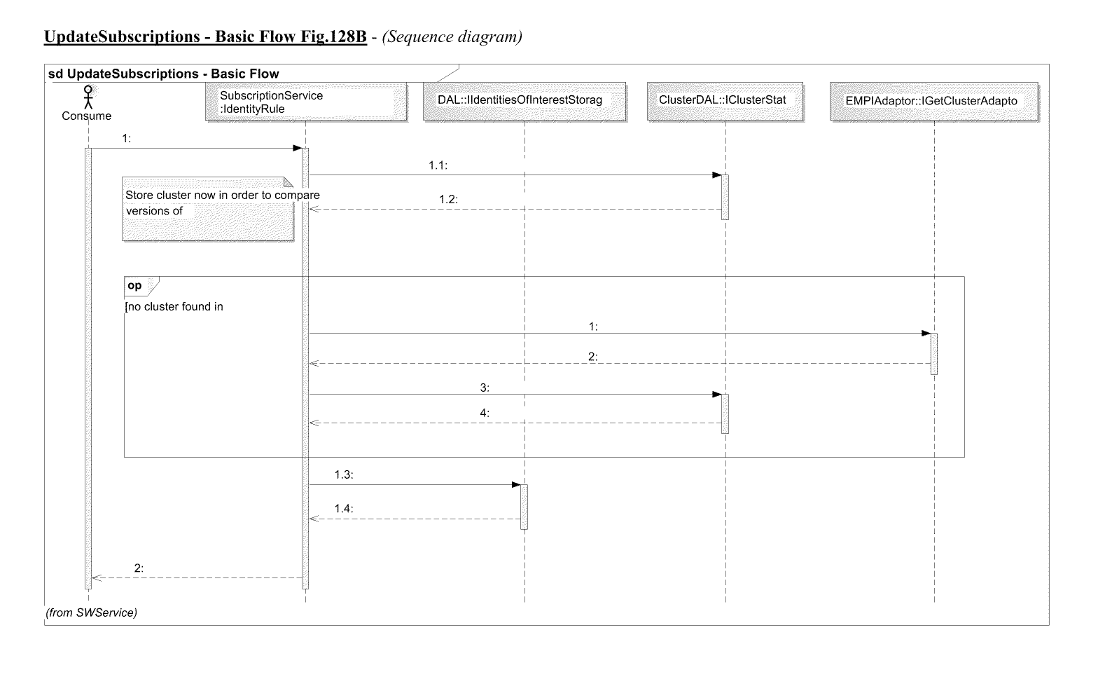

An alternative flow, as shown in FIGS. 128A-128B, is returning the cluster together with changes being made that the consumer (also a subscriber) may be aware of. In this case the consumer supplies also subscriber id and a handle (timestamp or record number) to retrieve results by, the handle typically representing the latest knowledge of consumer for the given person.

ii. Manage identity change rules subscriptions (ARM): An UpdateSubscriptions call is made to Person Identity Service's Subscription service. The service “persists” the subscriber, with its person interest in its subscription storage; typically this involves the service saving the subscription, comprising a subscriber or patient to be monitored, in storage.

v. Maintain Patient Identities: An example proactive flow is illustrated in FIG. 29. The proactive flow of FIG. 29 is significant when the EMPI (Enterprise Master Patient Index) vendor is unable to push updates to the system. It is realized by a call from a scheduling system to the ClusterUpdatesService typically under a suitable specialized interface termed herein ProactiveClusterUp dates Service.

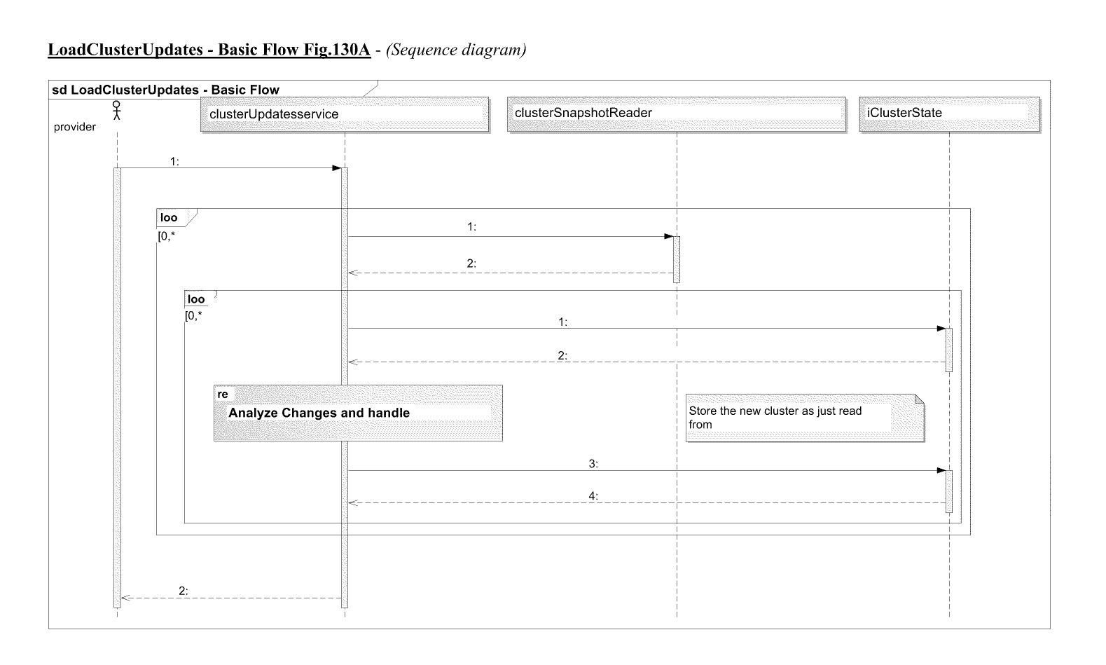

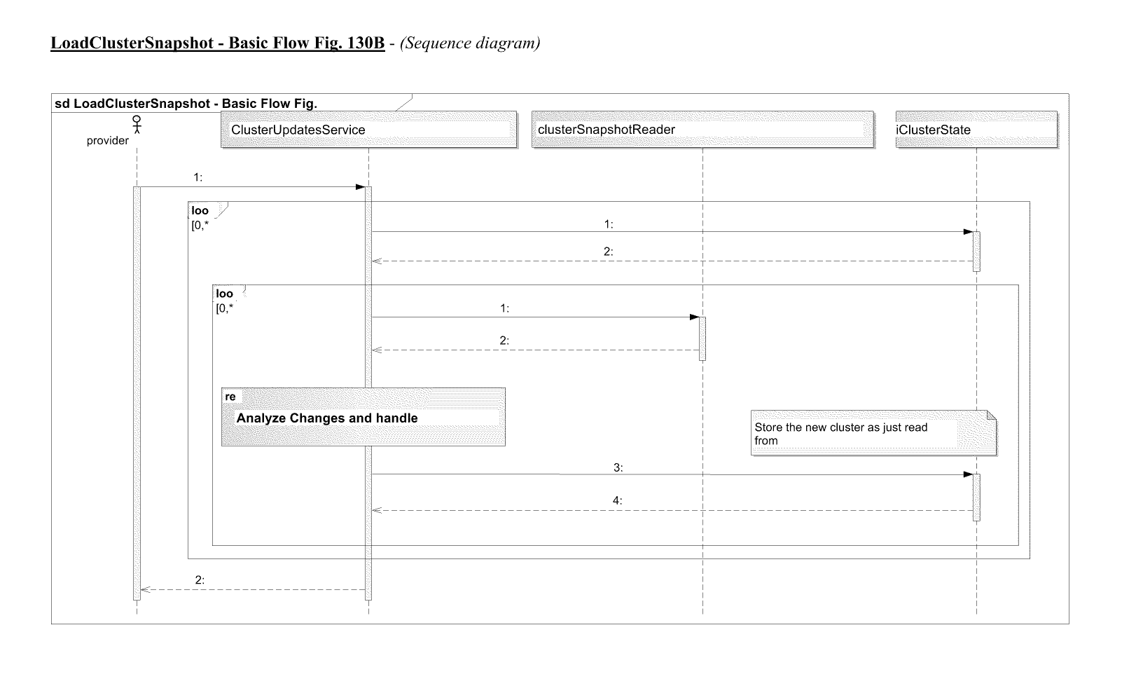

The passive flows (pushes from EMPI (Enterprise Master Patient Index) provider or a mediator on their behalf) are realized by calls to the ClusterUpdatesService, as illustrated in FIGS. 130A-130B. The proactive flow (main flow) is realized by an internal process which looks for persons whose identity is outdated and queries them with EMPI vendor to update the system knowledge of the cluster state.

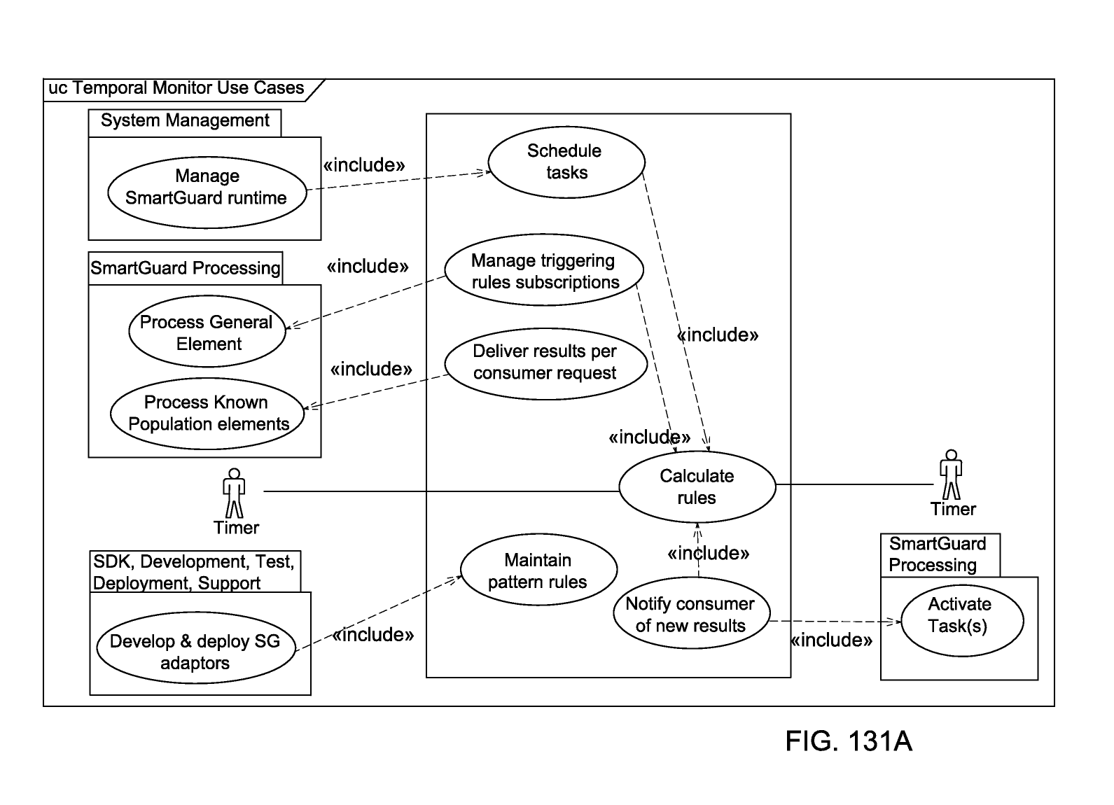

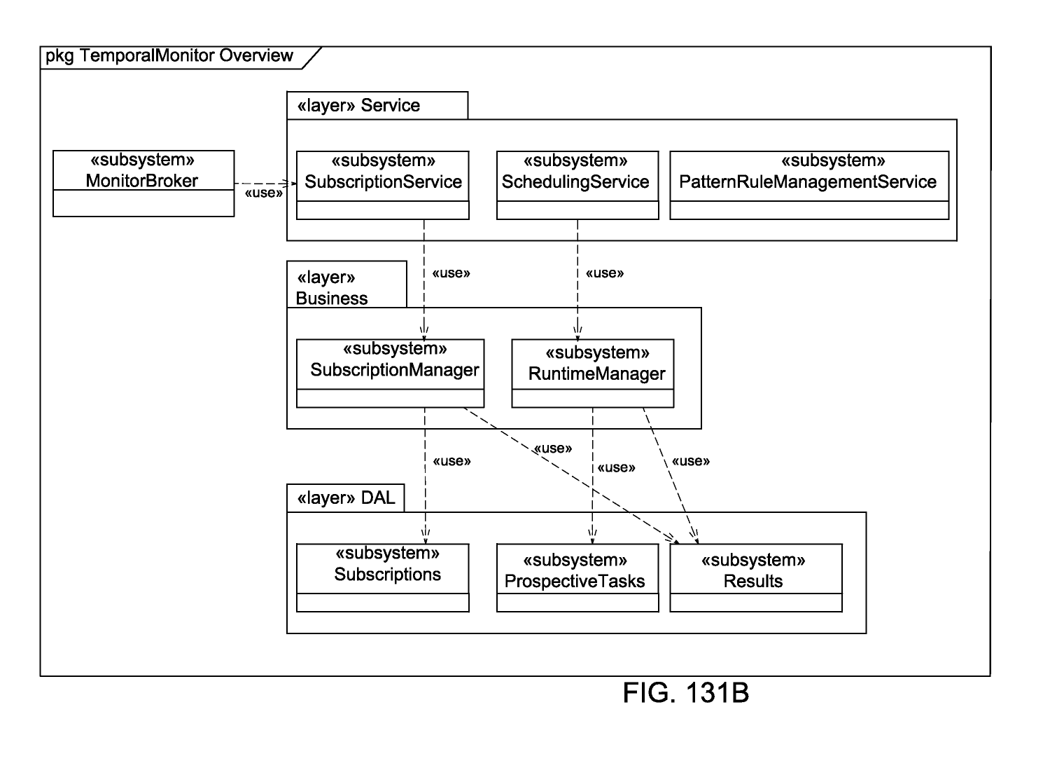

According to one centralized embodiment of the present invention, PersonIdentityService is deployed in one node and SmartWatchService(s) calls it remotely. According to another distributed embodiment of the present invention, wherever an individual SmartWatchService is deployed, PatientIdentityService is deployed as well, serving only that individual “local” SmartWatch system. The two embodiments may be suitably combined. The SmartWatch Temporal Monitor is now described, with reference to FIGS. 131-134. Typically, the monitor creates a component to facilitate SmartWatch execution of event driven tasks. The monitor typically provides mechanisms for subscribing, publishing, and delivering the results using a pull and push model, all without losing results and without pushing results to wrong consumers.

A Use-Case View of the SmartWatch temporal monitor is provided in FIG. 131A. An overview thereof is provided in FIG. 131B. Use cases of the temporal monitor may include some or all of the following:

i. Manage triggering rules subscriptions: The use case starts as a result of the “Process Population Element” use case, usually when the monitoring criteria is fired for a population member. According to SmartGuard definitions and business logic, SmartGuard Service requests the Temporal Monitor system to subscribe for one or more triggering rules.

ii. Schedule Tasks: The use case starts with the “Manage Guard runtime” use case, when a guard is activated. At that time, typically, the system ensures guard tasks are being run according to schedule defined within the guard. The system would subscribe these requests similar to i. Manage triggering rules subscriptions use case.

iii. Calculate Rules: This use case is triggered by a timer when the time calculated based on a subscription triggering rule elapses. The elapse time event triggers a workflow typically including some or all of the following steps:
a. Populates the results repository with new data b. Using the subscription's triggering rule calculates the event's next occurrence
c. Updates the prospective tasks repository with the new calculated event occurrence
d. If the subscription delivery preference is to use a push method the results are pushed to the URI specified by the consumer
e. If the rule's calculated number of occurrences or the subscription's end date are reached, the subscription is removed

iv. Deliver results per consumer request: This use case starts as a result of receiving a consumer request for getting results delivered after the execution of prospective tasks scheduled based on the submitted by the consumer triggering rules. The system searches the results repository using the criteria specified by the consumer. The use case ends as the system delivers the results.

v. Notify consumers of new results: The use case starts when the calculated subscription triggering rule fires and the subscription delivery preference is to use a push method. The results are pushed to the URI specified by the consumer. The use case ends as the system delivers the results.

FIG. 131B is a logical view of the temporal monitor according to certain embodiments of the present invention. As shown, the temporal monitor typically comprises a service layer which exposes services and/or packages to its consumer e.g. SmartWatch, such as one or more of the following services and packages:

a. SubscriptionService: service which provides functionality for managing the subscriptions and delivering the results to SmartWatch as a consumer.
b. SchedulingService: façade that allows consumers (SmartWatch service) to store and remove subscriptions. Receives a scheduling request, validates it, and stores it into the subscription repository.
c. PatternRuleManagementService: A service providing functionality for managing the Temporal Monitor triggering rules used by the system to create the subscription's prospective tasks executed by business layer at runtime.

A Business Layer encapsulates the Temporal Monitor business logic exposed as subsystems. The subsystems include internal service providing functionality for managing subscriptions, monitoring execution of prospective tasks based on the subscription's triggering rules, and delivering the results to the consumer. Functionalities which may be provided may include one, some or all of the following:

a. SubscriptionManager: responsible for managing the subscription's lifecycle. Also the subsystem notifies the Runtime Manager subsystem of new subscriptions that need an initial prospective task to be stored in the prospective tasks repository and are ready for execution.
b. ResultManager (not shown): delivers results per user request or pushes the results to a consumer defined location (URI).
c. RuntimeManager: Subscribes for notification events coming from the Subscription Manager subsystem or a prospective task elapsed time event. A business logic is applied to each event and a set of actions is executed. The next RR occurrence is computed and results are pushed to consumers.

A Data Access Layer (DAL) manages database access for the business layer.

Example Implementations or realizations for the temporal monitor's use cases are now described, except where self-explanatory:

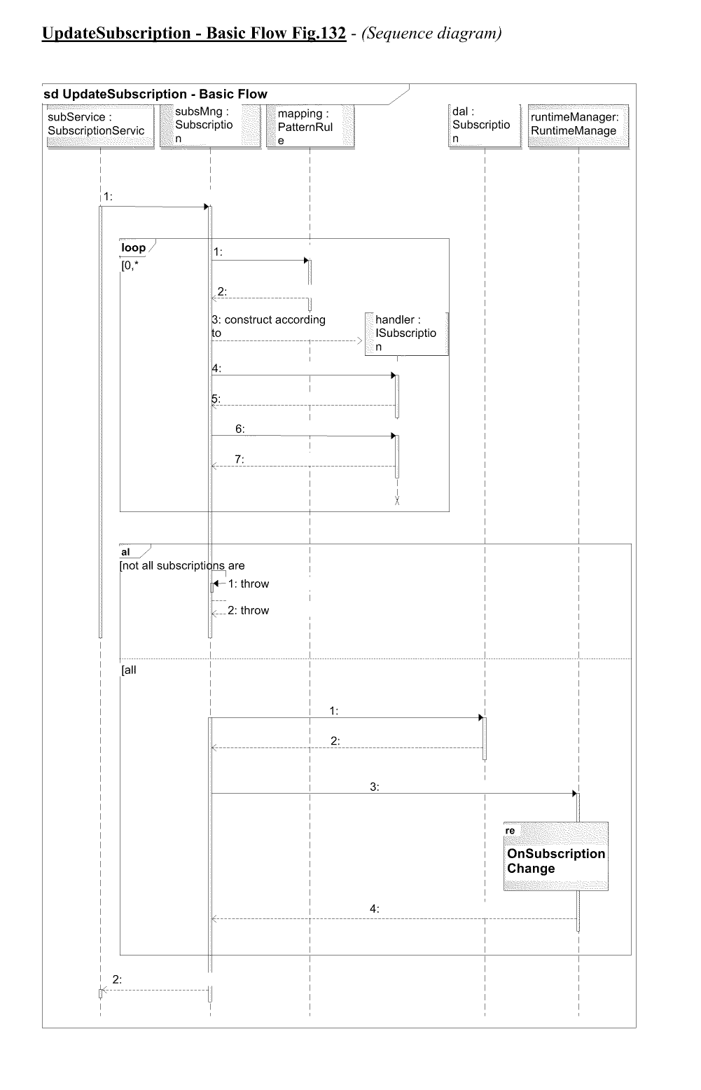

i. Develop SmartWatch Triggering Rules Subscription Workflow: This may be a non-automated process effort e.g. as shown.
ii. FIG. 132 is a diagram showing the basic flow of the Update Subscription functionality also termed herein the “schedule tasks” functionality. The workflow is operative to manage triggering rules subscriptions. The system receives a set of triggering rules subscriptions including the results delivery preferences (pull or push method). The subscriptions are validated based on predefined business logic and stored in the subscriptions database. The use case ends after the subscriptions are saved and a new Subscription Event is fired for all new subscriptions entering the system. The event triggers the execution of a workflow that calculates the triggering rules e.g. as described herein with reference to the iii. Calculate Rules use case iii of the temporal monitor. This results in creation of a new record in the prospective tasks repository and if the time of the new prospective task is closer than the “closest event” time held so far, the time is reset to the new prospective task's time.

This core use case typically employs the service, business, and data access layers. The steps involved in this use case are outlined in the sequence diagram of FIG. 132. After receiving a subscription request, the Subscription Service calls the subscription manager which performs subscription rule mapping, after successful subscription arguments validation the Subscription Manager constructs a subscription object which is passed to the Temporal Monitor data access layer. In case of a validation error, an exception is thrown describing the type of error.

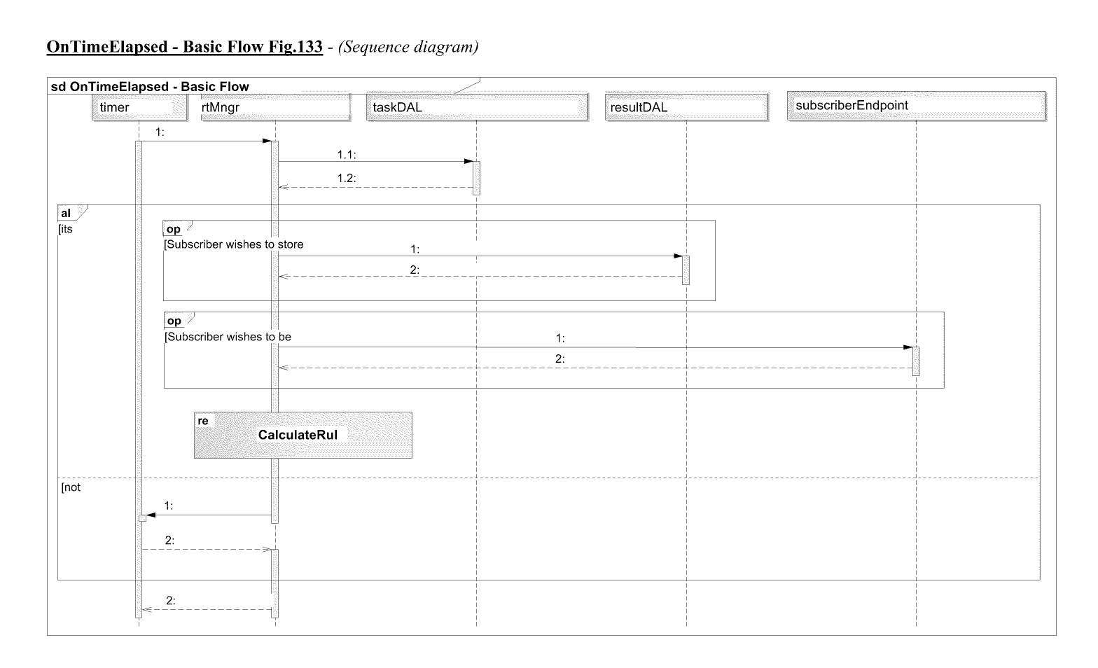

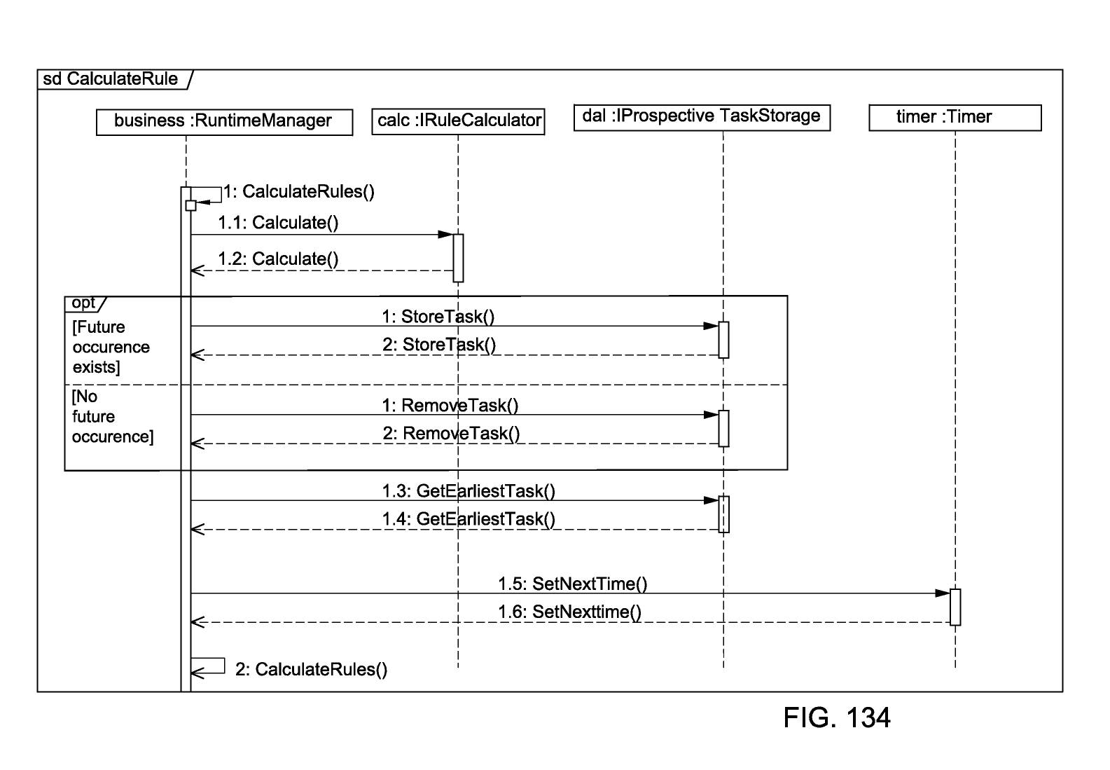

iii. Calculate Rules: This use case is triggered by a timer when the time calculated based on a subscription triggering rule elapses or when a triggered subscription change event is fired by the Subscription Manager. Steps which may be included in this use case are illustrated in the sequence diagrams of FIGS. 133-134 and may include some or all of the following steps:
a. The Runtime Manager gets the prospective task associated with the triggering rule.
b. Based on the subscriber's delivery preferences, the system stores the results into the Results database ready to be retrieved by the subscriber, or pushes the results to the subscriber ResultAwaitCallback service.
c. The Calculate Rule workflow calculates the next occurrence and saves it in the Prospective Tasks database.
d. After rule computation, in case of no future occurrence, the task is removed.
e. Runtime Manager retrieves the earliest task from a prospective tasks database and sets the next time on the timer.
   iv. Deliver results per consumer request: In this use case the service would retrieve results from its result data base, based on the parameters supplied to it in the request (ARM compliant). The bookmark in this case is a timestamp.
   v. Notify consumers of new results: This use case is based on a callback to the subscriber, to a URI specified at subscription time. Based on subscription time preference, the results may be stored in the DB for the subscriber to pull them (ping mode) or just sent directly (push). The push mode is expected only for scheduling service subscription (in which the subscriber wants a “wake up call” but would not need to pull any information past that).
   vi. Maintain pattern rules: This may be a manual process, performed by a developer who defines new triggering rule parameters, writes a handler that would know how to construct the proper subscription object from the input parameters, and registers the new rule.

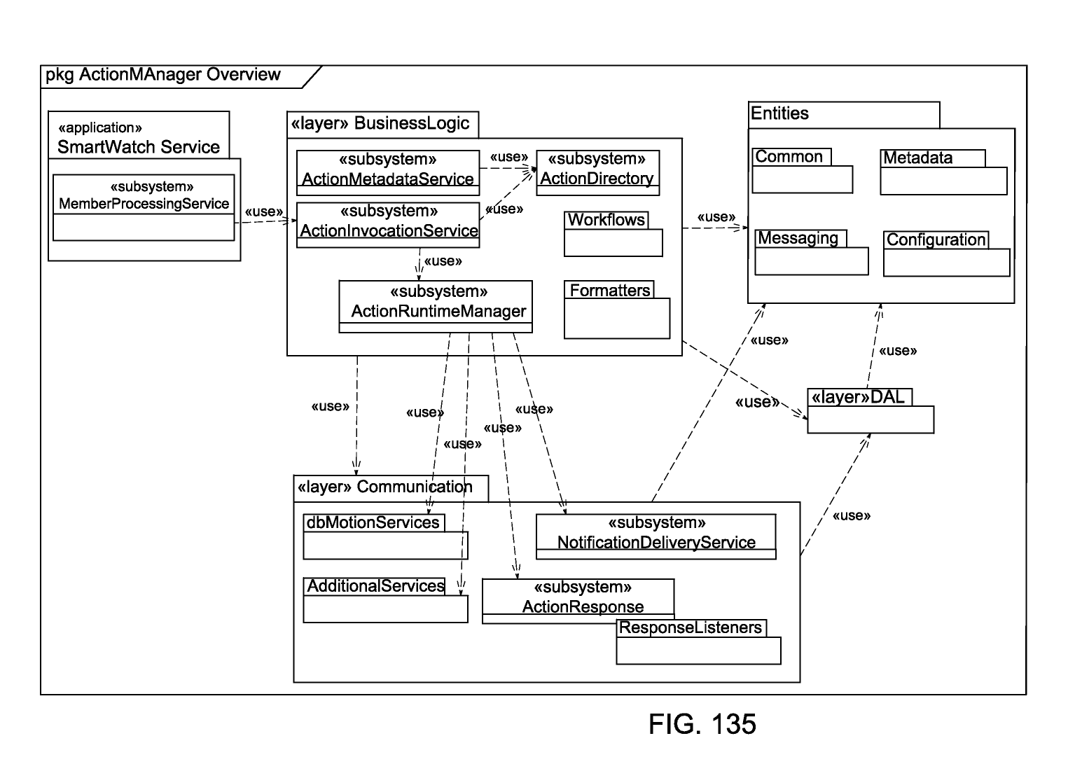

Referring now to FIGS. 135-137 inter alia, the Action Manager carries out SmartWatch recommendations to the outside world by notifying human users or other systems about SmartWatch findings. The Action Manager Provides flexibility to PS developers in creating mechanisms to fit the specific client's policies and needs, including message structure, format and look & feel, channels, schedule, workflows. This lowers the cost of project implementation by promoting quick development cycle of (sometime complex) actions to meet a specific client's need (project versus product). Typically, integration with the customer's current clinical workflow is seamless and the end consumer typically receives the messages within his day-to-day operational systems. Implemented actions follow up on sent notifications to “close the loop” and ensure notifications are being appropriately used, including a notification consumers' feedback mechanism that would allow continuous system improvement and system tune up. Typically, messages and notifications are not lost, notifications cannot be sent to wrong recipients, and message replays are allowed in the event of system error.

Action manager use cases may include some or all of the following:

i. Develop SmartWatch Action Workflow: developer develops a new action workflow to support client needs.

ii. Execute action: starts as a result of the “Process Population Element” use case described herein, usually when the monitoring criteria is fired for a population member. According to SmartGuard definitions and business logic, SmartGuard Service requests the Action Manager system to execute one or more Action Workflows. The Action Workflow collects appropriate information, creates a notification message, decides on the Delivery Channel, formats the message to fit the Delivery Channel, and sends the message through the channel. The end result includes sending a notification message to an Action Recipient, which can be either a Care Provider or a Action Receiving/Responding System.

This Use Case describes the available activities that can be used to create an Action Workflow. For example, Action Workflows can be developed in order to send e-mail or SMS, to add a record to a database/CDR, to invoke a workflow in an EMR/CPOE system, to send a report through fax and to activate another Action Workflow. The Action Workflow includes the logic to determine what data to be included in the notification, appropriate formatting, delivery channel, metadata properties. The Action Workflow can also include custom logic to interact with other systems and resources, e.g. dbMotion Security, Subscription System, and any other system that Action Manager supports. The use case ends when the requested Action Workflow is executed.

iii. Get Action Workflow Metadata. This use case typically defines data elements used for Action Workflow, defines Security settings, and/or uses delivery channels.

iv. Recall action: deals with situations in which actions SmartWatch invoked in the past are overridden and the new decision may be communicated to consumers who already received messages during original action invocation, for example, data changes in the CDR such as final lab results, or deleted records as a result of a DIL receiving update message.

v. Report Action statistics

vi. Replay notifications

vii. Send notification (breakdown from an executed action).

FIG. 135 is a logical overview of the Action Manager according to certain embodiments of the present invention. As shown, the action manager may comprise:

a. BusinessLogic Layer: exposes services to its consumer—SmartWatch. Typically includes:

a-1: ActionMetadataService: Provides consumer with metadata about the action manager. Used mostly by design time components such as SmartWatch management tool during SmartGuard editing.

a-2: ActionlnvocationService: A façade that allows consumers (SmartWatch service) to invoke actions supported by Action Manager, including receiving an invocation request, validating it and submitting the action for execution.

a-3: ActionDirectory: An internal service which holds mapping between action definitions and concrete action implementations (usually a workflow but maybe a simple class).

Used by ActionMetadataService in order to list actions and describe them. Used by ActionlnvocationService in order to map action request parameters implementing workflow and validation rules.

a-4: ActionRuntimeManager: An internal service which manages the running action workflow's lifetime. Starts off with action being submitted by ActionlnvocationService and is operative to monitor, report, manage (e.g. lookup hanged workflows and stop them). Also includes set of tools & services to facilitate rapid development of workflows, to meet developer productivity goals.

a-5: Workflows & Formatters: A package of customization in which concrete workflows and formatters (for content formatting) reside.

b. Communication Layers: responsible for handling any communication the workflow employs. It may include some or all of the following types of communications:

Input—which provide data to be included in notifications and to be used in workflow decision making; Output—delivering notification to recipients in the outside world (humans or systems); and Response—receiving messages from recipients (humans or systems) that include either acknowledgments or answers (from recipients) to specific questions included in notification.

The communication layer typically includes:

b-1: dbMotionServices & AdditionalServices are packages which supply workflow developer with a set of input communication to services it consumes. The package contains service client proxies. dbMotionServices are product-based (supplying access to services such as security, KNEO, dbMotion Business layer, PCP and so on), and AdditionalServices supplies customer-specific information sources.

b-2: NotificationDeliveryService: delivers messages thru delivery channels. It starts off with a notification request from a workflow, maps it to one of its delivery channels and assures reliable delivery, properly logged and so on. A commercially available product, such as a communication enabled business process (CEBP), may be used.

b-3: ActionResponseService: allows recipients to influence the workflow by responding to it. Responses may trigger events in the corresponding workflow. Based on pluggable listeners that know to communicate responses back to the workflow. This subsystem typically includes a Response Listeners package in which customized listeners reside.

A Data Access Layer (DAL) manages database access for business and communication layers.

Example implementations or realizations of the above-described use cases for the action manager are now described:

i. Develop SmartWatch Action Workflow: Typically non-automated. The workflow may be in accordance with the diagram of FIG. 136.

ii. Execute action: This use case employs several services from the business and communication layers and also typically employs the DAL in recording any operation being executed and artifact being produced (notifications, recipients, . . . ).

The following functionalities, action validation and notification delivery, typically form part of the execute action process above and typically comprise implementations of the execute action use case:

Validate Action: The diagram of FIG. 137A illustrates how actions are invoked by SmartWatchService, how the action request is validated and how the action request is submitted by the ActionlnvocationService to ActionRuntimeManager. Next, ActionRuntimeManager initializes and starts the workflow e.g. as shown in the diagram of FIG. 137B which, for simplicity, does not include details of the workflow being run. A typical action workflow may include decisions about who and what to communicate, including getting data to support decisions and to be included in the message, preparing message content (formatting), deciding on recipients, sending notification(s), waiting for responses and reacting to them.

Deliver Notification: FIG. 137C is a diagram of a notification delivery process. The workflow has collected data, decided on proper notification mechanism and prepared a notification message (content formatted). It calls NotificationDeliveryService to manage the delivery of the notification to its recipient(s).

iii. Get Action Workflow Metadata: This use case is realized by a call from SmartWatch Management tool to ActionMetadataService. Management tool which is a GUI component in which SmartGuard is edited. The metadata service would call ActionDirectory to locate the metadata such as list of actions, parameters, workflow associated with an action and so on.

iv. Get Action Response: This use case starts when one of the Action Response Listeners receives an Action Response Message. The message is forwarded to ActionResponseService for processing the response. This in turn would trigger the action workflow (assuming the workflow is waiting for that response) or the ActionResponseService would trigger a new workflow to process the Action Response e.g. as shown in FIG. 137E.

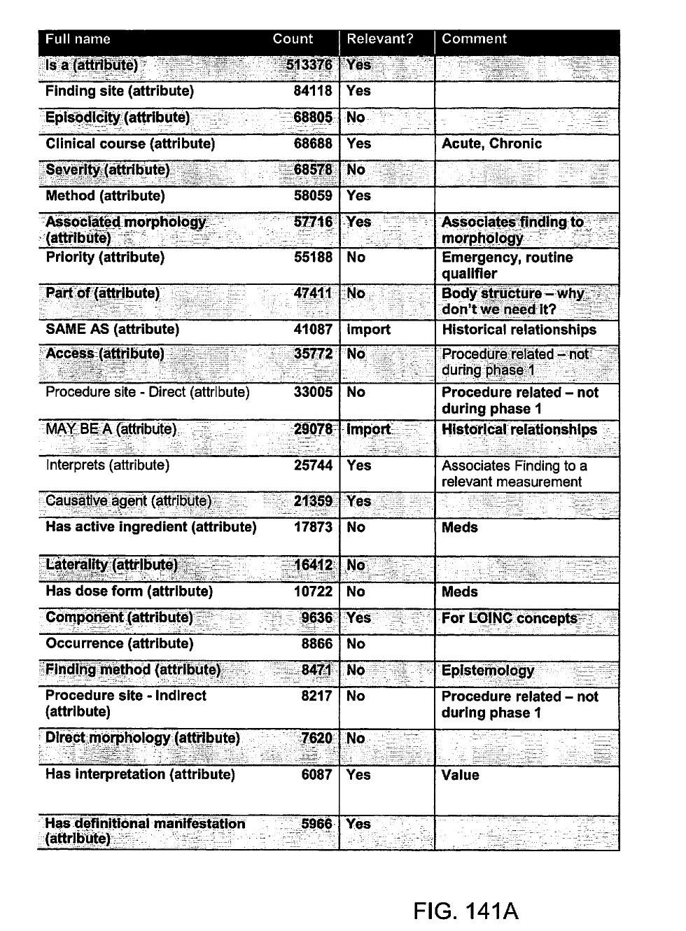

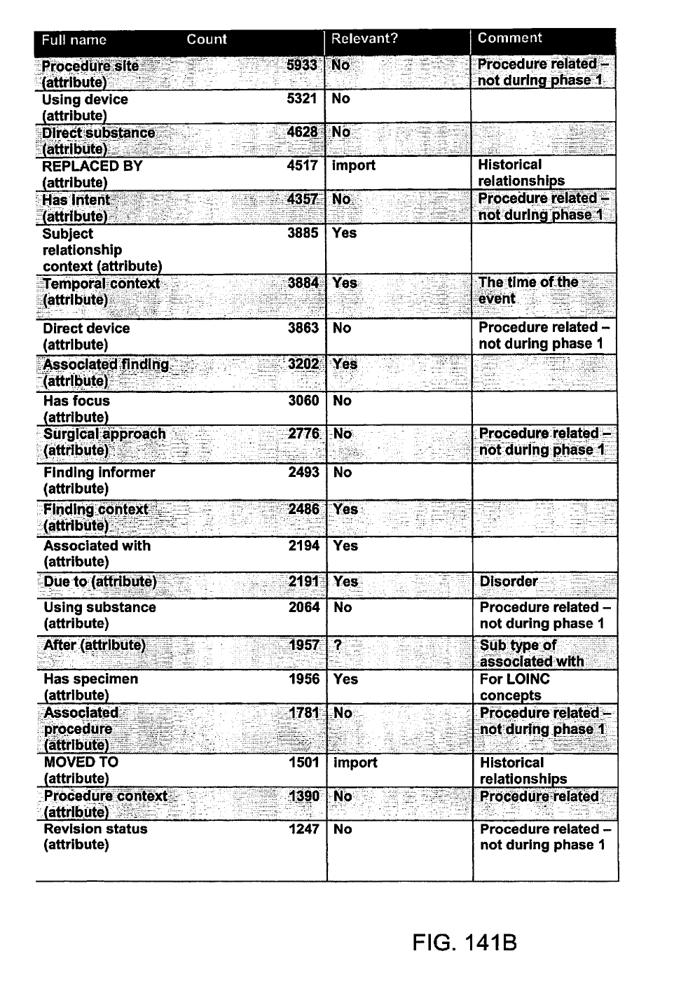

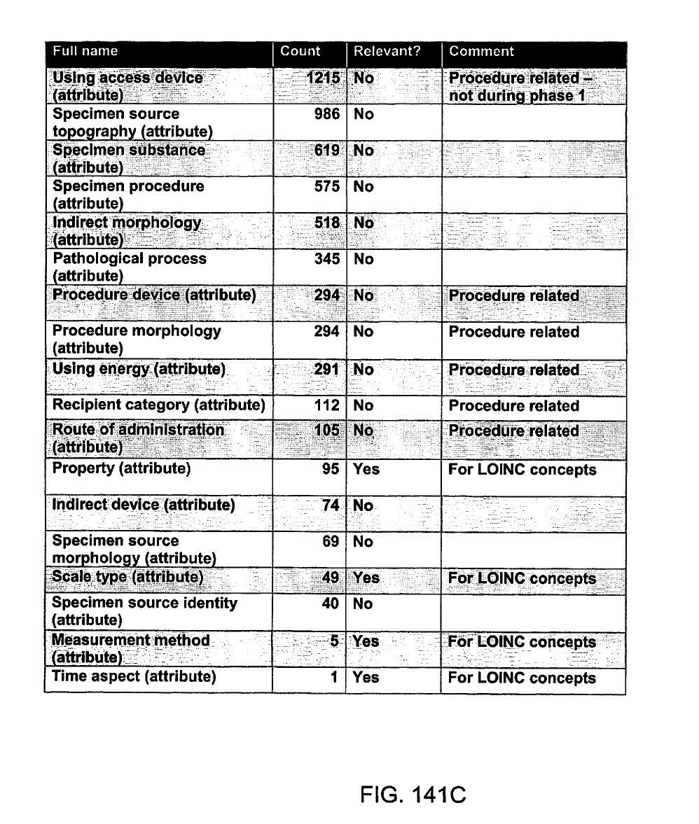

FIG. 141 is a table of ontological relationships, defined in conventional, public SNOMED terminology. The set of relationships in FIG. 141 is an example of semantic relationships, some or all of which may be used by the CTS subsystem of FIG. 1A. It is appreciated that this example is provided merely for purposes of clarification by way of example and, like many other examples provided herewithin, is not intended to be limiting.

The system shown and described herein typically but not necessarily uses conventional cache implementations such as Cache Application Block from Microsoft Enterprise library to provide client side caching functionalities in the CTS client subunit, which may be used by various of the SMW subsystems described herein.

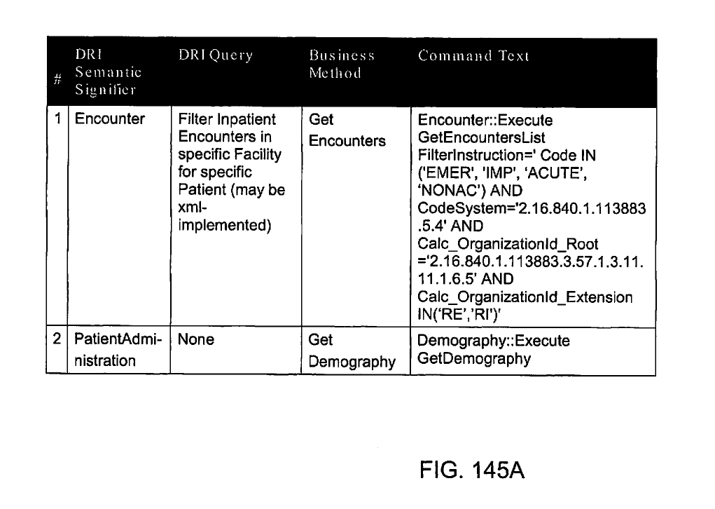

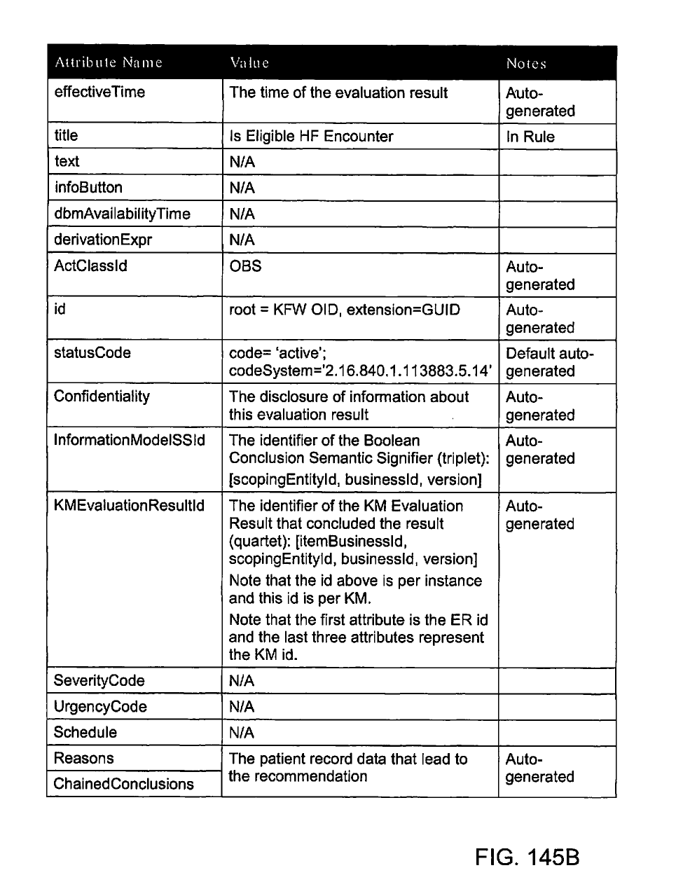

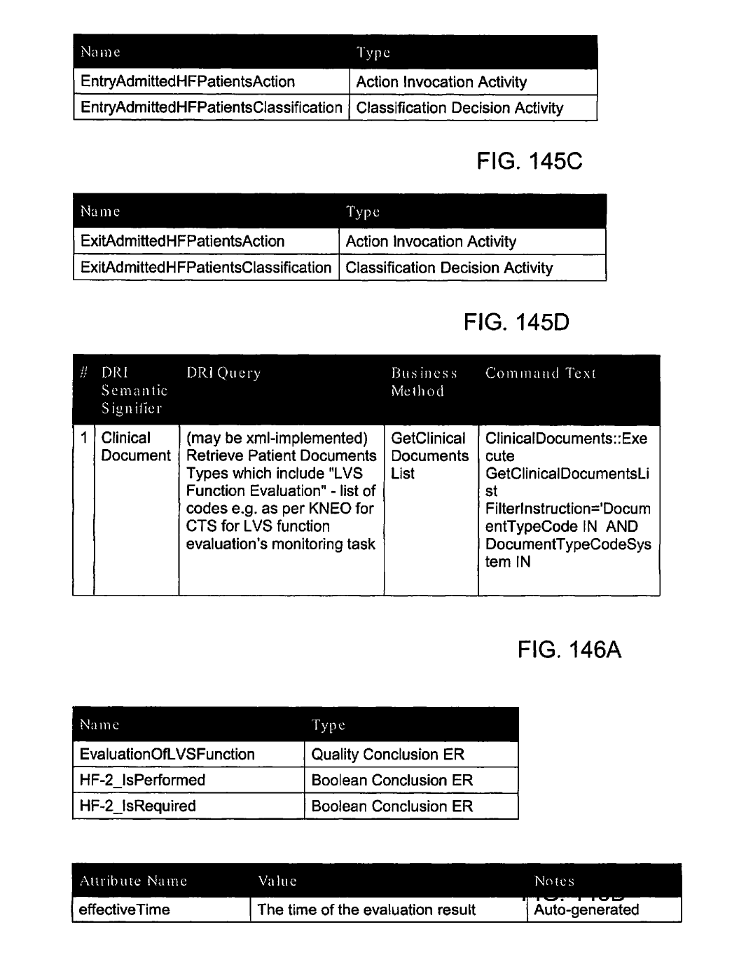

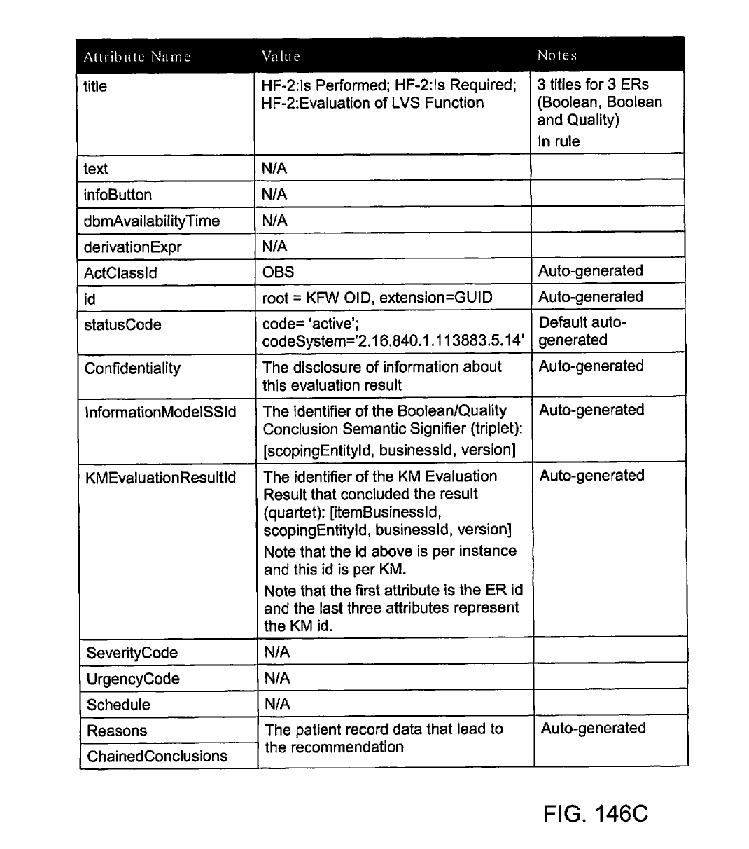

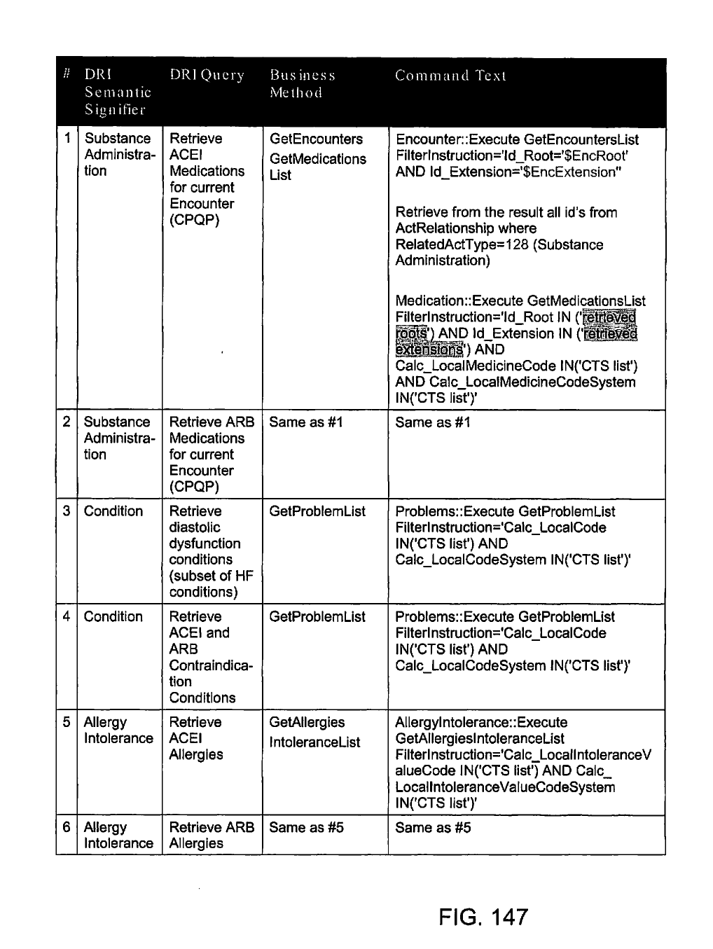

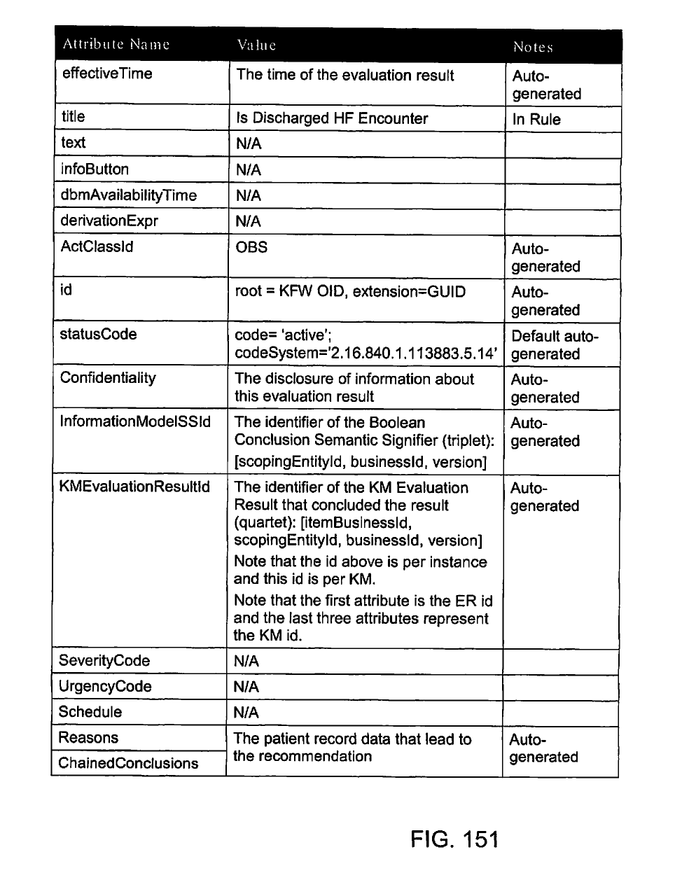

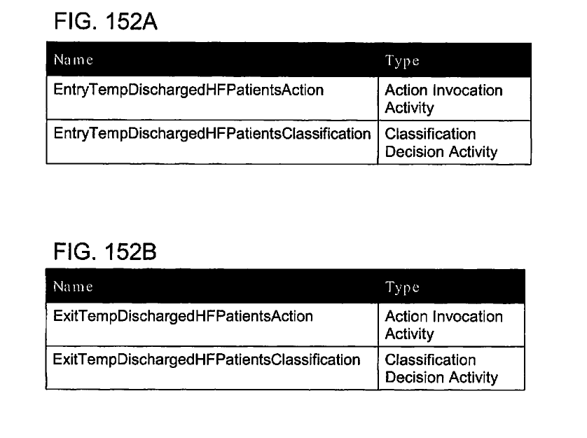

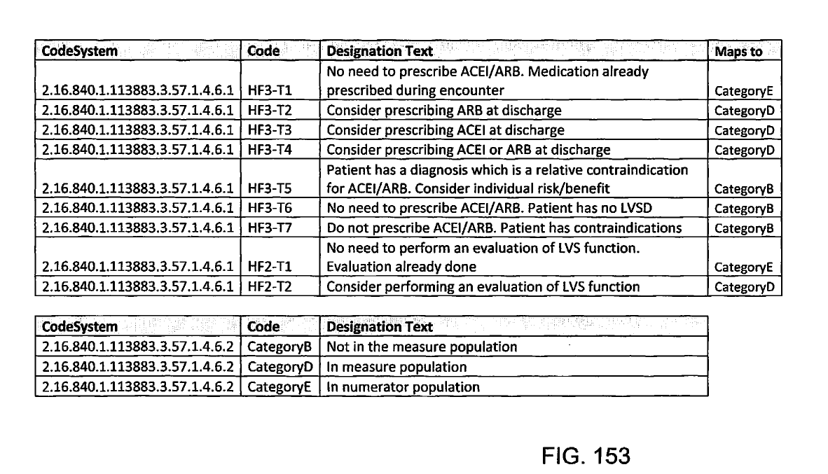

An example HF (heart failure) patients classification is described below with reference to FIGS. 144A-144C, including triggering rules and other characteristics for entry and exit tasks. Example admitted HF patient sub-classifications are described below with reference to FIGS. 145A-145D, including triggering rules and other characteristics for entry and exit tasks. An example of an LVS function evaluation method, including triggering rules and other characteristics for a monitoring task, is described below with reference to FIGS. 146A-145C. An example ACEI or ARB for LVSD is described below with reference to FIGS. 147-150. An example sub-classification for temp discharged HF patients is described below with reference to FIGS. 151-152B, including triggering rules and other characteristics for entry and exit tasks. Example vocabulary codes are described herein with reference to the table of FIG. 153. An example HF PATIENTS CLASSIFICATION is now described with reference to FIGS. 144A-144C, including triggering rules and other characteristics for entry and exit tasks.

An example Entry Task is now described.

Triggering Rules may include one or both of:

Identify new HF problems—an example list of codes is provided below under CTS triggering rules; and

### Is HF Patient KM

Inputs/Query Parameters are described in the table of FIG. 144A.

Example Decision logic is now described in words and in pseudo-code.

In words

When
Patient is alive
AND
Patient has a HF Condition
AND
The latest HF Condition is not negated
Then Return isHFPatient = True
Else Return isHFPatient = False

In pseudo code

When
PatientAdministration/DeceasedInd <> 1 //defined as bit data type in the
CDR
AND
HF Conditions DRI is not empty
Conditions/Condition/value/(code,codeSystem) Member In CTS list e.g. as
described below (CTS list for KFW).
AND
Latest (effectiveTime_Start) HF Conditions negationInd <> 1 //no use of
Condition.negationInd in UPMC.
OR
Latest (effectiveTime_Start) HF Conditions statusCode notMemberIn
([2.16.840.1.113883.5.14, aborted], [2.16.840.1.113883.5.14,
cancelled], [2.16.840.1.113883.5.14, suspended])
Condition status concept may be retrieved from the CTS (design-time)
Then Set Evaluation Result to True

Outputs may include IsHFPatient, whose type is Boolean Conclusion ER.

Attribute names, values and other characteristics of outputs are set out in the table of FIG. 144B.

SmartWatch KM is now described.

Inputs may include:

“Is HF Patient” KM evaluation result (Boolean Conclusion ER)

Decision logic, in words and in pseudo-code, may be as follows:

In words:

```
When “Is HF Patient” KM evaluation result is True
Then
Add member to population ″HF Patients″, Step in classification
Remove member from population “Candidates”, Step out classification
Else
      Remove member from population “Candidates”, Step out
      classification
```

In pseudo code:

```
When “Is HF Patient” KM evaluation result = True
Then
Create Evaluation Result - Classification Decision Activity:
ClassificationDecisionActivity/ClassificationDecision/classificationId =
“HFPatients”
                                          /move = “In”
AND
Create Evaluation Result - Classification Decision Activity:
ClassificationDecisionActivity/ClassificationDecision/classificationId =
“Candidates”
                                          /move = “Out”
```

Outputs may include EntryHFPatientsClassification, whose type is Classification Decision Activity.

CTS: Retrieve HF Condition codes

### Triggering Rule may be:

```
CTS list=
named query=” GetLocalCodesForConceptHierarchy”
Parameters=
      @code=″84114007″
      @codeSystemId=″2.16.840.1.113883.6.96″
]
```

### KNEO may be:

```
CTS list=
named query=” GetLocalCodesForConceptHierarchy”
Parameters=
      @code=″84114007″
      @codeSystemId=″2.16.840.1.113883.6.96″
]
```

### KFW

```
CTS list=
named query=” GetConceptHierarchy”
Parameters=
      @code=″84114007″
      @codeSystemId=″2.16.840.1.113883.6.96″
]
```

An Exit Task for the HF patients classification may be as follows:

Triggering Rules, each of which may be implemented in XML, may include some or all of:

Identify cancelled HF Problems for specific patient—list of codes may be as above (CTS list for triggering rule). (No use of Condition.negationInd in UPMC); and
Identify expiration of specific patient
Is HF Patient KM: may be same as for the entry task.

### SmartWatch KM:

Inputs may include:
“Is HF Patient” KM evaluation result (Boolean Conclusion ER)

Decision logic, in words and in pseudocode, may be as follows:

In words:

When “Is HF Patient” KM evaluation result is False
Then
Remove member from population ″HF Patients″, Step out classification
Exit criteria type: “not relevant” - patient was removed from the
population (patient is deceased) i.e. there is no need to monitor the
completion of his recommendations
Action: Store Result to EDR
The result stored in the EDR is the “Is HF Patient” (clinical) KM
evaluation result as-is.

In pseudo code:

```
When “Is HF Patient” KM evaluation result = False
Then
Create Evaluation Result - Classification Decision Activity:
ClassificationDecisionActivity/ClassificationDecision/classificationId =
“HFPatients”
                                          /move = “Out”
AND
Create Evaluation Result - Action Invocation Activity:
ActionInvocationActivity/ActionInvocation/actionId = “StoreToEDR”
                                /ActionInvocationParameter/alias =
                                “Is HF Patient”
/rootId = null
/extension = null
/InformationModelSSId= $IsHFPatientER.SSid
/value = $IsHFPatientER
```

Outputs are described in the table of FIG. 144C. CTS may be as for the entry task.

### Admitted

An example sub-classification for admitted HF patients is now described with reference to FIGS. 145A-145D, including triggering rules and other characteristics for entry and exit tasks.

Entry Task may be as follows:

Triggering Rules may be implemented in XML and may include some or all of the following:

a. Identify Active (status=active AND discharge date=null) Inpatient Encounters in specific

Facility for specific Patient

b. Identify (status=null AND discharge date=null) Inpatient Encounters in specific Facility for specific Patient
c. Identify Completed (status=completed AND discharge date < > null) Inpatient Encounters in specific Facility for specific Patient
d. Identify Completed (status=null AND discharge date < > null) Inpatient Encounters in specific Facility for specific Patient

Is Eligible HF Encounter KM may be as follows:

Inputs/Query Parameters are described in the table of FIG. 145A.

Decision logic, in words and in pseudocode, may be as follows:

In words:

When
Encounter is active OR Encounter discharge date is from the past 24 hours
AND
Encounter from a given facility
AND
Encounter deals with hospitalized patients (inpatient OR emergency)
AND
Encounter length of stay is less than 120 days
AND
Patient age exceeds 18 years (at the admission date)
The SW KM (smart watch knowledge module) e.g. as described below
may save the encounter id (CPQP) in the classification. The encounter
id may be extracted from the IsEligibleHFEncounterER.Reasons. In
general, only one encounter may be retrieved, but in exceptional cases
more than one may be retrieved. In order to guarantee that the SW KM
may only find one encounter id, enforce also a latest operation (on top
off all other conditions).
Then Return isEligableHFEncounter = True
Else Return isEligableHFEncounter = False

In pseudo code:

When
{((Encounters/Encounter/statusCode/code = “active” AND
Encounters/Encounter/statusCode/codeSystem =
“2.16.840.1.113883.5.14”) OR
Encounters/Encounter/statusCode/code = null)
AND
Encounters/Encounter/effectiveTime_end = null}
OR
{((Encounters/Encounter/statusCode/code = “completed” AND
Encounters/Encounter/statusCode/codeSystem =
“2.16.840.1.113883.5.14”) OR
Encounters/Encounter/statusCode/code = null)
AND
Encounters/Encounter/effectiveTime_end + 24 hours > Now}
Encounter status concept may be retrieved from the CTS (design-time)
AND
(Encounters/Encounter/assignedOrganization/id/root =
“2.16.840.1.113883.3.57.1.3.11.11.1.6.5”
AND Encounters/Encounter/assignedOrganization/id/extension =
“RE”) OR
(Encounters/Encounter/assignedOrganization/id/root =
“2.16.840.1.113883.3.57.1.3.11.11.1.6.5”
AND Encounters/Encounter/assignedOrganization/id/extension =
“RI”)
AND
(Encounters/Encounter/code/code = “EMER” AND
Encounters/Encounter/code/codeSystem = “2.16.840.1.113883.5.4”)
OR (Encounters/Encounter/code/code = “IMP” AND
Encounters/Encounter/code/codeSystem = “2.16.840.1.113883.5.4”) OR
(Encounters/Encounter/code/code = “ACUTE” AND
Encounters/Encounter/code/codeSystem = “2.16.840.1.113883.5.4”)
OR (Encounters/Encounter/code/code = “NONAC” AND
Encounters/Encounter/code/codeSystem = “2.16.840.1.113883.5.4”)
Encounter type concept may be retrieved from the CTS (design-time)
AND
When Encounters/Encounter/effectiveTime_end = null Then Now( ) −
Encounters/Encounter/effectiveTime_start <= 120 days Else
Encounters/Encounter/effectiveTime_end −
Encounters/Encounter/effectiveTime_start <= 120 days
AND
Encounters/Encounter/effectiveTime_start −
PatientAdministration/BirthTime >= 18 years
The SW KM e.g. as described below may save the encounter id (CPQP) in
the classification. The encounter id may be extracted from the
IsEligibleHFEncounterER.Reasons. In general, only one
encounter may be retrieved, but in exceptional cases more than one
may be retrieved. In order to guarantee that the SW KM may only find
one encounter id, enforce also a latest operation (in addition to all other
conditions).
Then Set Evaluation Result to True

Outputs may include IsEligibleHFEncounter, whose type is Boolean Conclusion ER.

Attribute names and values of outputs are described in the table of FIG. 145B.

An example SmartWatch KM is now described.

Inputs may include:

“Is Eligible HF Encounter” KM evaluation result (Boolean Conclusion ER)

Decision logic, in words and in pseudocode, may be as follows:

In words:

When “Is Eligible HF Encounter” KM evaluation result is True
Then
Add member to population ″Admitted HF Patients″, Step in classification
and save encounter id (CPQP) in classification
Action: Store Result to EDR
The result stored in the EDR is the “Is Eligible HF Encounter” (clinical)
KM evaluation result as-is.

In pseudo code:

When “Is Eligible HF Encounter” KM evaluation result = True
Then
Create Evaluation Result - Classification Decision Activity:
ClassificationDecisionActivity/ClassificationDecision/classificationId =
“AdmittedHFPatients”
/move = “In”
/ClassificationDecisionParameter/key =
“SW_ADMITTED_HF_ENC_ROOT”
/value = $IsEligibleHFEncounterER.Reasons...Act_ref/root
/ClassificationDecisionParameter/key =
“SW_ADMITTED_HF_ENC_EXT”
/value = $IsEligibleHFEncounterER.Reasons...Act_ref/extension
AND
Create Evaluation Result - Action Invocation Activity:
ActionInvocationActivity/ActionInvocation/actionId = “StoreToEDR”
/ActionInvocationParameter/alias = “Is Eligible HF Encounter”
/rootId = null
/extension = null
/InformationModelSSId= $IsEligibleHFEncounterER.SSid
/value = $IsEligibleHFEncounterER

Outputs are described in the table of FIG. 145C.

An example Exit Task for the sub-classification of the admitted HF patients is now described.

Triggering Rules may include:

Identify if specific encounter was not active OR encounter type was changed OR discharge date not empty; and
Temporal Trigger: Admission Date+120 days

Is Eligible HF Encounter KM may be as described above with reference to the corresponding characteristic of the entry task.

An example SmartWatch KM is now described.

Inputs may include:
“Is Eligible HF Encounter” KM evaluation result (Boolean Conclusion ER)

Decision logic, in words and in pseudocode, may be as follows:

In words:

When “Is Eligible HF Encounter” KM evaluation result is False
Then
Remove member from population ″Admitted HF Patients″, Step out
classification
Exit criteria type: “to be completed” - patient was removed from the
population due to some other event (not death) hence completion of all his
recommendations is still to be monitored.
Action: Store Result to EDR
The result stored in the EDR is the “Is Eligible HF Encounter” (clinical)
KM evaluation result as-is.

In pseudo code:

When “Is Eligible HF Encounter” KM evaluation result = False
Then
Create Evaluation Result - Classification Decision Activity:
ClassificationDecisionActivity/ClassificationDecision/classificationId =
“AdmittedHFPatients”
/move = “Out”
AND
Create Evaluation Result - Action Invocation Activity:
ActionInvocationActivity/ActionInvocation/actionId = “StoreToEDR”
/ActionInvocationParameter/alias = “Is Eligible HF Encounter”
/rootId = null
/extension = null
/InformationModelSSId= $IsEligibleHFEncounterER.SSid
/value = $IsEligibleHFEncounterER

Outputs are described in the table of FIG. 145D.

### HF—2: Evaluation of

An example, also termed herein HF-2, of an LVS function evaluation method, including triggering rules and other characteristics for a monitoring task, is now described with reference to FIGS. 146A-145B.

An example Monitoring Task for the above LVS function evaluation method is now described.

Triggering Rules may include:

Identify changes in the existence of LVS Function Evaluation Document for specific patient—list of codes, e.g. as for the triggering rule for the CTS described below, e.g. using a suitable XML implementation.

An example Evaluation of LVS Function KM may be as follows:

Inputs/Query Parameters are described in the table of FIG. 146A.

Decision logic, in words and in pseudocode, may be as follows:

In words:

When
At least one LVS Function Evaluation Document Exist in Patient Record
Then
Return Code HF2-T1
AND
Return isPerformed = True
AND
Return isRequired = False
Else
Return Code HF2-T2
AND
Return isPerformed = False
AND
Return isRequired = True

Code translations may be e.g. as shown in FIG. 153.

In pseudo code:

Rule #1
When
LVS Documents DRI is not empty
Documents/ClinicalDocument/code/(code,codeSystem) Member
In CTS list described below.
Then
Create Evaluation Result - Quality Conclusion:
QualityConclusion/QualityAnswer/SystemName = null
/code = “HF2-T1”
/codeSystem = “2.16.840.1.113883.3.57.1.4.6.1”
/displayName = null
/effectiveTime = null
/domainCode = null
Set Evaluation Result (IsPerformed) to True
Set Evaluation Result (IsRequired) to False
Rule #2 (else)
When
LVS Documents DRI is empty
IsEmpty (Documents/ClinicalDocument/code/(code,codeSystem)
Member In CTS list described below.
Then
Create Evaluation Result - Quality Conclusion:
QualityConclusion/QualityAnswer/SystemName = null
/code = “HF2-T2”
/codeSystem = “2.16.840.1.113883.3.57.1.4.6.1”
/displayName = null
/effectiveTime = null
/domainCode = null
Set Evaluation Result (IsPerformed) to False
Set Evaluation Result (IsRequired) to True

Outputs are described in the table of FIG. 146B. The Quality Conclusion contains a vocabulary code. The code designation may be retrieved from dbMotion vocabulary by the consumer (EDR). The vocabulary may also hold the mapping between the code and the relevant category e.g. as shown in FIG. 153.

Attribute names and values are described in the table of FIG. 146C.

An example SmartWatch KM for the LVS function evaluation method's monitoring task may be as follows:

Inputs may include:

“Evaluation of LVS Function” KM evaluation result

Decision logic, in words and in pseudocode, may be as follows:

In words:

When always
Then
Action: Store Result to EDR
The result stored in the EDR is the “Evaluation of LVS Function”
(clinical) KM evaluation result as-is.

In pseudo code:

When 1=1
Then
Create Evaluation Result - Action Invocation Activity:
ActionInvocationActivity/ActionInvocation/actionId = “StoreToEDR”
/ActionInvocationParameter/alias = “Evaluation of LVS Function”
/rootId = null
/extension = null
/InformationModelSSId= $EvaluationOfLVSFunctionER.SSid
/value = $EvaluationOfLVSFunctionER
/ActionInvocationParameter/alias = “HF-2:IsPerformed”
/rootId = null
/extension = null
/InformationModelSSId= $HF-2:IsPerformedER.SSid
/value = $HF-2:IsPerformedER
/ActionInvocationParameter/alias = “HF-2:IsRequired”
/rootId = null
/extension = null
/InformationModelSSId= $HF-2:IsRequiredER.SSid
/value = $HF-2:IsRequiredER

Outputs may include EvaluationOfLVSFunctionAction, which may be of the Action Invocation Activity type.

CTS: Retrieve list of document types (“LVS Function Evaluation”)

Triggering Rule may include:

```
CTS list=
    @code=“11522-0”; @codeSystemId=“ 2.16.840.1.113883.6.1”
    @code=“18745-0”; @codeSystemId=“ 2.16.840.1.113883.6.1”
]
```

### KNEO may be:

```
CTS list=
    @code=“11522-0”; @codeSystemId=“ 2.16.840.1.113883.6.1”
    @code=“18745-0”; @codeSystemId=“ 2.16.840.1.113883.6.1”
```

KFW may include:

```
CTS list=
    @code=“11522-0”; @codeSystemId=“ 2.16.840.1.113883.6.1”
    @code=“18745-0”; @codeSystemId=“ 2.16.840.1.113883.6.1”
```

### HF—3

An example, also termed herein HF-3, of ACEI or ARB for LVSD is now described with reference to FIGS. 147-150.

A Monitoring Task for ACEI or ARB for LVSD, may for example be as follows:

Triggering Rules, each of which may be implemented in XML, may include some or all of: Identify changes in ACEI or ARB Medications for specific Encounter—list of codes e.g. as described below with reference to the triggering rule for these medications.

Identify changes in ACEI or ARB Allergies for specific Patient—list of codes e.g. as described below with reference to the triggering rule for these allergies.

Identify negated OR cancelled HF Problem events for specific patient—e.g. as per exit task triggering rules for HF patient classification as described above.

Identify changes in ACEI or ARB Contraindication Conditions—list of codes e.g. as described below with reference to the triggering rule for these contraindication conditions.

### ACEI or ARB for LVSD KM:

Inputs/Query Parameters are described in the table of FIG. 147. The list of codes for the first and second rows in the table may be as described herein for the CTS of the ACEI or ARB for LVSD monitoring task (KNEO for ACEI and ARB medications). The list of codes for the third row in the table may be as described herein for the CTS of the ACEI or ARB for LVSD monitoring task (KNEO for diastolic dysfunction conditions). The list of codes for the fourth row in the table may be as described herein for the CTS of the ACEI or ARB for LVSD monitoring task (KNEO for contraindications conditions). The list of codes for the fifth and sixth rows in the table may be as described herein for the CTS of the ACEI or ARB for LVSD monitoring task (KNEO for ACEI and ARB allergies).

Decision logic, in words and in pseudocode, may be as follows:

In words:

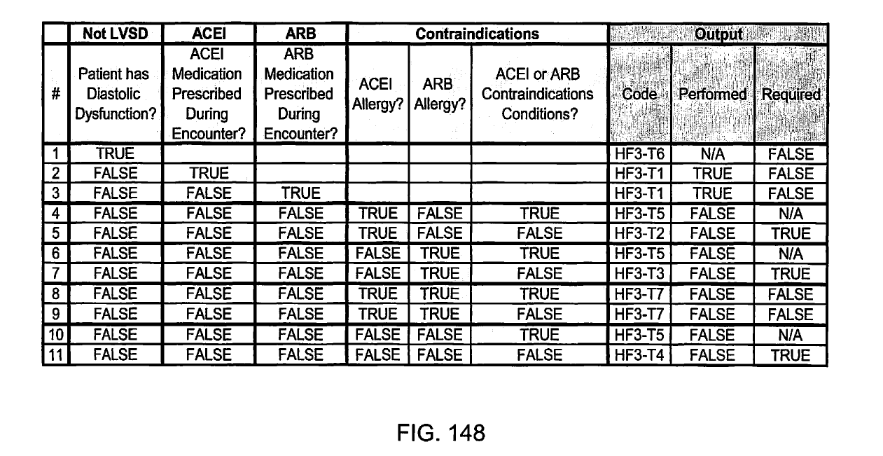

An example of a suitable decision table (in words) is provided in FIG. 148.

Codes translations may be as shown in FIG. 153.

In pseudo code:

When
Patient has Diastolic Dysfunction?
Diastolic Dysfunction Conditions DRI is not empty
Conditions/Condition/value/(code,codeSystem) Member In CTS list- 000
ACEI Medication Prescribed During Encounter?
ACEI Medications DRI is not empty
SubstancesAdministration/SubstanceAdministration/Medication/code/(code,codeSystem)
Member In CTS list e.g. as described herein with reference to the KFW of the ACEI and ARB
medications.
ARB Medication Prescribed During Encounter?
ARB Medications DRI is not empty
SubstancesAdministration/SubstanceAdministration/Medication/code/(code,codeSystem)
Member In CTS list- e.g. as described herein with reference to the KFW of the ACEI and ARB
medications.
ACEI Allergy?
ACEI Allergies DRI is not empty
Allergies/AllergyIntolerance/value/(code,codeSystem) Member In CTS list - e.g. as described
herein with reference to the KFW of the ACEI and ARB allergies.
ARB Allergy?
ARB Allergies DRI is not empty
Allergies/AllergyIntolerance/value/(code,codeSystem) Member In CTS list e.g. as described
herein with reference to the KFW of the ACEI and ARB allergies.
ACEI or ARB Contraindications Conditions?
ACEI and ARB Contraindication Conditions DRI is not empty
Conditions/Condition/value/(code,codeSystem) Member In CTS list - e.g. as described herein
with reference to the KFW of the contraindication conditions for the ACEI and ARB.
Then
Create Evaluation Result - Quality Conclusion:
QualityConclusion/QualityAnswer/SystemName = null
/code = according to the table of Fig. 148
/codeSystem = “2.16.840.1.113883.3.57.1.4.6.1”
/displayName = null
/effectiveTime = null
/domainCode = null
Set Evaluation Result (IsPerformed) to True/False according to the table of Fig. 148
Set Evaluation Result (IsRequired) to True/False according to the table of Fig. 148

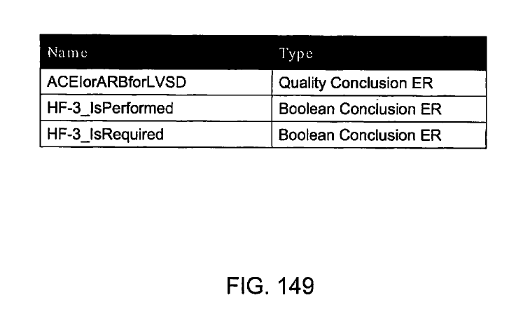

Outputs are described in the table of FIG. 149.

The Quality Conclusion contains a vocabulary code. The code designation may be retrieved from dbMotion vocabulary by the consumer (EDR). The vocabulary may also hold the mapping between the code and the relevant category e.g. as shown in FIG. 153.

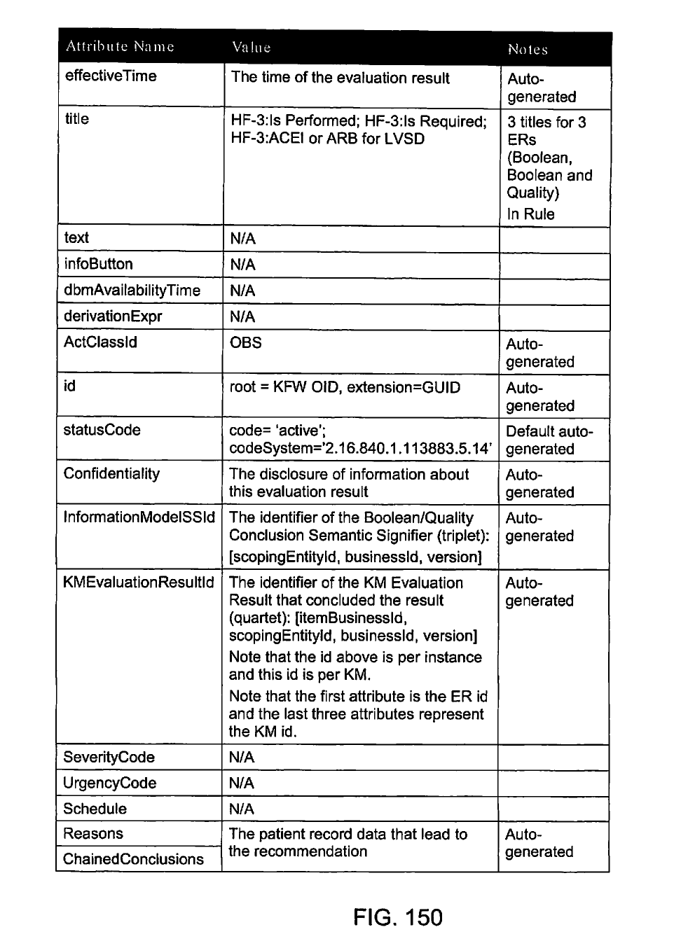

Attribute names, values and other characteristics are set out in the table of FIG. 150.

An example of a SmartWatch KM for the monitoring task of the ACEI or ARB for LVSD is now described.

Inputs may include:

“ACEI or ARB for LVSD” KM evaluation result

Decision logic, in words and in pseudocode, may be as follows:

In words:

When always
Then
Action: Store Result to EDR
The result stored in the EDR is the “ACEI or ARB for LVSD”
(clinical) KM evaluation result as-is.

In pseudo code:

When 1=1
Then
Create Evaluation Result - Action Invocation Activity:
ActionInvocationActivity/ActionInvocation/actionId = “StoreToEDR”
/ActionInvocationParameter/alias = “ACEI or ARB for LVSD”
/rootId = null
/extension = null
/InformationModelSSId= $ACEIorARBforLVSDER.SSid
/value = $ACEIorARBforLVSDER
/ActionInvocationParameter/alias = “HF-3:IsPerformed”
/rootId = null
/extension = null
/InformationModelSSId= $HF-3:IsPerformedER.SSid
/value = $HF-3:IsPerformedER
/ActionInvocationParameter/alias = “HF-3:IsRequired”
/rootId = null
/extension = null
/InformationModelSSId= $HF-3:IsRequiredER.SSid
/value = $HF-3:IsRequiredER

Outputs may include ACEIorARBforLVSDAction, of the Action Invocation Activity type. An example CTS for the monitoring task of the ACEI or ARB for LVSD is now described.

### ACEI and ARB Medications:

Retrieve list of ARB medications (ACEI and ARB)—2 separate lists

Triggering Rule may be as follows:

```
ACEI CTS list=
named query=” product/GetLocalCodesForConceptHierarchy”
Parameters=
    @code=″ 372733002″
    @codeSystemId=″2.16.840.1.113883.6.96″
ARB CTS list=
named query=” product/GetLocalCodesForConceptHierarchy”
Parameters=
    @code=″ 372913009″
    @codeSystemId=″2.16.840.1.113883.6.96″
```

KNEO may be as follows:

```
ACEI CTS list=
named query=” product/GetLocalCodesForConceptHierarchy”
Parameters=
    @code=″ 372733002″
    @codeSystemId=″2.16.840.1.113883.6.96″
ARB CTS list=
named query=” product/GetLocalCodesForConceptHierarchy”
Parameters=
    @code=″ 372913009″
    @codeSystemId=″2.16.840.1.113883.6.96″
```

KFW may be as follows:

```
ACEI CTS list=
named query=” product/GetConceptHierarchy”
Parameters=
  @code=″ 372733002″
  @codeSystemId=″2.16.840.1.113883.6.96″
ARB CTS list =
named query=″ product/GetConceptHierarchy″
Parameters=
  @code=″ 372913009″
  @codeSystemId=″2.16.840.1.113883.6.96″
```

ACEI and ARB Allergies for the CTS of the monitoring task of the ACEI or ARB for LVSD is now described.

Retrieve list of allergies (ACEI and ARB)—2 separate lists.

Triggering Rule may comprise:

```
ACEI Allergy CTS list =
named query=”product/GetLocalCodesForConceptHierarchy”
Parameters=
  @code=″372733002″
  @codeSystemId=″2.16.840.1.113883.6.96″
  ARB CTS list=
named query=”product/GetLocalCodesForConceptHierarchy”
Parameters=
  @code=″372913009″
  @codeSystemId=″2.16.840.1.113883.6.96″
```

KNEO may comprise:

```
ACEI CTS list=
named query=”product/GetLocalCodesForConceptHierarchy”
Parameters=
  @code=″372733002″
  @codeSystemId=″2.16.840.1.113883.6.96″
ARB CTS list=
named query=”product/GetLocalCodesForConceptHierarchy”
Parameters=
  @code=″372913009″
  @codeSystemId=″2.16.840.1.113883.6.96″
```

KFW may comprise:

```
ACEI CTS list=
named query=”product/GetConceptHierarchy”
Parameters=
  @code=″372733002″
  @codeSystemId=″2.16.840.1.113883.6.96″
ARB CTS list =
named query=”product/GetConceptHierarchy”
Parameters=
  @code=″372913009″
  @codeSystemId=″2.16.840.1.113883.6.96″
```

Contraindication conditions: list of contraindication conditions (ACEI and ARB) may be retrieved.

### Triggering Rule may be:

```
CTS list=
  @code=“41291007”
  @codeSystemId=“2.16.840.1.113883.6.96”
  @code=“45281005”
  @codeSystemId=“2.16.840.1.113883.6.96”
```

KNEO may be:

```
CTS list=
  @code=“41291007”
  @codeSystemId=“2.16.840.1.113883.6.96”
  @code=“45281005”
  @codeSystemId=“2.16.840.1.113883.6.96”
```

KFW may be:

@code=“41291007”
@codeSystemId=“2.16.840.1.113883.6.96”
@code=“45281005”
@codeSystemId=“2.16.840.1.113883.6.96”

Diastolic dysfunction conditions: list of diastolic dysfunction conditions (subset of HF conditions) may be retrieved.

KNEO may be:

```
CTS list=
  @code=“418304008”
  @codeSystemId=“2.16.840.1.113883.6.96”
```

KFW may be:

@code=“418304008”
@codeSystemId=“2.16.840.1.113883.6.96”

### Temp

An example sub-classification for temp discharged HF patients is now described with reference to FIGS. 151-152B, including triggering rules and other characteristics for entry and exit tasks. Motivation—to support a business requirement to continue monitoring discharged patients for 24 hours after the discharge. This sub-classification is a workaround for Dynamic Triggering Rule Parameters. Parent Classification—Admitted HF Patients.

An example Entry Task for the sub-classification for temp discharged HF patients is now described.

Triggering Rules Identify Completed Inpatient Encounters in specific Facility for specific Patient e.g. as per third and fourth triggering rules for entry task of admitted HF patients sub-classification, described above.

### Is Discharged HF Patient KM:

Inputs/Query Parameters may be as per row 1 in the table of FIG. 145A. Decision logic, in words and in pseudocode, may be as follows:

In words:

When
Encounter discharge date is from the last 24 hours
Then Return isDischargedHFEncounter = True
Else Return isDischargedHFEncounter = False

In pseudo code:

When
((Encounters/Encounter/statusCode/code = “completed” AND
Encounters/Encounter/statusCode/codeSystem =
“2.16.840.1.113883.5.14”) OR
Encounters/Encounter/statusCode/code = null)
AND
Encounters/Encounter/effectiveTime_end + 24 hours > Now
Encounter status concept may be retrieved from the CTS (design-time)
Then Set Evaluation Result to True

This rule may be exactly as the first part of the Is Eligible HF Encounter KM e.g. as described above with reference to “is eligible HF encounter KM” pertaining to the entry task of the sub-classification for admitted heart failure patients. Therefore it may be useful to reuse this logic i.e. the Is Eligible HF Encounter KM may be divided into 2 KMs/rules that one of them is this one. Outputs may include is DischargedHFEncounter, whose type is Boolean Conclusion ER. Attribute names, values, and other characteristics are set out in the table of FIG. 151.

### SmartWatch KM

Inputs may include:

“Is Discharged HF Patient” KM evaluation result (Boolean Conclusion ER)

Decision logic, in words and in pseudocode, may be as follows:

In words:

When “Is Discharged HF Patient” KM evaluation result is True
Then
Add member to population ″Temp Discharged HF Patients″,
Step in classification

In pseudo code:

When “Is Discharged HF Patient” KM evaluation result = True
Then
Create Evaluation Result—Classification Decision Activity:
ClassificationDecisionActivity/ClassificationDecision/classificationId =
“TempDischargedHFPatients”

/move = “In”

Outputs are set out in the table of FIG. 152.

An example Exit Task for the sub-classification for temp discharged HF patients is now described.

Triggering Rules may include at least the following:

Temporal Trigger Discharge Date+24 Hours

Is Discharged HF Patient KM: as for the entry task.

An example SmartWatch KM for the exit task may be as follows:

### Inputs:

“Is Discharged HF Patient” KM evaluation result (Boolean Conclusion ER)

Decision logic, in words and in pseudocode, may be as follows:

In words

When “Is Discharged HF Patient” KM evaluation result is False
Then
Remove member from population ″Temp Discharged HF Patients″,
Step out classification

In pseudo code

When “Is Discharged HF Patient” KM evaluation result = False
Then
Create Evaluation Result - Classification Decision Activity:
ClassificationDecisionActivity/ClassificationDecision/classificationId =
“TempDischargedHFPatients”

/move = “Out”

Outputs are set out in the table of FIG. 152.

Example vocabulary Codes for the embodiment of FIGS. 144A-152B are set out in the table of FIG. 153.

It is appreciated that terminology such as “mandatory”, “required”, “need” and “must” refer to implementation choices made within the context of a particular implementation or application described herewithin for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

All flowchart illustrations herein are simplified representations of corresponding methods. The corresponding methods typically comprise some or all of the illustrated steps, suitably ordered e.g. as illustrated. All diagram illustrations herein are simplified representations of corresponding structural portions of the system shown and described herein, according to certain embodiments. The corresponding structural portions typically comprise some or all of the illustrated blocks, suitably arranged e.g. as illustrated.

1. A health information exchange system comprising:
apparatus for archiving health information using a health information encoding procedure only if the health information fulfills a criterion of frequent use; and
apparatus for using a first procedure to respond to queries pertaining to said health information which fulfills the criterion of frequent use and using a second procedure to respond to queries not pertaining to said health information which fulfills the criterion of frequent use.

2. A health information exchange system comprising:
ontological apparatus for defining and storing ontological link elements ontologically linking between individual health care information items within a first population of health care information items;
apparatus for receiving a second population of health care information items and for associating at least some individual items in said second population, with corresponding individual items within said first population of health care information items; and
apparatus for responding to queries regarding particular information items in said second population including translating said particular information items into items in said first population corresponding to said particular information items and using link elements linking said items in said first population corresponding to said particular information items to generate data pertaining to said particular information items in said second population.

3. A system according to claim 1 and also comprising apparatus for making at least one health decision based on said queries.

4. A system according to claim 3 and also comprising apparatus for implementing said at least one health decision.

5. A system according to claim 2 and also comprising apparatus for making at least one health decision based on said queries.

6. A system according to claim 5 and also comprising apparatus for implementing said at least one health decision.

7. A health information exchange method comprising:
archiving health information using a health information encoding procedure only if said health information fulfills a criterion of frequent use; and
using a first procedure to respond to queries pertaining to said health information which fulfills the criterion of frequent use and using a second procedure to respond to queries not pertaining to said health information which fulfills the criterion of frequent use.

8. A health information exchange method comprising:
defining and storing link elements linking between individual health care information items within a first population of health care information items;
receiving a second population of health care information items and associating at least some individual items in said second population, with corresponding individual items within said first population of health care information items; and
responding to queries regarding particular information items in said second population including translating said particular information items into items in said first population corresponding to said particular information items and using link elements linking said items in said first population corresponding to said particular information items to generate data pertaining to said particular information items in said second population.

9. A method according to claim 7 and also comprising making at least one health decision based on said queries.

10. A method according to claim 9 and also comprising implementing said at least one health decision.

11. A method according to claim 8 and also comprising making at least one health decision based on said queries.

12. A method according to claim 11 and also comprising implementing said at least one health decision.

13. A computer program product, comprising a computer usable medium having a computer readable program code embodied therein, said computer readable program code adapted to be executed to implement a health information exchange method comprising:
archiving health information using a health information encoding procedure only if said health information fulfills a criterion of frequent use; and
using a first procedure to respond to queries pertaining to said health information which fulfills the criterion of frequent use and using a second procedure to respond to queries not pertaining to said health information which fulfills the criterion of frequent use.

14. A computer program product, comprising a computer usable medium having a computer readable program code embodied therein, said computer readable program code adapted to be executed to implement a health information exchange method comprising:
defining and storing link elements linking between individual health care information items within a first population of health care information items;
receiving a second population of health care information items and for associating at least some individual items in said second population, with corresponding individual items within said first population of health care information items; and
responding to queries regarding particular information items in said second population including translating said particular information items into items in said first population corresponding to said particular information items and using link elements linking said items in said first population corresponding to said particular information items to generate data pertaining to said particular information items in said second population.

15. A computer program product according to claim 13 and wherein said method also comprises making at least one health decision based on said queries.

16. A computer program product according to claim 15 and wherein said method also comprises implementing said at least one health decision.

17. A computer program product according to claim 14 and wherein said method also comprises making at least one health decision based on said queries.

18. A computer program product according to claim 17 and wherein said method also comprises implementing said at least one health decision.

19. A method according to claim 8 wherein said second population of health care information items are expressed in a local terminology and are mapped to a baseline terminology in which said first population of health care information items are expressed, to enable terminology interoperability at least when responding to queries.

20. A method according to claim 19 wherein said baseline terminology is semantically enriched by associating semantic information therewith, the method also comprising generating conclusions about health information expressed in at least one local terminology by using said semantic information rather than by defining semantic relations for said local terminology.

21. A system according to claim 1 in which only a subset of a universe of health information is archived.

22. A system according to claim 2 and wherein said apparatus for responding to queries uses a first procedure to respond to queries pertaining to said subset and uses a second procedure to respond to queries not pertaining to said universe of health information but not pertaining to said subset.

23. A system according to claim 2 and also including an end user interface allowing end users to define rules; and a decision support subsystem (DSS) interacting with said end user interface and using semantic capabilities of a baseline terminology in which the first population of health information items is encoded, to simplify definition of rules by the end users.

24. A system according to claim 23 wherein said decision support subsystem comprises an Enterprise DSS which has a process cycle and which uses DSS rules to define all phases in said process cycle.

25. A method according to claim 8 wherein said translating and said using is applied to a use case involving processing of Smart Guard Adapters, said processing including at least one of developing, defining and configuring.

26. A method according to claim 8 wherein said translating and said using is applied to a use case involving a SmartWatch System, said use case including at least one of processing and monitoring health of said system.

27. A method according to claim 8 wherein said translating and said using are applied to a use case involving Managing Guard runtime.

28. A method according to claim 8 wherein said translating and said using are applied to a use case involving applying Guard changes.

29. A method according to claim 8 wherein said translating and said using are applied to a use case involving task activation based upon a schedule.

30. A method according to claim 8 wherein said translating and said using is applied to a use case involving identifying patients to be added to a defined population of patients.

31. A method according to claim 8 wherein said translating and said using are applied to a use case involving monitoring a population of patients including determining if they need to be evaluated, evaluating them thereby to generate at least one evaluation result, and responding to the evaluation result.

32. A method according to claim 7 wherein said health information encoding procedure includes mapping health information expressed in at least one local terminology to a baseline terminology to enable terminology interoperability and storing ontological information interrelating health information items expressed in said baseline terminology.

33. A system according to claim 2 wherein said ontological apparatus includes interrelationships between clinical-level information items.

34. A system according to claim 33 wherein said clinical-level information item comprises at least one health care information item specifying at least one of a disease, rather than only a class thereof, and a medication, rather than only a class thereof.

35. A system according to claim 2 wherein said ontological apparatus maps at least one legacy concept expressed in local terminology to at least one ontology concept expressed in a baseline terminology thereby allowing queries on the level of a single legacy concept to be responded to.
